(19) United States
(12) Patent Application Publication
(10) Pub. No.: US 2013/0338962 A1
(43) Pub. Date: Dec. 19, 2013

(54) Motion Event Detection

(71) Applicant: Jerry Alan Crandall, Fernley, NV (US)

(72) Inventor: Jerry Alan Crandall, Fernley, NV (US)

(21) Appl. No.: 13/524,406

(22) Filed: Jun. 15, 2012

(51) Int. Cl. G06F 15/00; G01P 3/00

(52) U.S. Cl. 702/142

(57) ABSTRACT

In an embodiment, a method of motion event detection is disclosed. The method may include or comprise identifying a velocity associated with an object, identifying a location associated with the object, identifying a predefined area associated with the location, and identifying a velocity threshold associated with the predefined area. The method may also include or comprise conducting a comparison between the velocity and the velocity threshold and detecting a motion event based on the comparison.

### TECHNICAL FIELD

The present application relates to the field of motion event detection.

### BACKGROUND

The detection of traffic violations is an important duty of many law enforcement officers and peacekeeping authorities in countries around the world. Indeed, various traffic violations, such as exceeding a legal vehicular speed threshold when operating heavy machinery, can put the safety of the operator and passengers of a vehicle, as well as the safety of innocent bystanders outside of the vehicle, in jeopardy. As such, various systems, apparatuses, devices, methods and software that are capable of helping law enforcement officers and peacekeeping authorities to better carry out their duties in this regard can be indispensible tools for modern day law enforcement and peacekeeping agencies and organizations.

### SUMMARY

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

In an embodiment, a method of motion event detection is disclosed. The method may include or comprise identifying a velocity associated with an object, identifying a location associated with the object, identifying a predefined area associated with the location, and identifying a velocity threshold associated with the predefined area. The method may also include or comprise conducting a comparison between the velocity and the velocity threshold and detecting a motion event based on the comparison.

Additionally, in one embodiment, a method of motion event detection is disclosed, wherein the method may include or comprise accessing velocity data identifying a velocity associated with an object, accessing location data identifying a location associated with the object, accessing location information from a location database based on the location data, wherein the location information identifies a predefined area associated with the location, and accessing velocity information based on the location information, wherein the velocity information identifies a velocity threshold associated with the predefined area. The method may also include or comprise forwarding the velocity data and the velocity information to an electronic difference engine to determine a difference between the velocity and the velocity threshold and detecting a motion event based on the difference.

Moreover, in an embodiment, a motion event detection system is disclosed. The motion event detection system may include or comprise a velocity identification module configured to identify a velocity associated with an object, a location identification module configured to identify a location associated with the object, and an area identification module communicatively associated with the location identification module, wherein the area identification module is configured to identify a predefined area associated with the location. The method may also include or comprise a threshold identification module communicatively associated with the area identification module, wherein the threshold identification module is configured to identify a velocity threshold associated with the predefined area, a comparator communicatively associated with the velocity and threshold identification modules, wherein the comparator is configured to conduct a comparison between the velocity and the velocity threshold, and a detection module communicatively associated with the comparator, wherein the detection module is configured to detect a motion event based on the comparison.

Furthermore, in one embodiment, a method of motion event detection is disclosed, wherein the method may include or comprise accessing velocity data identifying a velocity associated with an object, accessing location data identifying a location associated with the object, accessing location information from a location database based on the location data, wherein the location information identifies a predefined area associated with the location, and accessing velocity information based on the location information, wherein the velocity information identifies upper and lower velocity thresholds associated with the predefined area. The method may also include or comprise conducting a first comparison between the velocity and the upper velocity threshold so as to determine whether the velocity is greater than the upper velocity threshold, conducting a second comparison between the velocity and the lower velocity threshold so as to determine whether the velocity is less than the lower velocity threshold, and detecting the motion event based on the velocity being either greater than the upper velocity threshold or less than the lower velocity threshold.

### DESCRIPTION OF THE DRAWINGS

The accompanying drawings, which are incorporated in and form a part of this specification, illustrate embodiments of the present technology, and, together with the Detailed Description, serve to explain principles discussed below.

FIG. 1A is a plan view of a first exemplary motion scenario in accordance with an embodiment.

FIG. 1B is a perspective view of a second exemplary motion scenario in accordance with an embodiment.

FIG. 2 is a block diagram of an exemplary velocity identification system in accordance with an embodiment.

FIG. 3 is a block diagram of an exemplary velocity data generation system in accordance with an embodiment.

FIG. 4 is a block diagram of an exemplary location identification system in accordance with an embodiment.

FIG. 5 is a block diagram of an exemplary location data generation system in accordance with an embodiment.

FIG. 6 is a block diagram of an exemplary course, path or route identification system in accordance with an embodiment.

FIG. 7 is a block diagram of an exemplary course, path or route data generation system in accordance with an embodiment.

FIG. 8 is a block diagram of an exemplary area identification system in accordance with an embodiment.

FIG. 9 is a block diagram of an exemplary location information generation system in accordance with an embodiment.

FIG. 10 is a block diagram of a first exemplary threshold identification system in accordance with an embodiment.

FIG. 11 is a block diagram of a first exemplary velocity information generation system in accordance with an embodiment.

FIG. 12 is a block diagram of a second exemplary threshold identification system in accordance with an embodiment.

FIG. 13 is a block diagram of a second exemplary velocity information generation system in accordance with an embodiment.

FIG. 14 is a block diagram of a first exemplary motion event detection system in accordance with an embodiment.

FIG. 15 is a block diagram of a second exemplary motion event detection system in accordance with an embodiment.

FIG. 16 is a block diagram of a third exemplary motion event detection system in accordance with an embodiment.

FIG. 17 is a block diagram of a first exemplary velocity difference determination system in accordance with an embodiment.

FIG. 18 is a block diagram of a fourth exemplary motion event detection system in accordance with an embodiment.

FIG. 19 is a block diagram of a first exemplary difference threshold calculation system in accordance with an embodiment.

FIG. 20 is a block diagram of a first exemplary comparison generation system in accordance with an embodiment.

FIG. 21 is a block diagram of a fifth exemplary motion event detection system in accordance with an embodiment.

FIG. 22A is a block diagram of a second exemplary velocity difference determination system in accordance with an embodiment.

FIG. 22B is a block diagram of a third exemplary velocity difference determination system in accordance with an embodiment.

FIG. 22C is a block diagram of a fourth exemplary velocity difference determination system in accordance with an embodiment.

FIG. 23A is a block diagram of a sixth exemplary motion event detection system in accordance with an embodiment.

FIG. 23B is a block diagram of a seventh exemplary motion event detection system in accordance with an embodiment.

FIG. 24 is a block diagram of a second exemplary comparison generation system in accordance with an embodiment.

FIG. 25 is a block diagram of a second exemplary difference threshold calculation system in accordance with an embodiment.

FIG. 26 is a block diagram of an exemplary signal transceiver arrangement in accordance with an embodiment.

FIG. 27 is a block diagram of a first exemplary velocity calculation system in accordance with an embodiment.

FIG. 28 is a block diagram of an exemplary time difference determination system in accordance with an embodiment.

FIG. 29 is a block diagram of an exemplary distance determination system in accordance with an embodiment.

FIG. 30 is a block diagram of a second exemplary velocity calculation system in accordance with an embodiment.

FIG. 31 is a block diagram of a first exemplary parameter provision system in accordance with an embodiment.

FIG. 32 is a block diagram of a first exemplary location determination system in accordance with an embodiment.

FIG. 33 is a plan view of a first exemplary location determination scenario in accordance with an embodiment.

FIG. 34 is a block diagram of a second exemplary location determination system in accordance with an embodiment.

FIG. 35 is a plan view of a second exemplary location determination scenario in accordance with an embodiment.

FIG. 36 is a perspective view of a third exemplary location determination scenario in accordance with an embodiment.

FIG. 37 is a block diagram of an exemplary data storage system in accordance with an embodiment.

FIG. 38 is a block diagram of an exemplary data access system in accordance with an embodiment.

FIG. 39 is a block diagram of an exemplary course, path or route storage system in accordance with an embodiment.

FIG. 40 is a block diagram of a second exemplary parameter provision system in accordance with an embodiment.

FIG. 41 is a block diagram of a first exemplary course, path or route calculation system in accordance with an embodiment.

FIG. 42 is a block diagram of a second exemplary course, path or route calculation system in accordance with an embodiment.

FIG. 43 is a block diagram of an exemplary real-time information paradigm in accordance with an embodiment.

FIG. 44 is a block diagram of a first exemplary real-time information system in accordance with an embodiment.

FIG. 45 is a block diagram of an exemplary updated information generation system in accordance with an embodiment.

FIG. 46 is a block diagram of a first exemplary updated information display system in accordance with an embodiment.

FIG. 47 is a block diagram of a first exemplary information updating system in accordance with an embodiment.

FIG. 48 is a block diagram of a second exemplary updated information display system in accordance with an embodiment.

FIG. 49 is a block diagram of a second exemplary information updating system in accordance with an embodiment.

FIG. 50 is a block diagram of an exemplary tolerance system in accordance with an embodiment.

FIG. 51 is a block diagram of an exemplary tolerance calculation system in accordance with an embodiment.

FIG. 52 is a block diagram of a second exemplary real-time information system in accordance with an embodiment.

FIG. 53 is a block diagram of an exemplary response system in accordance with an embodiment.

FIG. 54A is a block diagram of a first exemplary alarm system in accordance with an embodiment.

FIG. 54B is a block diagram of a second exemplary alarm system in accordance with an embodiment.

FIG. 55 is a block diagram of a first exemplary velocity threshold selection system in accordance with an embodiment.

FIG. 56A is a block diagram of an exemplary factor selection system in accordance with an embodiment.

FIG. 56B is a block diagram of an exemplary date information generation system in accordance with an embodiment.

FIG. 56C is a block diagram of an exemplary time information generation system in accordance with an embodiment.

FIG. 56D is a block diagram of an exemplary traffic information generation system in accordance with an embodiment.

FIG. 56E is a block diagram of an exemplary road information generation system in accordance with an embodiment.

FIG. 56F is a block diagram of an exemplary weather information generation system in accordance with an embodiment.

FIG. 56G is a block diagram of an exemplary environmental information generation system in accordance with an embodiment.

FIG. 57 is a block diagram of an exemplary velocity threshold display system in accordance with an embodiment.

FIG. 58 is a block diagram of an exemplary velocity threshold updating system in accordance with an embodiment.

FIG. 59 is a block diagram of a second exemplary velocity threshold selection system in accordance with an embodiment.

FIG. 60 is a block diagram of an exemplary speed threshold selection system in accordance with an embodiment.

FIG. 61 is a block diagram of an exemplary tolerance threshold selection system in accordance with an embodiment.

FIG. 62A is a block diagram of a first exemplary communication arrangement in accordance with an embodiment.

FIG. 62B is a block diagram of a second exemplary communication arrangement in accordance with an embodiment.

FIG. 63 is a block diagram of an exemplary computer system in accordance with an embodiment.

FIG. 64 is a block diagram of an exemplary instruction execution system in accordance with an embodiment.

FIG. 65 is a flowchart of a first exemplary method of motion event detection in accordance with an embodiment.

FIG. 66 is a flowchart of a second exemplary method of motion event detection in accordance with an embodiment.

FIG. 67 is a flowchart of a third exemplary method of motion event detection in accordance with an embodiment.

FIG. 68 is a flowchart of a first exemplary method of velocity threshold selection in accordance with an embodiment.

FIG. 69 is a flowchart of a second exemplary method of velocity threshold selection in accordance with an embodiment.

The drawings referred to in this description are not to be understood as being drawn to scale except if specifically noted, and such drawings are only exemplary in nature.

### DETAILED DESCRIPTION

Reference will now be made in detail to embodiments of the present technology, examples of which are illustrated in the accompanying drawings. While the present technology will be described in conjunction with various embodiments, these embodiments are not intended to threshold the present technology. Rather, the present technology is to be understood as encompassing various alternatives, modifications and equivalents.

Additionally, it is noted that numerous specific details are set forth herein in order to provide a thorough understanding of the present technology. It is further noted, however, that these specific details are exemplary in nature, and that the present technology may be practiced without these specific details. In other instances, well-known methods, procedures, components, and circuits have not been described in detail so as to not unnecessarily obscure aspects of the exemplary embodiments presented herein.

Moreover, it is noted that discussions throughout the present detailed description that utilize terms indicating that some action or process is to occur may refer to the actions and processes of a computer system, or a similar electronic computing device. For example, the computer system or similar electronic computing device manipulates and transforms data represented as physical (e.g., electronic) quantities within the computer system's registers and memories into other data similarly represented as physical quantities within the computer system memories or registers, or other such information storage, transmission, or display devices. The present technology is also well-suited to the use of other types of computer systems, such as, for example, optical and mechanical computers. Furthermore, for purposes of clarity, the term “module” may be construed as being, for example, a hardware module, a software module, or a combination of a number of hardware modules and/or a number of software modules.

Thus, it is noted that the present technology may be described in the general context of computer-executable instructions, such as program modules, being executed by a computer. Such program modules may include, for example, routines, programs, objects, components, data structures, etc., that perform particular tasks or implement particular abstract data types. In addition, the present technology may also be practiced in distributed computing environments where tasks are performed by remote processing devices that are linked through a communications network. In a distributed computing environment, program modules may be located in both local and remote data storage media and computer memory devices.

The foregoing notwithstanding, it is further noted that terms indicating that some action or process is to occur may refer to manual actions or processes. Indeed, various embodiments of the present technology implement a combination of one or more computer-implemented actions or processes with one or more manual actions or processes. Moreover, one or more of these computer-implemented actions or processes may occur automatically, such as in response to (1) a specific user input, (2) a qualifying factor or parameter or (3) the occurrence of a previous action or process.

Furthermore, it is noted that the terminology “coupled with” does not necessarily indicate a direct physical relationship. For example, when two components are described as being “coupled with” one another, there may be one or more other parts, materials, etc. (e.g., an adhesive or a signal/transmission line), that are coupled between, attaching, integrating, etc., the two components. As such, the terminology “coupled with” shall be given its broadest possible meaning, unless otherwise indicated.

Additionally, the terminology “communicatively associated with” does not necessarily indicate a physical relationship. For example, when two components are described as being “communicatively associated with” one another, these components may be configured to communicate with one another, for example, using a wireless and/or wired communication protocol. As such, the terminology “communicatively associated with” shall be given its broadest possible meaning, unless otherwise indicated.

Moreover, it is noted that the exemplary unit of speed “miles per hour” (MPH) is presented herein for purposes of illustration, and that other units of speed may be implemented. For example, the applicable unit of speed may be meters per second (M/S), feet per second (F/S), kilometers per hour (KM/H) or knots. Indeed, the present technology is not limited to the implementation of any particular unit of speed.

Furthermore, it is noted that the terms “road” and “highway” are used in a number of examples provided herein, and that these terms are not intended to limit the scope of the present technology. Moreover, the terms “road” and “highway” may be construed, for example, as merely indicating a potential path of travel. Indeed, these terms shall be given their broadest possible meanings, unless otherwise indicated.

### Overview

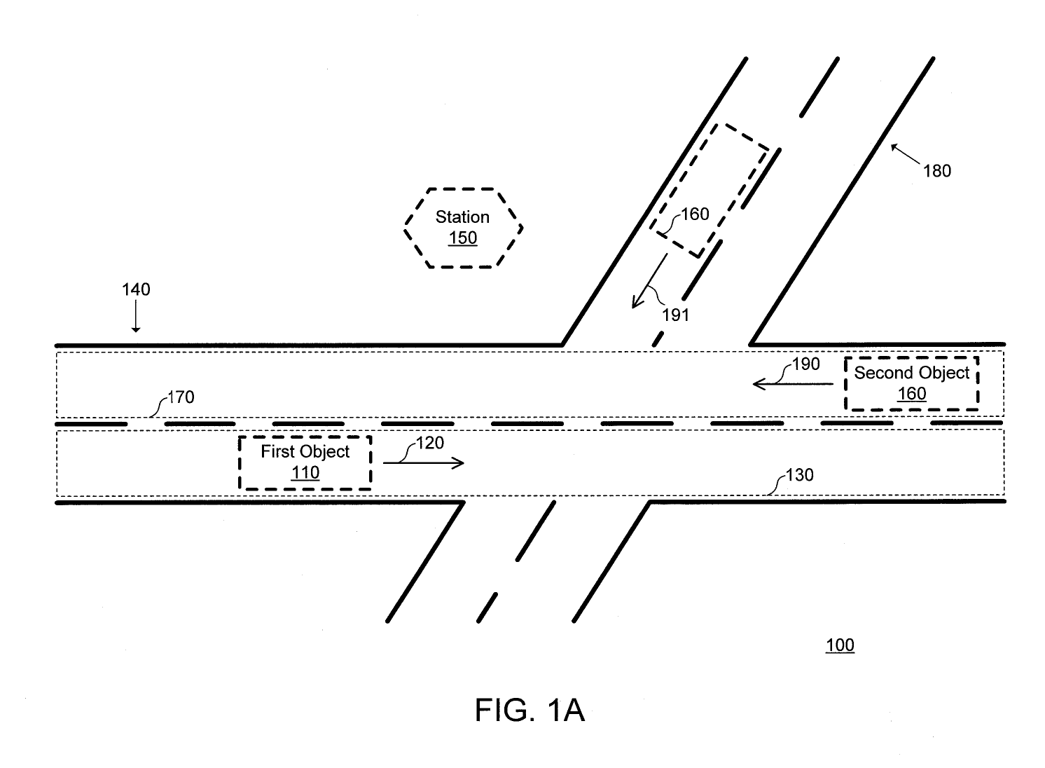

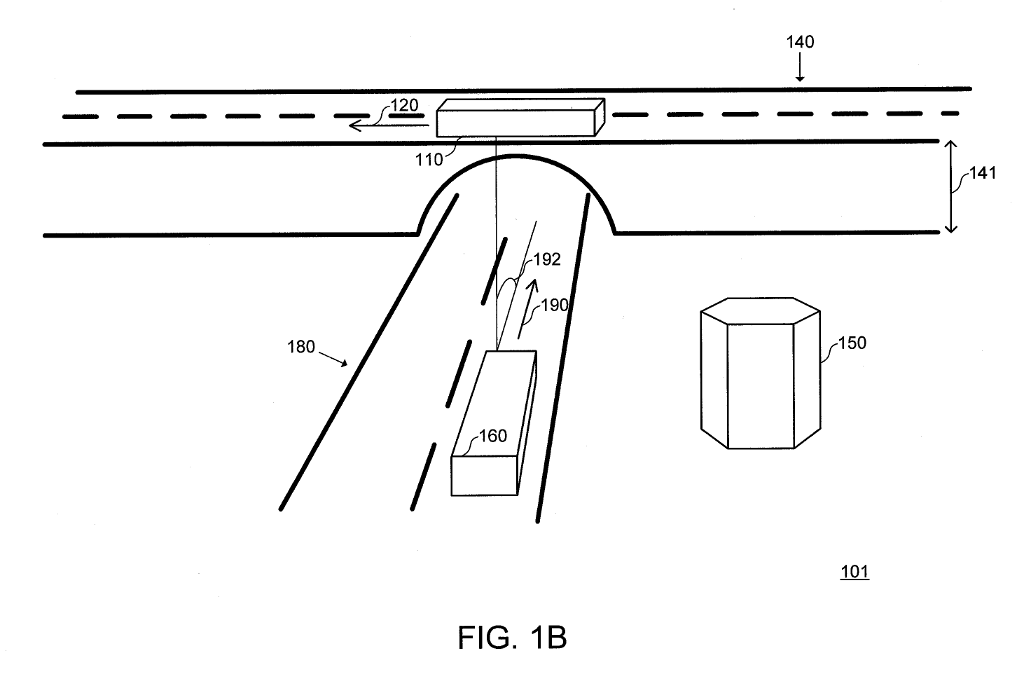

With reference now to FIG. 1A, a first exemplary motion scenario 100 in accordance with an embodiment is shown. In particular, a first object 110 (e.g., a civilian motor vehicle) is traveling in a first direction 120 along a first path in a first geographic area 130 (e.g., along a first lane of a first road or highway 140). A velocity and location of first object 110 is determined, such as with velocity and location determination devices integrated with a station 150 that is optionally positioned near first geographic area 130. Next, a velocity threshold (e.g., a vehicular speed threshold) associated with first geographic area 130 is automatically accessed (such as from a database of established velocity thresholds associated with predefined roads and highways), and the determined velocity of first object 110 is compared to this velocity threshold to determine if a motion event has occurred, such as where first object 110 has committed a traffic violation (e.g., by exceeding the applicable vehicular speed threshold).

The foregoing notwithstanding, in an embodiment, a second object 160 (e.g., a law enforcement motor vehicle) is positioned or traveling along a second path, such as in a second geographic area 170 (e.g., along a second lane of first road or highway 140 in a second direction 190) or along a lane of a second road or highway 180 in a third direction 191. It is noted that different vehicular speed thresholds may be associated with different lanes of the same road or highway, or with different roads or highways that intersect one another or are otherwise located near one another. A velocity and location of first object 110 is determined, such as with velocity and location determination devices integrated with second object 160, wherein a current velocity and/or location of second object 160 may be taken into account when determining (or approximating) the velocity and/or location of first object 110. Next, a velocity threshold (e.g., a vehicular speed threshold) associated with first geographic area 130 is automatically accessed (such as from a database of established velocity thresholds associated with predefined roads and highways), and the determined velocity of first object 110 is compared to this velocity threshold to determine if a motion event has occurred, such as where first object 110 has committed a traffic violation (e.g., by exceeding the applicable vehicular speed threshold).

With reference now to FIG. 1B, a second exemplary motion scenario 101 in accordance with an embodiment is shown. In particular, first and second objects 110, 160 are traveling along paths having different elevations. For example, as shown in FIG. 1B, first road or highway 140 is located a height 141 above second road or highway 180. Consequently, an angle of elevation 192 exists between the respective positions of first and second objects 110, 160. When first object 110 is located directly above second road or highway 180, as shown, this angle of elevation 192 may be utilized to determine whether first object 110 is traveling along first road or highway 140 or along second road or highway 180.

To illustrate, consider the example where a velocity and location of first object 110 is determined, such as with velocity and location determination devices integrated with second object 160. Additionally, angle of elevation 192 is determined, such as with an angle determination system integrated with second object 160. Next, a velocity threshold (e.g., a vehicular speed threshold) is automatically accessed (such as from a database of established velocity thresholds associated with predefined roads and highways) based on the determined velocity of first object 110 and angle of elevation, wherein the accessed velocity threshold is associated with first road or highway 140. The determined velocity of first object 110 may then be compared to this velocity threshold to determine if a motion event has occurred, such as Where first object 110 has committed a traffic violation (e.g., by exceeding the applicable vehicular speed threshold).

The foregoing notwithstanding, it is noted that the present technology may be implemented in conjunction with a number of different types of objects and pursuant to a number of different possible implementations. For example, first object 110 may be a land, water or aerial vehicle, and second object 160 may be a manned or unmanned aerial vehicle or drone that patrols a particular geographic area of interest in which first object 110 is currently traveling. Indeed, one exemplary implementation provides that second object 160 is an unmanned aerial vehicle equipped with a geographic positioning device (e.g., a Global Positioning System (GPS) receiver) configured to determine a current location of second object 160. Additionally, this current location of second object 160 serves as a reference point in determining (or approximating) a current location of first object 110 such that a predefined area in which first object 110 is currently traveling may be identified. Moreover, a velocity threshold assigned to this predefined area would then be accessed such that the current velocity of first object 110 could be compared to this velocity threshold.

Various exemplary embodiments of the present technology will now be discussed. It is noted, however, that the present technology is not limited to these exemplary embodiments, and that the present technology also includes obvious variations of the exemplary embodiments and implementations described herein. It is further noted that various well-known components are generally not illustrated in the drawings so as to not unnecessarily obscure various principles discussed herein, but that such well-known components may be implemented by those skilled in the art to practice various embodiments of the present technology.

### Exemplary Systems and Configurations

Various exemplary systems and configurations for implementing various embodiments of the present technology will now be described. However, the present technology is not limited to these exemplary systems and configurations. Indeed, other systems and configurations may be implemented.

I. Exemplary Data Identification and Generation Systems

In an embodiment, a motion event is identified or detected based on a number of data parameters. Consequently, a number of exemplary systems and configurations for identifying and/or generating such parameters will now be explored. However, the present technology is not limited to these exemplary systems and configurations. Indeed, other systems and configurations may be implemented.

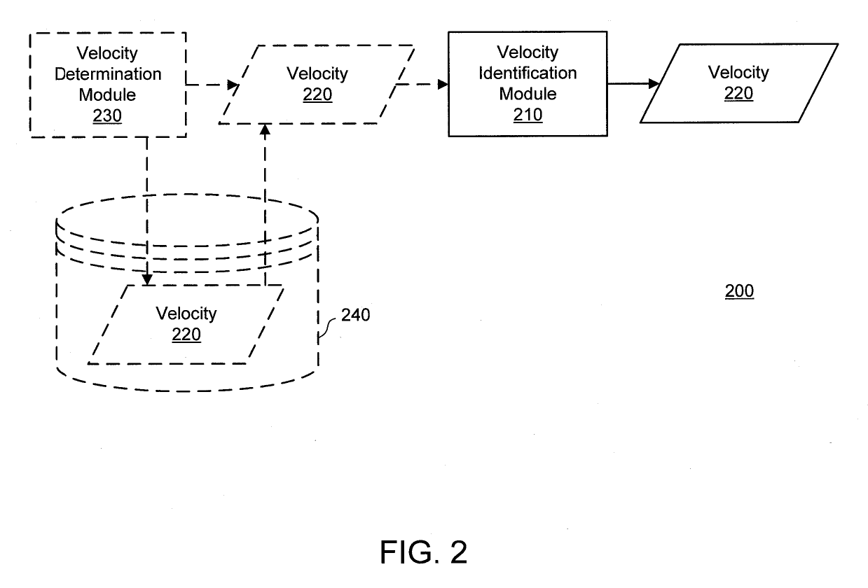

In an embodiment, a velocity of a traveling object, such as first object 110 shown in FIGS. 1A and 1B, is identified. To illustrate, and with reference now to FIG. 2, an exemplary velocity identification system 200 in accordance with an embodiment is shown. Exemplary velocity identification system 200 includes a velocity identification module 210 configured to identify a velocity 220 associated with an object, such as first object 110.

For example, in one embodiment, velocity identification module 210 includes or is integrated with a speed detection unit selected from a group of speed detection units that includes a radio detection and ranging (RADAR) speed detection unit and a light detection and ranging (LIDAR) speed detection unit. The foregoing notwithstanding, it is noted that various types of speed detection units may be implemented, and that the present technology is not limited to a specific type of speed detection unit. As such, a speed detection unit other than a RADAR or LIDAR speed detection unit may be implemented.

The foregoing notwithstanding, and with reference still to FIG. 2, an embodiment provides that velocity 220 is determined by an optional velocity determination module 230 and/or stored in an optional velocity storage unit 240. Additionally, velocity identification module 210, which may be communicatively associated or coupled with velocity determination module 230 and/or velocity storage unit 240, is configured to access the determined velocity. Pursuant to one embodiment, however, velocity identification module 210 is itself configured to determine velocity 220 based on information obtained by velocity identification module 210 that relates to the object's velocity. Indeed, it is noted that various velocity identification methodologies may be implemented, and that the present technology is not limited to any particular method of velocity identification.

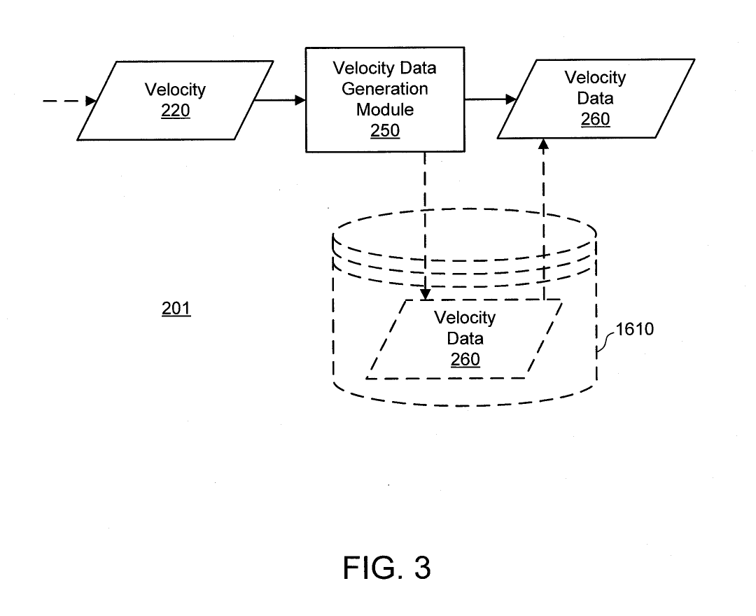

In an embodiment, velocity data, such as velocity data associated with velocity 220, is generated. To illustrate, and with reference now to FIG. 3, an exemplary velocity data generation system 201 in accordance with an embodiment is shown. Exemplary velocity data generation system 201 includes a velocity data generation module 250, which may be communicatively associated or coupled with velocity identification module 210 and/or velocity determination module 230. Velocity data generation module 250 is configured to generate velocity data 260 based on velocity 220.

To illustrate, consider the example where velocity 220 is determined to be 55 miles per hour (MPH). Velocity data generation module 250 generates velocity data 260, which is a digital or analog electronic signal, such that velocity data 260 reflects the numerical velocity “55” in a digital or analog for that that may be processed, for example, by a computer processing unit or microcontroller. It is noted, however, that various velocity data generation methodologies may be implemented. Indeed, the present technology is not limited to any particular method of velocity data generation.

The foregoing notwithstanding, and with reference still to FIG. 3, an embodiment provides that velocity data 260 may be stored in an optional velocity data storage unit 1610. In this manner, velocity data 260 can subsequently be accessed from velocity data storage unit 1610 when velocity data 260 is to be utilized. Pursuant to one embodiment, however, velocity data 260 may be acquired by another component or module directly from velocity data generation module 250. Indeed, it is noted that various velocity data identification methodologies may be implemented, and that the present technology is not limited to any particular method of velocity data identification.

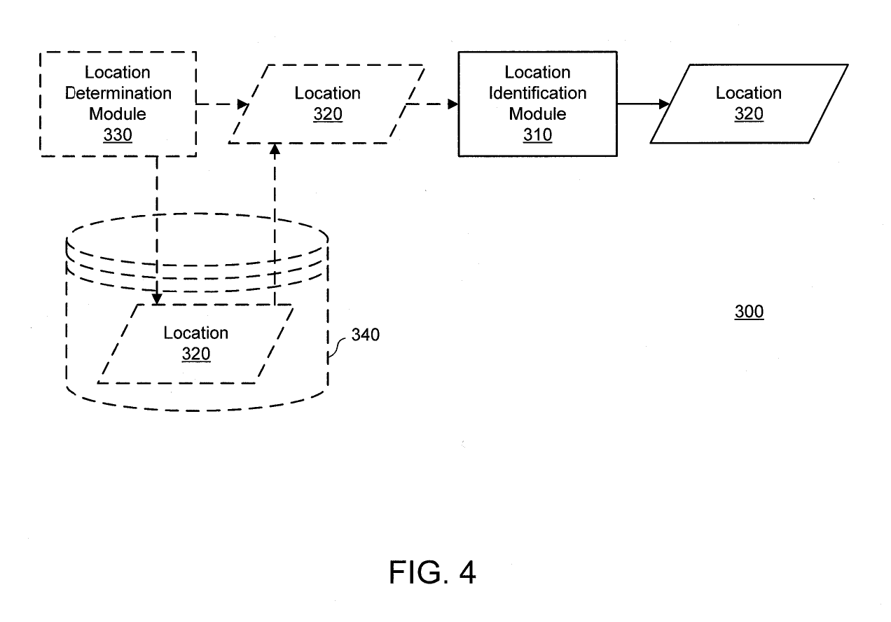

In an embodiment, a location of a traveling object, such as first object 110 shown in FIGS. 1A and 1B, is identified. To illustrate, and with reference now to FIG. 4, an exemplary location identification system 300 in accordance with an embodiment is shown. Exemplary location identification system 300 includes a location identification module 310 configured to identify a location 320 associated with an object, such as first object 110.

For example, in one embodiment, location identification module 310 includes or is integrated with a location detection unit selected from a group of location detection units that includes a RADAR location detection unit and a LIDAR location detection unit. The foregoing notwithstanding, it is noted that various types of location detection units may be implemented, and that the present technology is not limited to a specific type of location detection unit. As such, a location detection unit other than a RADAR or LIDAR location detection unit may be implemented.

The foregoing notwithstanding, and with reference still to FIG. 4, an embodiment provides that location 320 is determined by an optional location determination module 330 and/or stored in an optional location storage unit 340. Additionally, location identification module 310, which may be communicatively associated or coupled with location determination module 330 and/or location storage unit 340, is configured to access the determined location. Pursuant to one embodiment, however, location identification module 310 is itself configured to determine location 320 based on information obtained by location identification module 310 that relates to the object's location. Indeed, it is noted that various location identification methodologies may be implemented, and that the present technology is not limited to any particular method of location identification.

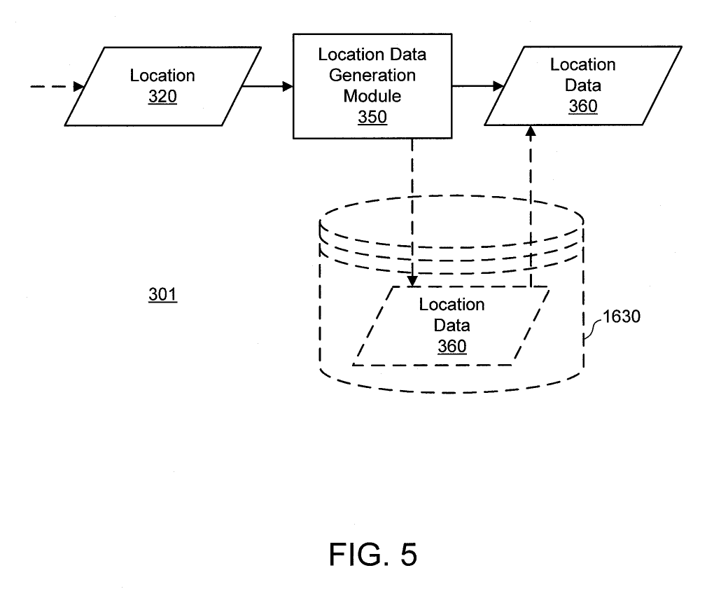

In an embodiment, location data, such as location data associated with location 320, is generated. To illustrate, and with reference now to FIG. 5, an exemplary location data generation system 301 in accordance with an embodiment is shown. Exemplary location data generation system 301 includes a location data generation module 350, which may be communicatively associated or coupled with location identification module 310 and/or location determination module 330. Location data generation module 350 is configured to generate location data 360 based on location 320.

To illustrate, consider the example where location 320 may be represented by the current, numerical latitude, longitude and/or elevation coordinates of first object 110. Location data generation module 350 generates location data 360, which is a digital or analog electronic signal, such that location data 360 reflects the numerical latitude, longitude and/or elevation coordinates of first object 110 in a digital or analog format that may be processed, for example, by a computer processing unit or microcontroller. It is noted, however, that various location data generation methodologies may be implemented. Indeed, the present technology is not limited to any particular method of location data generation.

The foregoing notwithstanding, and with reference still to FIG. 5, an embodiment provides that location data 360 may be stored in an optional location data storage unit 1630. In this manner, location data 360 can subsequently be accessed from location data storage unit 1630 when location data 360 is to be utilized. Pursuant to one embodiment, however, location data 360 may be acquired by another component or module directly from location data generation module 350. Indeed, it is noted that various location data identification methodologies may be implemented, and that the present technology is not limited to any particular method of location data identification.

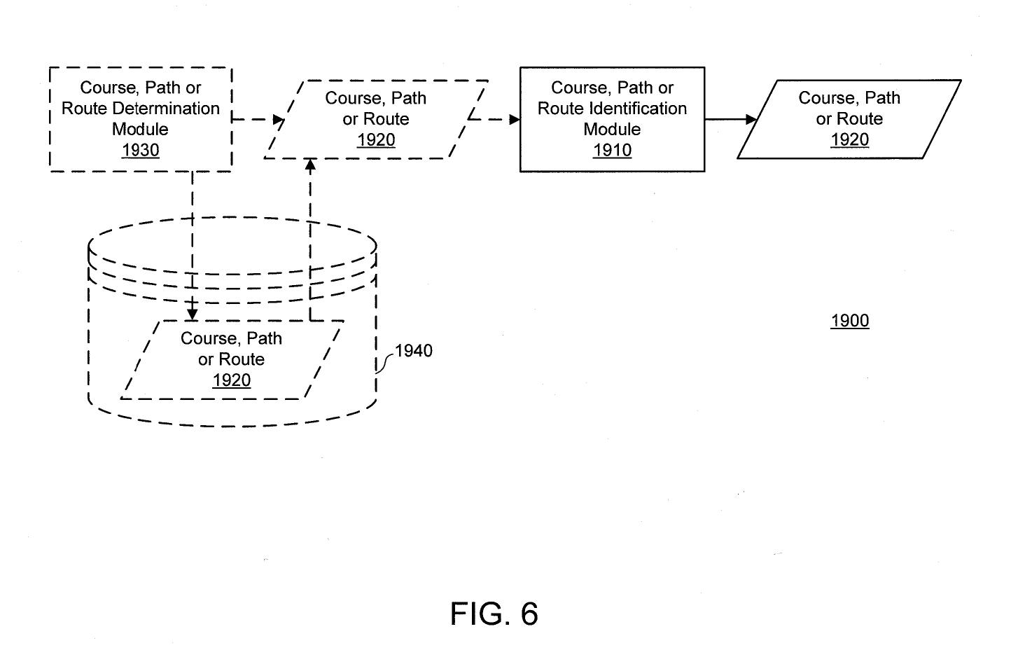

In an embodiment, a course, path or route of a traveling object, such as first object 110 shown in FIGS. 1A and 1B, is identified. To illustrate, and with reference now to FIG. 6, an exemplary course, path or route identification system 1900 in accordance with an embodiment is shown. Exemplary course, path or route identification system 1900 includes a course, path or route identification module 1910 configured to identify a course, path or route 1920 associated with an object, such as first object 110.

For example, in one embodiment, course, path or route identification module 1910 includes or is integrated with a course, path or route detection unit selected from a group of course, path or route detection units that includes a RADAR course, path or route detection unit and a LIDAR course, path or route detection unit. The foregoing notwithstanding, it is noted that various types of course, path or route detection units may be implemented, and that the present technology is not limited to a specific type of course, path or route detection unit. As such, a course, path or route detection unit other than a RADAR or LIDAR course, path or route detection unit may be implemented.

The foregoing notwithstanding, and with reference still to FIG. 6, an embodiment provides that course, path or route 1920 is determined by an optional course, path or route determination module 1930 and/or stored in an optional course, path or route storage unit 1940. Additionally, course, path or route identification module 1910, which may be communicatively associated or coupled with course, path or route determination module 1930 and/or course, path or route storage unit 1940, is configured to access the determined course, path or route. Pursuant to one embodiment, however, course, path or route identification module 1910 is itself configured to determine course, path or route 1920 based on information obtained by course, path or route identification module 1910 that relates to the object's course, path or route. Indeed, it is noted that various course, path or route identification methodologies may be implemented, and that the present technology is not limited to any particular method of course, path or route identification.

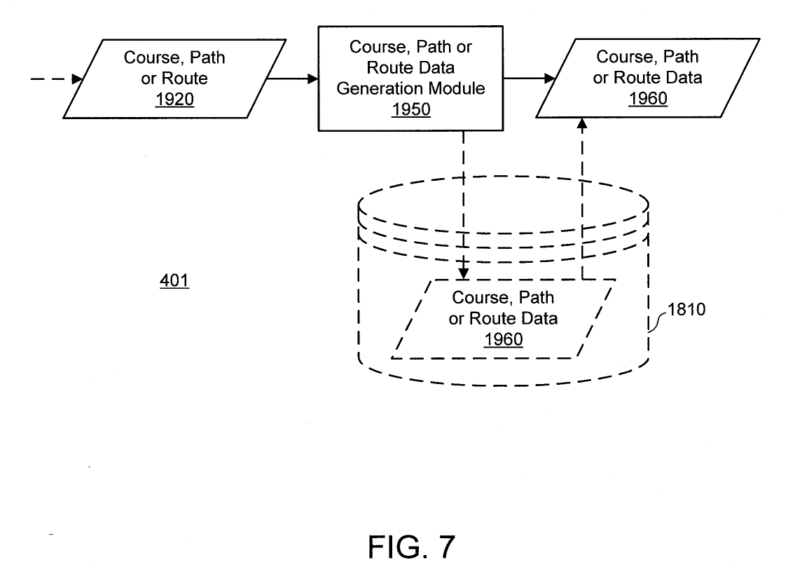

In an embodiment, course, path or route data, such as course, path or route data associated with course, path or route 1920, is generated. With reference now to FIG. 7, an exemplary course, path or route data generation system 401 in accordance with an embodiment is shown. Exemplary course, path or route data generation system 401 includes a course, path or route data generation module 1950, which may be communicatively associated or coupled with course, path or route identification module 1910 and/or course, path or route determination module 1930. Course, path or route data generation module 1950 is configured to generate course, path or route data 1960 based on course, path or route 1920.

To illustrate, consider the example where course, path or route 1920 is determined to be 30 degrees East of North with a 15 degree angle of elevation relative to a horizontal plane. Course, path or route data generation module 1950 generates course, path or route data 1960, which is a digital or analog electronic signal, such that course, path or route data 1960 reflects this numerical and directional data in a digital or analog format that may be processed, for example, by a computer processing unit or microcontroller. It is noted, however, that various course, path or route data generation methodologies may be implemented. Indeed, the present technology is not limited to any particular method of course, path or route data generation.

The foregoing notwithstanding, and with reference still to FIG. 7, an embodiment provides that course, path or route data 1960 may be stored in an optional course, path or route data storage unit 1810. In this manner, course, path or route data 1960 can subsequently be accessed from course, path or route data storage unit 1810 when course, path or route data 1960 is to be utilized. Pursuant to one embodiment, however, course, path or route data 1960 may be acquired by another component or module directly from course, path or route data generation module 1950. Indeed, it is noted that various course, path or route data identification methodologies may be implemented, and that the present technology is not limited to any particular method of course, path or route data identification.

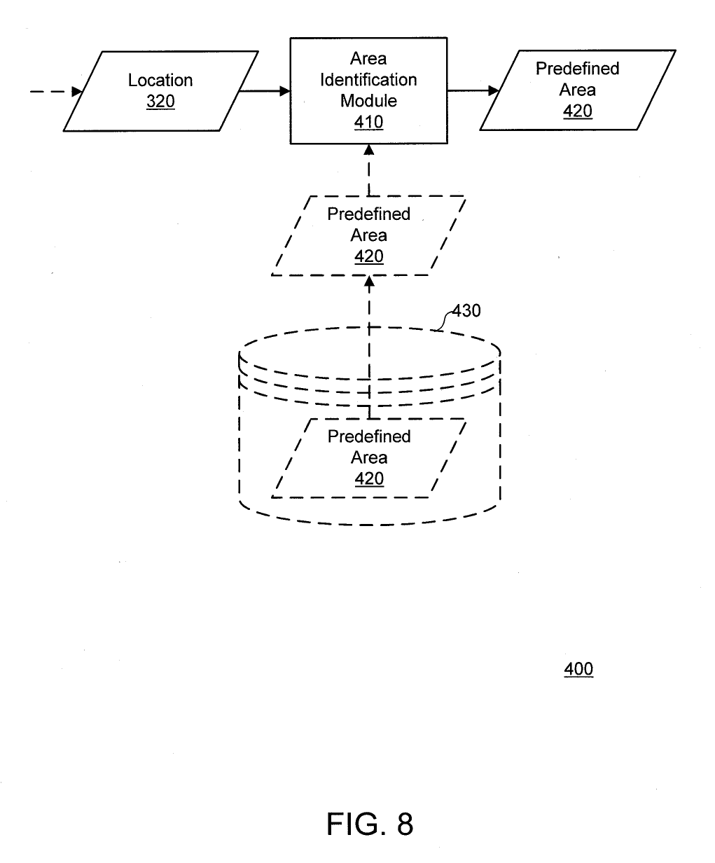

In an embodiment, a predefined area, such as a predefined area associated with location 320, is identified. To illustrate, and with reference now to FIG. 8, an exemplary area identification system 400 in accordance with an embodiment is shown. Exemplary area identification system 400 includes an area identification module 410 configured to identify a predefined area 420 associated with location 320. Indeed, in one embodiment, area identification module 410 is configured to identify predefined area 420 based on location 320.

For example, once a current position (e.g., location 320) of first object 110 is identified, a geographical region (e.g., predefined area 420) within which this current position is located is next identified by area identification module 410. Subsequently, a vehicular speed threshold assigned to this geographical region may be identified so as to determine whether first object 110 is traveling at a rate of speed that exceeds this vehicular speed threshold. It is noted, however, that various types of area identification modules may be implemented, and that the present technology is not limited to a specific type of area identification module.

The foregoing notwithstanding, and with reference still to FIG. 8, an embodiment provides that predefined area 420 is stored in an optional area database 430, and area identification module 410, which may be communicatively associated or coupled with area database 430, is configured to access predefined area 420 from area database 430. In accordance with one embodiment, however, predefined area 420 is routed to area identification module 410 by a router and/or server (not shown). Indeed, it is noted that various area identification methodologies may be implemented, and that the present technology is not limited to any particular method of area identification.

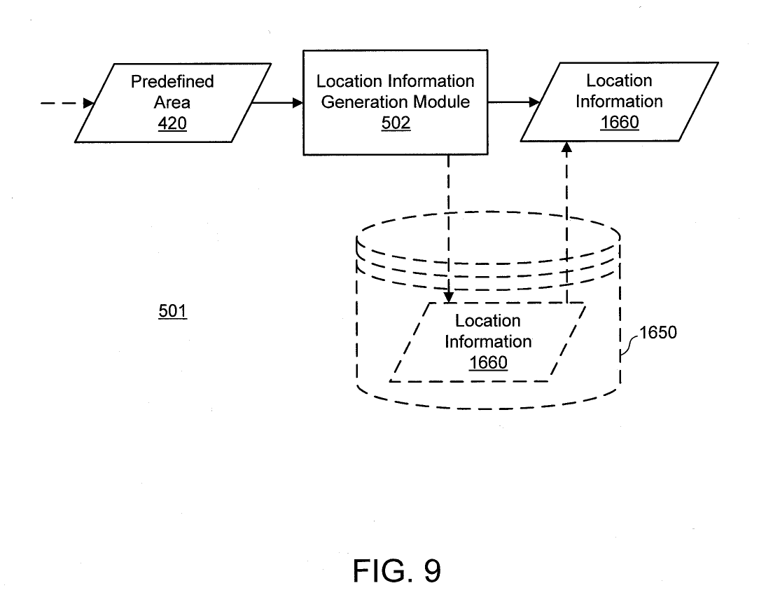

In an embodiment, location information, such as location information associated with predefined area 420, is identified. To illustrate, and with reference now to FIG. 9, an exemplary location information generation system 501 in accordance with an embodiment is shown. Exemplary location information generation system 501 includes a location information generation module 502, which may be communicatively associated or coupled with area identification module 410. Location information generation module 502 is configured to generate location information 1660 based on predefined area 420.

It is noted that, pursuant to one embodiment, location information 1660 identifies predefined area 420. To illustrate, consider the example where first object 110 is currently within a specific geographical region corresponding to predefined area 420, and where a current position (e.g., location 320) of first object 110 is identified to be within predefined area 420. Location information 1660, which identifies this predefined area 420, may be accessed once location information 1660 is generated by location information generation module 502, and a vehicular speed threshold assigned to predefined area 420 may subsequently be identified so as to determine whether first object 110 is traveling at a rate of speed within predefined area 420 that exceeds this vehicular speed threshold. It is noted, however, that various types of location information generation modules may be implemented, and that the present technology is not limited to a specific type of location information generation module.

The foregoing notwithstanding, and with reference still to FIG. 9, an embodiment provides that location information 1660 may be stored in an optional location database 1650. In this manner, location information 1660 can subsequently be accessed from location database 1650 when location information 1660 is to be utilized. Pursuant to one embodiment, however, location information 1660 may be acquired by another component or module directly from location information generation module 502. Indeed, it is noted that various location information identification methodologies may be implemented, and that the present technology is not limited to any particular method of location information identification.

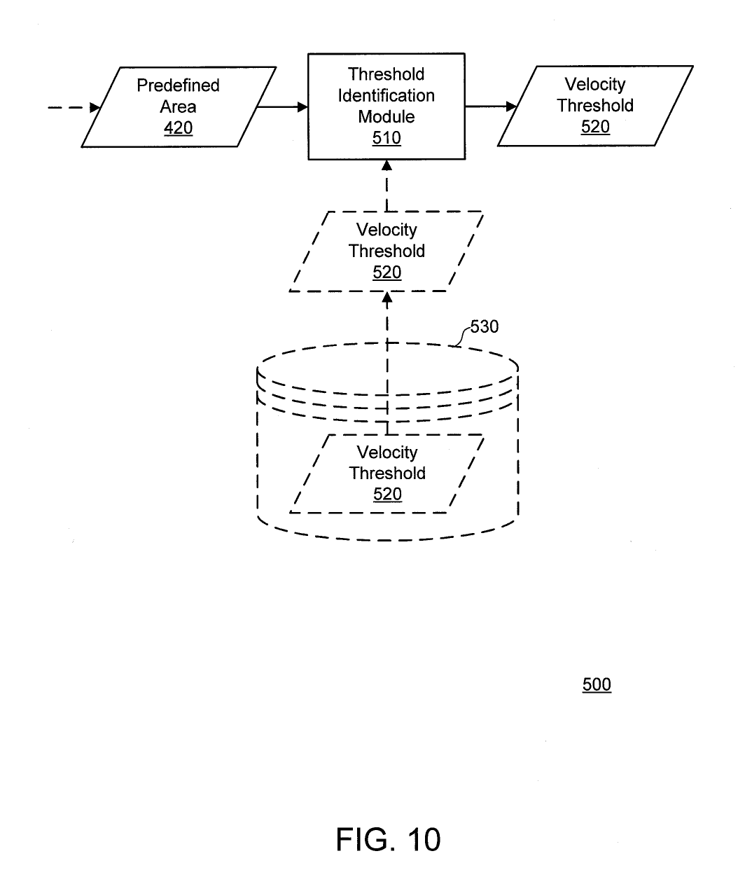

In an embodiment, a velocity threshold, such as a velocity threshold associated with predefined area 420, is identified. To illustrate, and with reference now to FIG. 10, a first exemplary threshold identification system 500 in accordance with an embodiment is shown. First exemplary threshold identification system 500 includes a threshold identification module 510 configured to identify a velocity threshold 520 associated with predefined area 420. Indeed, in one embodiment, threshold identification module 510 is configured to identify velocity threshold 520 based on predefined area 420. It is noted, however, that various types of threshold identification modules may be implemented, and that the present technology is not limited to a specific type of threshold identification module.

It is noted that, pursuant to one embodiment, velocity threshold 520 is a vehicular speed threshold associated with or assigned to predefined area 420. To illustrate, consider the example where velocity threshold 520 is an upper vehicular speed threshold (e.g., a maximum allowable vehicular velocity), or lower vehicular speed threshold (e.g., a minimum allowable vehicular velocity), assigned to a specific road, path or geographical area. For example, a highway may be assigned an upper vehicular speed threshold of 65 MPH, such that a law enforcement officer may issue a citation to a driver that is traveling at a rate of speed above this threshold. Additionally, this same highway may also be assigned a lower vehicular speed threshold (e.g., 40 MPH), since slow moving vehicles can increase the chances of road collisions when the flow of traffic is generally moving at a velocity that is relatively at or around the upper vehicular speed threshold of 65 MPH.

The foregoing notwithstanding, an embodiment provides that velocity threshold 520 is defined to be above or below a vehicular speed threshold associated with or assigned to predefined area 420, such as based on a preselected upper or lower margin. To illustrate, consider the example where velocity threshold 520 is defined as an upper velocity threshold of 70 MPH, which is 5 MPH greater than an upper vehicular speed threshold of 65 MPH that is assigned to a specific road, path or geographical area, such that a law enforcement officer may issue a citation to a driver that is traveling at a rate of speed above this upper velocity threshold of 70 MPH. In a second example, velocity threshold 520 is defined as a lower velocity threshold of 35 MPH, which is 5 MPH less than a lower vehicular speed threshold of 40 MPH that is assigned to a specific road, path or geographical area, such that a law enforcement officer may issue a citation to a driver that is traveling at a rate of speed below this lower velocity threshold of 35 MPH.

The foregoing notwithstanding, and with reference still to FIG. 10, an embodiment provides that velocity threshold 520 is stored in an optional threshold database 530, and threshold identification module 510, which may be communicatively associated or coupled with threshold database 530, is configured to access velocity threshold 520 from threshold database 530. In accordance with one embodiment, however, velocity threshold 520 is routed to threshold identification module 510 by a router and/or server (not shown). Indeed, it is noted that various threshold identification methodologies may be implemented, and that the present technology is not limited to any particular method of threshold identification.

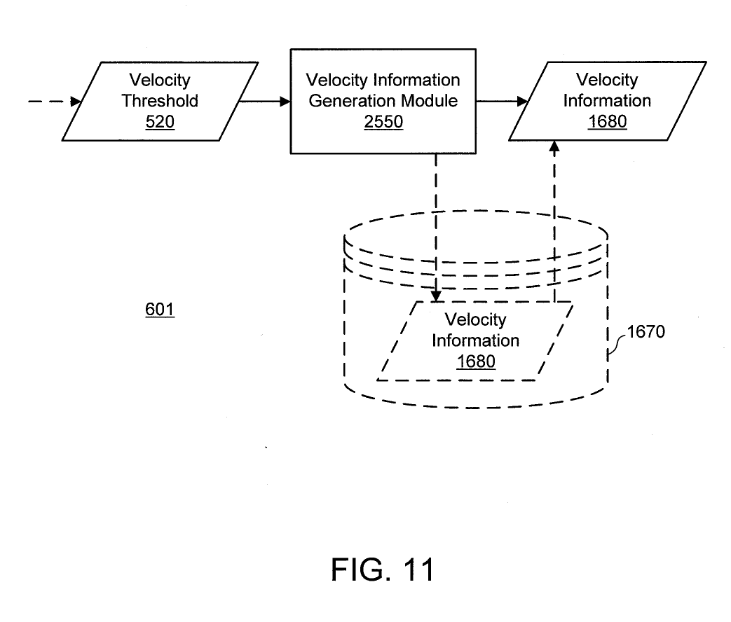

In an embodiment, velocity information, such as velocity information associated with velocity threshold 520, is generated. To illustrate, and with reference now to FIG. 11, a first exemplary velocity information generation system 601 in accordance with an embodiment is shown. First exemplary velocity information generation system 601 includes a velocity information generation module 2550, which may be communicatively associated or coupled with threshold identification module 510. Velocity information generation module 2550 is configured to generate velocity information 1680 based on velocity threshold 520. It is noted, however, that various types of velocity information generation modules may be implemented, and that the present technology is not limited to a specific type of velocity information generation module.

It is noted that, pursuant to one embodiment, velocity information 1680 identifies velocity threshold 520. To illustrate, consider the example where velocity threshold 520 is a numerical speed threshold associated with or assigned to predefined area 420, such as an upper or lower vehicular speed threshold assigned to a specific road, path or geographical area within predefined area 420. Velocity information 1680 includes digital or analog data that indicates this numerical speed threshold, wherein this digital or analog data may be processed by a data processing unit (not shown).

The foregoing notwithstanding, and with reference still to FIG. 11, an embodiment provides that velocity information 1680 may be stored in an optional velocity database 1670. In this manner, velocity information 1680 can subsequently be accessed from velocity database 1670 when velocity information 1680 is to be utilized. Pursuant to one embodiment, however, velocity information 1680 may be acquired by another component or module directly from velocity information generation module 2550. Indeed, it is noted that various velocity information identification methodologies may be implemented, and that the present technology is not limited to any particular method of velocity information identification.

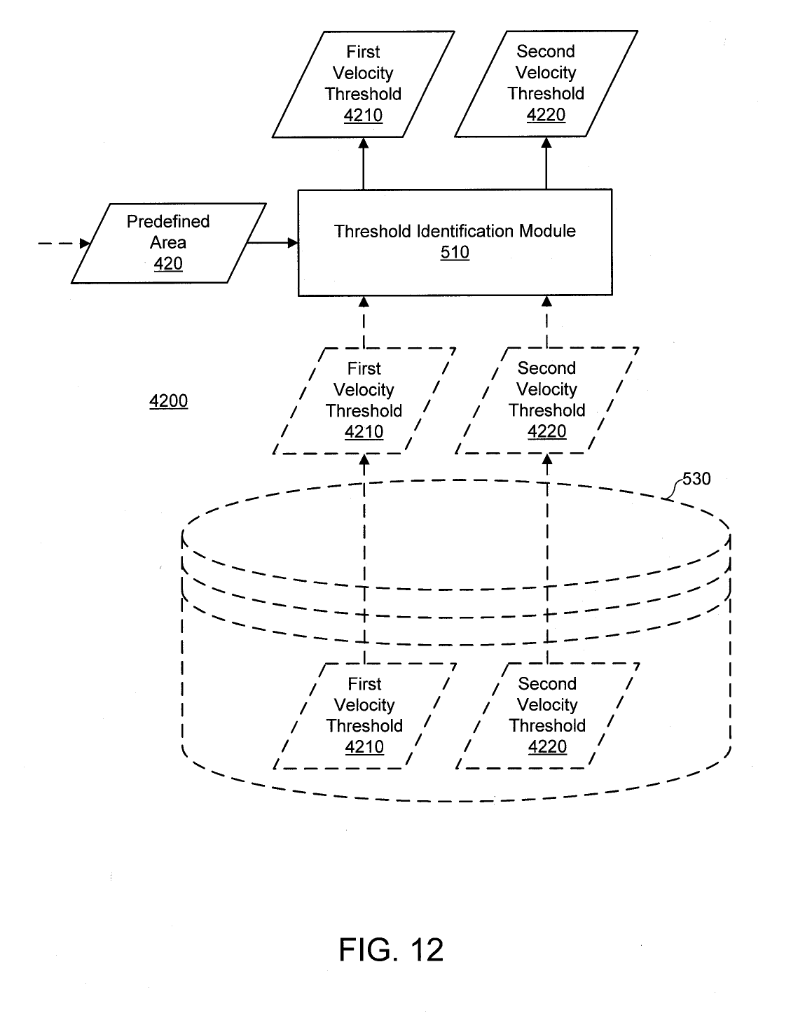

In an embodiment, to or more different velocity thresholds, such as a number of distinct velocity thresholds associated with predefined area 420, are identified. To illustrate, and with reference now to FIG. 12, a second exemplary threshold identification system 4200 in accordance with an embodiment is shown. Second exemplary threshold identification system 4200 includes threshold identification module 510, which is configured to identify first and second velocity thresholds 4210, 4220 associated with predefined area 420. Indeed, in one embodiment, threshold identification module 510 is configured to identify first and second velocity thresholds 4210, 4220 based on predefined area 420. It is noted, however, that various types of threshold identification modules may be implemented, and that the present technology is not limited to a specific type of threshold identification module.

It is noted that, pursuant to one embodiment, first and second velocity thresholds 4210, 4220 are different vehicular speed thresholds associated with or assigned to predefined area 420. To illustrate, consider the example where first velocity threshold 4210 is an upper vehicular speed threshold (e.g., a maximum allowable vehicular velocity) assigned to a specific road, path or geographical area, and where second velocity threshold 4220 is a lower vehicular speed threshold (e.g., a minimum allowable vehicular velocity) assigned to the same road, path or geographical area. For example, a highway may be assigned an upper vehicular speed threshold of 65 MPH, such that a law enforcement officer may issue a citation to a driver that is traveling at a rate of speed above this threshold. Additionally, this same highway may also be assigned a lower vehicular speed threshold (e.g., 40 MPH), since slow moving vehicles can increase the chances of road collisions when the flow of traffic is generally moving at a velocity that is relatively at or around the upper vehicular speed threshold of 65 MPH.

The foregoing notwithstanding, an embodiment provides that first velocity threshold 4210 is defined to be above an upper vehicular speed threshold associated with or assigned to predefined area 420, such as based on a preselected margin, while second velocity threshold 4220 is defined to be below a lower vehicular speed threshold associated with or assigned to predefined area 420, such as based on this same preselected lower margin. To illustrate, consider the example where first velocity threshold 4210 is defined as an upper velocity threshold of 75 MPH, which is 10 MPH (e.g., the preselected margin) greater than an upper vehicular speed threshold of 65 MPH that is assigned to a specific road, path or geographical area, such that a law enforcement officer may issue a citation to a driver that is traveling at a rate of speed above this upper velocity threshold of 75 MPH. Additionally, second velocity threshold 4220 is defined as a lower velocity threshold of 30 MPH, which is 10 MPH (e.g., the preselected margin) less than a lower vehicular speed threshold of 40 MPH that is assigned to this same road, path or geographical area, such that a law enforcement officer may issue a citation to a driver that is traveling at a rate of speed below this lower velocity threshold of 30 MPH.

Similarly, in one embodiment, first velocity threshold 4210 is defined to be above an upper vehicular speed threshold associated with or assigned to predefined area 420, such as based on a preselected upper margin, while second velocity threshold 4220 is defined to be below a lower vehicular speed threshold associated with or assigned to predefined area 420, such as based on a preselected lower margin. To illustrate, consider the example where first velocity threshold 4210 is defined as an upper velocity threshold of 75 MPH, which is 10 MPH the preselected upper margin) greater than an upper vehicular speed threshold of 65 MPH that is assigned to a specific road, path or geographical area, such that a law enforcement officer may issue a citation to a driver that is traveling at a rate of speed above this upper Velocity threshold of 75 MPH. Additionally, second velocity threshold 4220 is defined as a lower velocity threshold of 35 MPH, which is 5 MPH (e.g., the preselected lower margin) less than a lower vehicular speed threshold of 40 MPH that is assigned to this same road, path or geographical area, such that a law enforcement officer may issue a citation to a driver that is traveling at a rate of speed below this lower velocity threshold of 35 MPH.

Furthermore, an embodiment provides that first velocity threshold 4210 is an upper velocity threshold that is higher than a vehicular speed threshold associated with or assigned to predefined area 420, such as based on a preselected margin, while second velocity threshold 4220 is a lower velocity threshold that is lower than this same vehicular speed threshold, such as based on the same preselected margin. To illustrate, consider the example where first velocity threshold 4210 is defined as an upper velocity threshold of 45 MPH, which is 10 MPH (e.g., the preselected margin) greater than a vehicular speed threshold of 35 MPH that is assigned to a specific road, path or geographical area, such that a law enforcement officer may issue a citation to a driver that is traveling at a rate of speed above this upper velocity threshold of 45 MPH. Additionally, second velocity threshold 4220 is defined as a lower velocity threshold of 25 MPH, which is 10 MPH (e.g., the preselected margin) less than this same vehicular speed threshold of 35 MPH, such that a law enforcement officer may issue a citation to a driver that is traveling at a rate of speed below this lower velocity threshold of 25 MPH.

Similarly, in one embodiment, first velocity threshold 4210 is an upper velocity threshold that is higher than a vehicular speed threshold associated with or assigned to predefined area 420, such as based on a preselected upper margin, while second velocity threshold 4220 is a lower velocity threshold that is lower than this same vehicular speed threshold, such as based on a preselected lower margin. To illustrate, consider the example where first velocity threshold 4210 is defined as an upper velocity threshold of 45 MPH, which is 10 MPH (e.g., the preselected upper margin) greater than a vehicular speed threshold of 35 MPH that is assigned to a specific road, path or geographical area, such that a law enforcement officer may issue a citation to a driver that is traveling at a rate of speed above this upper velocity threshold of 45 MPH. Additionally, second velocity threshold 4220 is defined as a lower velocity threshold of 20 MPH, which is 15 MPH (e.g., the preselected lower margin) less than this same vehicular speed threshold of 35 MPH, such that a law enforcement officer may issue a citation to a driver that is traveling at a rate of speed below this lower velocity threshold of 20 MPH.

The foregoing notwithstanding, and with reference still to FIG. 12, an embodiment provides that first and second velocity thresholds 4210, 4220 are stored in optional threshold database 530. Additionally, threshold identification module 510, which may be communicatively associated or coupled with threshold database 530, is configured to access first and second velocity thresholds 4210, 4220 from threshold database 530. In accordance with one embodiment, however, first and second velocity thresholds 4210, 4220 are routed to threshold identification module 510 by a router and/or server (not shown). Indeed, it is noted that various threshold identification methodologies may be implemented, and that the present technology is not limited to any particular method of threshold identification.

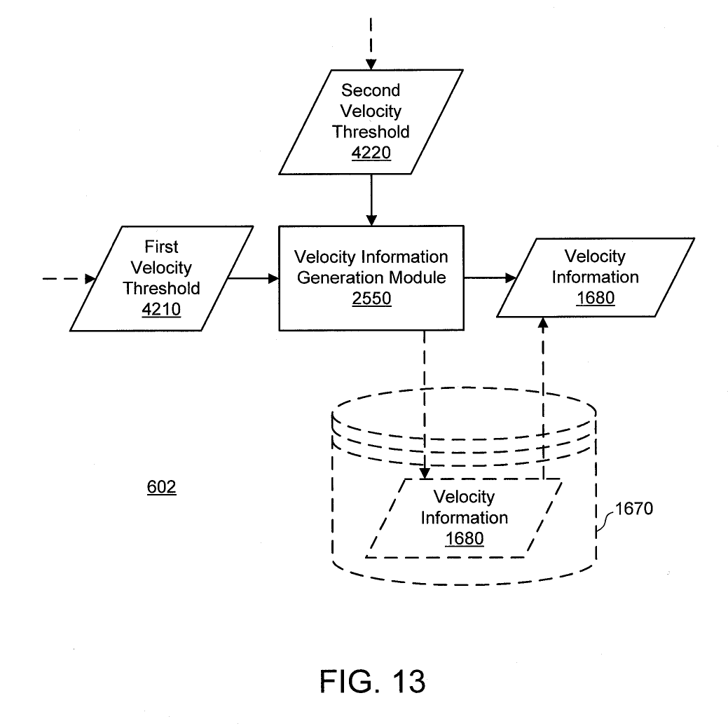

In an embodiment, velocity information, such as velocity information associated with velocity threshold 520, is generated. To illustrate, and with reference now to FIG. 13, a second exemplary velocity information generation system 602 in accordance with an embodiment is shown. Second exemplary velocity information generation system 602 includes velocity information generation module 2550, which may be communicatively associated or coupled with threshold identification module 510. Velocity information generation module 2550 is configured to generate velocity information 1680 based on first and second velocity thresholds 4210, 4220. It is noted, however, that various types of velocity information generation modules may be implemented, and that the present technology is not limited to a specific type of velocity information generation module.

It is noted that, pursuant to one embodiment, velocity information 1680 identifies first and second velocity thresholds 4210, 4220. To illustrate, consider the example where first and second velocity thresholds 4210, 4220 are upper and lower numerical speed thresholds, respectively, associated with or assigned to predefined area 420, such as upper or lower vehicular speed thresholds, respectively, assigned to a specific road, path or geographical area within predefined area 420. Velocity information 1680 includes digital or analog data that indicates these numerical speed thresholds, wherein this digital or analog data may be processed by a data processing unit (not shown).

The foregoing notwithstanding, and with reference still to FIG. 11, an embodiment provides that velocity information 1680 may be stored in an optional velocity database 1670. In this manner, velocity information 1680 can subsequently be accessed from velocity database 1670 when velocity information 1680 is to be utilized. Pursuant to one embodiment, however, velocity information 1680 may be acquired by another component or module directly from velocity information generation module 2550. Indeed, it is noted that various velocity information identification methodologies may be implemented, and that the present technology is not limited to any particular method of velocity information identification.

II. Exemplary Motion Event Detection Systems

In view of the foregoing, it is noted that, in an embodiment, a number of data parameters are identified, wherein such data parameters may then be utilized to identify or detect a motion event. Consequently, a number of exemplary systems and configurations for identifying or detecting a motion event will now be explored. However, the present technology is not limited to these exemplary systems and configurations. Indeed, other systems and configurations may be implemented.

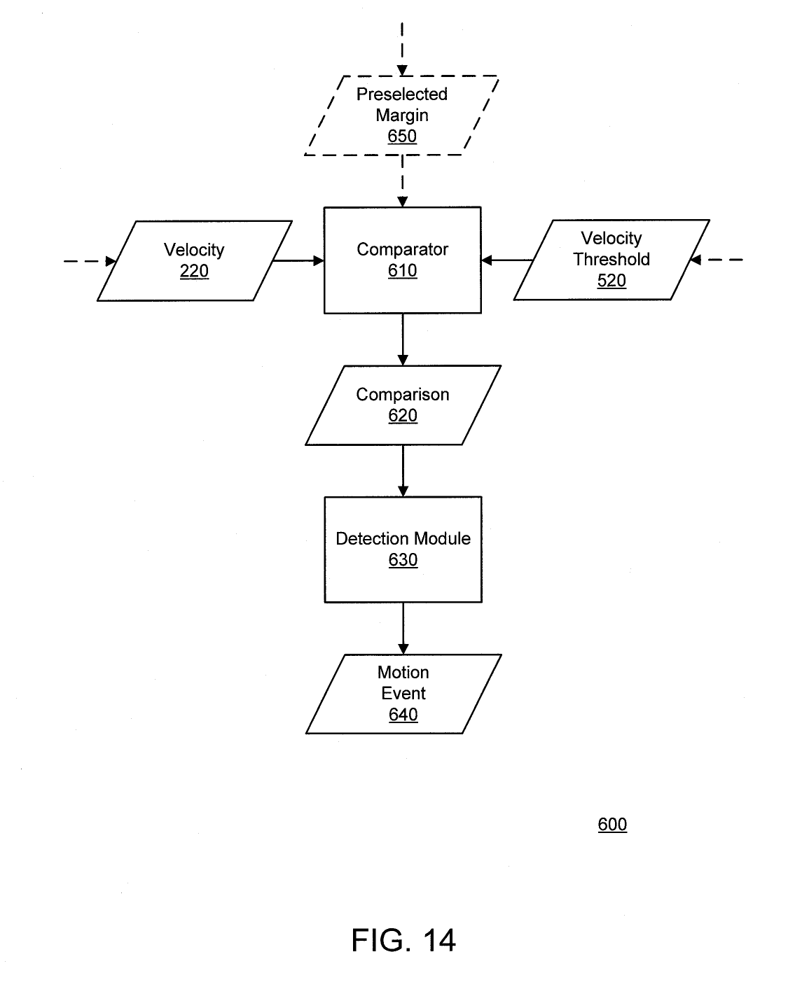

With reference now to FIG. 14, a first exemplary motion event detection system 600 in accordance with an embodiment is shown. First exemplary motion event detection system 600 includes a comparator 610 configured to conduct a comparison 620 between velocity 220 and velocity threshold 520. To illustrate, comparator 610 may be configured to determine or calculate whether velocity 220 is greater or less than velocity threshold 520, and comparison 620 would be, for example, (1) a binary output (e.g., a “1” state or a “0” state in Boolean algebra or logic) reflecting this determination or calculation or (2) a digital or analog output reflecting the degree (e.g., the number of miles per hour) by which velocity 220 is greater or less than velocity threshold 520.

With reference still to FIG. 14, first exemplary motion event detection system 600 also includes a detection module 630, which may be communicatively associated or coupled with comparator 610. Detection module 630 is configured to detect a motion event 640 based on comparison 620. It is noted that motion event 640 may be, for example, a citable speeding violation, such as when a vehicle is traveling at a rate of speed within predefined area 420 that is above or below an applicable vehicular speed threshold by a preselected margin. It is further noted, however, that the present technology is not limited to the detection of a particular type of motion event.

in an embodiment, detection module 630 is configured to detect motion event 640 if velocity 220 is greater than velocity threshold 520. To illustrate, consider the example where velocity threshold 520 is defined as the vehicular speed threshold along a particular road or highway in which a vehicle, such as first object 110, is currently traveling at velocity 220. Comparison 620 is a binary value that is a logic “1” (e.g., +5 volts) if velocity 220 is determined to be greater than velocity threshold 520. In response to this binary value of logic “1”, which may be referred to, for example, as a positive indicator for motion event 640, detection module 630 will detect motion event 640. In contrast, comparison 620 is a binary value that is logic “0” (e.g., 0 or −5 volts) if velocity 220 is determined to be equal to or less than velocity threshold 520. In response to this binary value of logic “0”, which may be referred to, for example, as a negative indicator for motion event 640, motion event 640 will not be detected; therefore, it may be deduced that a detectable motion event, at least with respect to the acquired information, does not yet exist in the applicable geographical area.

To further illustrate, consider the example where it is considered dangerous for a vehicle to travel along a road or highway in a particular geographic area at a rate of speed that is greater than 10 MPH over the applicable vehicular speed threshold. If the vehicular speed threshold along this road or highway is 65 MPH, velocity threshold 520 is defined as 75 MPH, such that the 10 MPH upper margin is accounted for. Additionally, comparison 620 is a binary value that is a logic “1” if velocity 220 is determined to be greater (rather than less) than velocity threshold 520. In response to this binary value of logic “1”, detection module 630 will detect motion event 640, and a law enforcement officer may consequently decide to issue a citation to the operator of the vehicle due to the vehicle's dangerously high rate of speed. In contrast, comparison 620 is a binary Value that is logic “0” if velocity 220 is determined to be equal to or less than velocity threshold 520. In response to this binary value of logic “0”, motion event 640 will not be detected.

The foregoing notwithstanding, in one embodiment, detection module 630 is configured to detect motion event 640 if velocity 220 is less than velocity threshold 520. To illustrate, consider the example where it is considered dangerous for a vehicle to travel along a road or highway at a rate of speed that is significantly (e.g., greater than 15 MPH) below the applicable vehicular speed threshold, as this vehicle is not moving with the flow of traffic. If the vehicular speed threshold along this road or highway is 65 MPH, velocity threshold 520 is defined as, for example, 50 MPH, such that the 15 MPH lower margin is accounted for. Additionally, comparison 620 is a binary value that is a logic “1” if velocity 220 is determined to be less (rather than greater) than velocity threshold 520. In response to this binary value of logic “1”, detection module 630 will detect motion event 640, and a law enforcement officer may consequently decide to issue a citation to the operator of the vehicle due to the vehicle's dangerously row rate of speed. In contrast, comparison 620 is a binary value that is logic “0” if velocity 220 is determined to be equal to or greater than velocity threshold 520. In response to this binary value of logic “0”, motion event 640 will not be detected.

With reference still to FIG. 14, an embodiment provides that detection module 630 is optionally configured to detect motion event 640 if velocity 220 is greater (or less than) velocity threshold 520 by a preselected margin 650. To illustrate, consider the example where comparison 620 is a digital or analog output reflecting the degree (e.g., the number of miles per hour) by which velocity 220 is greater than velocity threshold 520, and where law enforcement Officers have been instructed to not issue a traffic citation to a driver that is merely traveling at a rate of speed that is 5 MPH over the applicable vehicular speed threshold on a particular road or highway. Detection module 630 is configured to determine whether comparison 620 is greater than 5 MPH, and, if so, motion event 640 (e.g., a citable speeding violation taking into account the preselected 5 MPH margin) is detected. If however, comparison 620 is not greater than 5 MPH, motion event 640 will not be detected.

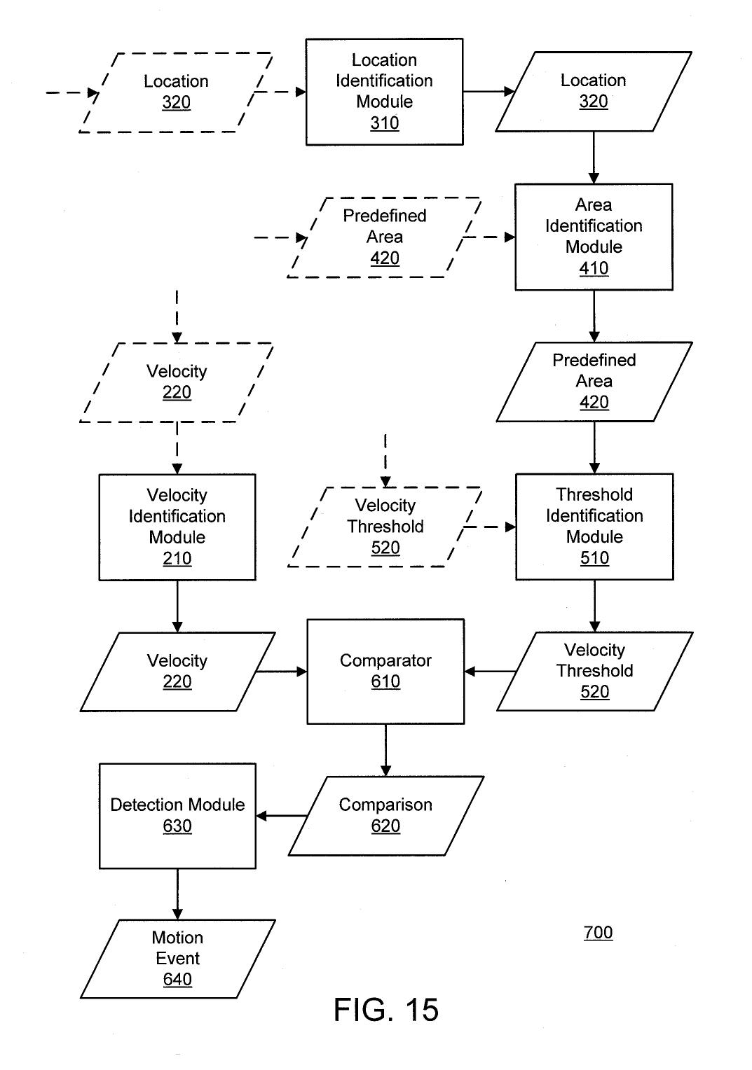

Pursuant to one embodiment, first exemplary motion event detection system 600 may include a number of additional components or subsystems, such as those exemplary Components and subsystems described herein. To illustrate, and with reference now to FIG. 15, a second exemplary motion event detection system 700 in accordance with an embodiment is shown. Second exemplary motion event detection system 700 includes velocity and location identification modules 210, 310, which are configured to identify velocity 220 and location 320, respectively. Second exemplary motion event detection system 700 also includes area identification module 410, which may be communicatively associated or coupled with location identification Module 310, wherein area identification module 410 is configured to identify predefined area 420 based on location 320. Second exemplary motion event detection system 700 further includes threshold identification module 510, which may be communicatively associated or coupled with area identification module 410, wherein threshold identification module 510 is configured to identify velocity threshold 520 based on predefined area 420.

In an embodiment, second exemplary motion event detection system 700 also includes comparator 610, which may be communicatively associated or coupled with velocity and threshold identification modules 210, 510, wherein comparator 610 is configured to conduct comparison 620 between velocity 220 and velocity threshold 520. Second exemplary motion event detection system 700 further includes detection Module 630, which may be communicatively associated or coupled with comparator 610, wherein detection module 630 is configured to detect motion event 640 based on comparison 620.

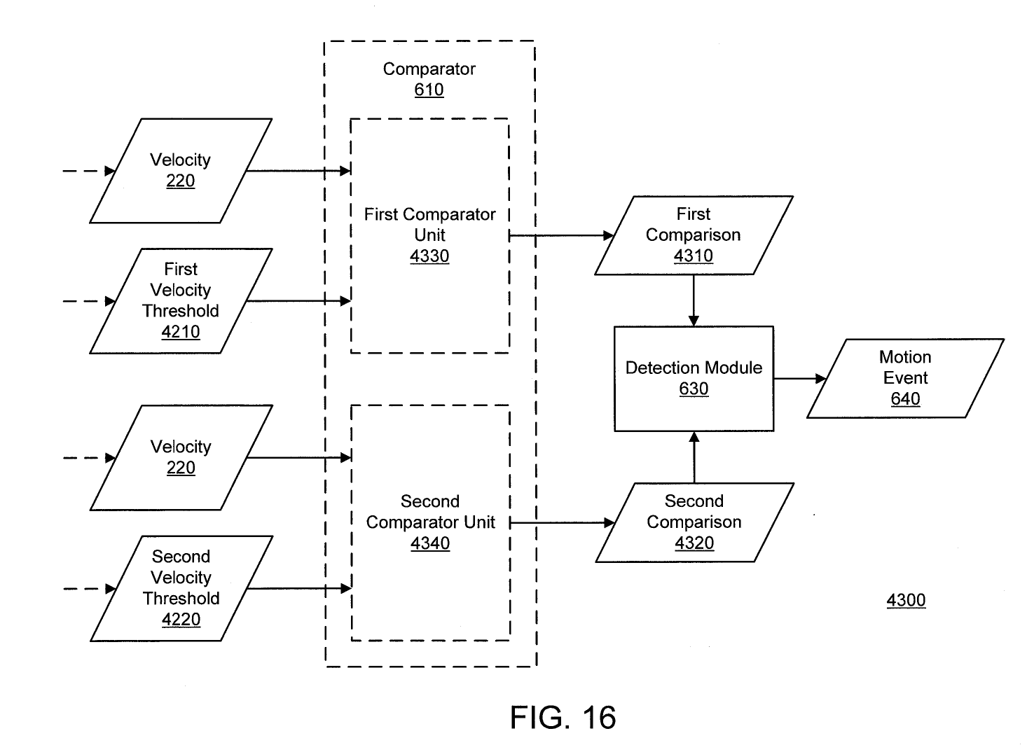

With reference now to FIG. 16, a third exemplary motion event detection system 4300 in accordance with an embodiment is shown. In an embodiment, third exemplary motion event detection system 4300 includes comparator 610, which may be communicatively associated or coupled with threshold identification module 510. Comparator 610 is configured to conduct a comparison between velocity 220 and first velocity threshold 4210, wherein this comparison may be referred to as a first comparison 4310, so as to determine whether velocity 220 is greater than first velocity threshold 4210. Comparator 610 is further configured to conduct a comparison between velocity 220 and second velocity threshold 4220, wherein this comparison may be referred to as a second comparison 4320. Third exemplary motion event detection system 4300 also includes detection module 630, which may be communicatively associated or coupled with comparator 610. Detection module 630 is configured to detect motion event 640 based on first and second comparisons 4310, 4320.

The foregoing notwithstanding, it is noted that the present technology is not limited to the implementation of a single comparator, and that a plurality of comparator units may be implemented to carry out the various comparisons and mathematical operations mentioned herein. To illustrate, and with reference still to FIG. 16, an embodiment provides that comparator 610 optionally includes first and second comparator units 4330, 4340, which may be communicatively associated or coupled with threshold identification module 510. For example, first comparator unit 4330 is configured to conduct a comparison between velocity 220 and first velocity threshold 4210, wherein this comparison may be referred to as first comparison 4310, so as to determine whether velocity 220 is greater than first velocity threshold 4210. Additionally, second comparator unit 4340 is configured to conduct a comparison between velocity 220 and second velocity threshold 4220, wherein this comparison may be referred to as second comparison 4320, so as to determine whether velocity 220 is less than second velocity threshold 4220. Moreover, detection module 630, which may be communicatively associated or coupled with first and second comparator units 4330, 4340, is configured to detect motion event 640 based on first and second comparisons 4310, 4320.

For example, if first and second velocity thresholds 4210, 4220 are upper and lower velocity thresholds associated with predefined area 420, detection module 630 may be configured to detect motion event 640 based on velocity 220 being either greater than first velocity threshold 4210 or less than second velocity threshold 4220. To further illustrate, consider the example where it is considered dangerous for a vehicle to travel along a road or highway in a particular geographic area at a rate of speed that is greater than 10 MPH over, or less than 15 MPH below, the applicable vehicular speed threshold. If the vehicular speed threshold along this road or highway is 65 MPH, first velocity threshold 4210 is defined as 75 MPH, such that the 10 MPH upper margin is accounted for, and second velocity threshold 4220 is defined as 50 MPH, such that the 15 MPH lower margin is accounted for. Additionally, first comparison 4310 is (1) a binary value that is a logic “1” if velocity 220 is determined to be greater than first velocity threshold 4210 or (2) a logic “0” if velocity 220 is determined to be equal to or less than first velocity threshold 4210. Second comparison 4320 is a binary value that is (1) a logic “1” if velocity 220 is determined to be less than second velocity threshold 4220 or (2) a logic “0” if velocity 220 is determined to be equal to or greater than second velocity threshold 4220. Moreover, detection module 630, which may be, for example, a digital logic (e.g. Boolean) OR gate, is configured to detect motion event 640 if either of first and second comparisons 4310, 4320 are a logic “1”.

The foregoing notwithstanding, although the previous example mentions the possible implementation of a digital logic OR gate, it is noted that the present technology is not limited to any particular type of logic architecture. For example, a number of digital logic (e.g. Boolean) AND gates, NAND gates, XOR gates, NOR gates and/or NOT (e.g., inverter) gates, along with a number of other digital (e.g. Boolean) components, may be implemented in different configurations such that a particular result may be achieved.

In view of the foregoing, it is noted that, in one embodiment, motion event 640 is detected based on a difference between velocity 220 and velocity threshold 520. As such, a first exemplary velocity difference determination system, as well as an exemplary implementation of this system with an exemplary motion event detection system, will now be explored. However, the present technology is not limited to these exemplary systems and configurations. Indeed, other systems and configurations may be implemented.

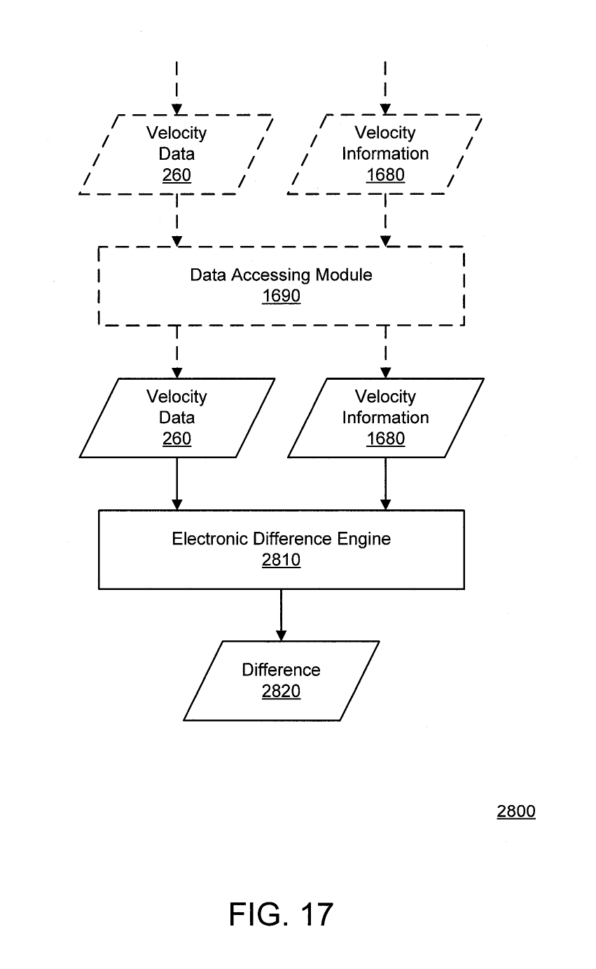

With reference now to FIG. 17, a first exemplary velocity difference determination system 2800 in accordance with an embodiment is shown. First exemplary velocity difference determination system 2800 includes an electronic difference engine 2810 configured to receive velocity data 260 (which is based on velocity 220) and velocity information 1680 (which identifies velocity threshold 520). For example, velocity threshold 520 may be a numerical speed threshold associated with or assigned to predefined area 420, such as an upper or lower vehicular speed threshold assigned to a specific road, path or geographical area within predefined area 420. Velocity information 1680 is digital or analog data that indicates this numerical speed threshold, and this digital or analog data is received by electronic difference engine 2810, along with velocity data 260, wherein velocity data 260 is digital or analog data that indicates velocity 220.

It is noted that electronic difference engine 2810 may be communicatively associated or coupled with velocity data storage unit 1610 and velocity database 1670, wherein velocity data storage unit 1610 stores velocity data 260, which identifies velocity 220, and wherein velocity database 1670 stores velocity information 1680, which identifies velocity threshold 520. Alternatively, or in addition to the foregoing, first exemplary velocity difference determination system 2800 may optionally include or be integrated with a data accessing module 1690, which may be communicatively associated or coupled with electronic difference engine 2810. In an embodiment, data accessing module 1690 is configured to forward velocity data 260 and velocity information 1680 to electronic difference engine 2810. Pursuant to one embodiment, however, electronic difference engine 2810 is itself configured, positioned or integrated so as to receive velocity data 260 and velocity information 1680 from one or more other respective sources of velocity data 260 and velocity information 1680.

With reference still to FIG. 17, in an embodiment, electronic difference engine 2810 is further configured to determine a difference 2820 between velocity 220 and velocity threshold 520. To illustrate, consider the example where velocity threshold 520 is a vehicular speed threshold associated with or assigned to a particular geographic area in which first object 110 is currently traveling at velocity 220. Difference 2820 is calculated by electronic difference engine 2810, wherein difference 2820 is a digital or analog output reflecting the degree (e.g., the number of miles per hour) by which velocity 220 is greater than velocity threshold 520. Subsequently, a motion event may be detected based on this difference.

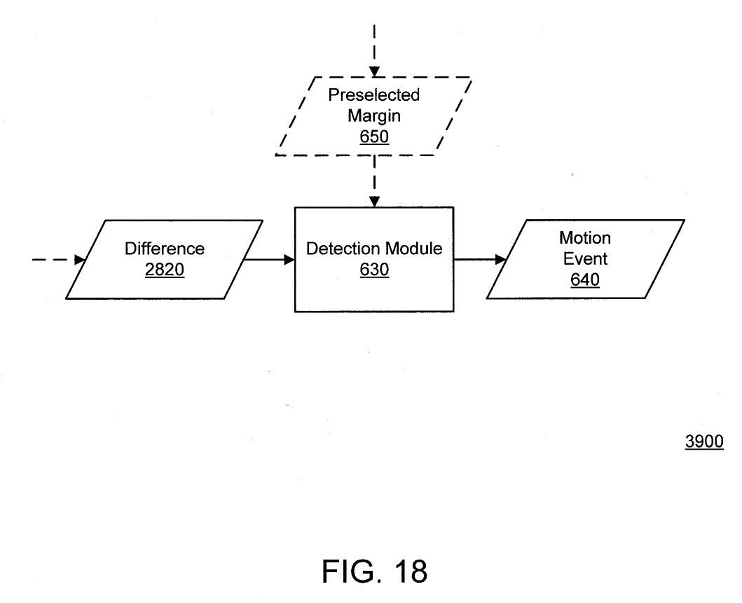

With reference now to FIG. 18, a fourth exemplary motion event detection system 3900 in accordance with an embodiment is shown. Fourth exemplary motion event detection system 3900 includes detection module 630, which may be communicatively associated or coupled with electronic difference engine 2810. Detection module 630 is configured to detect motion event 640 based on difference 2820. Indeed, in one embodiment, detection module 630 is configured to detect motion event 640 based on velocity 220 being greater than velocity threshold 520. To illustrate, consider the example where velocity threshold 520 is a vehicular speed threshold of 65 MPH associated with or assigned to a particular geographic area in which a motor vehicle is currently traveling at velocity 220. Once calculated, difference 2820 reflects that the vehicle is currently traveling at a rate of speed that is greater than 65 MPH. Accordingly, motion event 640 is detected, and a law enforcement officer may consequently decide to issue a citation to the driver or operator of this vehicle.

Moreover, an embodiment provides that detection module 630 is configured to detect motion event 640 based on velocity 220 being less (rather than greater) than velocity threshold 520. To illustrate, consider the example where a vehicular speed threshold of 65 MPH is associated with or assigned to a particular geographic area, and where velocity threshold 520 is a lower vehicular velocity threshold of 40 MPH associated with or assigned to this geographic area. Once calculated, difference 2820 reflects that a vehicle is currently traveling at a rate of speed that is less than 40 MPH. Accordingly, motion event 640 is detected, and a law enforcement officer may consequently decide to issue a citation to the driver or operator of this vehicle.

The foregoing notwithstanding, and with reference still to FIG. 18, in one embodiment, motion event 640 is detected when velocity 220 is higher or lower than velocity threshold 520 by a preselected numerical margin (e.g., preselected margin 650). For example, detection module 630 may be configured to detect motion event 640 based on difference 2820 (or an absolute value of difference 2820) being greater than preselected margin 650 (or an absolute value of preselected margin 650). To illustrate, consider the example where velocity threshold 520 is a vehicular speed threshold of 65 MPH associated with or assigned to a particular geographic area in which a Motor vehicle is currently traveling at velocity 220. If the vehicle is currently traveling at a rate of speed of 75 MPH, then difference 2820, once calculated, reflects that the vehicle is currently traveling at a rate of speed that is 10 MPH greater than the applicable vehicular speed threshold. Furthermore, if preselected margin 650 is defined as a 5 MPH numerical margin, difference 2820 will be determined to be greater than preselected margin 650, and motion event 640 will consequently be detected.

In view of the forgoing, it is noted that a numerical margin may be implemented. As such, an exemplary numerical margin (or difference threshold) calculation-system will now be explored. However, the present technology is not limited to this exemplary numerical margin (or difference threshold) calculation system, and other exemplary numerical margin (or difference threshold) calculation systems may be implemented.

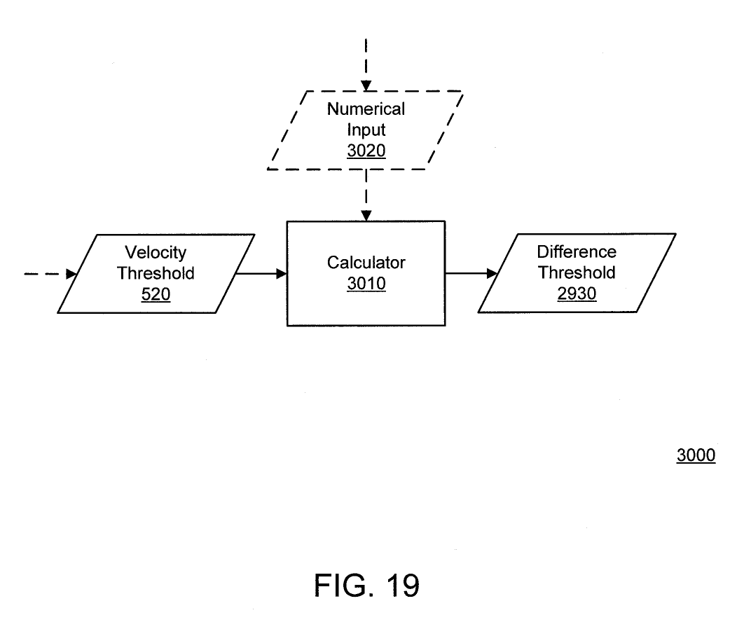

With reference now to FIG. 19, a first exemplary difference threshold calculation system 3000 in accordance with an embodiment is shown. First exemplary difference threshold calculation system 3000 includes a calculator 3010, which may be communicatively associated or coupled with threshold identification module 510. Calculator 3010 is configured to calculate a difference threshold 2930, such as preselected margin 650, based on velocity threshold 520. Indeed, in one embodiment, calculator 3010 is configured to calculate difference threshold 2930 based on velocity threshold 520 and a numerical input 3020. To illustrate, consider the example where velocity threshold 520 is 65 MPH, and where numerical input 3020 is 10% (or 0.1). As a result, calculator 3010 is configured to calculate 10% of this velocity threshold 520, and difference threshold 2930 is consequently defined as 6.5 MPH.

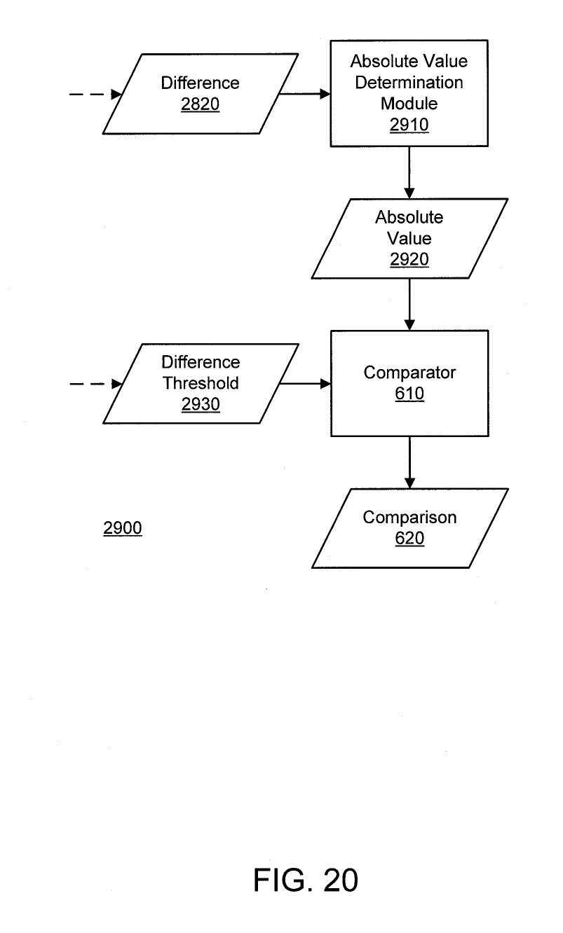

With reference now to FIG. 20, a first exemplary comparison generation system 2900 in accordance with an embodiment is shown. First exemplary comparison generation system 2900 includes an absolute value determination module 2910, which may be communicatively associated or coupled with electronic difference engine 2810. Absolute value determination module 2910 is configured to determine an absolute value 2920 of difference 2820. Additionally, first exemplary comparison generation system 2900 includes comparator 610, which may be communicatively associated or coupled with absolute value determination module 2910 and calculator 3010. Comparator 610 is configured to compare absolute value 2920 to difference threshold 2930 (or to an absolute value of difference threshold 2930) so as to generate comparison 620. Indeed, in one embodiment, comparator 610 defines comparison 620 as, or associates comparison 620 with, (1) a logical or binary value of “1” if absolute value 2920 is greater than difference threshold 2930 (or an absolute value of difference threshold 2930) or (2) a logical or binary value of “0” if absolute value 2920 is less than or equal to difference threshold 2930 (or an absolute value of difference threshold 2930).

To illustrate, consider the example where difference 2820 is determined to be a numerical value of −20, which indicates that velocity 220 is less than velocity threshold 520 by 20 MPH. Absolute value 2920 of −20 is determined to be 20, and this value of 20 is compared to difference threshold 2930. Additionally, in so much as driving more than 15 miles above or below the applicable vehicular speed threshold may be considered dangerous in a specific geographic area, difference threshold 2930 is set to 15. Consequently, when absolute value 2920 is compared to difference threshold 2930, the resulting comparison 620 reflects (such as by being defined as or associated with a logical or binary value of “1”) that absolute value 2920 is greater than difference threshold 2930, in which case a motion event may be detected based comparison 620.

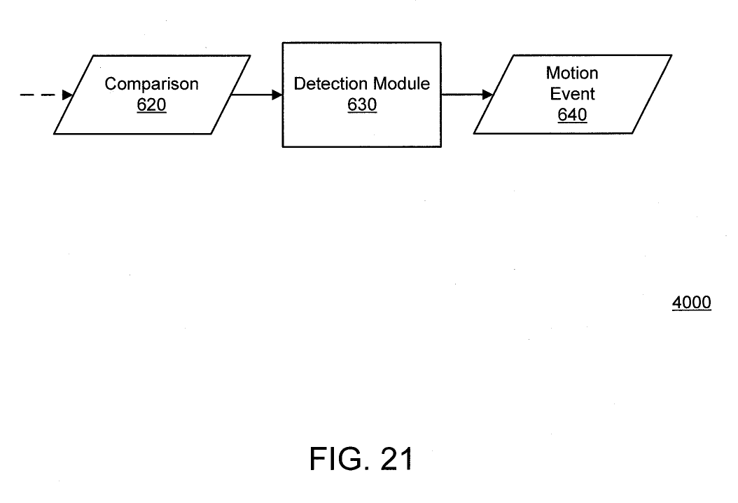

With reference now to FIG. 21, a fifth exemplary motion event detection system 4000 in accordance with an embodiment is shown. Fifth exemplary motion event detection system 4000 includes detection module 630, which may be communicatively associated or coupled with comparator 610. Detection module 630 is configured to detect motion event 640 based on, or in response to, comparison 620. For example, in one embodiment, detection module 630 is configured to detect motion event 640 in response to comparison 620 reflecting (such as being defined as or associated with a logical or binary value of “1”) that absolute value 2920 is greater than difference threshold 2930.

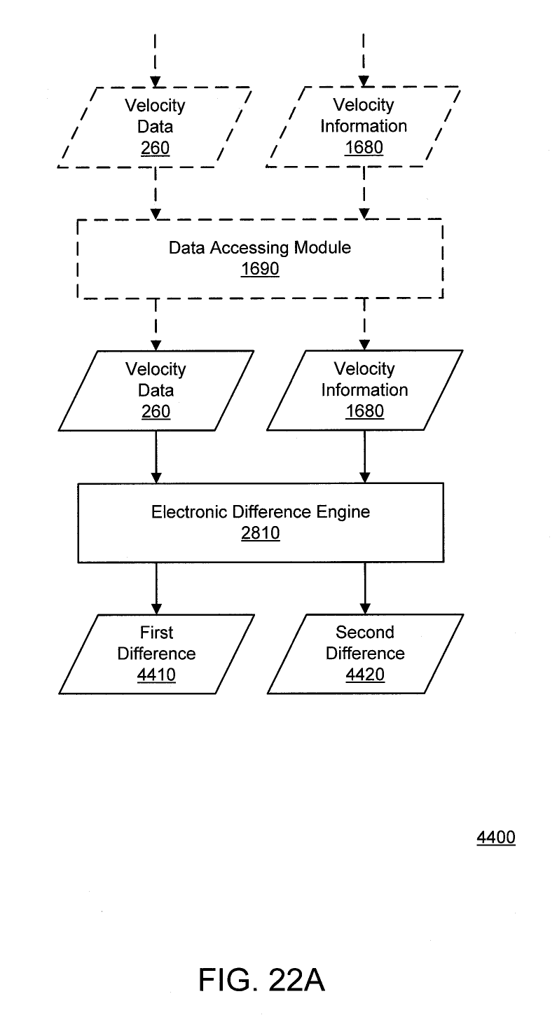

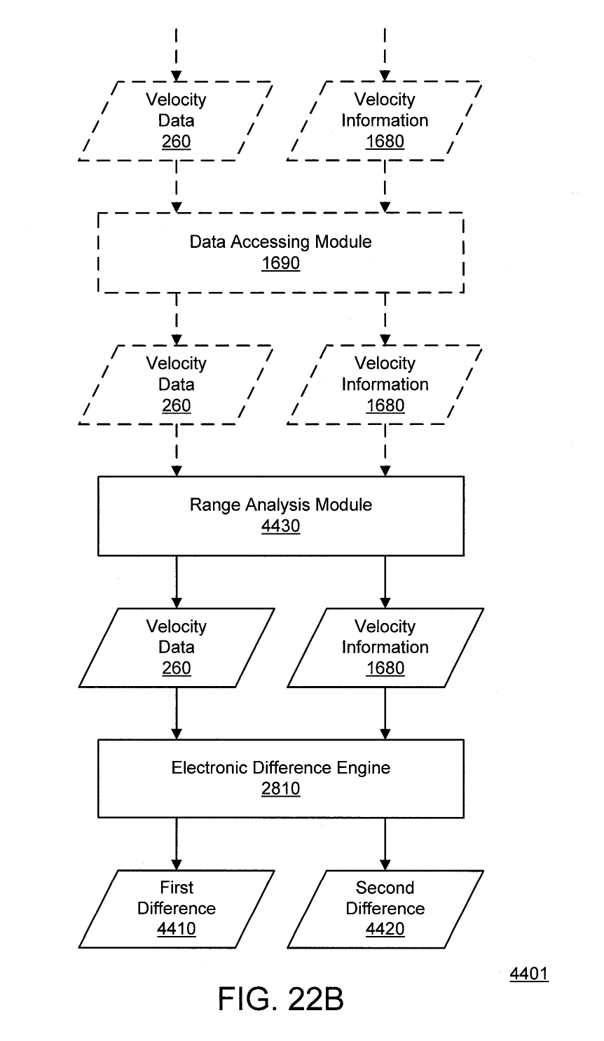

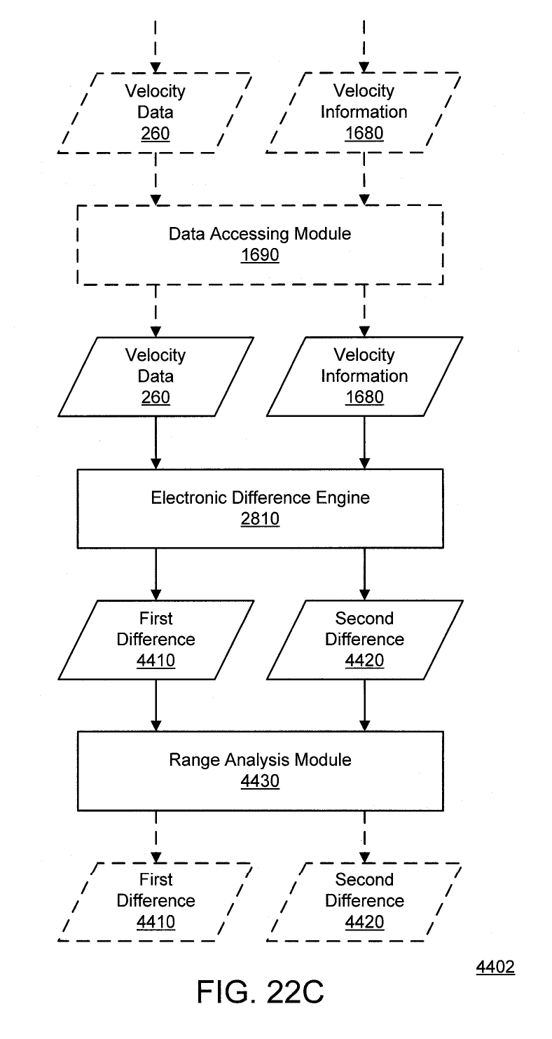

With reference now to FIG. 22A, a second exemplary velocity difference determination system 4400 in accordance with an embodiment is shown. Second exemplary velocity difference determination system 4400 includes an electronic difference engine 2810 configured to receive velocity data 260 (which is based on velocity 220) and velocity information 1680 (which identifies first and second velocity thresholds 4210, 4220). For example, first and second velocity thresholds 4210, 4220 may be upper and lower numerical speed thresholds associated with or assigned to predefined area 420, such as upper and lower vehicular speed thresholds assigned to a specific road, path or geographical area within predefined area 420. Velocity information 1680 is digital or analog data that indicates these numerical speed thresholds, and this digital or analog data is received by electronic difference engine 2810, along with velocity data 260, wherein velocity data 260 is digital or analog data that indicates velocity 220.

It is noted that electronic difference engine 2810 may be communicatively associated or coupled with velocity data storage unit 1610 and velocity database 1670, wherein velocity data storage unit 1610 stores velocity data 260, which identifies velocity 220, and wherein velocity database 1670 stores velocity information 1680, which identifies first and second velocity thresholds 4210, 4220. Alternatively, or in addition to the foregoing, second exemplary velocity difference determination system 4400 may optionally include or be integrated with a data accessing module 1690, which may be communicatively associated or coupled with electronic difference engine 2810. In an embodiment, data accessing module 1690 is configured to forward velocity data 260 and velocity information 1680 to electronic difference engine 2810. Pursuant to one embodiment, however, electronic difference engine 2810 is itself Configured, positioned or integrated so as to receive velocity data 260 and velocity information 1680 from one or more other respective sources of velocity data 260 and velocity information 1680.

With reference still to FIG. 22A, in an embodiment, electronic difference engine 2810 is further configured to determine (1) a first difference 4410 between velocity 220 and first velocity threshold 4210 and (2) a second difference 4420 between velocity 220 and second velocity threshold 4220. To illustrate, consider the example where first and second velocity thresholds 4210, 4220 are upper and lower vehicular speed thresholds, respectively, associated with or assigned to a particular geographic area in which first object 110 is currently traveling at velocity 220, and where first and second differences 4410, 4420 are calculated by electronic difference engine 2810. If first difference 4410 indicates a degree (e.g., the number of miles per hour) by which velocity 220 is greater than first velocity threshold 4210, a motion event may be detected based on this difference. Similarly, if second difference 4420 indicates a degree by which velocity 220 is less than second velocity threshold 4220, a motion event may be detected based on this difference.

With reference now to FIG. 22B, a third exemplary velocity difference determination system 4401 in accordance with an embodiment is shown. Third exemplary velocity difference determination system 4401 includes an optional range analysis module 4430, which may be communicatively associated or coupled with data accessing module 1690 and electronic difference engine 2810. Range analysis module 4430 is configured to determine Whether velocity 220 is greater than the upper velocity threshold or less than the lower velocity threshold. For example, if range analysis module 4430 determines that velocity 220 falls within a range of velocities between the upper and lower velocity thresholds, then the implemented motion event analysis algorithm may be automatically halted, and no motion event will be detected. If, however, range analysis module 4430 determines that velocity 220 is either greater than the upper velocity threshold or less than the lower velocity threshold, then range analysis module 4430 will route or forward velocity data 260 and velocity information 1680 to electronic difference engine 2810 such that electronic difference engine 2810 is able to calculate first and second differences 4410, 4420 such that the motion event analysis may continue.

With reference now to FIG. 22C, a fourth exemplary velocity difference determination system 4402 in accordance with an embodiment is shown. Fourth exemplary velocity difference determination system 4402 includes optional range analysis module 4430, which may be communicatively associated or coupled with data accessing module 1690 and detection module 630. Range analysis module 4430 is configured to determine whether velocity 220 is greater than the upper velocity threshold or less than the lower velocity threshold. For example, if range analysis module 4430 determines that velocity 220 falls within a range of velocities between the upper and lower velocity thresholds, then the implemented motion event analysis algorithm may be automatically halted, and no motion event will be detected. If, however, range analysis module 4430 determines that velocity 220 is either greater than the upper velocity threshold or less than the lower velocity threshold, then range analysis module 4430 will route or forward first and second differences 4410, 4420 to detection module 630 such that detection module 630, whereby motion event 640 may be detected based on first and second differences 4410, 4420.

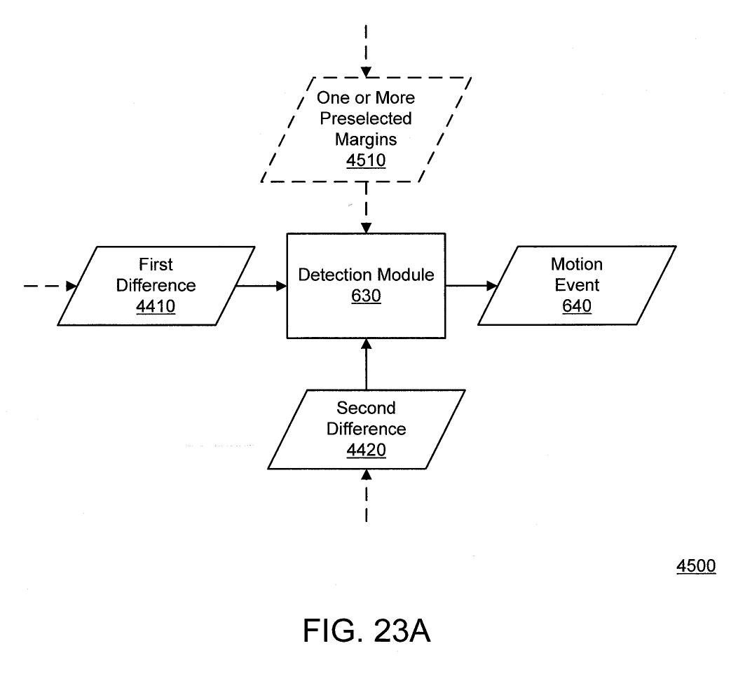

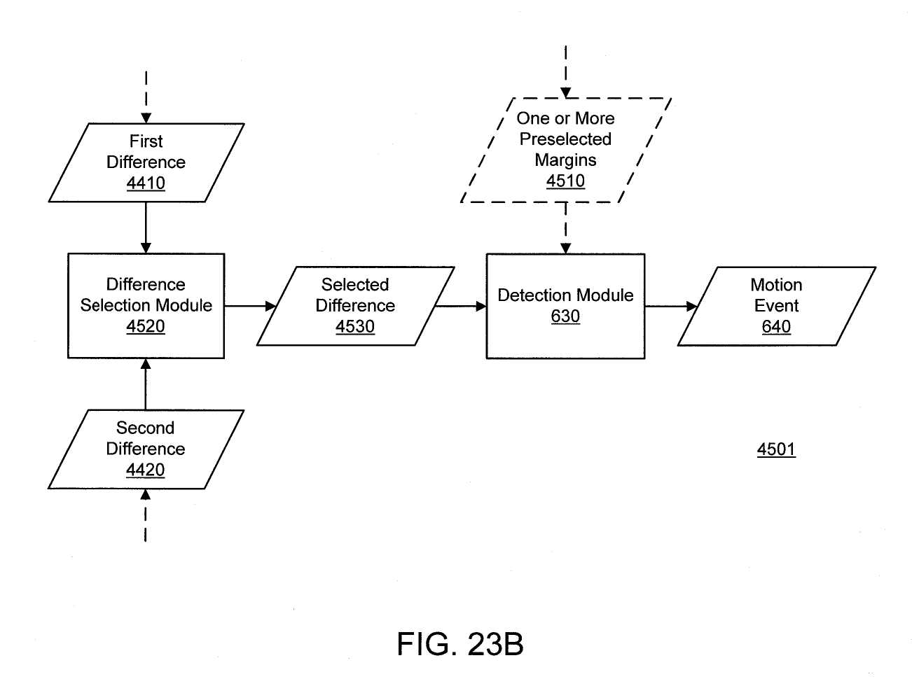

With reference now to FIG. 23A, a sixth exemplary motion event detection system 4500 in accordance with an embodiment is shown. Sixth exemplary motion event detection system 4500 includes detection module 630, which may be communicatively associated or coupled with electronic difference engine 2810. Detection module 630 is configured to detect motion event 640 based on first and/or second differences 4410, 4420. Indeed, in one embodiment, first and second velocity thresholds 4210, 4220 are upper and lower velocity thresholds, respectively, and detection module 630 is configured to detect motion event 640 based on velocity 220 being greater than first velocity threshold 4210 or less than second velocity threshold 4220.

To illustrate, consider the example where first and second velocity thresholds 4210, 4220 are vehicular speed thresholds of 65 MPH and 40 MPH, respectively, associated with or assigned to a particular geographic area in which a motor vehicle is currently traveling at velocity 220. Motion event 640 will be detected (1) if first difference 4410 reflects that the vehicle is currently traveling at a rate of speed that is greater than 65 MPH or (2) if second difference 4420 reflects that the vehicle is currently traveling at a rate of speed that is less than 40 MPH.

For example, if velocity 220 is 70 MPH, 65 is subtracted from 70 to yield a first difference 4410 of +5 (positive 5). Additionally, 40 is subtracted from 70 to yield a second difference 4420 of +30 (positive 30). In so much as both of first and second differences 4410, 4420 are positive, detection module 630 detects motion event 640. Similarly, if velocity 220 is 35 MPH, 65 is subtracted from 35 to yield a first difference 4410 of −30 (negative 30). Additionally, 40 is subtracted from 35 to yield a second difference 4420 of −5 (negative 5). In so much as both of first and second differences 4410, 4420 are negative, detection module 630 detects motion event 640. However, if velocity 220 is 50 MPH, 65 is subtracted from 50 to yield a first difference 4410 of −15 (negative 15). Additionally, 40 is subtracted from 50 to yield a second difference 4420 of +10 (positive 10). In so much as one of first and second differences 4410, 4420 is positive and the other of first and second differences 4410, 4420 is negative, detection module 630 does not detect a motion event.

The foregoing notwithstanding, and with reference still to FIG. 23A, in one embodiment, motion event 640 is detected when velocity 220 is higher than first velocity threshold 4210 or lower than second velocity threshold 4220 by one or more preselected numerical margins (e.g., one or more preselected margins 4510), respectively. For example, if one or more preselected margins 4510 includes a single preselected margin, detection module 630 may be configured to detect motion event 640 based on either of first and second differences 4410, 4420 being greater than this preselected margin. If, however, one or more preselected Margins 4510 includes two preselected margins, detection module 630 may be configured to detect motion event 640 based on (1) first difference 4410 being greater than a first preselected margin from among these two preselected margins or (2) second difference 4420 being greater than a second preselected margin from among these two preselected margins.

To illustrate, consider the example where one or more preselected margins 4510 includes a single preselected margin of 5 MPH, and where first and second velocity thresholds 4210, 4220 are vehicular speed thresholds of 65 MPH and 40 MPH, respectively, wherein these vehicular speed thresholds are associated with or assigned to a particular geographic area in which a motor vehicle is currently traveling at velocity 220. If the vehicle is currently traveling at a rate of speed of 75 MPH, then first difference 4410, once calculated, reflects that the vehicle is currently traveling at a rate of speed that is 10 MPH greater than the applicable upper vehicular speed threshold. Thus, in so much as the preselected margin is defined as a 5 MPH numerical margin, first difference 4410 will be determined to be greater than this preselected margin, and motion event 640 will consequently be detected. Similarly, if the vehicle is currently traveling at a rate of speed of 30 MPH, then second difference 4420, once calculated, reflects that the vehicle is currently traveling at a rate of speed that is 10 MPH less than the applicable lower vehicular speed threshold. Thus, in so much as the preselected margin is defined as a 5 MPH numerical margin, second difference 4420 will be determined to be greater than this preselected margin, and motion event 640 will consequently be detected.

To further illustrate, consider the example one or more preselected margins 4510 includes two preselected margins, and where first velocity threshold 4210 is an upper vehicular speed threshold of 65 MPH associated with or assigned to a particular geographic area in which a motor vehicle is currently traveling at velocity 220. If the vehicle is currently traveling at a rate of speed of 75 MPH, then first difference 4410, once calculated, reflects that the vehicle is currently traveling at a rate of speed that is 10 MPH greater than the applicable vehicular speed threshold. Furthermore, if a first preselected margin from among one or more preselected margins 4510 is defined as a 5 MPH numerical margin (wherein this first preselected margin is associated with first difference 4410), first difference 4410 will be determined to be greater than this first preselected margin, and motion event 640 will consequently be detected.

Similarly, and in accordance with an example, one or more preselected margins 4510 includes two preselected margins, and second velocity threshold 4220 is a lower vehicular speed threshold of 40 MPH associated with or assigned to a particular geographic area in which a motor vehicle is currently traveling at velocity 220. If the vehicle is currently traveling at a rate of speed of 25 MPH, then second difference 4420, once calculated, reflects that the vehicle is currently traveling at a rate of speed that is 15 MPH less than the applicable vehicular speed threshold. Furthermore, if a second preselected margin from among one or more preselected margins 4510 is defined as a 10 MPH numerical margin (wherein this second preselected margin is associated with second difference 4420), second difference 4420 will be determined to be greater, than this second preselected margin, and motion event 640 will consequently be detected.

In view of the forgoing, it is noted that one or more numerical margins may be implemented. As such, an exemplary numerical margin (or difference threshold) calculation system will now be explored. However, the present technology is not limited to this exemplary numerical margin (or difference threshold) calculation system, and other exemplary numerical margin (or difference threshold) calculation systems may be implemented.

The foregoing notwithstanding, an embodiment provides that one of first and second differences 4410, 4420 is selected, and that a motion event is detected based on the selected difference. To illustrate, and with reference now to FIG. 23B, a seventh exemplary motion event detection system 4501 in accordance with an embodiment is shown. Seventh exemplary motion event detection system 4501 includes a difference selection module 4520, which may be communicatively associated or coupled with electronic difference engine 2810. Difference selection module 4520 is configured to select a difference from among first and second differences 4410, 4420 so as to output a selected difference 4530. Additionally, seventh exemplary motion event detection system 4501 includes detection module 630, which may be communicatively associated or coupled with difference selection module 4520. Detection module 630 is configured to detect motion event 640 based on selected difference 4530, such as where a magnitude of selected difference 4530 is greater than a magnitude of a selected margin from among one or more preselected margins 4510.

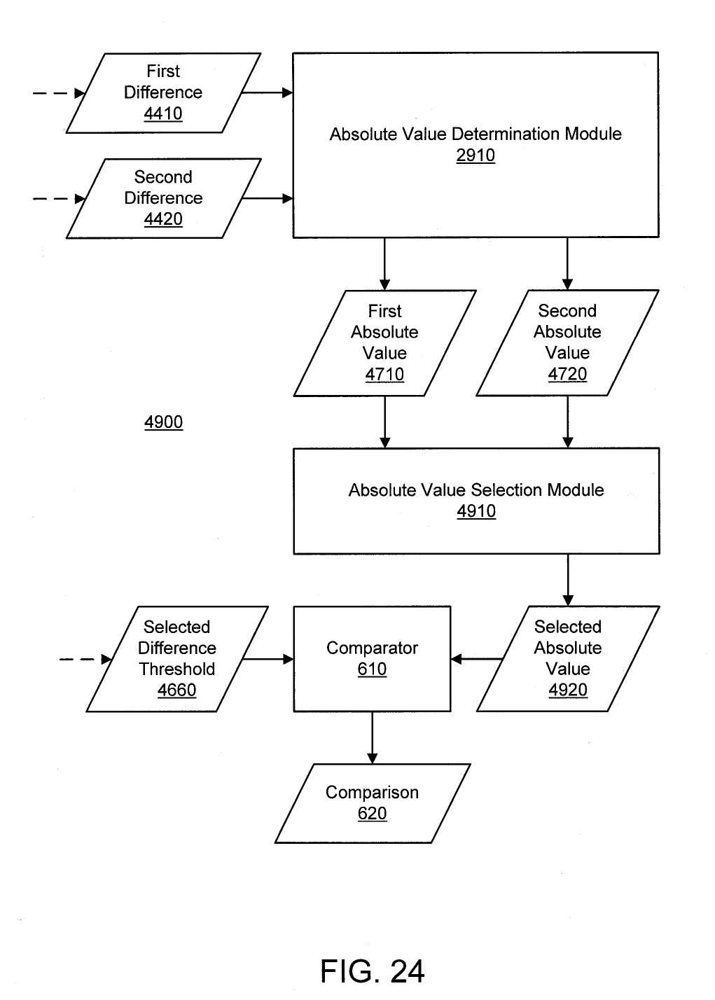

With reference now to FIG. 24, a second exemplary comparison generation system 4900 in accordance with an embodiment is shown. Second exemplary comparison generation system 4900 includes absolute value determination module 2910, which may be communicatively associated or coupled with electronic difference engine 2810. Absolute value determination module 2910 is configured to determine first and second absolute values 4710, 4720 of first and second differences 4410, 4420, respectively. Additionally, second exemplary comparison generation system 4900 includes an absolute value selection module 4910, which may be communicatively associated or coupled with absolute value determination module 2910. Absolute value selection module 4910 is configured to select an absolute value (e.g., a lowest absolute value) from among first and second absolute values 4710, 4720 so as to output a selected absolute value 4920. Moreover, second exemplary comparison generation system 4900 includes comparator 610, which may be communicatively associated or coupled with absolute value selection module 4910. Comparator 610 is configured to compare selected absolute value 4920 to a selected difference threshold 4660 (or to an absolute value of selected difference threshold 4660) so as to generate comparison 620. Furthermore, it is noted that, pursuant to one embodiment, detection module 630 is configured to detect motion event 640 in response to comparison 620 reflecting that selected absolute value 4920 is greater than selected difference threshold 4660 (or than an absolute value of selected difference threshold 4660).

To illustrate, consider the example where first and second differences 4410, 4420 are determined to be numerical values of +5 (positive 5) and +30 (positive 30), respectively. First and second absolute values 4710, 4720 are determined to be 5 and 30, respectively, and absolute value selection module 4910 consequently selects the lower numerical value of 5 to be the selected absolute value 4920. Indeed, the fact that first absolute value 4710 is less than second absolute value 4720 indicates that velocity 220 is closer to first velocity threshold 4210 than to second velocity threshold 4220. Selected absolute value 4920 is then compared to selected difference threshold 4660, which is set to a numerical value of 4, and the resulting comparison 620 reflects that selected absolute value 4920 is greater than selected difference threshold 4660 such that a motion event is detected.

To further illustrate, consider the example where first and second differences 4410, 4420 are determined to be numerical values of −30 (negative 30) and −5 (negative 5), respectively. First and second absolute values 4710, 4720 are determined to be 30 and 5, respectively, and absolute value selection module 4910 consequently selects the lower numerical value of 5 to be the selected absolute value 4920. Indeed, the fact that second absolute value 4720 is less than first absolute value 4710 indicates that velocity 220 is closer to second velocity threshold 4220 than to first velocity threshold 4210. Selected absolute value 4920 is then compared to selected difference threshold 4660, which is set to a numerical value of 4, and the resulting comparison 620 reflects that selected absolute value 4920 is greater than selected difference threshold 4660 such that a motion event is detected.

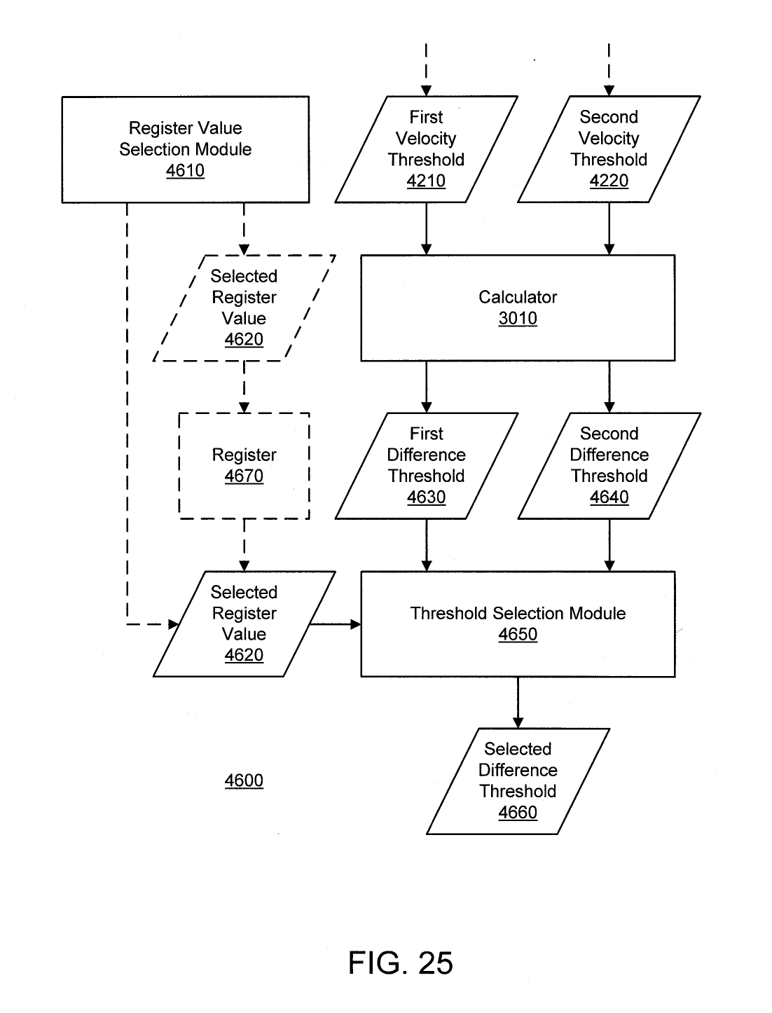

With reference now to FIG. 25, a second exemplary difference threshold calculation system 4600 in accordance with an embodiment is shown. Second exemplary difference threshold calculation system 4600 includes a register value selection module 4610, which may be communicatively associated or coupled with absolute value selection module 4910. Register value selection module 4610 is configured to select either (1) a first register Value (e.g., a logic “0”) if first absolute value 4710 is the lowest absolute value from among first and second absolute values 4710, 4720 or (2) a second register value (e.g., a logic “1”) if second absolute value 4720 is the lowest absolute value from among first and second absolute values 4710, 4720 in order to generate a selected register value 4620 (e.g., logic “0” or “1”).

With reference still to FIG. 25, second exemplary difference threshold calculation system 4600 also includes a calculator 3010, which may be communicatively associated or coupled with threshold identification module 510. Calculator 3010 is configured to calculate first and second difference thresholds 4630, 4640 based on first and second velocity thresholds 4210, 4220, respectively. To illustrate, consider the example where first and second velocity thresholds 4210, 4220 are 65 MPH and 40 MPH, respectively. Calculator 3010 is configured to calculate, for example, (1) 10% of first velocity threshold 4210 such that first difference threshold 4630 is consequently defined as 6.5 MPH and (2) 10% of second velocity threshold 4220 such that second difference threshold 4640 is consequently defined as 4 MPH.

With reference still to FIG. 25, second exemplary difference threshold calculation system 4600 further includes a threshold selection module 4650, which may be communicatively associated or coupled with register value selection module 4610, calculator 3010 and comparator 610. Threshold selection module 4650 is configured to select one of first and second difference thresholds 4630, 4640 based on selected register value 4620 so as to output selected difference threshold 4660. For example, if selected register value 4620 is a logic “0”, thereby indicating that first absolute value 4710 is the lowest absolute value from among first and second absolute values 4710, 4720, then first difference threshold 4630 is selected. If, however, selected register value 4620 is a logic “1”, thereby indicating that second absolute value 4720 is the lowest absolute value from among first and second absolute values 4710, 4720, then second difference threshold 4640 is selected.

The foregoing notwithstanding, in one embodiment, second exemplary difference threshold calculation system 4600 optionally includes a register 4670, which may be communicatively associated or coupled with register value selection module 4610 and threshold selection module 4650. Register 4670 is configured to store selected register value 4620. For example, selected register value 4620 may be forwarded from register value selection module 4610 to register 4670, at which point selected register value 4620 will be stored in register 4670 such that selected register value 4620 may be subsequently accessed by threshold selection module 4650.

III. Exemplary Velocity Calculation Systems

As previously discussed, an embodiment provides that a number of data parameters are identified, wherein such data parameters may then be utilized to identify or detect a motion event. In one embodiment, velocity 220 is determined or calculated. Consequently, a number of exemplary systems and configurations for determining or calculating velocity 220 will now be explored. However, the present technology is not limited to these exemplary systems and configurations. Indeed, other systems and configurations may be implemented.

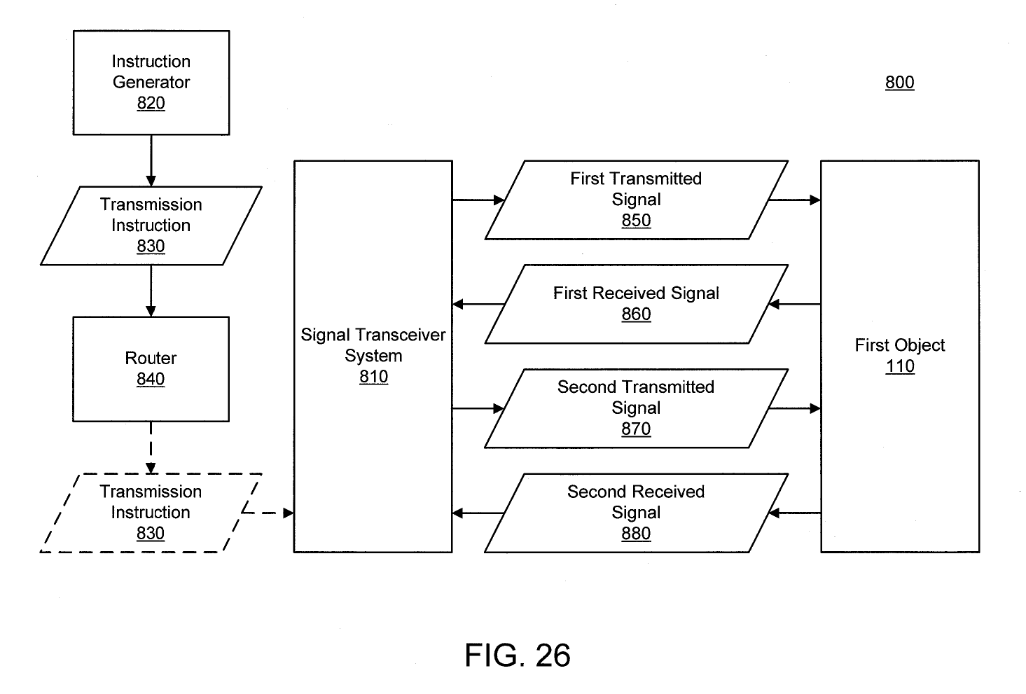

With reference now to FIG. 26, an exemplary signal transceiver arrangement 800 in accordance with an embodiment is shown. Exemplary signal transceiver arrangement 800 includes a signal transceiver system 810 configured to transmit and receive signals and an instruction generator 820 configured to generate a transmission instruction 830. Additionally, a router 840 may be communicatively associated or coupled with signal transceiver system 810 and instruction generator 820. Router 840 is configured to route transmission instruction 830 to signal transceiver system 810 so as to cause signal transceiver system 810 to transmit a first signal toward an object (e.g., first object 110) at a first point in time, wherein this transmitted signal may be referred to as a first transmitted signal 850. Signal transceiver system 810 then receives the first signal at a second point in time, wherein this received signal may be referred to as a first received signal 860, and wherein the first signal has first and second frequencies at the first and second points in time, respectively. It is noted that this frequency difference may result from a Doppler shift caused by, or associated with, a velocity at which first object 110 is traveling. Consequently, an embodiment provides that this frequency difference is utilized to determine or calculate velocity 220.

The foregoing notwithstanding, it is noted that signal transceiver system 810 may be configured to transmit multiple, consecutive signals toward an object. For example, in one embodiment, router 840 is configured to route transmission instruction 830 to signal transceiver system 810 so as to cause signal transceiver system 810 to transmit a first signal toward first object 110 at a first point in time (e.g., first transmitted signal 850), wherein signal transceiver system 810 receives this first signal at a second point in time (e.g., first received signal 860), and then transmit a second signal toward first object 110 at a third point in time, wherein this subsequently transmitted signal may be referred to as a second transmitted signal 870. Signal transceiver system 810 then receives the second signal at a fourth point in time, wherein this Subsequently received signal may be referred to as a second received signal 880.

Furthermore, an embodiment provides that a first frequency difference between first transmitted and received signals 850, 860 and a second frequency difference between second transmitted and received signals 870, 880 are identified, wherein these two frequency differences are distinguishable from one another. Next, two different Doppler shifts corresponding to these two, distinguishable frequency differences, respectively, are identified, and then first and second velocities corresponding to these two Doppler shifts, respectively, are subsequently calculated. Consequently, an average velocity of first object 110 may be determined over time, such as by averaging the velocities associated with these two different Doppler shifts. In this manner, the accuracy of the velocity determination process performed by Velocity identification module 210, or by velocity determination module 230, may be increased. It is further noted that additional such iterations, may be performed, such as by transmitting and receiving additional signals in a similar manner, and then performing the pertinent frequency, Doppler shift and velocity calculations, so as to further increase this level of accuracy.

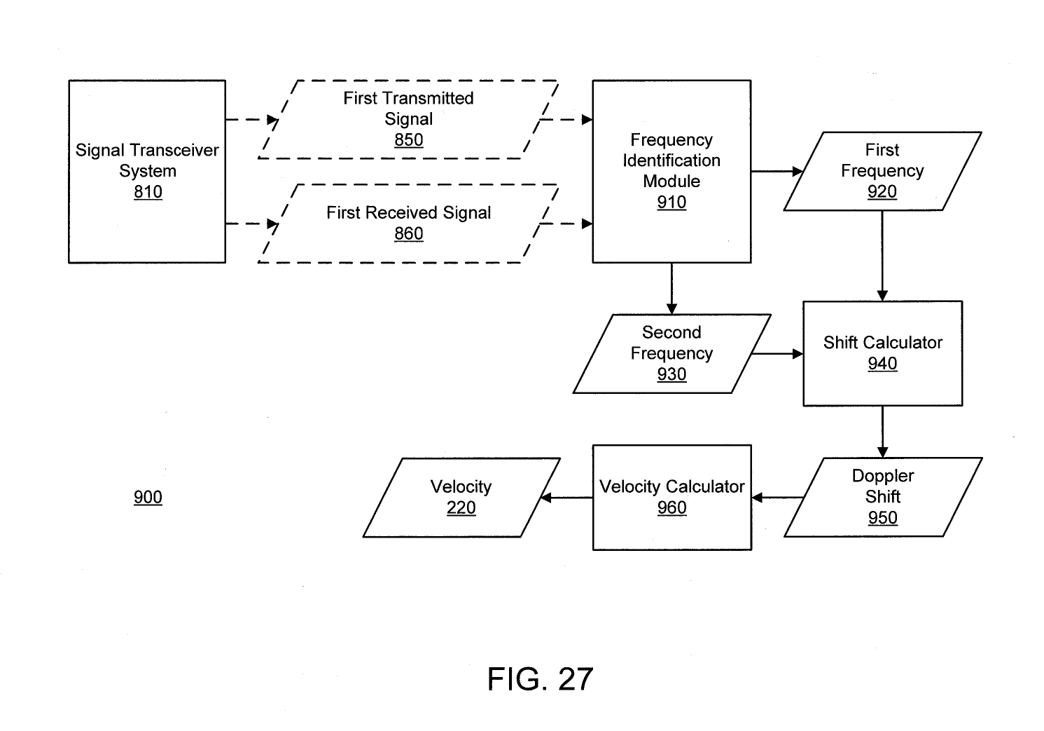

Thus, in an embodiment, signal transceiver system 810 transmits first signal 850 toward first object 110 at a first point in time, and then receives first signal 850 at a second point in time, wherein first signal 850 has first and second frequencies at these first and second points in time, respectively. With reference now to FIG. 27, a first exemplary velocity calculation System 900 in accordance with an embodiment is shown. First exemplary velocity calculation system 900 includes a frequency identification module 910, which may be communicatively associated or coupled with signal transceiver system 810. Frequency identification module 910 is configured to identify first and second frequencies 920, 930 corresponding to first transmitted and received signals 850, 860. For example, first transmitted and received signals 850, 860 may be routed to frequency identification module 910, which then determines the respective signal frequencies (e.g., first and second frequencies 920, 930) of these signals by implementing a frequency analysis and determination process.

First exemplary velocity calculation system 900 also includes a shift calculator 940, which may be communicatively associated or coupled with frequency identification module 910. Shift calculator 940 is configured to calculate a Doppler shift 950 between first and second frequencies 920, 930. First exemplary velocity calculation system 900 further includes a velocity calculator 960, which may be communicatively associated or coupled with shift calculator 940. Velocity calculator 960 is configured to calculate velocity 220 based on Doppler shift 950.

To illustrate, consider the example where first transmitted signal 850 is transmitted at an original frequency (F₀), and where the return frequency (Fᵣ) of first received signal 860 is a function of the Doppler shift (F_{d}) (e.g., Doppler shift 950), which is a function of object speed (vₜ) (e.g., velocity 220). Doppler shift 950 is positive (e.g., F_{d}) for approaching or on-coming traffic and negative (e.g., −F_{d}) for receding traffic. Thus, F_{d} may be represented as:

F_{d}=Fᵣ−F₀,

for approaching traffic; and

F_{d}=F₀−Fᵣ,

for receding traffic. Additionally, it is noted that the Doppler shift F_{d} is a function of the original frequency F₀, the speed of light (c), and object speed vₜ, wherein vₜ is positive (e.g., +vₜ) for approaching traffic and negative (e.g., −vt) for receding traffic. Consequently, F_{d} may be calculated as follows:

F_{d}=±2vₜF₀/(c−vₜ).

In so much as vₜ is much smaller than the speed of light c, F_{d} may be estimated as follows:

F_{d}=±2vₜF₀/c.

As a result, vₜ may be calculated as follows:

vₜ=F_{d}c/(2F₀).

It is noted, however, that the foregoing equations are exemplary in nature. Indeed, other equations may be implemented to determine velocity 220.

Thus, an embodiment provides that first exemplary velocity calculation system 900 may be implemented to determine velocity 220. For example, first exemplary velocity calculation system 900, or one or more components thereof, may be included within, or integrated with, velocity identification module 210 (or velocity determination module 230) such that the velocity determination process may be performed. It is noted, however, that first exemplary velocity calculation system 900 is exemplary in nature, and that the present technology is not limited to first exemplary velocity calculation system 900. As such, a velocity calculation system other than first exemplary velocity calculation system 900 may be implemented. Indeed, a different velocity calculation system may be included within, or integrated with, velocity identification module 210 (or velocity determination module 230) such that the velocity determination process may be performed.

With reference again to FIG. 26, and as previously noted, an embodiment provides that signal transceiver system 810 transmits first transmitted signal 850 toward first object 110 at a first point in time, receives first received signal 860 at a second point in time, transmits second transmitted signal 870 toward first object 110 at a third point in time, and receives second received signal 880 at a fourth point in time. Pursuant to one embodiment, two or more of these four points in time are identified. Consequently, one or more time differences between the various temporal values may be determined or calculated such that a number of corresponding distances and velocities may then be determined or calculated. As such, a number of exemplary time difference, distance and velocity determination or calculation systems will now be explored. It is noted, however, that the present technology is not limited to these exemplary time difference, distance and velocity determination or calculation systems, and that other time difference, distance and velocity determination or calculation systems may be implemented.

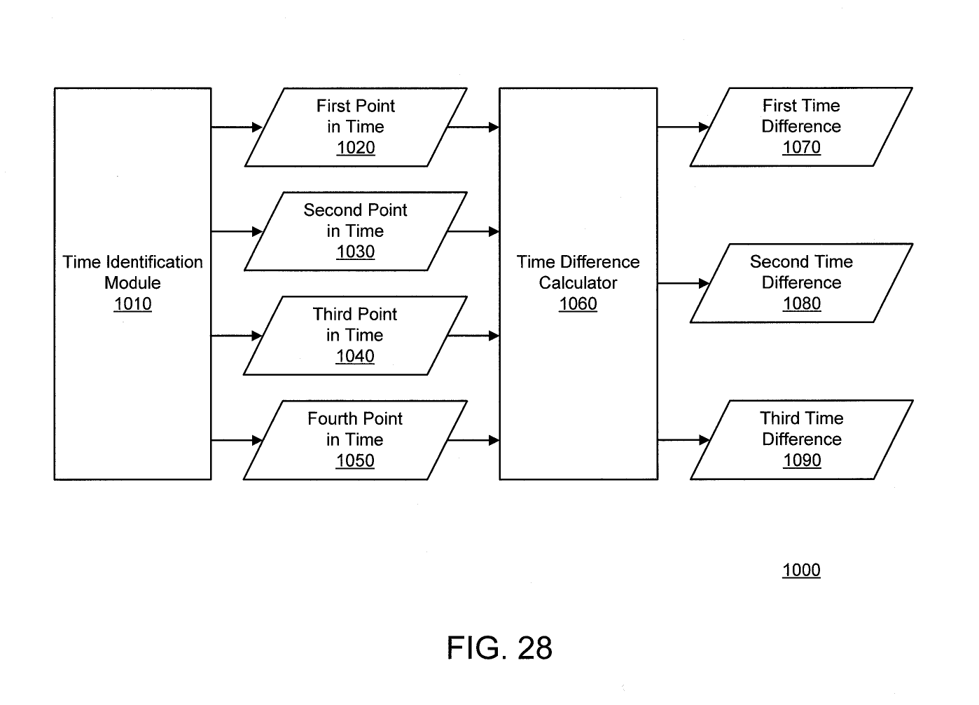

With reference now to FIG. 28, an exemplary time difference determination system 1000 in accordance with an embodiment is shown. Exemplary time difference determination system 1000 includes a time identification module 1010, which may be communicatively associated or coupled with said signal transceiver system 810. Time identification module 1010 is configured to identify the aforementioned first, second, third and fourth points in time (which are shown as first, second, third and fourth points in time 1020, 1030, 1040, 1050). Exemplary time difference determination system 1000 also includes a time difference calculator 1060, which may be communicatively associated or coupled with time identification module 1010. Time difference calculator 1060 is configured to calculate a first time difference 1070 between first and second points in time 1020, 1030, a second time difference 1080 between third and fourth points in time 1040, 1050, and a third time difference 1090 between one of first and second points in time 1020, 1030 and one of third or fourth points in time 1040, 1050.

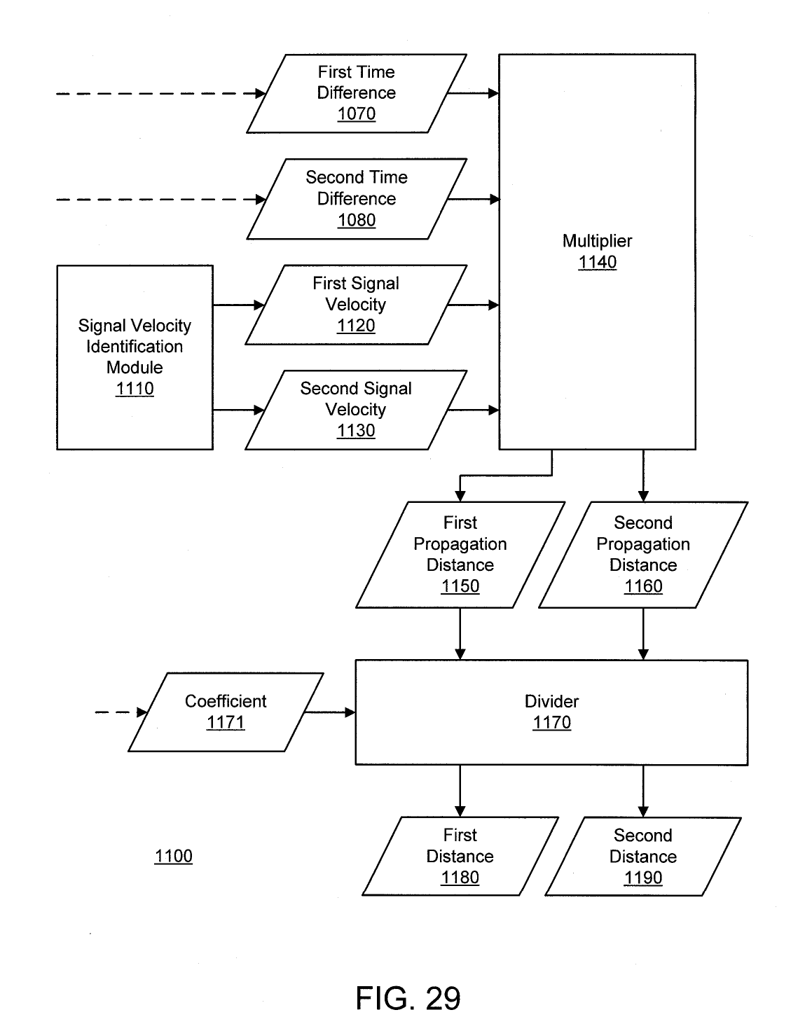

With reference now to FIG. 29, an exemplary distance determination system 1100 in accordance with an embodiment is shown. Exemplary distance determination system 1100 includes a signal velocity identification module 1110, which may be communicatively associated or coupled with signal transceiver system 810. Signal velocity identification module 1110 is configured to identify a first signal velocity 1120 associated with the aforementioned first signal (e.g., the signal corresponding to first transmitted and received signals 850, 860) and/or a second signal velocity 1130 associated with the aforementioned second signal (e.g., the signal corresponding to second transmitted and received signals 870, 880).

It is noted, however, that first and second signal velocities 1120, 1130 may be the same or different signal velocities. For example, if the signal velocity of first transmitted signal 850 is the same as the signal velocity of second transmitted signal 870, or if the signal velocity of first received signal 860 is the same as the signal velocity of second received signal 880, then first and second signal velocities 1120, 1130 will be indistinguishable. This may occur, for example, if the various transmitted signals are being propagated through the same transmission medium. However, if the signal velocity of first transmitted signal 850 is different than the signal velocity of second transmitted signal 870, or if the signal velocity of first received signal 860 is different than the signal velocity of second received signal 880, then first and second signal velocities 1120, 1130 will be distinguishable. This may occur, for example, if the various transmitted signals are being propagated through different transmission mediums, such as may occur (1) when these signals are propagated through different gases, liquids or solids or (2) as a result of different environmental factors (e.g., electromagnetic interference) occurring at different points in time.

Exemplary distance determination system 1100 also includes a multiplier 1140, which may be communicatively associated or coupled with time difference calculator 1060 and signal velocity identification module 1110. Multiplier 1140 is configured to (1) multiply first time difference 1070 by first signal velocity 1120 to determine a first propagation distance 1150 and (2) multiply second time difference 1080 by second signal velocity 1130 to determine a second propagation distance 1160. Exemplary distance determination system 1100 further includes a divider 1170, which may be communicatively associated or coupled with multiplier 1140. Divider 1170 is configured to divide each of first and second propagation distances 1150, 1160 by a coefficient 1171 to thereby determine first and second distances 1180, 1190, respectively, wherein first and second distances 1180, 1190 represent the estimated distances between signal transceiver system 810 and first object 110 when the aforementioned first signal (e.g., the signal corresponding to first transmitted and received signals 850, 860) and the aforementioned second signal (e.g., the signal corresponding to second transmitted and received signals 870, 880) are, for example, transmitted, reflected, received or propagated.

In one embodiment, coefficient 1171 is selected to be a factor of 2, or a factor that is substantially equal to 2. To illustrate, consider the example where a signal transmitted by signal transceiver system 810 is reflected off of first object 110. In particular, the transmitted signal travels a distance D₁ from signal transceiver system 810 to first object 110, and then travels a distance D₂ to return to signal transceiver system 810. In accordance with a number of exemplary implementations, the difference between these two distances may be considered negligible, such as where D1 is actually equal to D2, or such as where signal transceiver system 810 is moving at a velocity that is significantly slower than the applicable signal propagation speed. Consequently, coefficient 1171 is selected to be 2, and, as a result, divider 1170 divides each of first and second propagation distances 1150, 1160 in half (by dividing by the selected factor of 2) in order to determine first and second distances 1180, 1190, respectively, wherein first and second distances 1180, 1190 are close estimations of D₁ and D₂, respectively.

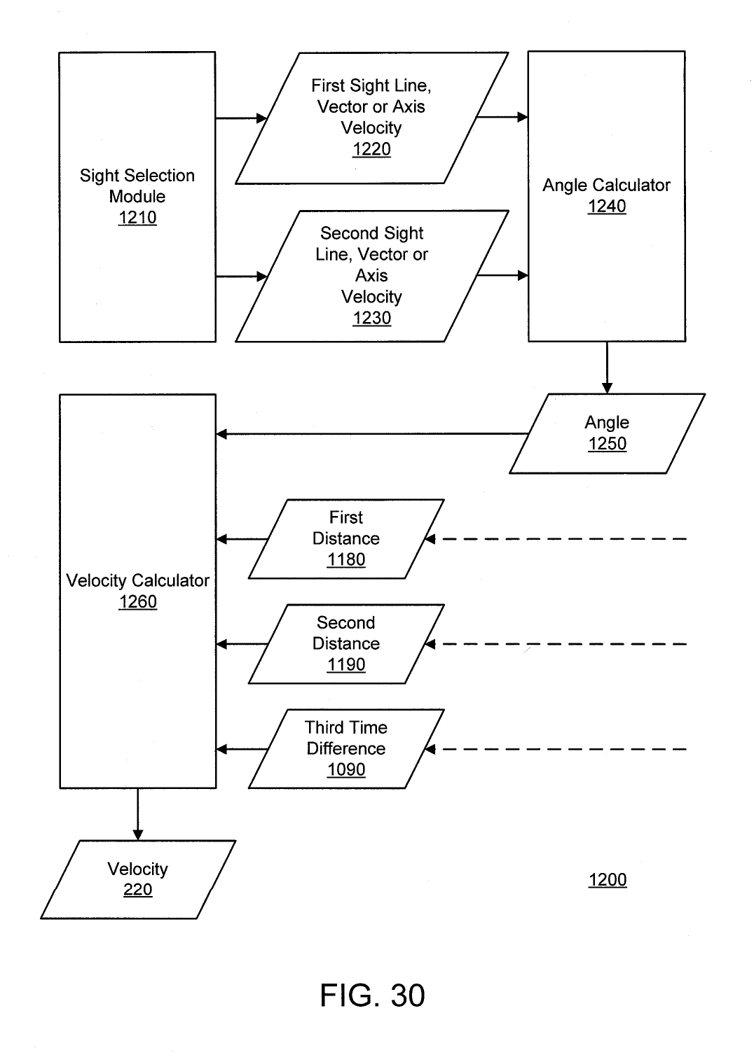

With reference now to FIG. 30, a second exemplary velocity calculation system 1200 in accordance with an embodiment is shown. Second exemplary velocity calculation system 1200 includes a sight selection module 1210, which may be communicatively associated or coupled with signal transceiver system 810. Sight selection module 1210 is configured to select first and second sight lines, vectors or axes 1220, 1230, wherein both of signal transceiver system 810 and first object 110 are located along first sight line, vector or axis 1220 at first and/or second points in time 1020, 1030, and wherein both of signal transceiver system 810 and first object 110 are located along second sight line, vector or axis 1230 at third and/or fourth points in time 1040, 1050.

Second exemplary velocity calculation system 1200 also includes an angle calculator 1240, which may be communicatively associated or coupled with sight selection module 1210. Angle calculator 1240 is configured to calculate an angle 1250 between first and second sight lines, vectors or axes 1220, 1230. In an embodiment, angle 1250 is determined to be within a range of 0 degrees to 360 degrees (or from 0 degrees to less than 360 degrees, as an angle of 360×N degrees, with N being any integer value, would be the same as an angle of 0 degrees). Pursuant to one embodiment, however, angle 1250 is determined to be within a range of negative (−) 180 degrees to positive (+) 180 degrees (e.g., from greater than −180 degrees to +180 degrees or from −180 degrees to less than +180 degrees).

With reference still to FIG. 30, second exemplary velocity calculation system 1200 further includes a velocity calculator 1260, which may be communicatively associated or coupled with divider 1170, angle calculator 1240 and time difference calculator 1060. Velocity Calculator 1260 is configured to calculate velocity 220 based on first distance 1180, second distance 1190, angle 1250 and third time difference 1090. It is noted that, once velocity 220 is calculated, velocity 220 may be compared to a velocity threshold in order to determine whether a motion event has occurred.

IV. Exemplary Location Determination Systems

In addition to the foregoing, in an embodiment, location 320 is determined or calculated. Consequently, a number of exemplary systems and configurations for determining or calculating location 320 will now be explored. However, the present technology is not limited to these exemplary systems and configurations. Indeed, other systems and configurations may be implemented.

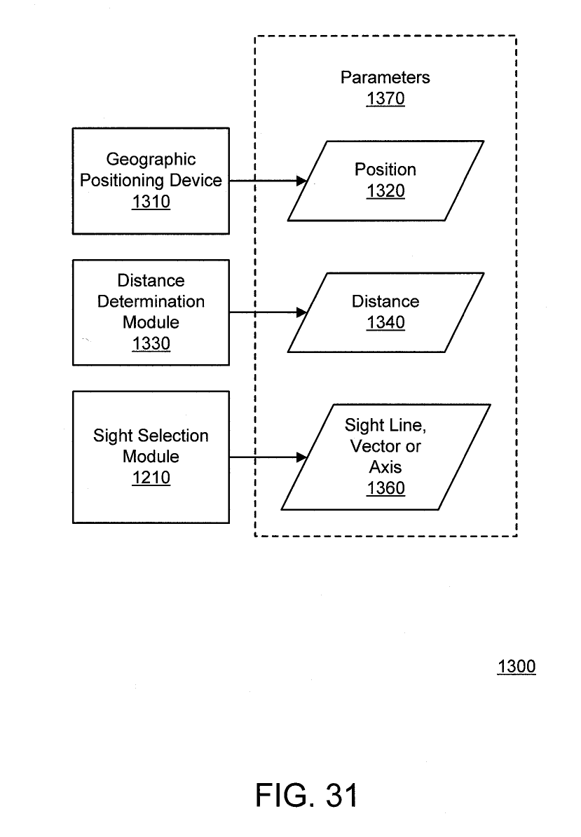

With reference now to FIG. 31, a first exemplary parameter provision system 1300 in accordance with an embodiment is shown. First exemplary parameter provision system 1300 includes a geographic positioning device 1310 configured to determine a position 1320 associated with geographic positioning device 1310. To illustrate, consider the example where geographic positioning device 1310 includes an electronic receiver configured to determine (e.g., such as by implementing a location determination process involving triangulation and/or trilateration) its location (e.g., its latitude, longitude, and altitude coordinates) within a relatively small margin of error, such as by using a number of satellite signals each transmitted along a different line-of-sight between the receiver and a different satellite from among a plurality of satellites within a satellite navigation system (e.g., a global navigation satellite system (GNSS)). In one embodiment, in so much as the receiver's calculated position may be somewhat erroneous, due to the aforementioned margin of error, it is noted that position 1320 is nevertheless “associated with” geographic positioning device 1310 (such as to account for this margin of error) even if position 1320 is not the exact location of geographic positioning device 1310 at the precise moment that position 1320 is calculated.

It is noted that geographic positioning device 1310 may be configured to implement one or more navigation or positioning systems to thereby determine position 1320, wherein these one or more navigation or positioning systems may be selected, for example, from among the following exemplary navigation or positioning systems: BeiDou Navigation System, Doppler Orbitography and Radiopositioning Integrated by Satellite (DORIS) System, Galileo, Global Positioning System (GPS), Globalnaya Navigatsionnaya Sputnikovaya Sistema (GLONASS), Indian Regional Navigational Satellite System (IRNSS) and Quasi-Zenith Satellite System (QZSS). It is further noted that the present technology is not limited to the implementation of these exemplary navigation or positioning systems, and that other navigation or positioning systems not discussed herein may be implemented.

First exemplary parameter provision system 1300 also includes a distance determination module 1330, which may be communicatively associated or coupled with geographic positioning device 1310. Distance determination module 1330 is configured to determine a distance 1340 between geographic positioning device 1310 and first object 110. For example, distance determination module 1330 may be configured to (1) transmit a signal, such as an electromagnetic or light signal, toward first object 110, (2) receive this signal once it has been reflected back from first object 110, (3) measure the time between the transmission and receipt of this signal, (4) multiply this time interval by the predetermined propagation speed associated with this signal to thereby determine the total distance traveled by this signal, and then (5) divide this total distance by a coefficient (e.g., a factor of 2) to thereby calculate distance 1340.

First exemplary parameter provision system 1300 further includes sight selection module 1210, which may be communicatively associated or coupled with geographic positioning device 1310, wherein sight selection module 1210 is configured to select a sight line, vector or axis 1360, wherein both of geographic positioning device 1310 and first object 110 are located along sight line, vector or axis 1360 at a particular point in time. In this manner, first exemplary parameter provision system 1300 may be implemented to provide one or more of parameters 1370.

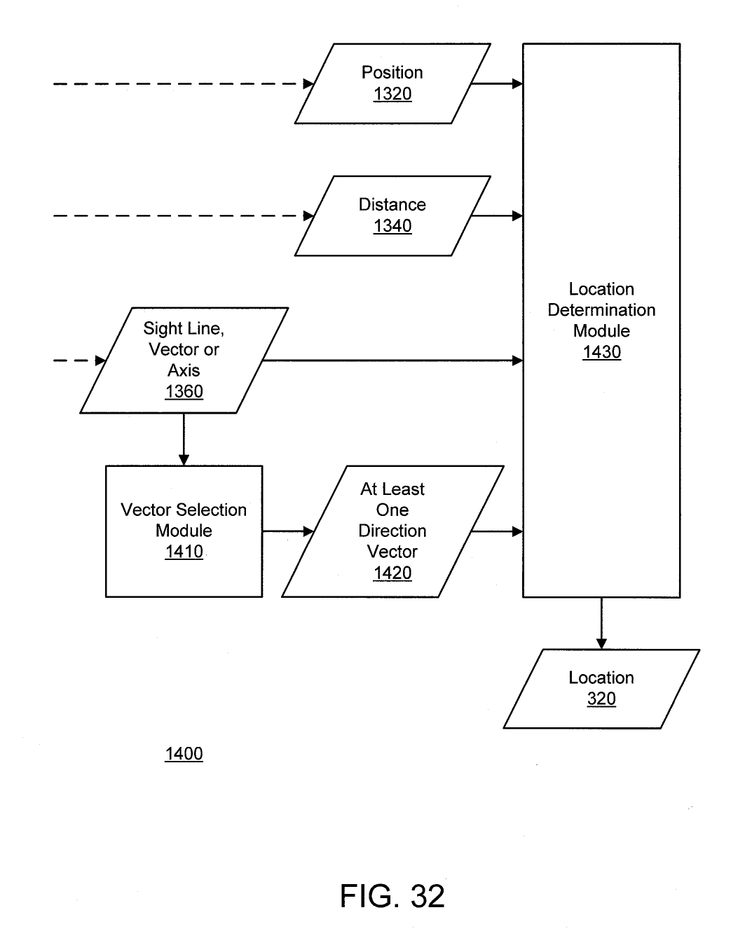

With reference now to FIG. 32, a first exemplary location determination system 1400 in accordance with an embodiment is shown. First exemplary location determination system 1400 includes a vector selection module 1410, which may be communicatively associated or coupled with sight selection module 1350. Vector selection module 1410 is configured to select at least one direction vector 1420 based on sight line, vector or axis 1360. For example, once sight line, vector or axis 1360 is selected, a direction vector that is 15 degrees East of North is selected based on sight line, vector or axis 1360. First exemplary location determination system 1400 also includes a location determination module 1430, which may be communicatively associated or coupled with geographic positioning device 1310, distance determination module 1330 and vector selection module 1410. Location determination module 1430 is configured to determine location 320 based on position 1320, distance 1340 and at least one direction vector 1420. Moreover, location determination module 1430 may also be configured to determine location 320 based on sight line, vector or axis 1360.

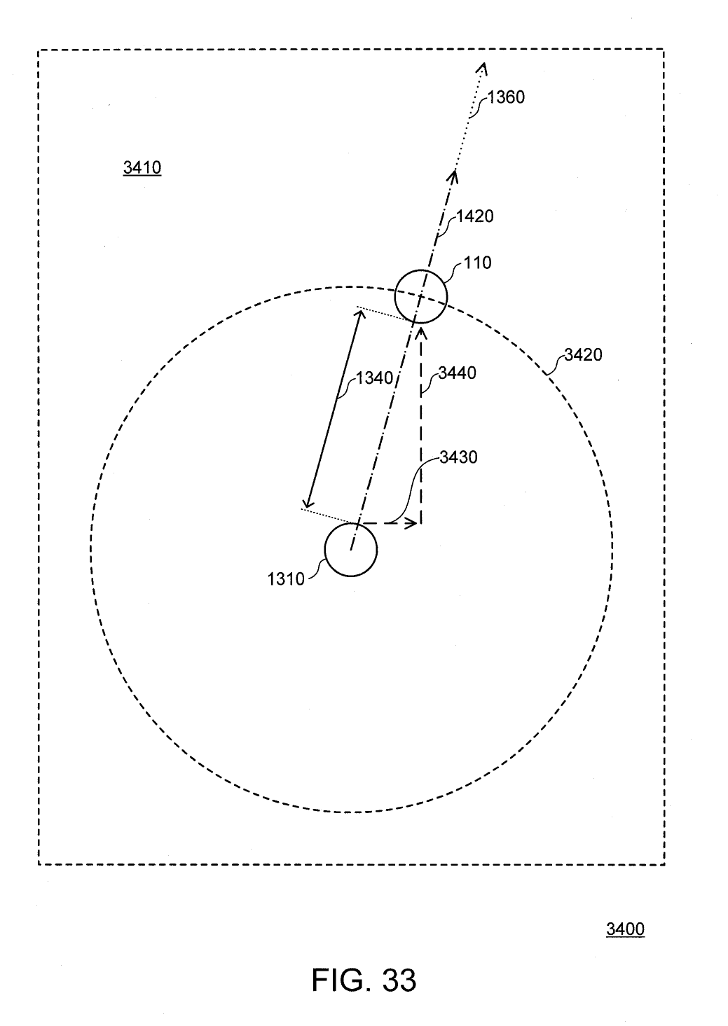

To further illustrate, and with reference now to FIG. 33, a first exemplary location determination scenario 3400 in accordance with an embodiment is shown. In particular, first object 110 is located a distance 1340 from geographic positioning device 1310 within a geographic area 3410. Position 1320 (not shown) of geographic positioning device 1310 within geographic area 3410 is determined, wherein position 1320 will serve as a point of reference Within geographic area 3410 for determining (or approximating) location 320 (not shown) of first object 110. Additionally, distance 1340 is determined such that a perimeter 3420 (e.g., a circular perimeter) around geographic positioning device 1310 may optionally be defined based on distance 1340, wherein the geographic position corresponding to location 320 of first object 110 is located somewhere along perimeter 3420. Furthermore, sight line, vector or axis 1360 is selected, wherein both of geographic positioning device 1310 and first object 110 are located along sight line, vector or axis 1360 within geographic area 3410, and at least one direction vector 1420 (e.g., 15 degrees East of North) is selected, based on sight line, vector or axis 1360. Next, location 320 may be determined, such as by identifying normal or perpendicular direction vectors 3430, 3440 (e.g., based on (1) distance 1340 and (2) one of sight line, vector or axis 1360 and at least one direction vector 1420) and then adjusting the latitude and longitude coordinates position 1320 based on the respective magnitudes of normal or perpendicular direction vectors 3430, 3440 to thereby identify the latitude and longitude coordinates of location 320.

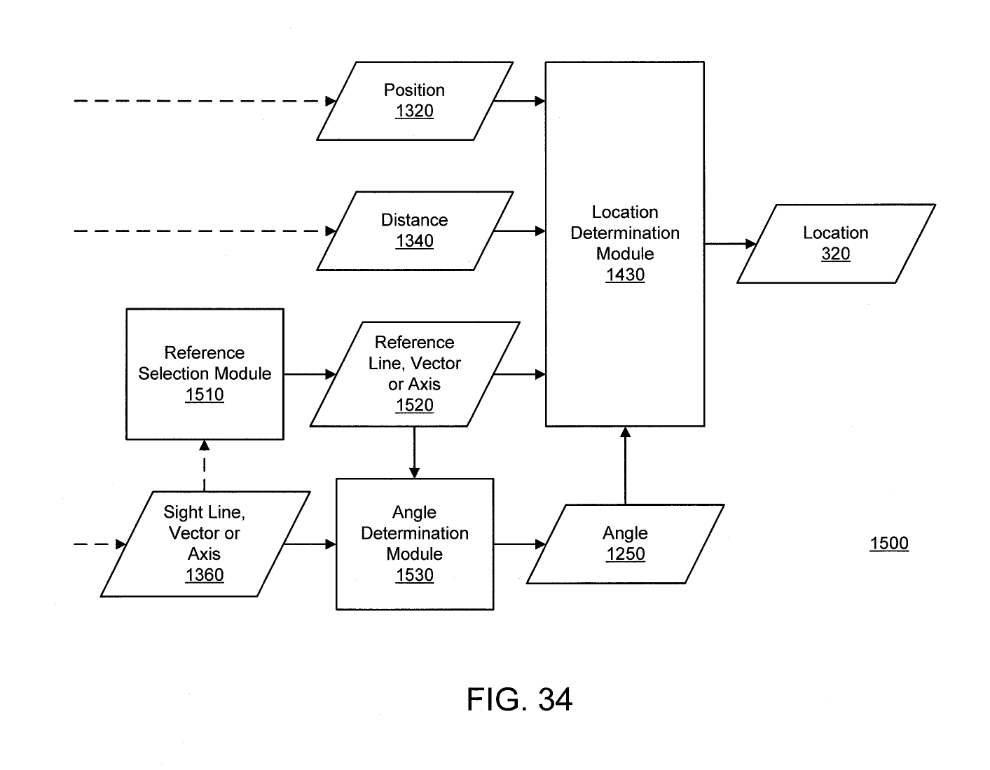

With reference now to FIG. 34, a second exemplary location determination system 1500 in accordance with an embodiment is shown. Second exemplary location determination system 1500 includes a reference selection module 1510 configured to select a reference line, vector or axis 1520, such as a horizontal reference line, vector or axis (e.g., a horizontal reference line, vector or axis pointing north) that may serve as a reference direction for determining (or approximating) an azimuth. It is noted that the term “azimuth” may be defined, for example, as a horizontal angle, or angular distance, between two lines, vectors or axes. Pursuant to one embodiment, however, reference selection module 1510 is configured to Select a reference line, vector or axis 1520 based on sight line, vector or axis 1360, wherein reference line, vector or axis 1520 may be, for example, a horizontal or vertical reference line, vector or axis selected to serve as a reference direction with respect to an angle of elevation.

Second exemplary location determination system 1500 also includes an angle determination module 1530, which may be communicatively associated or coupled with reference selection module 1510 and sight selection module 1210. Angle determination module 1530 is configured to determine angle 1250 between reference line, vector or axis 1520 and sight line, vector or axis 1360. In an embodiment, angle 1250 is an azimuth. Pursuant to one embodiment, however, angle 1250 is an elevation angle.

With reference still to FIG. 34, second exemplary location determination system 1500 further includes a location determination module 1430, which may be communicatively associated or coupled with geographic positioning device 1310, distance determination module 1330, angle determination module 1530 and reference selection module 1510. Location determination module 1430 is configured to determine location 320 based on position 1320, distance 1340, angle 1250 and reference line, vector or axis 1520.

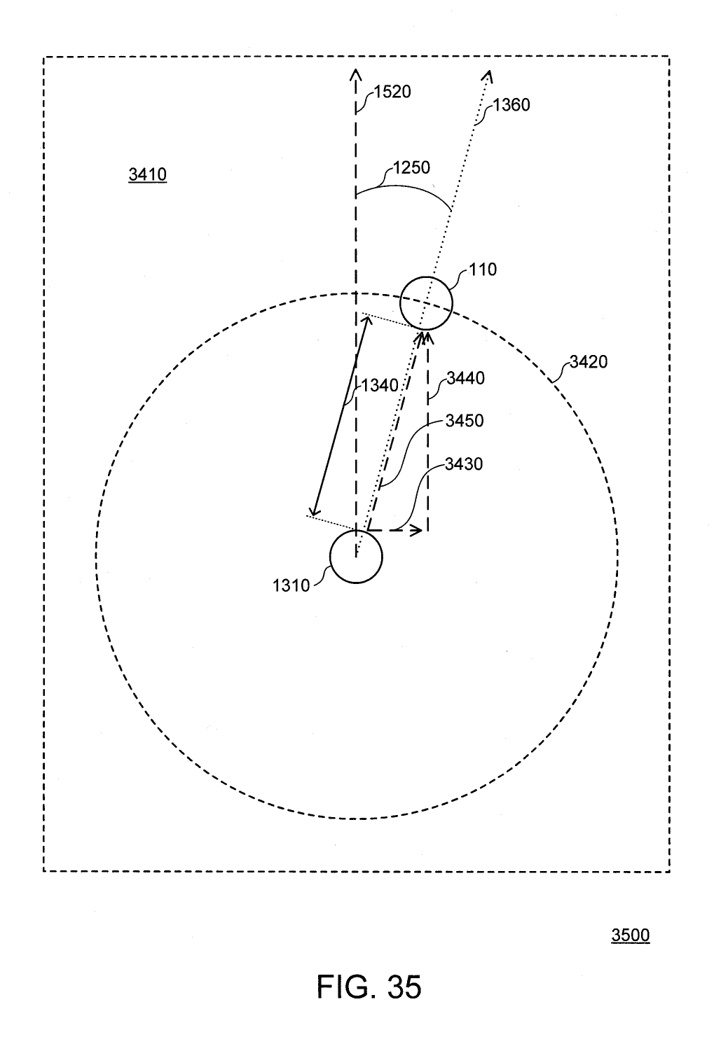

To further illustrate, and with reference now to FIG. 35, a second exemplary location determination scenario 3500 in accordance with an embodiment is shown. In particular, first object 110 is located a distance 1340 from geographic positioning device 1310 within geographic area 3410. Position 1320 (not shown) of geographic positioning device 1310 within geographic area 3410 is determined, wherein position 1320 will serve as a point of reference within geographic area 3410 for determining (or approximating) location 320 (not shown) of first object 110. Additionally, distance 1340 is determined such that perimeter 3420 (e.g., a circular perimeter) around geographic positioning device 1310 may optionally be defined based on distance 1340, wherein a geographic position corresponding to location 320 of first object 110 is located somewhere along perimeter 3420. Moreover, sight line, vector or axis 1360 is selected, wherein both of geographic positioning device 1310 and first object 110 are located along sight line, vector or axis 1360 within geographic area 3410. Furthermore, reference line, vector or axis 1520 (e.g., magnetic north) is selected, and angle 1250, which may be, for example, an azimuth, is calculated between reference line, vector or axis 1520 and sight line, vector or axis 1360.

With reference still to second exemplary location determination scenario 3500, location 320 is determined based on position 1320, distance 1340, angle 1250 and reference line, vector or axis 1520, such as by identifying normal or perpendicular direction vectors 3430, 3440 (e.g., based on distance 1340 and angle 1250) and then adjusting the latitude and longitude coordinates of position 1320 based on the respective magnitudes of normal or perpendicular direction vectors 3430, 3440 to thereby identify the latitude and longitude coordinates of location 320. To illustrate, consider the example where normal or perpendicular direction vectors 3430, 3440 are geometric or spatial (e.g., Euclidean) vectors, such that adding these two vectors would yield a single vector (e.g., a horizontal direction vector 3450) having a magnitude equal to distance 1340 and extending parallel to sight line, vector or axis 1360. Additionally, it is noted that the magnitude of one of normal or perpendicular direction vectors 3430, 3440 is a latitudinal magnitude reflecting a difference between the respective latitude coordinates of first object 110 and geographic positioning device 1310, and that the magnitude of the other of normal or perpendicular direction vectors 3430, 3440 is a longitudinal magnitude reflecting a difference between the respective longitude coordinates of first object 110 and geographic positioning device 1310. Consequently, the latitudinal magnitude is used to adjust the latitude coordinate of position 1320, such as where this latitudinal magnitude is added to the latitude coordinate of position 1320, to thereby identify the latitude coordinate of location 320. Similarly, the longitudinal magnitude is used to adjust the longitude coordinate of position 1320, such as where this longitudinal magnitude is added to the longitude coordinate of position 1320, to thereby identify the longitude coordinate of location 320.

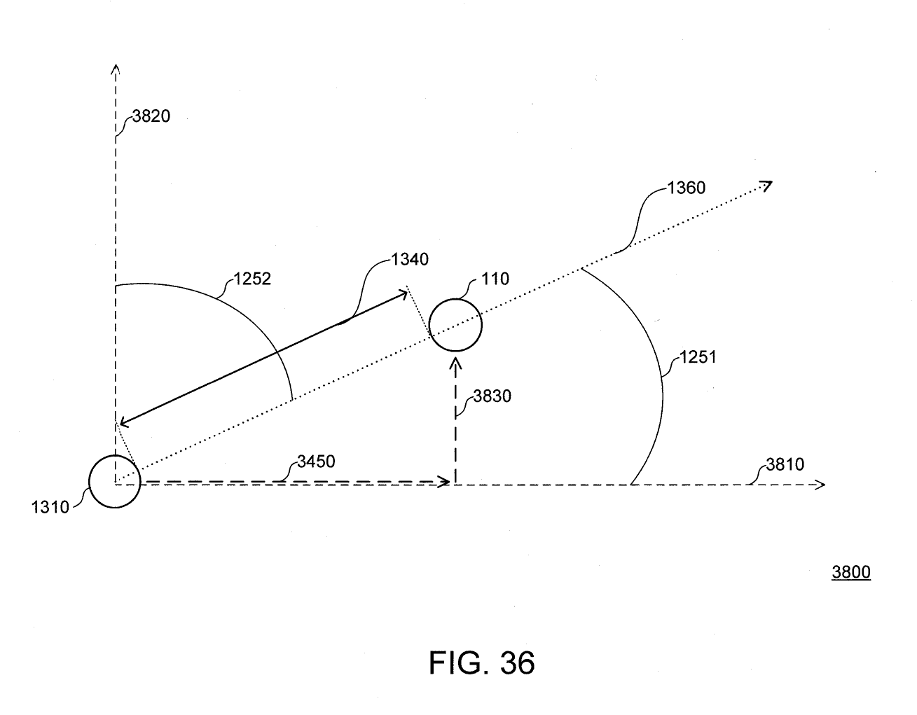

The foregoing notwithstanding, and with reference now to FIG. 36, a third exemplary location determination scenario 3800 in accordance with an embodiment is shown. In particular, first object 110 is located a distance 1340 from geographic positioning device 1310 within a geographic region, wherein first object 110 and geographic positioning device 1310 are located at different elevations within this geographic region (see, e.g., vertical direction vector 3830), and wherein first object 110 and geographic positioning device 1310 may also have different latitude and/or longitude coordinates (see, e.g., horizontal direction vector 3450). Pursuant to third exemplary location determination scenario 3800, position 1320 (not shown) of geographic positioning device 1310 within this geographic region is determined, wherein position 1320 will serve as a point of reference within this geographic region for determining (or approximating) location 320 (not shown) of first object 110. Additionally, distance 1340 is determined, and sight line, vector or axis 1360 is selected, wherein both of geographic positioning device 1310 and first object 110 are located along sight line, vector or axis 1360 within this geographic region.

Moreover, and with reference still to third exemplary location determination scenario 3800, reference line, vector or axis 1520 is selected, such as based on sight line, vector or axis 1360. For example, reference line, vector or axis 1520 may be a horizontal reference line 3810 or a vertical reference line 3820 positioned within a same vertical plane as sight line, vector or axis 1360. In this manner, reference line, vector or axis 1520 may serve as a reference direction with respect to an angle of elevation. Next, angle 1250, which is an angle of elevation, is calculated between the selected reference line, vector or axis 1520 (e.g., horizontal reference line 3810 or vertical reference line 3820) and sight line, vector or axis 1360; in this regard, first and second exemplary elevation angles 1251, 1252 are shown in FIG. 36.

Furthermore, and with reference still to third exemplary location determination scenario 3800, location 320 is determined based on position 1320, distance 1340, reference line, vector or axis 1520 (e.g., One of horizontal and vertical reference lines 3810, 3820) and angle 1250 first exemplary elevation angle 1251 if reference line, vector or axis 1520 is horizontal reference line 3810 or second exemplary elevation angle 1252 if reference line, vector or axis 1520 is vertical reference line 3820), such as by identifying horizontal and vertical direction vectors 3450, 3830 (e.g., based on distance 1340 and angle 1250) and then adjusting the latitude, longitude and elevation coordinates of position 1320 based on the respective magnitudes of horizontal and vertical direction vectors 3450, 3830 to thereby identify the latitude, longitude and elevation coordinates of location 320. For example, once a magnitude of vertical direction vector 3830 is determined, wherein this magnitude reflects a difference between the respective elevations of first object 110 and geographic positioning device 1310, this magnitude is added to the elevation of geographic positioning device 1310 to thereby determine the elevation of first object. Additionally, pursuant to one example, one or more direction vectors (see, e.g., normal or perpendicular direction vectors 3430, 3440 shown in FIG. 35) corresponding to horizontal direction vector 3450 are determined such that a latitudinal magnitude and/or longitudinal magnitude may be identified. If a latitudinal magnitude is identified, then this latitudinal magnitude is used to adjust the latitude coordinate of position 1320 to thereby identify the latitude coordinate of location 320. Similarly, if a longitudinal magnitude is identified, then this longitudinal magnitude is used to adjust the longitude coordinate of position 1320 to thereby identify the longitude coordinate of location 320.

V. Exemplary Data Storage and Access Systems

In an embodiment, a number of data parameters are stored such that these parameters may later be accessed and utilized. Consequently, a number of exemplary systems and configurations for storing and accessing data will now be explored. However, the present technology is not limited to these exemplary systems and configurations. Indeed, other systems and configurations may be implemented.

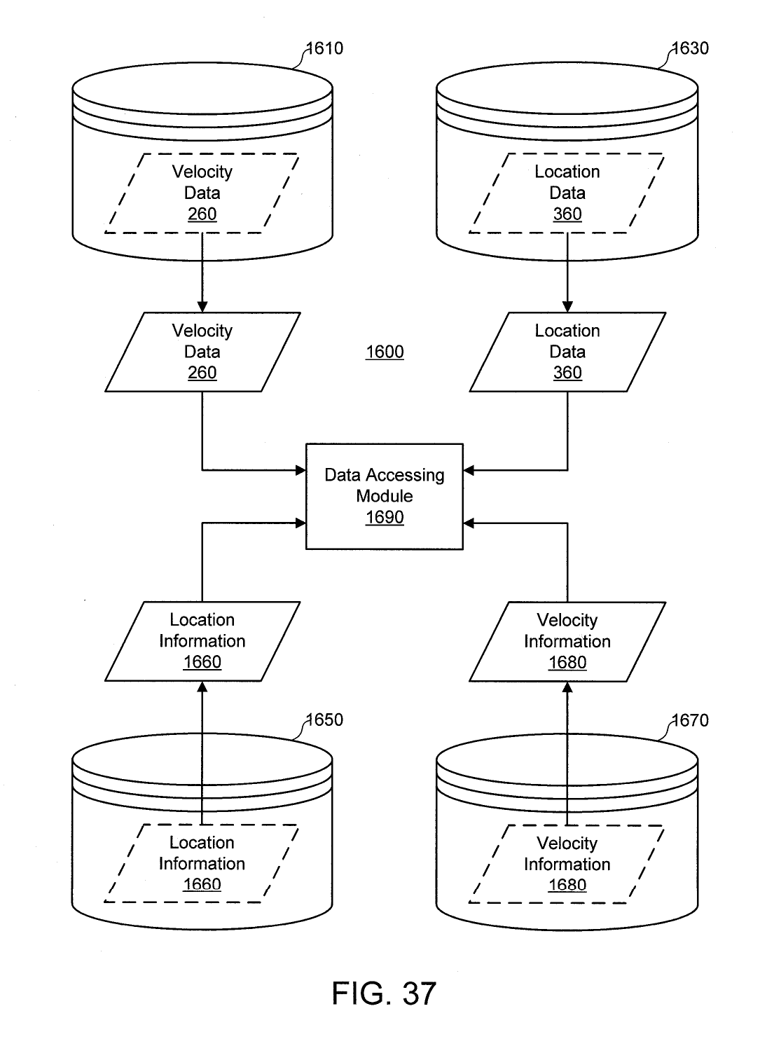

With reference now to FIG. 37, an exemplary data storage system 1600 in accordance with an embodiment is shown. Exemplary data storage system 1600 includes a velocity data storage unit 1610 storing velocity data 260, wherein velocity data 260 identifies velocity 220. Exemplary data storage system 1600 also includes a location data storage unit 1630 storing location data 360, wherein location data 360 identifies location 320.

Exemplary data storage system 1600 further includes a location database 1650 storing location information 1660. In an embodiment, location information 1660 identifies predefined area 420. To illustrate, consider the example where first object 110 is currently within a specific geographical region corresponding to predefined area 420, and where a current position (e.g., location 320) of first object 110 is identified to be within predefined area 420. Location information 1660, which identifies this predefined area 420, is accessed, and a vehicular speed threshold assigned to predefined area 420 may subsequently be identified so as to determine whether first object 110 is traveling too fast within predefined area 420.

Exemplary data storage system 1600 also includes a velocity database 1670 storing velocity information 1680, wherein velocity information 1680 identifies velocity threshold 520. For example, velocity threshold 520 may be a vehicular speed threshold associated with or assigned to predefined area 420, such as an upper or lower vehicular speed threshold assigned to a specific road, path or geographical area within predefined area 420. In one embodiment, however, velocity threshold 520 is defined to be above or below a vehicular speed threshold associated with or assigned to predefined area 420, such as based on a preselected upper or lower margin.

It is noted that one or more of the various data storage units and databases discussed herein, such as location database 1650, may include an electronic data storage unit or database, such as, but not limited to, electronic random access memory (RAM) (e.g., static RAM and/or dynamic RAM), electronic flash memory, and electronic read-only memory (ROM) (e.g., programmable ROM, erasable programmable ROM (EPROM), and/or electrically erasable programmable ROM (EEPROM)). It is also noted that one or more of the various data storage units and databases discussed herein, such as location database 1650, may include a magnetic data storage unit or database, such as, but not limited to, a magnetic hard disk drive (HDD). The foregoing notwithstanding, it is further noted that the present technology is not limited to the implementation of electronic and/or magnetic data storage units and databases. Indeed, other types of data storage units and databases may be implemented.

In view of the foregoing, it is noted that exemplary data storage system 1600 includes a number of data storage units and databases configured to store certain data and information that may be accessed and utilized in accordance with various embodiments of the present technology. With reference still to FIG. 37, in one embodiment, exemplary data storage system 1600 further includes a data accessing module 1690, which may be communicatively associated or coupled with velocity and location data storage units 1610, 1630 and location and velocity databases 1650, 1670. Data accessing module 1690 is configured to access velocity data 260, location data 360, location information 1660 and velocity information 1680. Once this data is accessed, it may then be processed or utilized to achieve a number of different results, such as those discussed herein.

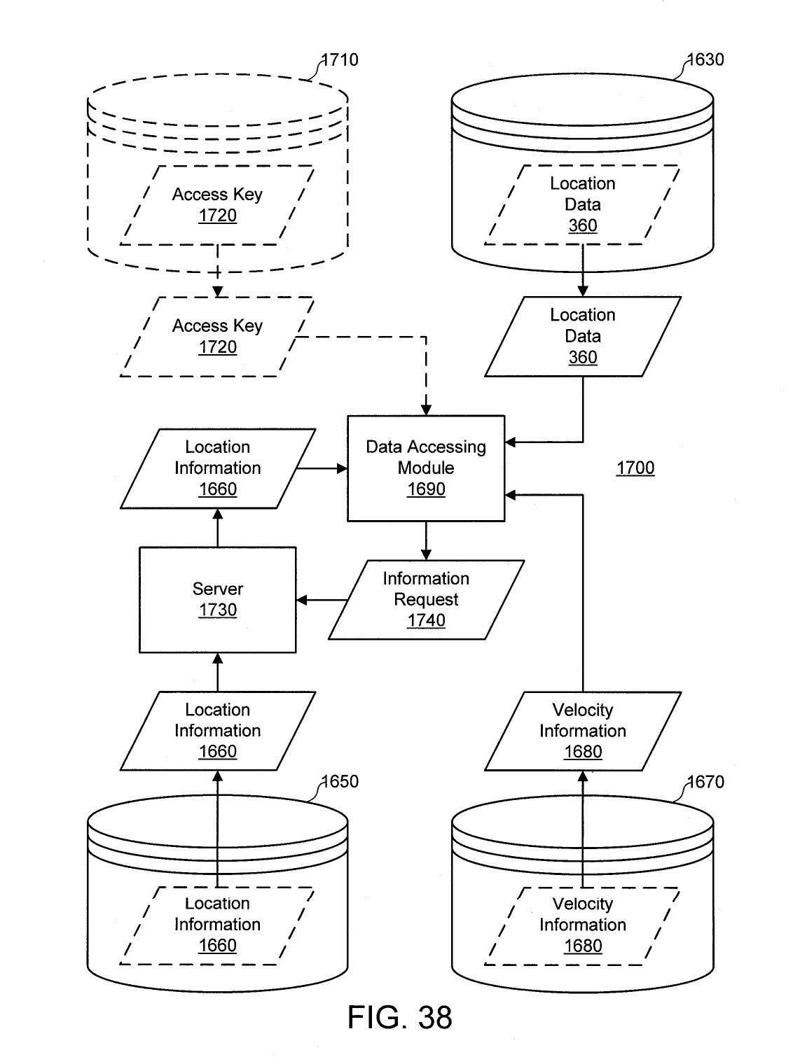

With reference now to FIG. 38, an exemplary data access system 1700 in accordance with an embodiment is shown. Exemplary data access system 1700 includes a server 1730, which may be communicatively associated or coupled with location database 1650. Server 1730 is configured to receive an information request 1740 that includes location data 360, access location information 1660 in response to this information request 1740 and based on location data 360, and forward location information 1660 to a destination associated with information request 1740. Additionally, data accessing module 1690 may be communicatively associated or coupled with server 1730, wherein data accessing module 1690 is configured to generate information request 1740, forward information request 1740 to server 1730, receive location information 1660 from server 1730 in response to information request 1740, and based on location data 360, and access velocity information 1680 based on location information 1660.

The foregoing notwithstanding, in one embodiment, exemplary data access system 1700 optionally includes an access key storage unit 1710 storing an access key 1720. It is noted that access key 1720 may be implemented, for example, to determine whether a destination associated with information request 1740 is authorized to access location information 1660. Additionally, server 1730 is configured to receive information request 1740, which includes access key 1720 and location data 360, access location information 1660 in response to this information request 1740 and based on access key 1720 and location data 360, and forward location information 1660 to a destination associated with information request 1740. Furthermore, data accessing module 1690 may be communicatively associated or coupled with server 1730 and access key storage unit 1710, wherein data accessing module 1690 is configured to access or acquire access key 1720, generate information request 1740, forward information request 1740 to server 1730, receive location information 1660 from server 1730 in response to information request 1740 and based on access key 1720 and location data 360, and access velocity information 1680 based on location information 1660.

VI. Exemplary Course, Path or Route Systems

It is noted that an object may be traveling within a geographic region along or pursuant to a specific course, path or route. If this course, path or route significantly corresponds to a predefined course, path or route (e.g., a road or highway), then this information may be useful in identifying which velocity threshold, from among a plurality of velocity thresholds associated with the applicable geographic region, is to be selected and applied.

Moreover, in an embodiment, predefined area 420 is associated with location 320 and course, path or route 1920. In particular, one exemplary scenario provides that course, path or route 1920 is defined by a bearing or heading that is 30 degrees East of North with a 15 degree angle of elevation relative to a horizontal plane. A predefined road or highway within predefined area 420 is identified as being positioned along the path corresponding to course, path or route 1920 and location 320. Therefore, it is noted that course, path or route 1920 may be an important factor in the process of identifying location information 1660, wherein location information 1660 identifies predefined area 420 (within which location 320 is positioned).

In view of the foregoing, it is noted that, in accordance with one embodiment, course, path or route 1920 is identified, determined, calculated and/or stored. Consequently, a number of exemplary systems and configurations that may be implemented to identify, determine, calculate and/or store course, path or route 1920 will now be explored. However, the present technology is not limited to these exemplary systems and configurations. Indeed, other systems and configurations may be implemented.

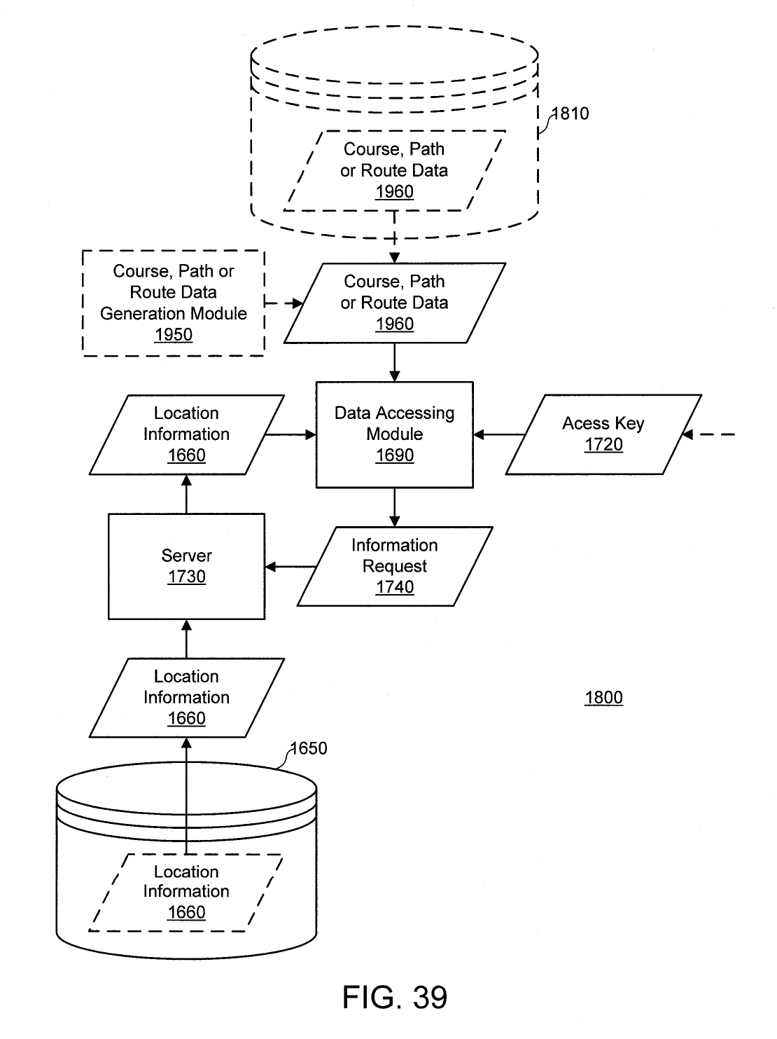

First, and with reference now to FIG. 39, an exemplary course, path or route storage system 1800 in accordance with an embodiment is shown. Exemplary course, path or route storage system 1800 includes a course, path or route data storage unit 1810 storing course, path or route data 1960 that identifies a course, path or route associated with an object, such as first object 110. For example, once course, path or route 1920 is identified, course, path or route data 1960 is generated based on course, path or route 1920, wherein course, path or route data 1960 may be, for example, digital or analog data reflecting the numerical data corresponding to course, path or route 1920 in a digital or analog format that may be processed, for example, by a computer processing unit or microcontroller. After being generated, course, path or route data is stored in course, path or route data storage unit 1810.

In an embodiment, data accessing module 1690 may be communicatively associated or coupled with course, path or route data storage unit 1810. Data accessing module 1690 is configured to access course, path or route data 1960, generate information request 1740 such that information request 1740 includes course, path or route data 1960, forward information request 1740 to server 1730, and receive location information 1660 from server 1730 in response to information request 1740 and based on location information 1660 and course, path or route data 1960. The foregoing notwithstanding, one embodiment provides that course, path or route data generation module 1950 may be communicatively associated or coupled with data accessing module 1690, such as where course, path or route data storage unit 1810 is optionally implemented, and such that data accessing module 1690 may obtain or access course, path or route data 1960 directly from course, path or route data generation module 1950.

Moreover, in an embodiment, data accessing module 1690 is configured to access or acquire access key 1720, generate information request 1740 such that information request 1740 includes course, path or route data 1960 and access key 1720, forward information request 1740 to server 1730, and receive location information 1660 from server 1730 in response to information request 1740 and based on access key 1720, location information 1660 and course, path or route data 1960. It is noted that access key 1720 may be implemented, for example, to prevent Unauthorized access to location information 1660.

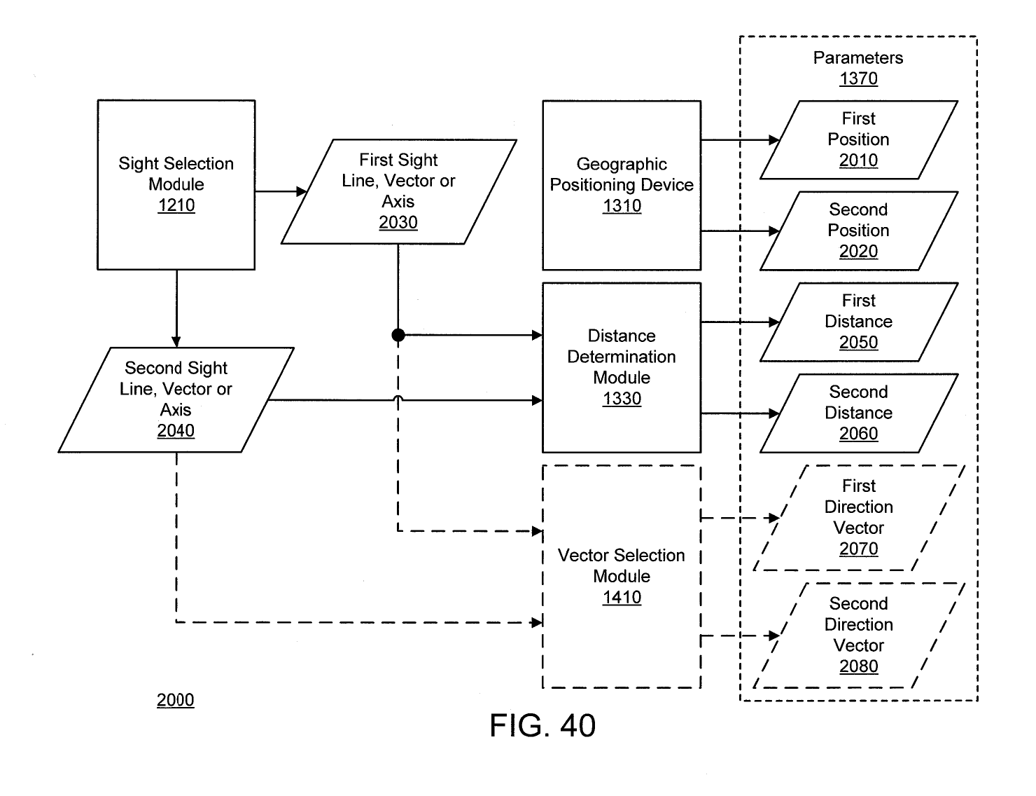

With reference now to FIG. 40, a second exemplary parameter provision system 2000 in accordance with an embodiment is shown. Second exemplary parameter provision system 2000 includes geographic positioning device 1310, which is configured to determine a first position 2010 of geographic positioning device 1310. To illustrate, consider the example where geographic positioning device 1310 includes an electronic receiver configured to determine (e.g., such as by implementing a location determination process involving triangulation and/or trilateration) its location (e.g., its latitude, longitude, and altitude coordinates) within a relatively small margin of error, such as by using a number of satellite Signals each transmitted along a different line-of-sight between the receiver and a different satellite from among a plurality of satellites within a satellite navigation system (e.g., a GNSS). In one embodiment, in so much as the receiver's calculated position may be somewhat erroneous, due to the aforementioned margin of error, it is noted that first position 2010 is nevertheless “associated with” geographic positioning device 1310 (such as to account for this margin of error) even if first position 2010 is not the exact location of geographic positioning device 1310 at the precise moment that first position 2010 is calculated.

Furthermore, in one embodiment, geographic positioning device 1310 is also configured to determine a second position 2020 of geographic positioning device 1310. It is noted that first and second positions 2010, 2020 may both be determined, for example, such that a course, path or route corresponding to these two positions may be subsequently determined. It is further noted that performing multiple calculations for each of the various positions associated with geographic positioning device 1310 may increase a level of accuracy associated with the position and course, path or route determination processes, since a single position calculation may be erroneous. Consequently, in order to further increase this level of accuracy, more than two positions may be calculated such that an average of multiple, different calculations may be identified.

With reference still to FIG. 40, second exemplary parameter provision system 2000 also includes sight selection module 1210, which may be communicatively associated or coupled with geographic positioning device 1310. Sight selection module 1210 is configured to select first and second sight lines, vectors or axes 2030, 2040. In an embodiment, both of geographic positioning device 1310 and first object 110 are located along first and second sight lines, vectors or axes 2030, 2040 at first and second points in time 1020, 1030, respectively. Pursuant to one embodiment, however, both of geographic positioning device 1310 and first object 110 are located along first and second sight lines, vectors or axes 2030, 2040 when geographic positioning device 1310 is in first and second positions 2010, 2020, respectively, such as where geographic positioning device 1310 is coupled with, mounted on or located within a vehicle that is in motion.

Second exemplary parameter provision system 2000 further includes distance determination module 1330, which may be communicatively associated or coupled with geographic positioning device 1310 and sight selection module 1210. Distance determination Module 1330 is configured to determine first and second distances 2050, 2060 between geographic positioning device 1310 and first object 110 along first and second sight lines, vectors or axes 2030, 2040, respectively. It is noted that these two different distances may be subsequently utilized to determine a course, path or route of first object 110, such as will be further explored herein.

The foregoing notwithstanding, in an embodiment, second exemplary parameter provision system 2000 optionally includes vector selection module 1410, which may be communicatively associated or coupled with sight selection module 1210. Vector selection module 1410 is configured to select first and second direction vectors 2070, 2080 based on first and second sight lines, vectors or axes 2030, 2040, respectively. For example, first and second direction vectors 2070, 2080 may be directional vectors corresponding to linear directions associated with first and second sight lines, vectors or axes 2030, 2040. Thus, it is noted that second exemplary parameter provision system 2000 may be implemented to provide one or more of parameters 1370.

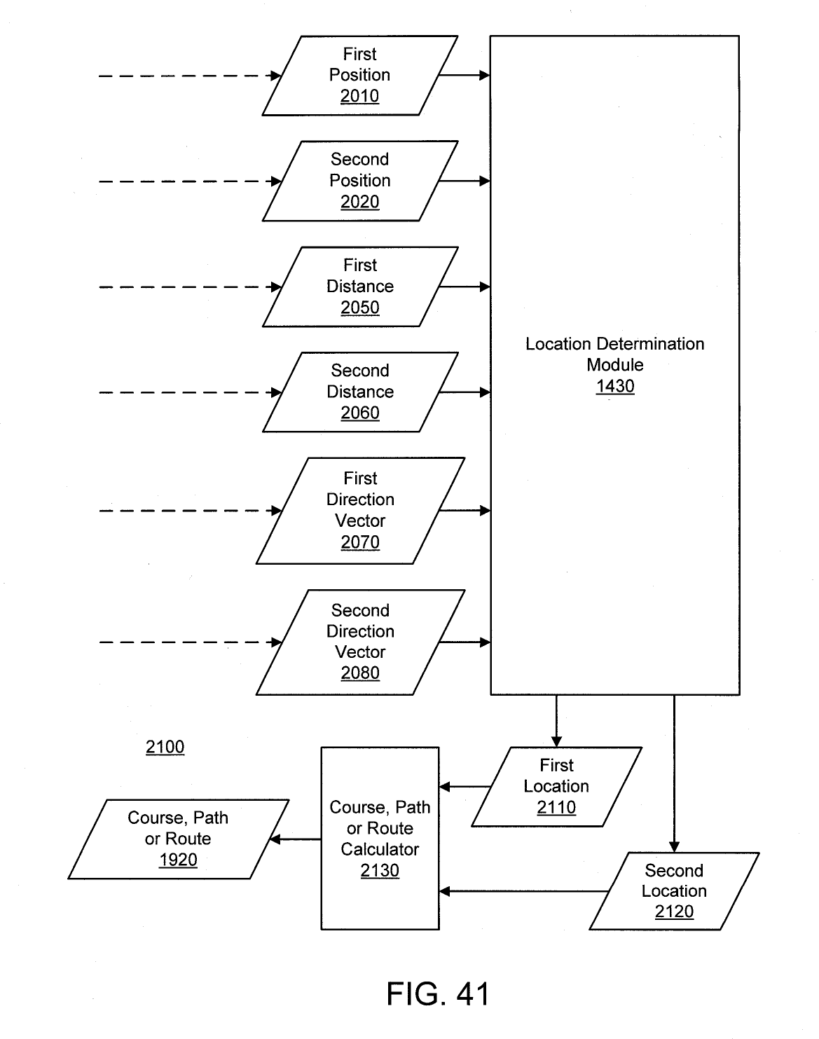

In one embodiment, once one or more of parameters 1370 are accessed, a course, path or route of first object 110 may be determined or calculated. To illustrate, and with reference now to FIG. 41, a first exemplary course, path or route calculation system 2100 in accordance with an embodiment is shown. First exemplary course, path or route calculation system 2100 includes location determination module 1430, which may be communicatively associated or coupled with geographic positioning device 1310, distance determination module 1330 and vector selection module 1410. In an embodiment, location determination module 1430 is configured to determine a first location 2110 associated with first object 110 based on first distance 2050 and first direction vector 2070, and based on a single position selected from among first and second positions 2010, 2020. Location determination module 1430 is further configured to determine a second location 2120 associated with first object 110 based on second distance 2060 and second direction vector 2080, and based on the single position selected from among first and second positions 2010, 2020. For example, where geographic positioning device 1310 is not moving, or where a time period between the displacement of geographic positioning device 1310 from first position 2010 to second position 2020 is negligible, second position 2020 may be disregarded such that both of first and second locations 2110, 2120 are determined based on first position 2010 (but irrespective of second position 2020).

The foregoing notwithstanding, one embodiment provides that location determination module 1430 is configured to determine first location 2110 based on first position 2010, first distance 2050 and first direction vector 2070 and determine second location 2120 based on second position 2020, second distance 2060 and second direction vector 2080. For example, where geographic positioning device 1310 is moving to a degree that is not negligible, second location 2120 is determined based on second position 2020. Thus, it is noted that multiple, different positions of geographic positioning device 1310 may be accessed so as to increase a level of accuracy associated with the determination of the various locations associated with first object 110.

With reference still to FIG. 41, first exemplary course, path or route calculation system 2100 also includes a course, path or route calculator 2130, which may be communicatively associated or coupled with location determination module 1430. Course, path or route calculator 2130 is configured to calculate course, path or route 1920 based on first and second locations 2110, 2120. This course, path or route 1920 may then be compared to a number of predefined courses, paths or routes (e.g., predefined roads and highways) within a geographic area to thereby determine with regard to which predefined course, path or route first object 110 is traveling.

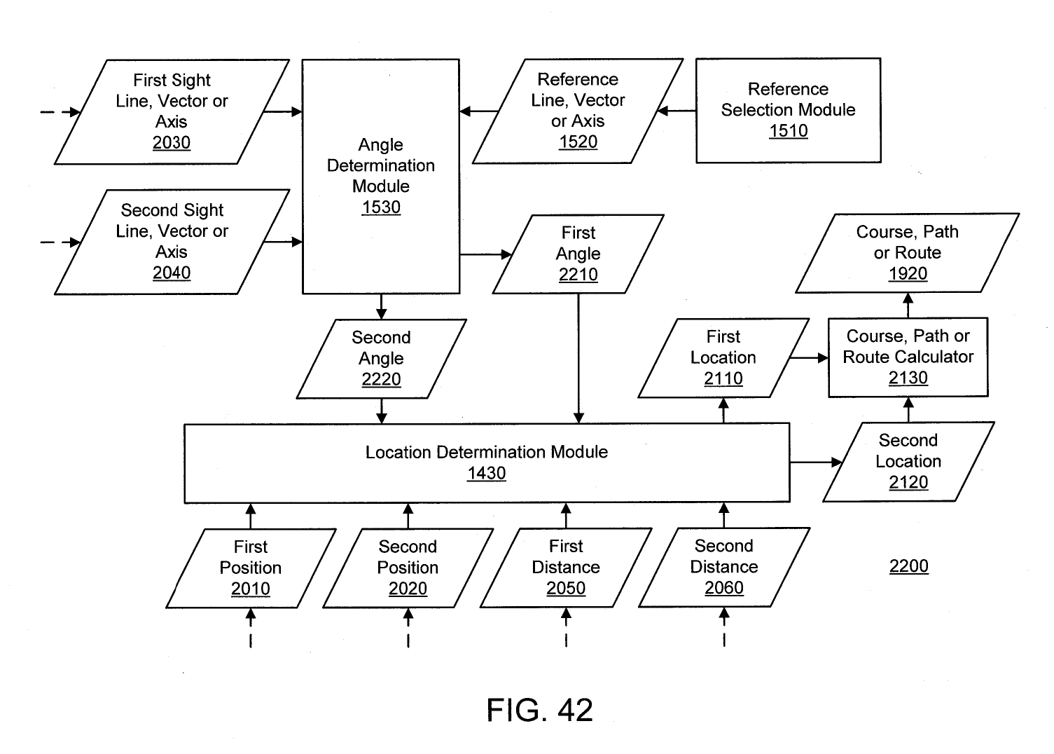

With reference now to FIG. 42, a second exemplary course, path or route calculation system 2200 in accordance with an embodiment is shown. Second exemplary course, path or route calculation system 2200 includes reference selection module 1510, which is configured to identify a reference line, vector or axis 1520. In an embodiment, reference line, vector or axis 1520 is a horizontal reference line, vector or axis, such as a horizontal reference direction pointing toward magnetic north. It is noted that this reference line, vector or axis 1520 may be utilized to identify a number of reference angles (e.g., one or more azimuths).

Second exemplary course, path or route calculation system 2200 also includes angle determination module 1530, which may be communicatively associated or coupled with reference selection module 1510 and sight selection module 1210. Angle determination module 1530 is configured to determine a first angle 2210 between reference line, vector or axis 1520 and first sight line, vector or axis 2030 and determine a second angle 2220 between reference line, vector or axis 1520 and second sight line, vector or axis 2040. It is noted that first and second angles 2210, 2220 may be utilized to determine first and second locations, respectively, of first object 110. Indeed, in one embodiment, first and second angles 2210, 2220 are first and second azimuths, respectively.

Second exemplary course, path or route calculation system 2200 further includes location determination module 1430, which may be communicatively associated or coupled with geographic positioning device 1310, distance determination module 1330 and angle determination module 1530. In an embodiment, location determination module 1430 is configured to determine first location 2110 based on first distance 2050 and first angle 2210, and based on a single position selected from among first and second positions 2010, 2020. Location determination module 1430 is further configured to determine second location 2120 based on second distance 2060 and second angle 2220, and based on the single position selected from among first and second positions 2010, 2020. For example, where geographic positioning device 1310 is not moving, or where a time period between the displacement of geographic positioning device 1310 from first position 2010 to second position 2020 is negligible, second position 2020 may be disregarded such that both of first and second locations 2110, 2120 are determined based on first position 2010 (but irrespective of second position 2020).

The foregoing notwithstanding, one embodiment provides that location determination module 1430 is configured to determine first location 2110 based on first position 2010, first distance 2050 and first angle 2210 and determine second location 2120 based on second position 2020, second distance 2060 and second angle 2220. For example, where geographic positioning device 1310 is moving to a degree that is not negligible, first location 2110 is determined based on first position 2010 and second location 2120 is determined based on second position 2020. Thus, it is noted that multiple, different positions of geographic positioning device 1310 may be accessed so as to increase a level of accuracy associated with the determination of the various locations associated with first object 110.

With reference still to FIG. 42, second exemplary course, path or route calculation system 2200 also includes course, path or route calculator 2130, which may be communicatively associated or coupled with location determination module 1430. Course, path or route calculator 2130 is configured to calculate course, path or route 1920 based on first and second locations 2110, 2120. As previously discussed, this course, path or route 1920 may then be compared to a number of predefined courses, paths or routes (e.g., predefined roads and highways) within a geographic area to thereby determine with regard to which predefined course, path or route first object 110 is traveling.

VII. Exemplary Real-Time Information Systems

In an embodiment, new information that is captured or identified in real-time may be useful to carrying out one or more of the operations discussed herein. Consequently, a numbers of exemplary real-time information systems and configurations will now be explored. However, the present technology is not limited to these exemplary systems and configurations. Indeed, other systems and configurations may be implemented.

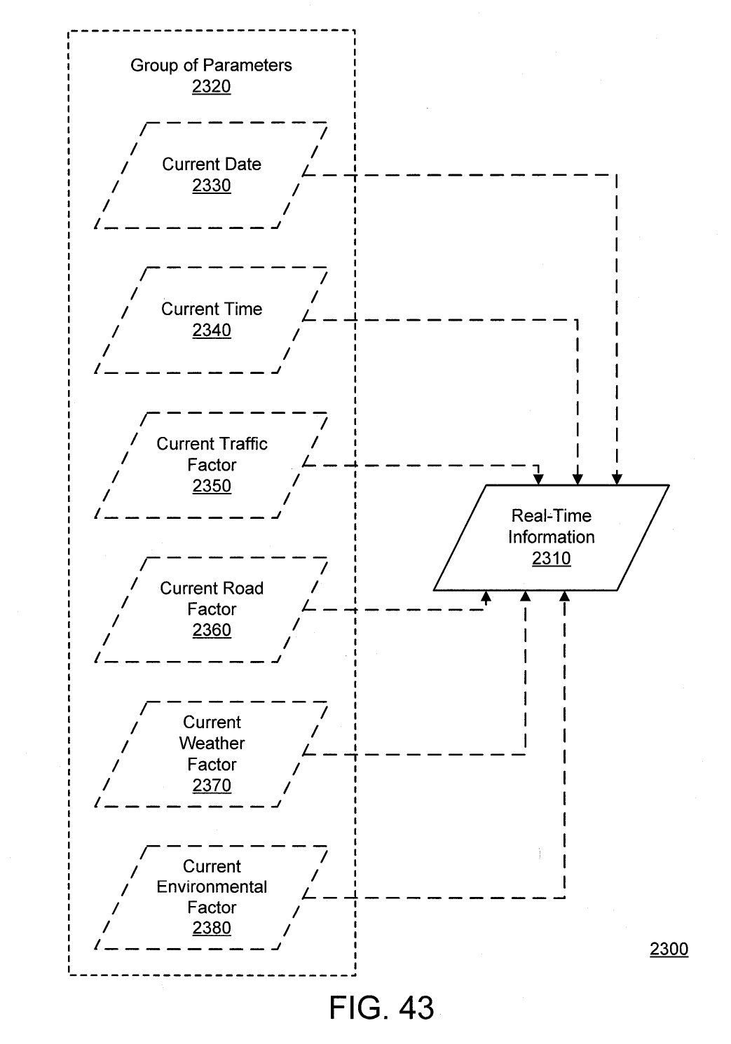

With reference now to FIG. 43, an exemplary real-time information paradigm 2300 in accordance with an embodiment is shown. Exemplary real-time information paradigm 2300 includes real-time information 2310, which identifies one or more parameters selected from a group of parameters 2320, wherein one or more of these parameters may be associated with, or define a current state of predefined area 420. For example, group of parameters 2320 may include a number of the following exemplary parameters: a current date 2330, current time 2340, current traffic factor 2350, current road factor 2360, current weather factor 2370 and current environmental factor 2380. The foregoing notwithstanding, it is noted that these parameters are exemplary in nature, and that the present technology is not limited to these exemplary parameters. Indeed, group of parameters 2320 may include one, all or some of these exemplary parameters and/or a number of other parameters not mentioned herein.

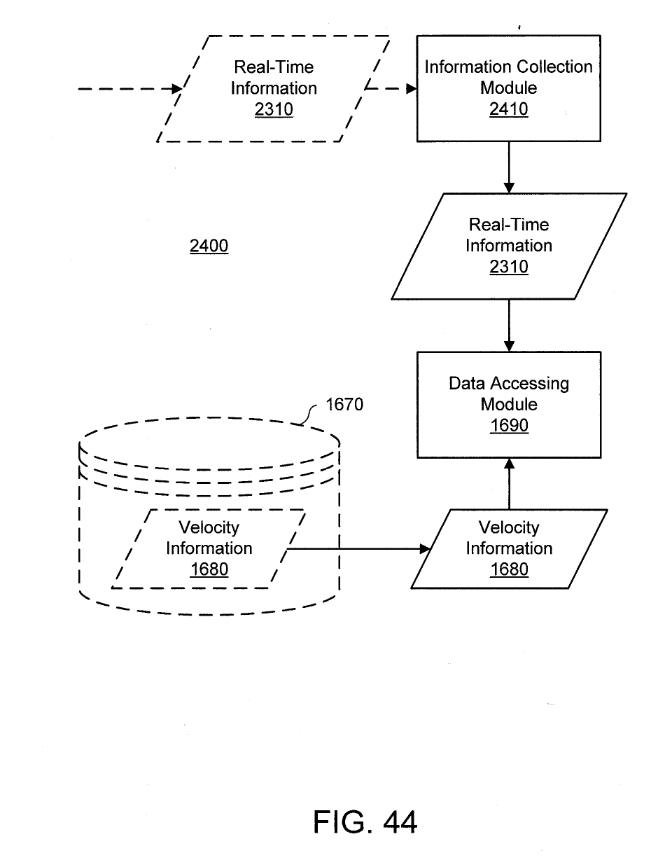

With reference now to FIG. 44, a first exemplary real-time information system 2400 in accordance with an embodiment is shown. First exemplary real-time information system 2400 includes an information collection module 2410 configured to collect real-time information 2310. Additionally, data accessing module 1690, which may be communicatively associated or coupled with information collection module 2410, is configured to access real-time information 2310. Data accessing module 1690 is also configured to access velocity information 1680, such as from velocity database 1670, based on real-time information 2310 (e.g., based on one or more parameters from group of parameters 2320). Indeed, in one embodiment, a specific velocity threshold from among a plurality of possible velocity thresholds may be accessed in real-time (e.g., by data accessing module 1690) based on one or more parameters from group of parameters 2320.

To illustrate, consider the example where two different upper vehicular speed thresholds are assigned or associated with a school zone, such as where a first upper vehicular speed threshold of 15 MPH is applicable in the school zone during school hours and a second upper vehicular speed threshold of 25 MPH is applicable in the school zone at all other times. During a specific week, the school hours for this school zone last from 7:00 a.m. (ante meridiem) to 3:00 p.m. (post meridiem) during the days of Monday through Friday. Consequently, current date 2330 could be accessed in real-time to determine if the day of the week is currently Saturday or Sunday; if so, the current vehicular speed threshold would be 25 MPH. Moreover, a combination of both current date 2330 and current time 2340 could be accessed in real-time to determine if the current day of the week is between Monday and Friday and if the current time of day is between 7:00 a.m. and 3:00 p.m.; if so, the current vehicular speed threshold would be 15 MPH. Furthermore, a combination of both current date 2330 and current time 2340 could be accessed in real-time to determine if the current time of day is before 7:00 a.m. or after 3:00 p.m. during one of the days between Monday and Friday; if so, the current vehicular speed threshold would be 25 MPH.

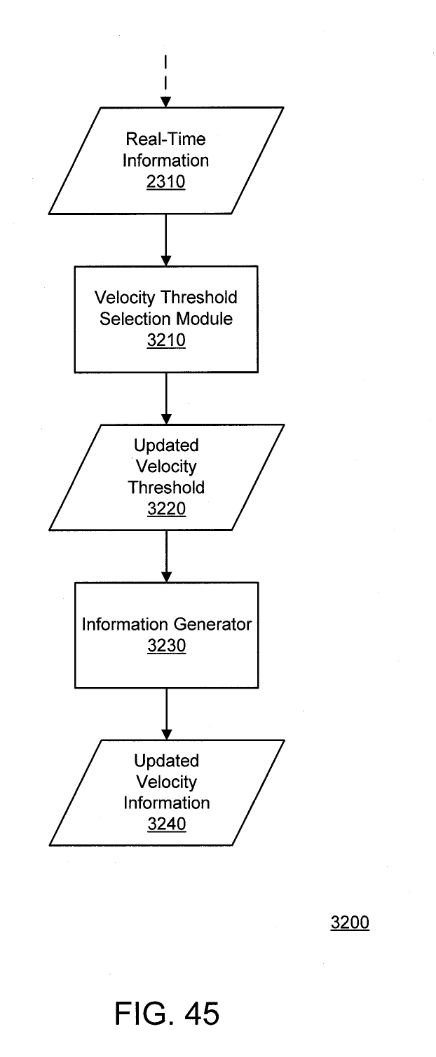

The foregoing notwithstanding, in one embodiment, a new or updated vehicular speed threshold or velocity threshold is selected in real-time based on real-time information 2310. With reference now to FIG. 45, an exemplary updated information generation system 3200 in accordance with an embodiment is shown. Exemplary updated information generation system 3200 includes a velocity threshold selection module 3210, which may be communicatively associated or coupled with data accessing module 1690. Velocity threshold selection module 3210 is configured to receive real-time information 2310 and select (e.g., (1) automatically or (2) in response to a user input or initiation command) an updated velocity threshold 3220 based on real-time information 2310 (e.g., based on one or more parameters from group of parameters 2320).

To illustrate, consider the example where real-time information 2310 includes current traffic factor 2350, which identifies a traffic jam or bottleneck on a heavily traveled highway. Velocity threshold selection module 3210 may be configured to automatically select updated velocity threshold 3220, based on this current traffic factor 2350, to be a lower vehicular Speed threshold than is usually assigned to this highway, and this lower vehicular speed threshold will be posted along the highway, such as with an electronic velocity threshold display unit that is capable of being updated in real-time to reflect updated velocity threshold 3220. In this manner, the probability of a vehicular collision occurring on this highway as a result of the traffic jam or bottleneck will be lowered.

Similarly, a second example provides that real-time information 2310 includes current road factor 2360, which identifies an obstacle, such as a stalled vehicle or a torn up section of asphalt, on a heavily traveled highway. Velocity threshold selection module 3210 may be configured to automatically select updated velocity threshold 3220, based on this current road factor 2360, to be a lower vehicular speed threshold than is usually assigned to this highway, and this lower vehicular speed threshold will be posted along the highway, such as with an electronic velocity threshold display unit that is capable of being updated in real-time to reflect updated velocity threshold 3220. In this manner, the probability of a vehicular collision occurring on this highway as a result of the identified obstacle will be lowered.

In a third example, real-time information 2310 includes current weather factor 2370, which identifies (1) a degree of rain, snow or hail that is falling upon, or has accumulated upon, a heavily traveled highway within the predefined area and/or (2) a degree of relatively high winds to which the geographic vicinity of interest is currently being subjected. Velocity threshold selection module 3210 may be configured to automatically select updated velocity threshold 3220, based on this current weather factor 2370, to be a lower vehicular speed threshold than is usually assigned to this highway, and this lower vehicular speed threshold will be posted along the highway, such as with an electronic velocity threshold display unit that is capable of being updated in real-time to reflect updated velocity threshold 3220. In this manner, the probability of a vehicular collision occurring on this highway as a result of the identified weather factor will be lowered.

Similarly, a fourth example provides that real-time information 2310 includes current environmental factor 2380, which identifies an earthquake occurring in the vicinity of a heavily traveled highway. Velocity threshold selection module 3210 may be configured to automatically select updated velocity threshold 3220, based on this current environmental factor 2380, to be a lower vehicular speed threshold than is usually assigned to this highway, and this lower vehicular speed threshold will be posted along the highway, such as with an electronic velocity threshold display unit that is capable of being updated in real-time to reflect updated velocity threshold 3220. In this manner, the probability of a vehicular collision occurring on this highway as a result of the identified earthquake will be lowered.

With reference still to FIG. 45, exemplary updated information generation system 3200 also includes an information generator 3230, which may be communicatively associated or coupled with velocity threshold selection module 3210. Information generator 3230 is configured to generate updated velocity information 3240, which identifies updated velocity threshold 3220. To illustrate, consider the example where updated velocity threshold 3220 is a numerical velocity. Updated velocity information 3240 may include a digital or analog electronic signal that reflects this numerical velocity in a digital or analog format that may be processed, for example, by a computer processing unit or microcontroller.

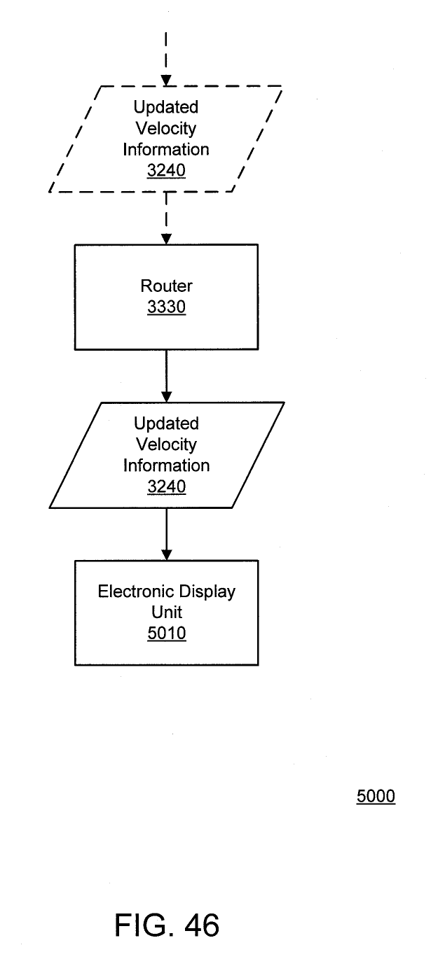

As previously noted, an embodiment provides that an electronic velocity threshold display unit that is capable of being updated in real-time to reflect updated velocity threshold 3220 may be implemented. To illustrate, and with reference now to FIG. 46, a first exemplary updated information display system 5000 in accordance with an embodiment is shown. First exemplary updated information display system 5000 includes an electronic display unit 5010 configured to receive electronic information and generate a visual display based on the electronic information. First exemplary updated information display system 5000 also includes a router 3330, which may be communicatively associated or coupled with information generator 3230 and electronic display unit 5010. Router 3330 is configured to receive updated velocity information 3240 and route updated velocity information 3240 to electronic display unit 5010 such that updated velocity threshold 3220 is displayed by electronic display unit 5010.

To further illustrate, consider the example where electronic display unit 5010 is positioned along a road or highway. Electronic display unit 5010 displays velocity threshold 520 such that operators of vehicles traveling along this road or highway can see velocity threshold 520 when they pass by, or are in viewing distance of, electronic display unit 5010. In this manner, electronic display unit 5010 is configured, and positioned, to inform oncoming vehicle operators of the current velocity threshold. Once velocity threshold 520 is updated, such that velocity threshold 520 changes to updated velocity threshold 3220, electronic display unit 5010 displays this new velocity threshold to the oncoming vehicle operators. In this manner, the new velocity threshold is posted in real-time to reflect the most recently selected velocity threshold that is associated with the road or highway.

Furthermore, it is noted that electronic display unit 5010 may include, or be integrated with, for example, a cathode ray tube (CRT) display, a field emission display (FED), a plasma display, a liquid crystal display (LCD) or a light emitting diode (LED) display. It is further noted, however, that the present technology is not limited to the implementation of these exemplary displays, and that electronic display unit 5010 may include, or be implemented with, a display other than one of the aforementioned exemplary displays.

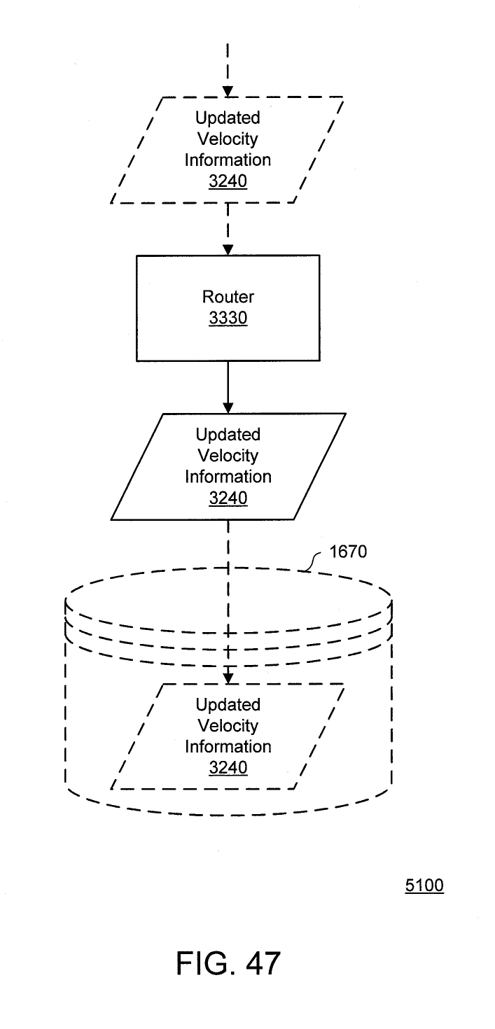

With reference now to FIG. 47, a first exemplary information updating system 5100 in accordance with an embodiment is shown. First exemplary information updating system 5100 includes router 3330, which may be communicatively associated or coupled with information generator 3230 and velocity database 1670. Router 3330 is configured to receive updated velocity information 3240 and route updated velocity information 3240 to velocity database 1670 such that velocity database 1670 stores updated velocity information 3240. In this manner, the stored velocity threshold is updated to reflect updated velocity threshold 3220.

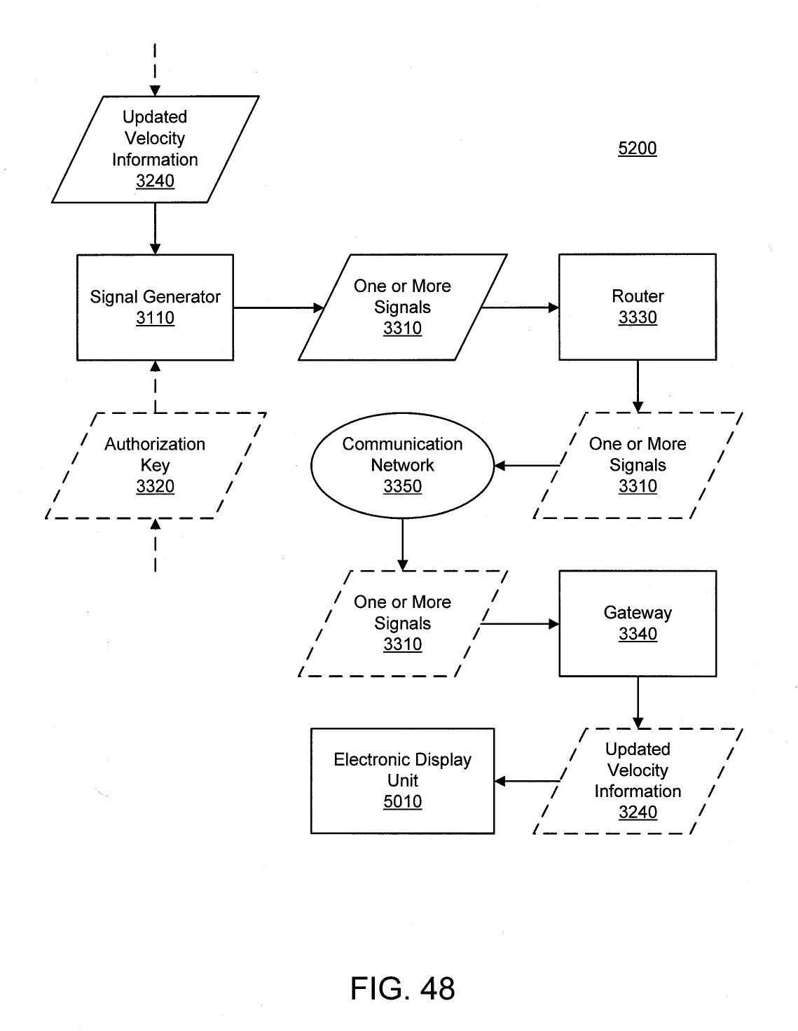

With reference now to FIG. 48, a second exemplary updated information display system 5200 in accordance with an embodiment is shown. Second exemplary updated information display system 5200 includes electronic display unit 5010, which is configured to receive electronic information and generate a visual display based on the electronic information. Second exemplary updated information display system 5200 also includes a gateway 3340, which may be communicatively associated or coupled with electronic display unit 5010. Gateway 3340 is configured to receive a communication that includes the electronic information and an authorization key 3320. Gateway 3340 is further configured to forward the electronic information to electronic display unit 5010 based on authorization key 3320.

Second exemplary updated information display system 5200 further includes a signal generator 3110, which may be communicatively associated or coupled with information generator 3230. Signal generator 3110 is configured to generate one or more signals that include authorization key 3320 and updated velocity information 3240. Second exemplary updated information display system 5200 also includes a router 3330, which may be communicatively associated or coupled with signal generator 3110 and gateway 3340. Router 3330 is configured to route one or more signals 3310 over a communication network 3350 (e.g., a wireless communication network) to gateway 3340 such that gateway 3340 receives one or more signals 3310 and, based on authorization key 3320, forwards updated velocity information 3240 to electronic display unit 5010 such that updated velocity threshold 3220 is displayed by electronic display unit 5010.

In view of the foregoing, it is noted that an embodiment provides that authorization key 3320 is implemented, such as for security purposes. In one embodiment, however, authorization key 3320 is not implemented. To illustrate, an embodiment provides that gateway 3340 is configured to receive a communication that includes electronic information and forward the electronic information to electronic display unit 5010. Additionally, signal generator 3110 is configured to generate one or more signals that include updated velocity information 3240. Moreover, router 3330 is configured to route one or more signals 3310 over communication network 3350 to gateway 3340 such that gateway 3340 receives one or more signals 3310 and forwards updated velocity information 3240 to electronic display unit 5010 such that updated velocity threshold 3220 is displayed by electronic display unit 5010.

Furthermore, it is noted that second exemplary updated information display system 5200 includes, or is communicatively integrated or associated with, communication network 3350. It is further noted that communication network 3350 may be, for example, a wireless communication network, such as a radio frequency (RF) network (e.g., a cellular network) or a satellite communications network, or a wired communication network, such as a public switched telephone network (PSTN), a cable network or a fiber-optic network. However, the present technology is not limited to these exemplary communication networks. Indeed, other types of communication networks may be implemented.

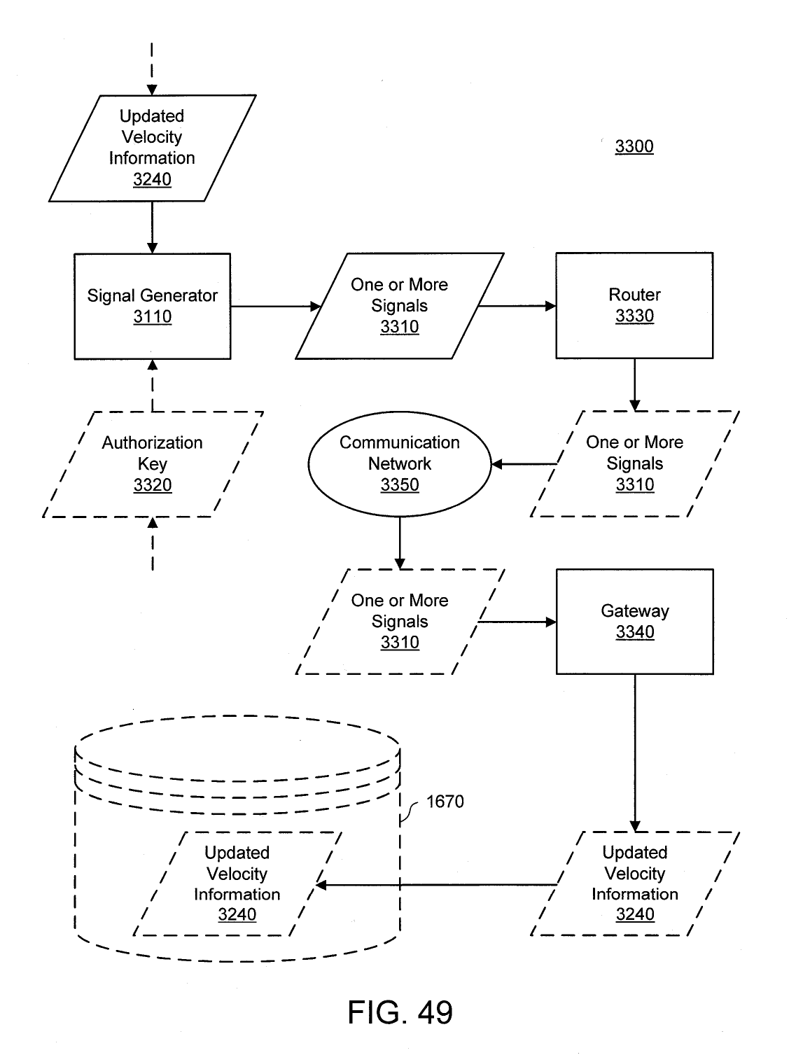

With reference now to FIG. 49, a second exemplary information updating system 3300 in accordance with an embodiment is shown. Second exemplary information updating system 3300 includes gateway 3340, which may be communicatively associated or coupled with velocity database 1670. Gateway 3340 is configured to receive a communication comprising authorization key 3320. Gateway 3340 is further configured to update the velocity threshold stored in velocity database 1670 in response to the communication and based on authorization key 3320. Second exemplary information updating system 3300 also includes signal generator 3110, which may be communicatively associated or coupled with information generator 3230. Signal generator 3110 is configured to generate one or more signals 3310 that include authorization key and updated velocity information 3240. Second exemplary information updating system 3300 further includes router 3330, which may be communicatively associated or coupled with signal generator 3110 and gateway 3340. Router 3330 is configured to route one or more signals 3310 over communication network 3350 (e.g., a wireless communication network) to gateway 3340 such that gateway 3340 receives one or more signals 3310 and, based on authorization key 3320, stores updated velocity information 3240 in velocity database 1670. In this manner, the stored velocity threshold is updated to reflect updated velocity threshold 3220.

In view of the foregoing, it is noted that an embodiment provides that authorization key 3320 is implemented, such as for security purposes. In one embodiment, however, authorization key 3320 is not implemented. To illustrate, an embodiment provides that gateway 3340 is configured to receive a communication and then update the velocity threshold stored in velocity database 1670 in response to the communication. Additionally, signal generator 3110 is configured to generate one or more signals 3310 that include updated velocity information 3240, and router 3330 is configured to route one or more signals 3310 over communication network 3350 to gateway 3340 such that gateway 3340 receives one or more signals 3310 and stores updated velocity information 3240 in velocity database 1670.

Furthermore, it is noted that second exemplary information updating system 3300 includes, or is communicatively integrated or associated with, communication network 3350. It is further noted that communication network 3350 may be, for example, a wireless communication network, such as a radio frequency (RF) network (e.g., a cellular network) or a satellite communications network, or a wired communication network, such as a public switched telephone network (PSTN), a cable network or a fiber-optic network. However, the present technology is not limited to these exemplary communication networks. Indeed, other types of communication networks may be implemented.

VIII. Exemplary Tolerance Systems

In an embodiment, velocity information may be generated based on a tolerance threshold, such as where the tolerance threshold is added to, or subtracted from, a speed threshold so as to obtain a velocity threshold. Consequently, a number of exemplary tolerance threshold systems and configurations will now be explored. However, the present technology is not limited to these exemplary systems and configurations. Indeed, other systems and configurations may be implemented.

With reference now to FIG. 50, an exemplary tolerance system 2500 in accordance with an embodiment is shown. Exemplary tolerance system 2500 optionally includes a speed threshold database 2510, wherein speed threshold database 2510 stores speed information 2520 that identifies a speed threshold associated with predefined area 420. Exemplary tolerance system 2500 may also optionally include a tolerance threshold database 2530, wherein tolerance threshold database 2530 stores a tolerance threshold 2540. Additionally, data accessing module 1690, which may be communicatively associated or coupled with speed and tolerance threshold databases 2510, 2530, is configured to access speed information 2520, based on location information 1660, and access tolerance threshold 2540. Exemplary tolerance system 2500 further includes a velocity information generation module 2550, which may be communicatively associated or coupled with data accessing module 1690. Velocity information generation module 2550 is configured to receive speed information 2520 and tolerance threshold 2540, add tolerance threshold 2540 to, or subtract tolerance threshold 2540 from, the aforementioned speed threshold to thereby obtain velocity threshold 520, and generate velocity information 1680 based on velocity threshold 520.

To illustrate, consider the example where law enforcement officers have been instructed to not issue a traffic citation to a driver that is merely traveling at a rate of speed of 5 MPH over the applicable vehicular speed threshold of 65 MPH on a particular highway. Speed information 2520 is generated such that the speed threshold associated with this highway is 65 MPH. Additionally, tolerance threshold 2540 is defined to be 5 MPH. Moreover, tolerance threshold 2540 is added to the aforementioned speed threshold such that velocity threshold 520 is calculated to be 70 MPH: Consequently, and with reference again to FIG. 14, if the velocity 220 of a driver exceeds velocity threshold 520, wherein velocity threshold 520 reflects the 5 MPH buffer above the 65 MPH vehicular speed threshold, then motion event 640 is identified, and a law enforcement officer may accordingly choose to issue a traffic citation to the driver.

Moreover, and in accordance with an embodiment, a number of different tolerance thresholds may be implemented, wherein the various tolerance thresholds are each associated with a different geographic area, such as where different buffers are to be applied with respect to different roads and highways. As such, one embodiment provides that tolerance threshold 2540 is associated with, or assigned to, predefined area 420, and that data accessing module 1690 is configured to access both speed information 2520 and tolerance threshold 2540 based on location information 1660.

It is noted that one or more of the various data storage units and databases discussed herein, such as speed threshold database 2510, may include an electronic data storage unit or database, such as, but not limited to, electronic random access memory (RAM) (e.g., static RAM and/or dynamic RAM), electronic flash memory, and electronic read-only memory (ROM) (e.g., programmable ROM, erasable programmable ROM (EPROM), and/or electrically erasable programmable ROM (EEPROM)). It is also noted that one or more of the various data storage units and databases discussed herein, such as speed threshold database 2510, may include a magnetic data storage unit or database, such as, but not limited to, a magnetic hard disk drive (HDD). The foregoing notwithstanding, it is further noted that the present technology is not limited to the implementation of electronic and/or magnetic data storage units and databases. Indeed, other types of data storage units and databases may be implemented.

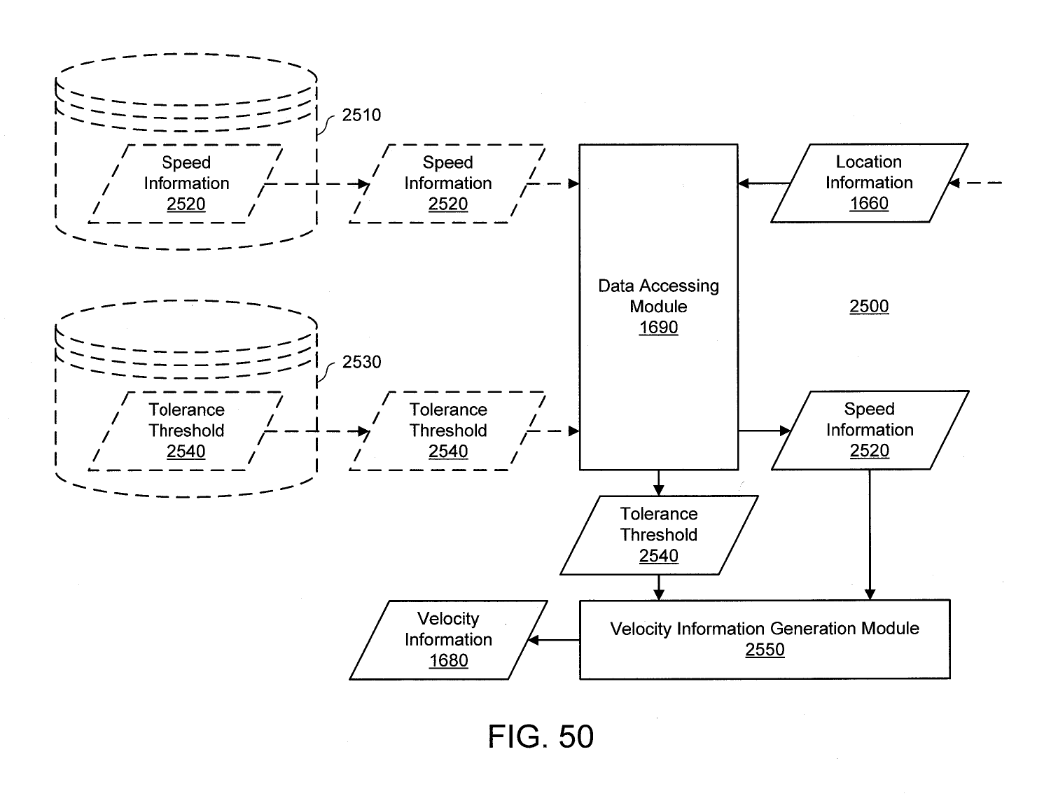

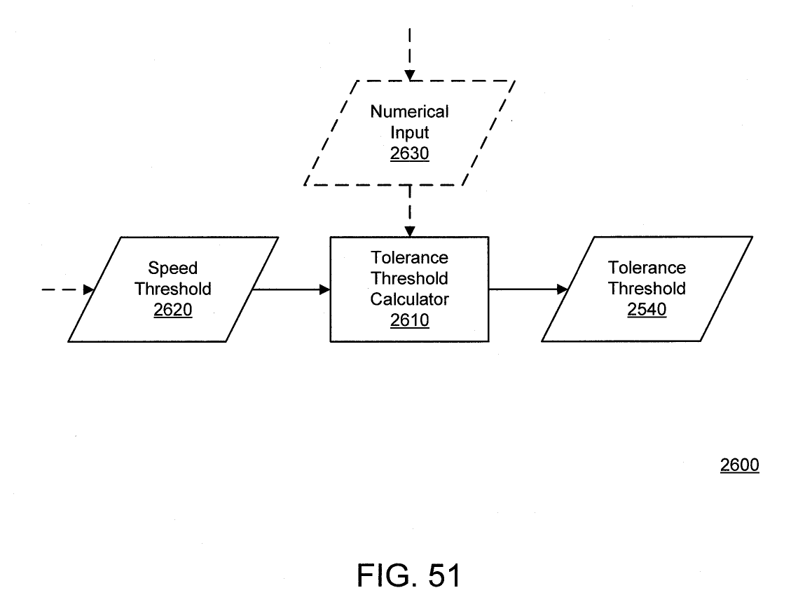

The foregoing notwithstanding, and with reference now to FIG. 51, an exemplary tolerance calculation system 2600 in accordance with an embodiment is shown. Exemplary tolerance calculation system 2600 includes a tolerance threshold calculator 2610, which may be communicatively associated or coupled with data accessing module 1690. Tolerance threshold calculator 2610 is configured to calculate tolerance threshold 2540 based on a speed threshold 2620 associated with predefined area 420. Moreover, in one embodiment, tolerance threshold calculator 2610 is configured to calculate tolerance threshold 2540 based on speed threshold 2620 and a numerical input 2630.

To illustrate, consider the example where numerical input 2630 is 10%. If the vehicular speed threshold (or speed threshold 2620) assigned to or associated with predefined area 420 is 50 MPH, then tolerance threshold calculator 2610 calculates 10% of this speed threshold 2620 to be 5 MPH, and tolerance threshold 2540 is consequently defined as 5 MPH. Similarly, if the vehicular speed threshold (or speed threshold 2620) assigned to or associated with predefined area 420 is 65 MPH, then tolerance threshold calculator 2610 calculates 10% of this speed threshold 2620 to be 6.5 MPH, and tolerance threshold 2540 is consequently defined as 6.5 MPH. In this manner, tolerance threshold 2540 is a function of the applicable speed threshold. Indeed, in one embodiment, tolerance threshold calculator 2610 is configured to automatically recalculate tolerance threshold 2540 in response to a change in the speed threshold. The foregoing notwithstanding, it is noted that the present technology is not limited to any specific algorithm or paradigm for calculating or determining tolerance threshold 2540, and that other algorithms and paradigms not discussed herein may be implemented.

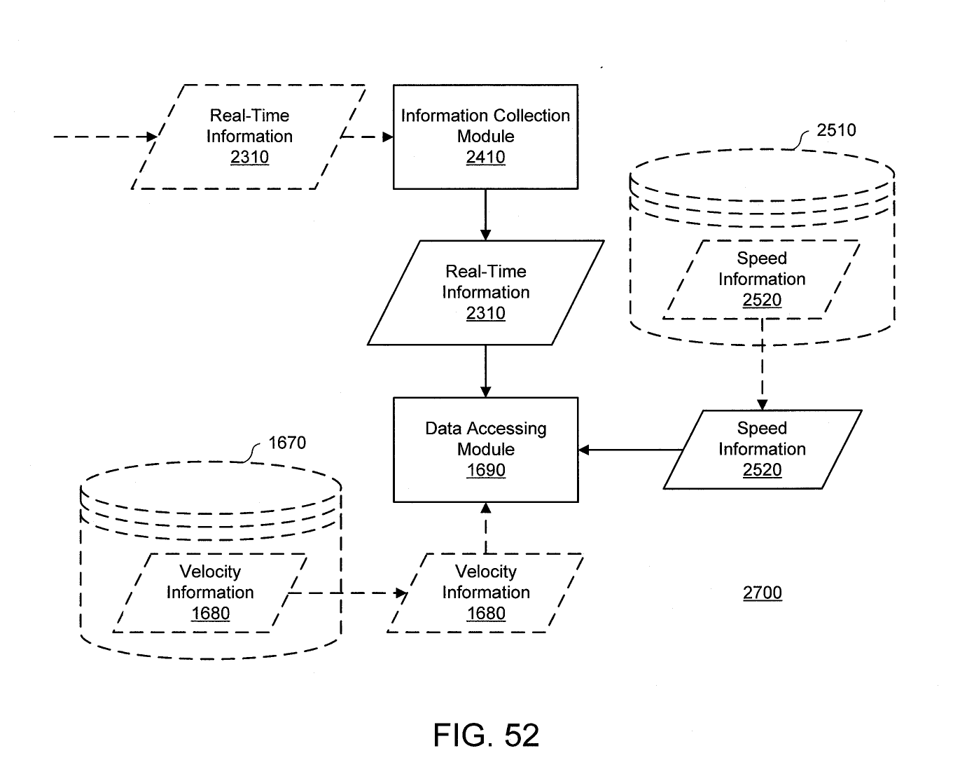

With reference now to FIG. 52, a second exemplary real-time information system 2700 in accordance with an embodiment is shown. Second exemplary real-time information system 2700 includes information collection module 2410, which is configured to collect real-time information 2310. Additionally, data accessing module 1690, which may be communicatively associated or coupled with information collection module 2410, is configured to access real-time information 2310. Data accessing module 1690 is also configured to access speed information 2520, such as from threshold database 2510, based on one or more parameters from group of parameters 2320.

To illustrate, consider the example where two different vehicular speed thresholds (or speed thresholds) are assigned to or associated with a school zone, such as where a lower vehicular speed threshold of 15 MPH is applicable in the school zone during school hours and a higher vehicular speed threshold of 25 MPH is applicable in the school zone at all other times. During a specific week, the school hours for this school zone last from 7:00 a.m. to 3:00 p.m. during the days of Monday through Friday. Consequently, current date 2330 could be accessed in real-time to determine if the day of the week is currently Saturday or Sunday; if so, the current vehicular speed threshold (or speed threshold 2620) would be 25 MPH. Moreover, a combination of both current date 2330 and current time 2340 could be accessed in real-time to determine if the current day of the week is between Monday and Friday and if the current time of day is between 7:00 a.m. and 3:00 p.m.; if so, the current vehicular speed threshold (or speed threshold 2620) would be 15 MPH. Furthermore, a combination of both current date 2330 and current time 2340 could be accessed in real-time to determine if the current time of day is before 7:00 a.m. or after 3:00 p.m. during one of the days between Monday and Friday; if so, the current vehicular speed threshold (or speed threshold 2620) would be 25 MPH. In view of the foregoing, an embodiment provides that a number of speed thresholds are stored, and that specific speed information (e.g., speed information 2520) reflecting the applicable speed threshold is accessed based on, for example, the current date and time information.

Furthermore, and with reference still to FIG. 52, data accessing module 1690 may also be configured to access velocity information 1680, such as from velocity database 1670. Indeed, it is noted that velocity information 1680 identifies velocity threshold 520, wherein velocity threshold 520 may reflect, for example, the sum of speed threshold 2620 and tolerance threshold 2540 (e.g., when speed threshold 2620 is an upper vehicular speed threshold) or the difference of speed threshold 2620 and tolerance threshold 2540 (e.g., when speed threshold 2620 is a lower vehicular speed threshold).

IX. Exemplary Response Systems

In an embodiment, a response may be automatically initiated when a motion event is detected. Consequently, a number of exemplary response systems and configurations will now be explored. However, the present technology is not limited to these exemplary systems and configurations. Indeed, other systems and configurations may be implemented.

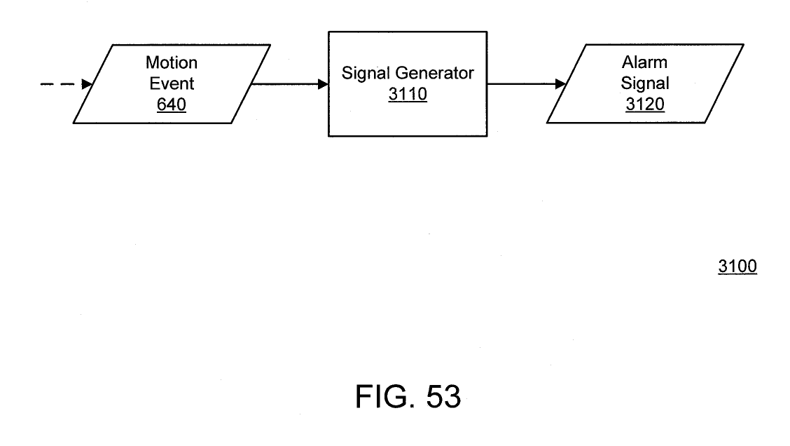

With reference now to FIG. 53, an exemplary response system 3100 in accordance with an embodiment is shown. Exemplary response system 3100 includes a signal generator 3110, which may be communicatively associated or coupled with detection module 630. Signal generator 3110 is configured to automatically generate an alarm signal 3120 in response to motion event 640 being detected. It is noted that alarm signal 3120 may include, or be implemented or associated with, for example, one or more electronic signals and/or sensory (e.g., audio, visual and heat sensory signals).

For example, once motion event 640 is detected, an audio sound may be emitted from an audio speaker system and/or a visual cue may be emitted from a light source. In this manner, a motion event detection system may be integrated with the anatomical or biological sensory system of a law enforcement officer such that the law enforcement officer may be alerted to the detection of motion event 640 through audio and/or visual cues.

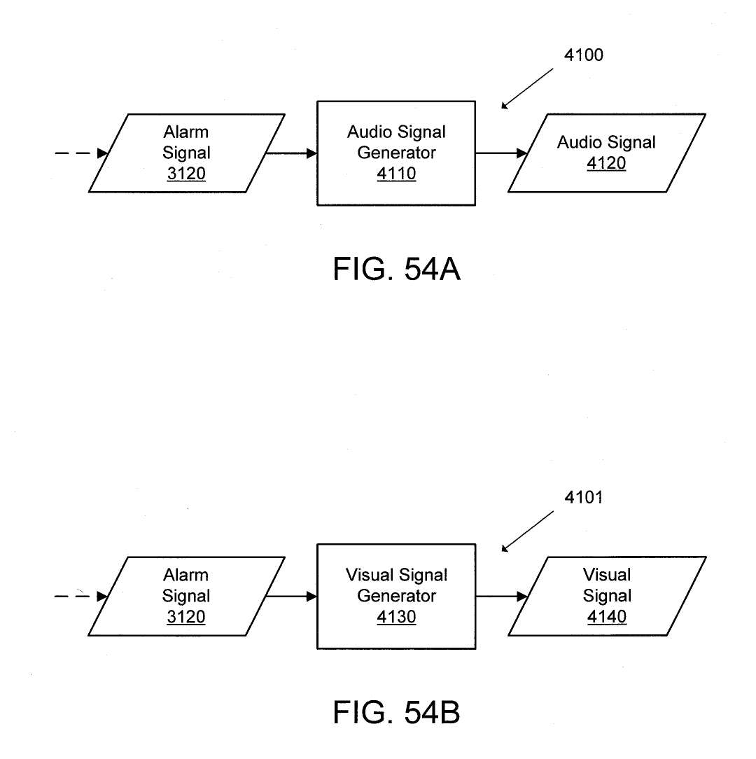

To further illustrate, and with reference now to FIG. 54A, a first exemplary alarm system 4100 in accordance with an embodiment is shown. First exemplary alarm system 4100 includes an audio signal generator 4110, which may be communicatively associated or coupled with signal generator 3110. Audio signal generator 4110 is configured to generate an audio signal 4120 in response to alarm signal 3120. In an embodiment, audio signal 4120 has a continuous, preselected amplitude and/or frequency. Pursuant to one embodiment, however, an amplitude and/or frequency of audio signal 4120 changes over time.

With reference now to FIG. 54B, a second exemplary alarm system 4101 in accordance with an embodiment is shown. Second exemplary alarm system 4101 includes a visual signal generator 4130, which may be communicatively associated or coupled with signal generator 3110. Visual signal generator 4130 is configured to generate a visual signal 4140 in response to alarm signal 3120. In an embodiment, visual signal 4140 has a continuous, preselected intensity and/or frequency. Pursuant to one embodiment, however, an intensity and/or frequency of visual signal 4140 changes over time.

X. Exemplary Velocity Threshold Selection Systems

As previously noted, an embodiment provides that a velocity threshold, such as a velocity threshold associated with predefined area 420, is accessed or identified. In one embodiment, such a velocity threshold is selected, such as based on one or more inputs. As such, a number of exemplary velocity threshold selection systems will now be explored. It is noted, however, that the present technology is not limited to these exemplary velocity threshold selection systems.

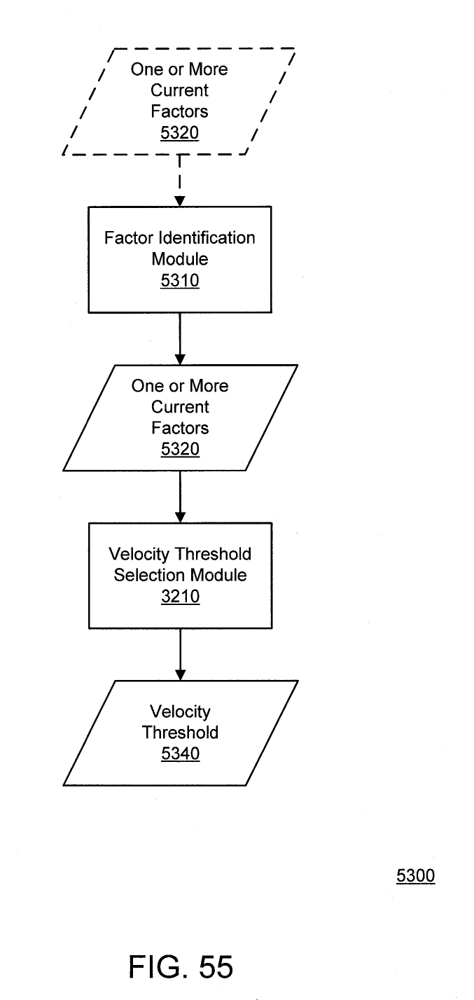

With reference now to FIG. 55, a first exemplary velocity threshold selection system 5300 in accordance with an embodiment is shown. First exemplary velocity threshold selection system 5300 includes a factor identification module 5310 configured to identify one or more current factors 5320 (e.g., date, time, traffic, road, weather and/or environmental information) associated with a predefined area, such as predefined area 420. First exemplary velocity threshold selection system 5300 also includes a velocity threshold selection module 3210, which may be communicatively associated or coupled with factor identification module 5310. Velocity threshold selection module 3210 is configured to select a velocity threshold 5340, such as updated velocity threshold 3220, based on one or more current factors 5320.

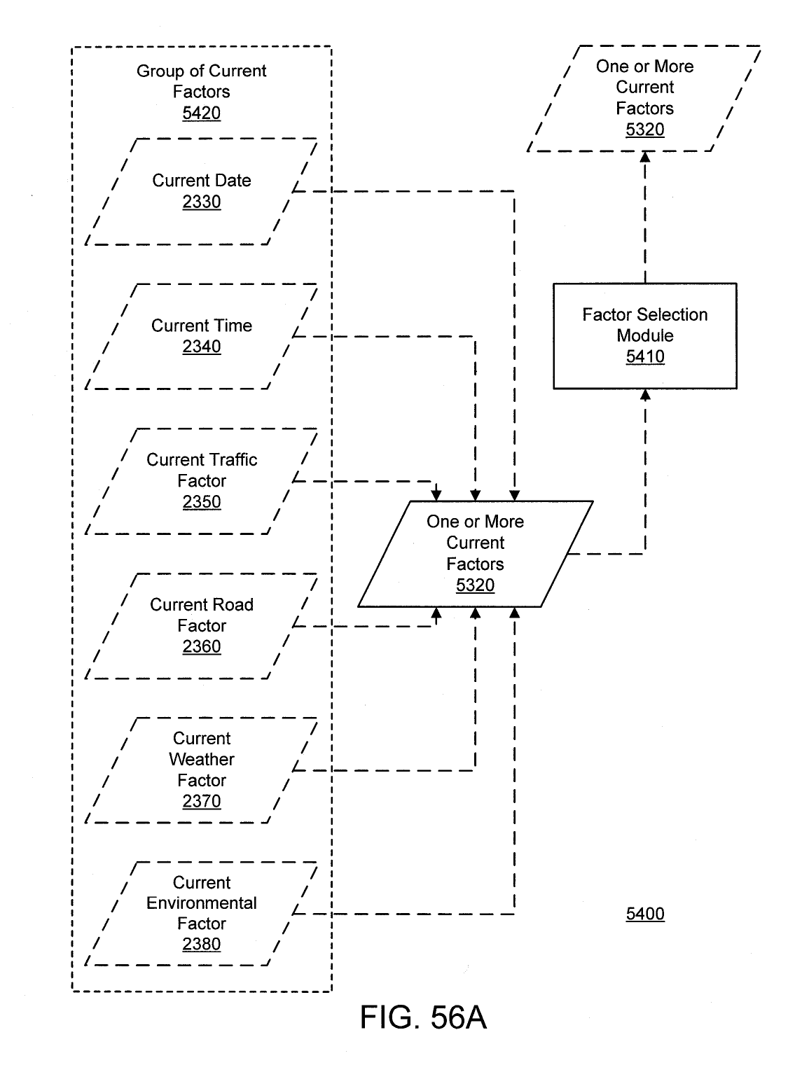

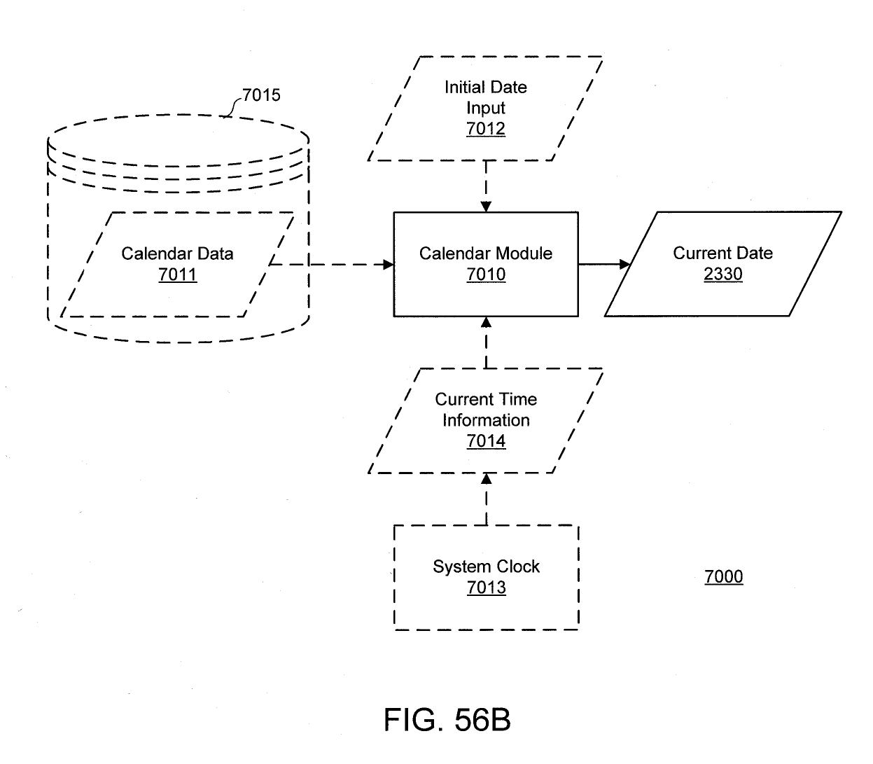

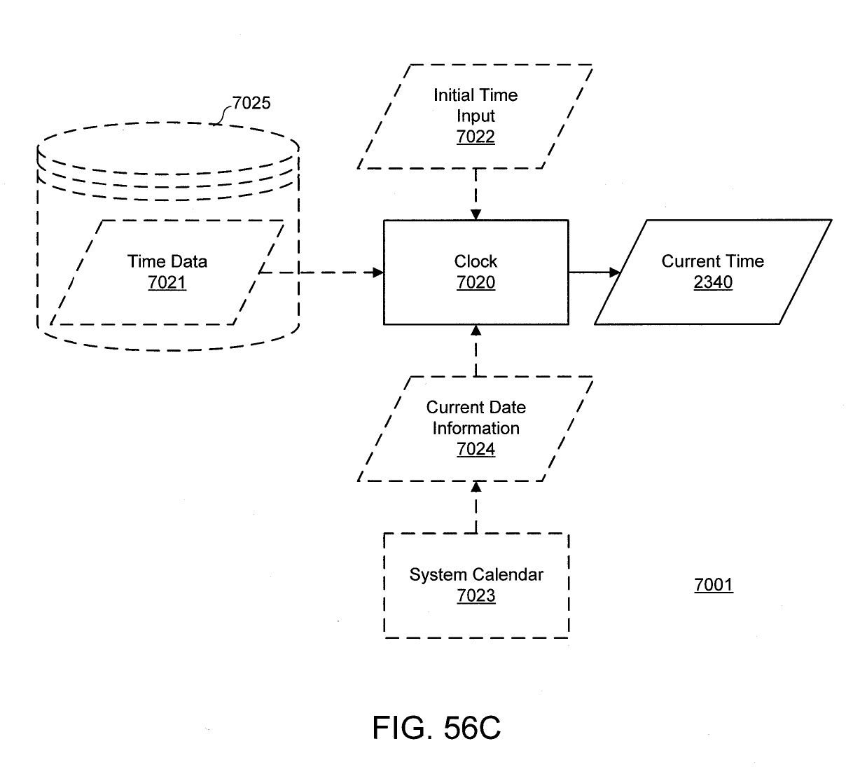

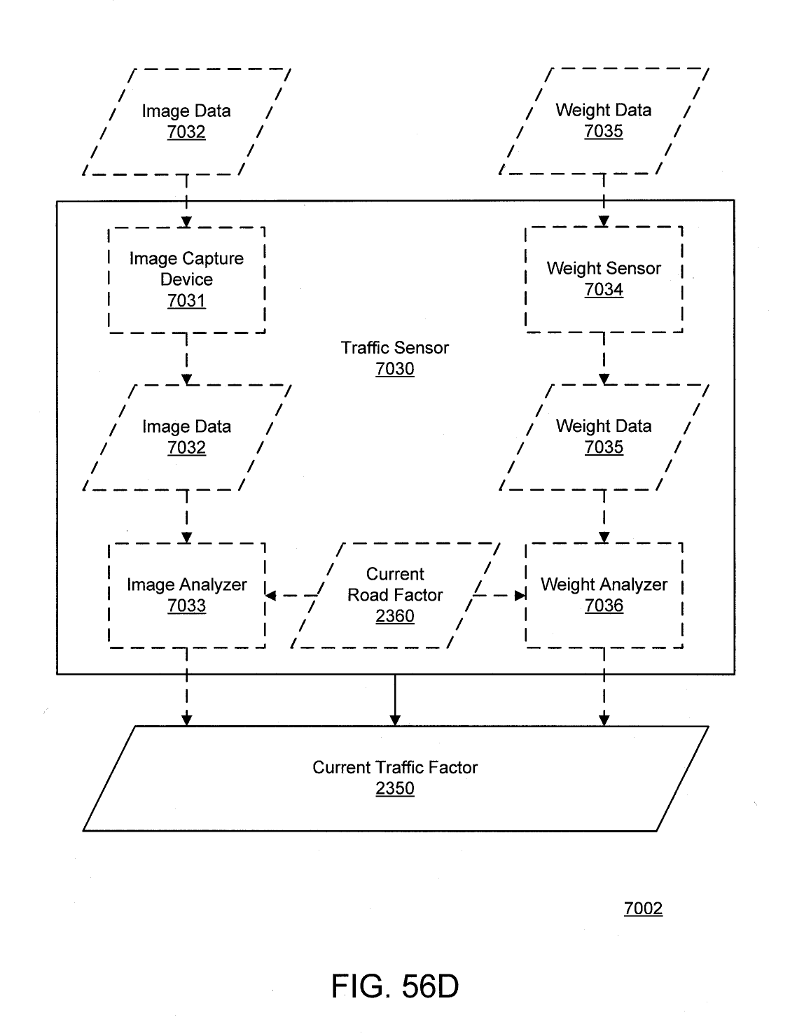

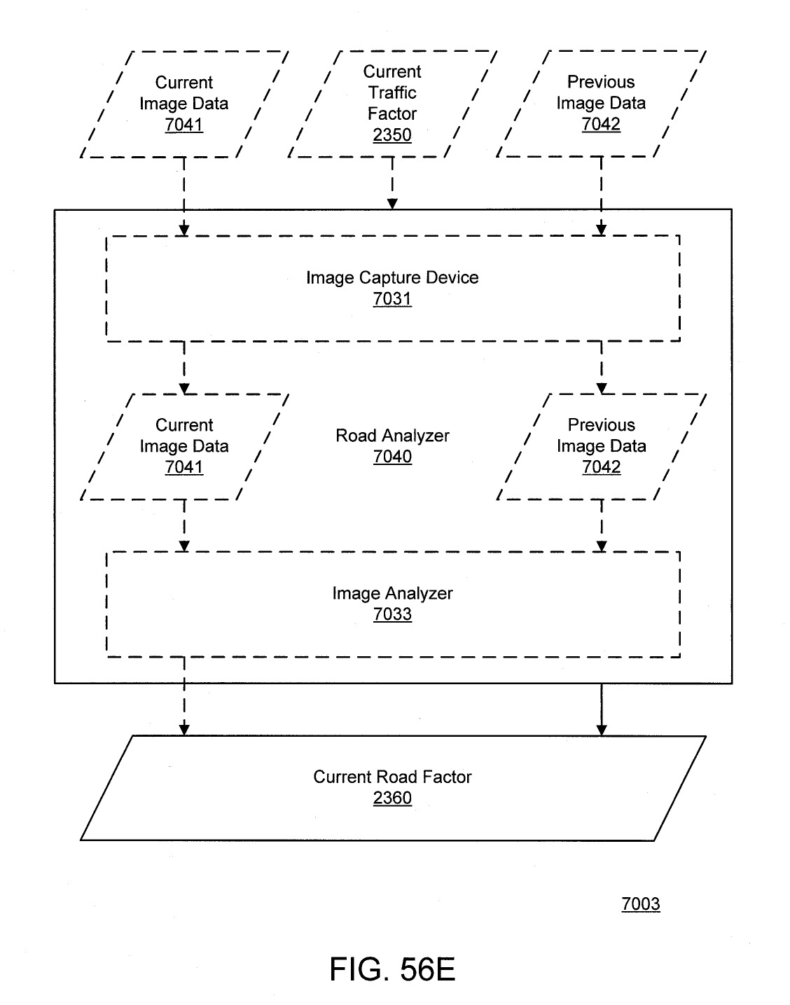

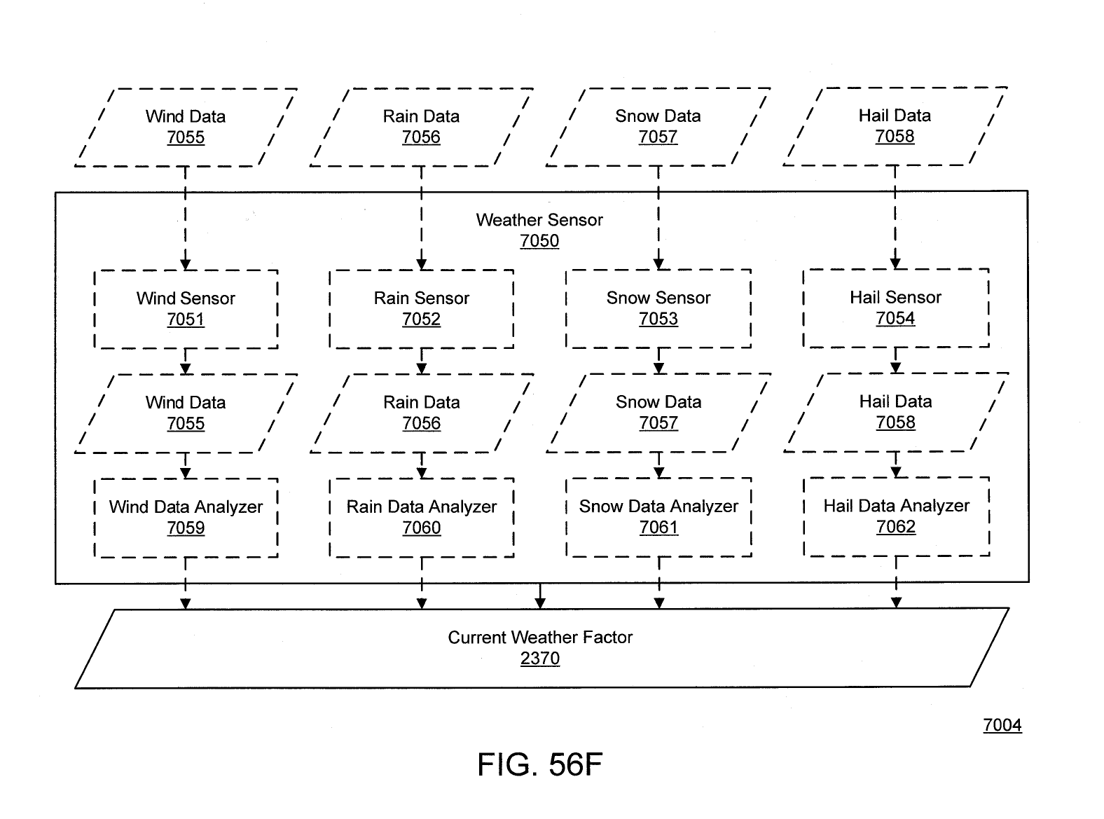

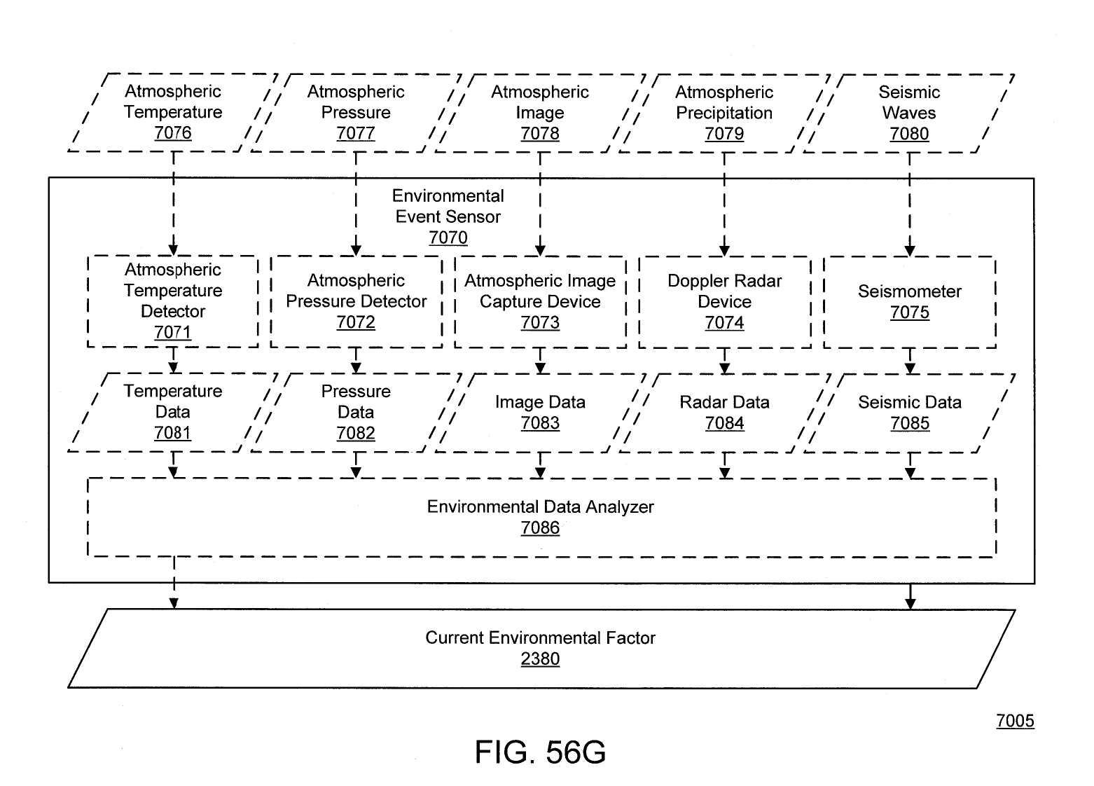

It is noted that velocity threshold 5340 may be selected based on a number of different factors, and that the present technology is not limited to the implementation of any particular factors. With reference now to FIG. 56A, an exemplary factor selection system 5400 in accordance with an embodiment is shown. Exemplary factor selection system 5400 includes a factor selection module 5410, which may be communicatively associated or coupled with factor identification module 5310. Factor selection module 5410 is configured to select one or more current factors 5320 from a group of current factors 5420, wherein one or more of these factors may be associated with, or define a current state of, predefined area 420. Group of current factors 5420 may include, for example, a number of the following exemplary factors: a current date 2330, current time 2340, current traffic factor 2350, current road factor 2360, current weather factor 2370 and current environmental factor 2380.

To illustrate, consider the example where two different upper vehicular speed thresholds are assigned or associated with a school zone, such as where a first upper vehicular speed threshold of 15 MPH is applicable in the school zone during school hours and a second upper vehicular speed threshold of 25 MPH is applicable in the school zone at all other times. During a specific week, the school hours for this school zone last from 7:00 a.m. (ante meridiem) to 3:00 p.m. (post meridiem) during the days of Monday through Friday. Consequently, current date 2330 could be accessed in real-time to determine if the day of the week is currently Saturday or Sunday; if so, a current vehicular speed threshold of 25 MPH would be selected. Moreover, a combination of both current date 2330 and current time 2340 could be accessed in real-time to determine if the current day of the week is between Monday and Friday and if the current time of day is between 7:00 a.m. and 3:00 p.m.; if so, a current vehicular speed threshold of 15 MPH would be selected. Furthermore, a combination of both current date 2330 and current time 2340 could be accessed in real-time to determine if the current time of day is before 7:00 a.m. or after 3:00 p.m. during one of the days between Monday and Friday; if so, a current vehicular speed threshold of 25 MPH would be selected.

In accordance with a second example, one or more current factors 5320 includes Current traffic factor 2350, which identifies a traffic jam or bottleneck on a heavily traveled highway. Velocity threshold selection module 3210 may be configured to automatically select velocity threshold 5340 (e.g., updated velocity threshold 3220), based on this current traffic factor 2350, to be a lower vehicular speed threshold than is usually assigned to this highway, and this lower vehicular speed threshold will be posted along the highway, such as with an electronic velocity threshold display unit that is capable of being updated in real-time to reflect velocity threshold 5340 (e.g., updated velocity threshold 3220). In this manner, the probability of a vehicular collision occurring on this highway as a result of the traffic jam or bottleneck will be lowered.

Similarly, a third example provides that one or more current factors 5320 includes current road factor 2360, which identifies an obstacle, such as a stalled vehicle or a torn up section of asphalt, on a heavily traveled highway. Velocity threshold selection module 3210 may be configured to automatically select velocity threshold 5340 (e.g., updated velocity threshold 3220), based on this current road factor 2360, to be a lower vehicular speed threshold than is usually assigned to this highway, and this lower vehicular speed threshold will be posted along the highway, such as with an electronic velocity threshold display unit that is capable of being updated in real-time to reflect velocity threshold 5340 (e.g., updated velocity threshold 3220). In this manner, the probability of a vehicular collision occurring on this highway as a result of the identified obstacle will be lowered.

In a fourth example, one or more current factors 5320 includes current weather factor 2370, which identifies (1) a degree of rain, snow or hail that is falling upon, or has accumulated upon, a heavily traveled highway within the predefined area and/or (2) a degree of relatively high winds to which the geographic vicinity of interest is currently being subjected. Velocity threshold selection module 3210 may be configured to automatically select velocity threshold 5340 (e.g., updated velocity threshold 3220), based on this current weather factor 2370, to be a lower vehicular speed threshold than is usually assigned to this highway, and this lower vehicular speed threshold will be posted along the highway, such as with an electronic velocity threshold display unit that is capable of being updated in real-time to reflect velocity threshold 5340 (e.g., updated velocity threshold 3220). In this manner, the probability of a vehicular collision occurring on this highway as a result of the identified weather factor will be lowered.

Similarly, a fifth example provides that one or more current factors 5320 includes current environmental factor 2380, which identifies an earthquake occurring in the vicinity of a heavily traveled highway. Velocity threshold selection module 3210 may be confirmed to automatically select velocity threshold 5340 (e.g., updated velocity threshold 3220), based on this current environmental factor 2380, to be a lower vehicular speed threshold than is usually assigned to this highway, and this lower vehicular speed threshold will be posted along the highway, such as with an electronic velocity threshold display unit that is capable of being updated in real-time to reflect velocity threshold 5340 (e.g., updated velocity threshold 3220). In this manner, the probability of a vehicular collision occurring on this highway as a result of the identified earthquake will be lowered.

Thus, it is noted that group of current factors 5420 may include, for example, a number of the following exemplary factors: current date 2330, current time 2340, current traffic factor 2350, current road factor 2360, current weather factor 2370 and current environmental factor 2380. It is further noted, however, that these factors are exemplary in nature, and that the present technology is not limited to these exemplary factors. Indeed, group of current factors 5420 may include one, all or some of these exemplary factors and/or a number of other factors not mentioned herein.

The foregoing notwithstanding, it is noted that a number of systems for determining such factors may be implemented, and that the present technology is not limited to any particular factor determination system. However, for purposes of illustration, a number of exemplary factor determination systems will now be explored, wherein these exemplary factor determination systems may be referred to, for example, as information generation systems.

With reference now to FIG. 56B, an exemplary date information generation system 7000 in accordance with an embodiment is shown. Exemplary date information generation system 7000 includes a calendar module 7010, which may be communicatively coupled or associated with factor selection module 5410, a system clock 7013 and/or a calendar database 7015. Calendar module 7010 is configured to identify or select current date 2330. To illustrate, calendar module 7010 may be configured to access calendar data 7011, such as from Calendar database 7015, as well as an initial date input 7012, wherein calendar data 7011 specifies, for example, each of the possible dates (e.g., for one or more calendar years), and wherein initial date input 7012 identities an initial starting date from among these possible dates. Calendar module 7010 subsequently constructs a timeline or calendar based on calendar data 7011 and tracks current date 2330 within this timeline or calendar (beginning with the initial starting date). In particular, calendar module 7010 may be integrated with system clock 7013, which is configured to provide current time information 7014 (e.g., current time 2340) to calendar module 7010 such that calendar module 7010 is able to constantly track current date 2330.

With reference now to FIG. 56C, an exemplary time information generation system 7001 in accordance with an embodiment is shown. Exemplary time information generation system 7001 includes a clock 7020, such as system clock 7013, which may be communicatively coupled or associated with factor selection module 5410, a time database 7025 and/or a system calendar 7023 (e.g., calendar module 7010). Clock 7020 is configured to identify or select current time 2340. For example, clock 7020 may be configured to access time data 7021, such as from time database 7025, as well as an initial time input 7022, wherein time data 7021 specifies, for example, the length of each day (or the possible times of each day) within a specific period of time, and wherein initial time input 7022 identifies an initial starting time from among these possible times. To illustrate, a particular day of a specific year may have a duration of approximately 24 hours, whereas a different day of the same year may have a duration of approximately 23 or 25 hours (such as to account for daylight savings time). Clock 7020 tracks current time 2340, beginning with the initial starting time. In particular, clock 7020 may be integrated with system calendar 7023 (e.g., calendar module 7010), which is configured to provide current date information 7024 (e.g., current date 2330) to clock 7020 such that clock 7020 is able to constantly track current time 2340. Indeed, it is noted that exemplary date information generation system 7000 and exemplary time information generation system 7001 may be integrated together such that current date 2330 and current time 2340 may be tracked over time.

With reference now to FIG. 56D, an exemplary traffic information generation system 7002 in accordance with an embodiment is shown. Exemplary traffic information generation system 7002 includes a traffic sensor 7030, which may be communicatively coupled or associated with factor selection module 5410. Traffic sensor 7030 is configured to identify or select current traffic factor 2350. For example, traffic sensor 7030 may include or be integrated with an image capture device 7031 configured to capture image data 7032 associated with a heavily traveled highway and provide this image data 7032 to an image analyzer 7033, which may be communicatively coupled or associated with image capture device 7031. Image analyzer 7033 then analyzes image data 7032 so as to determine a current degree of traffic associated with the highway based on this image data 7032. Finally, image analyzer 7033 identifies or selects current traffic factor 2350 based on this current degree of traffic.

To illustrate, consider the example where image data 7032 reflects that four automobiles are traveling along a selected section of the highway at a specific point in time. Image analyzer 7033 is configured to count these automobiles, such as by utilizing image recognition software configured to distinguish such automobiles from an image background. Image analyzer 7033 is also configured to estimate the velocity of these automobiles based on the number of counted automobiles, the length of the selected section of highway, the number of traffic lanes available to these automobiles within this selected section of highway and/or current road factor 2360, wherein current road factor 2360 may reflect, for example, an obstacle that is currently obstructing traffic in one of more of the traffic lanes. Image analyzer 7033 is further configured to select current traffic factor 2350 based on this estimated velocity.

In a second example, traffic sensor 7030 may include or be integrated with a weight sensor 7034 configured to capture weight data 7035 associated with a heavily traveled highway and provide this weight data 7035 to a weight analyzer 7036, which may be communicatively coupled or associated with weight sensor 7034. Weight analyzer 7036 then analyzes weight data 7035 so as to determine a current degree of traffic associated with the highway based on this weight data 7035. Finally, weight analyzer 7036 identifies or selects current traffic factor 2350 based on this current degree of traffic.

To illustrate, consider the example where weight data 7035 reflects that four automobiles are traveling along a selected section of the highway within a specific period of particular, weight sensor 7034 is positioned across the highway such that the front and back wheels of each of these four automobiles come into contact with weight sensor 7034. Each time that this occurs, weight data 7035 is updated to reflect that an additional automobile is present within the specific period of time. Weight analyzer 7036 is configured to count these automobiles based on weight data 7035. Weight analyzer 7036 is also configured to estimate the velocity of these automobiles based on the number of counted automobiles, the length of the selected section of highway, the number of traffic lanes available to these automobiles within this selected section of highway and/or current road factor 2360, wherein current road factor 2360 may reflect, for example, an obstacle that is currently obstructing traffic in one of more of the traffic lanes. Weight analyzer 7036 is further configured to select current traffic factor 2350 based on this estimated velocity. Moreover, it is noted that traffic sensor 7030 may be configured to select current traffic factor 2350 based on outputs of both image and weight analyzers 7033, 7036 such that an accuracy of current traffic factor 2350 may be increased.

With reference now to FIG. 56E, an exemplary road information generation system 7003 in accordance with an embodiment is shown. Exemplary road information generation system 7003 includes a road analyzer 7040, which may be communicatively coupled or associated with factor selection module 5410. Road analyzer 7040 is configured to identify or Select current road factor 2360. For example, road analyzer 7040 may include or be integrated with an image capture device 7031 configured to capture current and previous image data 7041, 7042 associated with a heavily traveled highway and provide this captured image data to an image analyzer 7033, which may be communicatively coupled or associated with image capture device 7031. Image analyzer 7033 then compares current image data 7041 to previous image data 7042 so as to determine if an obstacle currently exists along the highway. Finally, image analyzer 7033 identifies or selects current road factor 2360 based on whether such an obstacle has been detected.

To further illustrate, consider the example where black asphalt has been laid upon a predefined path that constitutes a highway. This black asphalt causes the highway, from a bird's eye view, to have or be defined by a black background. As such, image capture device 7031 will capture a first image (e.g., previous image data 7042) at a first point in time, wherein this first image includes a black background as well as a number of distinguishable features (e.g., white or yellow lines (e.g., solid or dashed lines) that define the edges of the various traffic lanes. Additionally, at a second point in time, image capture device 7031 will capture a second image (e.g., current image data), and this second image will be compared (e.g., with object recognition Software) to the first image in order to determine whether an obstacle is now present, such as where such an obstacle is distinguishable from both the black background and the aforementioned distinguishable features within the second image.

The foregoing notwithstanding, in an embodiment, road analyzer 7040 includes or is integrated with image capture device 7031, wherein image capture device 7031 is configured to capture current image data 7041 and provide current image data 7041 to image analyzer 7033. Image analyzer 7033 is configured to analyze current image data 7041, such as by utilizing object recognition software, to thereby determine if an obstacle currently exists along the highway, such as where such an obstacle is distinguishable from both the black background and the shapes of the white or yellow lines that define the edges of the various traffic lanes. Finally, image analyzer 7033 identifies or selects current road factor 2360 based on whether such an obstacle has been detected.

Moreover, it is noted that the aforementioned images may be captured by image capture device 7031, and the foregoing image analysis executed, on a periodic basis (e.g., every 30 to 60 seconds) such that current road factor 2360 may be periodically updated over time. Pursuant to one embodiment, however, current image data 7041 is captured, and the foregoing image analysis is executed, in response to an update request.

With reference still to FIG. 56E, in an embodiment, road analyzer 7040 is configured to select current road factor 2360 based on an output of image analyzer 7033 as well as current traffic factor 2350. For example, current traffic factor 2350 may reflect that the highway is currently experiencing a relatively high degree of traffic, such as when a traffic jam or bottleneck occurs. This relatively high degree of traffic indicates that an obstacle is present along the highway, in which case current road factor 2360 is selected to reflect this indicated obstacle. Thus, it is noted that exemplary traffic information generation system 7002 and exemplary road information generation system 7003 may be integrated together such that an accuracy of current traffic and road factors 2350, 2360 may be increased.

With reference now to FIG. 56F, an exemplary weather information generation system 7004 in accordance with an embodiment is shown. Exemplary weather information generation system 7004 includes a weather sensor 7050, which may be communicatively coupled or associated with factor selection module 5410. Weather sensor 7050 is configured to identify or select current weather factor 2370. To illustrate, weather sensor 7050 may include or be integrated with one or more specific sensors each configured to capture specific weather data. Weather sensor 7050 may also include or be integrated with one or more data analyzers. In particular, the captured weather data is provided to the one or more data analyzers, which may be communicatively coupled or associated with the one or more data sensors, respectively. The one or more data analyzers are configured to conduct an analysis of this captured weather data and select current weather factor 2370 based on this analysis.

To illustrate, weather sensor 7050 may include or be integrated with, for example, wind, rain, snow and hail sensors 7051-7054, wherein wind, rain, snow and hail sensors 7051-7054 are configured to capture wind, rain, snow and hail data 7055-7058, respectively, and wherein the captured wind, rain, snow and hail data 7055-7058 is associated with a specific geographic area in which a heavily traveled highway is located. Weather sensor 7050 may also include or be integrated with a wind data analyzer 7059, a rain data analyzer 7060, a snow data analyzer 7061 and a hail data analyzer 7062, which may be communicatively coupled or associated with wind, rain, snow and hail sensors 7051-7054, respectively. Wind, rain, snow and hail sensors 7051-7054 are configured to provide wind, rain, snow and hail data 7055-7058, respectively, to wind data analyzer 7059, rain data analyzer 7060, snow data analyzer 7061 and hail data analyzer 7062, respectively. Moreover, wind data analyzer 7059, rain data analyzer 7060, snow data analyzer 7061 and hail data analyzer 7062 are configured to conduct analyses of wind, rain, snow and hail data 7055-7058, respectively, so as to determine the degree of wind, rain, snow and hail that is currently present in the geographic area of interest. Finally, weather sensor 7050 identifies or selects current weather factor 2370 based on the results of these weather analyses.

With reference now to FIG. 56G, an exemplary environmental information generation system 7005 in accordance with an embodiment is shown. Exemplary environmental information generation system 7005 includes an environmental event sensor 7070, which may be communicatively coupled or associated with factor selection module 5410. Environmental event sensor 7070 is configured to identify or select current environmental factor 2380. To illustrate, environmental event sensor 7070 may include or be integrated with one or more specific sensors which are configured to capture specific environmental data), such as, for example, an atmospheric temperature detector 7071, an atmospheric pressure detector 7072, an atmospheric image capture device 7073, a Doppler radar device 7074 and a seismometer 7075. Atmospheric temperature detector 7071 is configured to detect an atmospheric temperature 7076 and generate temperature data 7081 that reflects atmospheric temperature 7076. Atmospheric pressure detector 7072 is configured to detect an atmospheric pressure 7077 and generate pressure data 7082 that reflects atmospheric pressure 7077. Atmospheric image capture device 7073 is configured to capture an atmospheric image 7078 and generate image data 7083 that reflects atmospheric image 7078. Doppler radar device 7074 is configured to detect atmospheric precipitation 7079 and generate precipitation data 7084 that reflects atmospheric precipitation 7079. Seismometer 7075 is configured to detect seismic waves 7080 and generate seismic data 7085 that reflects seismic waves 7080.

The foregoing one or more sensors are configured to provide this captured data (e.g., temperature, pressure, image, precipitation and seismic data 7081-7085) to an environmental data analyzer 7086, which may be communicatively coupled or associated with atmospheric temperature detector 7071, atmospheric pressure detector 7072, atmospheric image capture device 7073, Doppler radar device 7074 and seismometer 7075. Environmental data analyzer 7086 is configured to conduct analyses of this captured data so as to determine whether an environmental event of interest (e.g., an earthquake, tornado or hurricane) is currently, or will soon be, taking place in a geographic area of interest. Finally, environmental event sensor 7070 identifies or selects current environmental factor 2380 based on the results of these environmental event analyses.

Thus, and with reference again to FIG. 55, it is noted that factor identification module 5310 is configured to identify one or more current factors 5320, and that velocity threshold selection module 3210 is configured to select velocity threshold 5340 (e.g., updated velocity threshold 3220) based on one or more current factors 5320. In one embodiment, this velocity threshold 5340 is routed (1) to an electronic velocity threshold display unit that is capable of displaying velocity threshold 5340 (e.g., such that the operators of vehicles along a heavily traveled highway are able to view velocity threshold 5340) and/or (2) to a velocity database that is capable of storing velocity threshold 5340 (e.g., such that velocity threshold 5340 may be subsequently accessed).

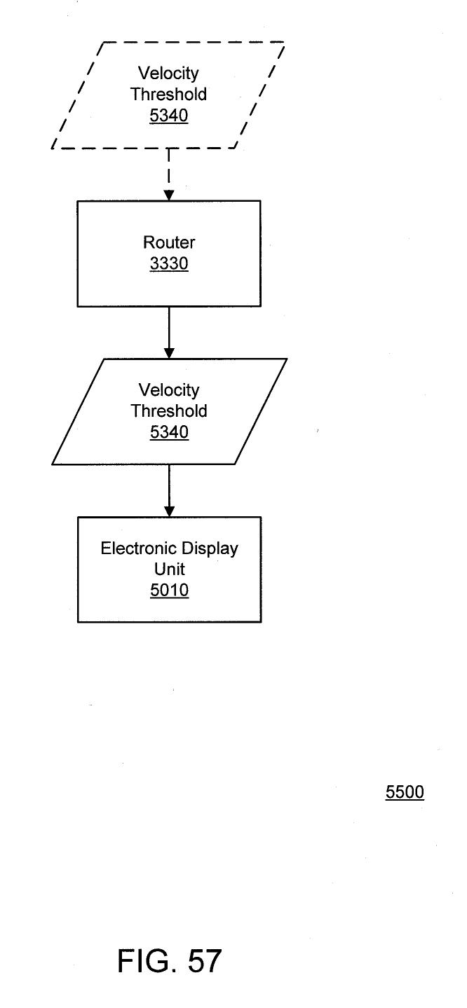

To illustrate, and with reference now to FIG. 57, an exemplary velocity threshold display system 5500 in accordance with an embodiment is shown. Exemplary velocity threshold display system 5500 includes an electronic display unit 5010 configured to receive electronic information and generate a visual display based on the electronic information. Exemplary velocity threshold display system 5500 also includes a router 3330, which may be communicatively associated or coupled with velocity threshold selection module 3210 and electronic display unit 5010. Router 3330 is configured to route (e.g., using wireless and/or wired communication technologies) velocity threshold 5340 to electronic display unit 5010 such that velocity threshold 5340 is displayed (e.g., in real-time) by electronic display unit 5010.

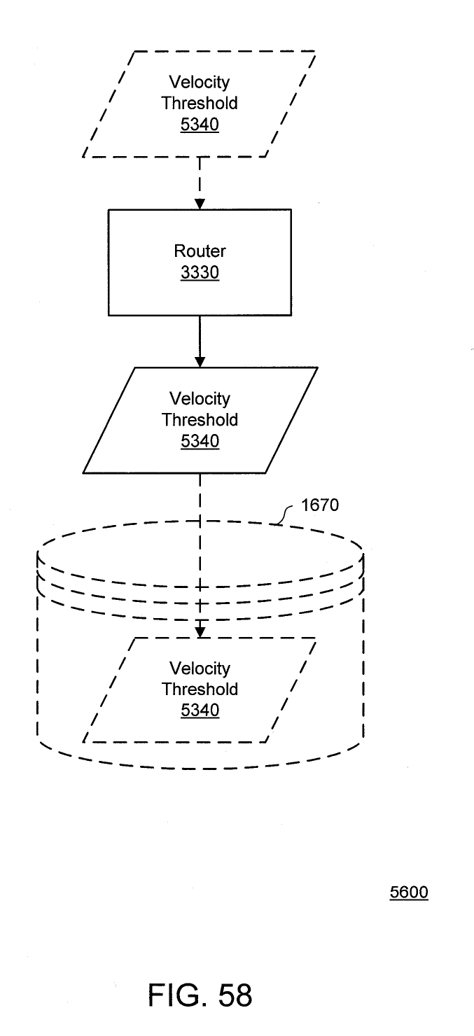

With reference now to FIG. 58, an exemplary velocity threshold updating system 5600 in accordance with an embodiment is shown. Exemplary velocity threshold updating system 5600 includes router 3330, which may be communicatively associated or coupled with velocity threshold selection module 3210. Router 3330 is configured to route velocity threshold 5340 to a velocity database 1670 that stores a preselected velocity threshold such that velocity database 1670 stores velocity threshold 5340, and such that the preselected velocity threshold is thereby updated to reflect velocity threshold 5340.

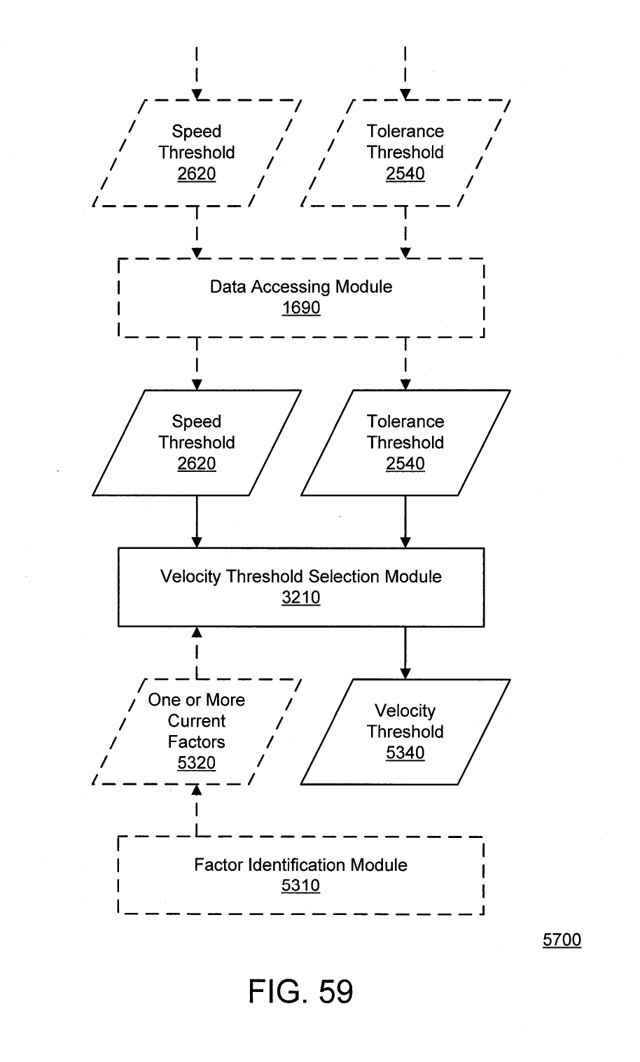

With reference now to FIG. 59, a second exemplary velocity threshold selection system 5700 in accordance with an embodiment is shown. Second exemplary velocity threshold selection system 5700 optionally includes a data accessing module 1690 configured to access a speed threshold 2620 and a tolerance threshold 2540, wherein speed threshold 2620 and/or tolerance threshold 2540 may be associated with a predefined area, such as predefined area 420. Second exemplary velocity threshold selection system 5700 also includes velocity threshold selection module 3210, which may be communicatively associated or coupled with data accessing module 1690. Velocity threshold selection module 3210 is configured to select velocity threshold 5340, such as updated velocity threshold 3220, based on speed threshold 2620 and tolerance threshold 2540.

Additionally, and with reference again to FIG. 51, an embodiment provides that second exemplary velocity threshold selection system 5700 further includes a tolerance threshold calculator 2610, which may be communicatively associated or coupled with data accessing module 1690. Tolerance threshold calculator 2610 is configured to calculate tolerance threshold 2540 based on speed threshold 2620. To illustrate, consider the example where a numerical input of 0.1 (or 10%) is selected. If the speed threshold assigned to or associated with predefined area 420 is 50 MPH, then 10% of this speed threshold is calculated to be 5 MPH, and tolerance threshold 2540 is consequently defined as 5 MPH. Similarly, if the speed threshold assigned to or associated with predefined area 420 is 65 MPH, then 10% of this speed threshold is calculated to be 6.5 MPH, and tolerance threshold 2540 is consequently defined as 6.5 MPH. In this manner, tolerance threshold 2540 is a function of speed threshold 2620. Indeed, in one embodiment, tolerance threshold 2540 is automatically recalculated or changed in response to a change in speed threshold 2620. The foregoing notwithstanding, it is noted that the present technology is not limited to any specific algorithm or paradigm for calculating or determining tolerance threshold 2540, and that other algorithms and paradigms not discussed herein may be implemented.

With reference still to FIG. 59, one embodiment provides that velocity threshold selection module 3210 is configured to add tolerance threshold 2540 to speed threshold 2620 to thereby obtain velocity threshold 5340. To illustrate, consider the example where law enforcement officers have been instructed to not issue a traffic citation to a driver that is merely traveling at a rate of speed of 5 MPH over the applicable vehicular speed threshold of 65 MPH on a particular highway. As such, tolerance threshold 2540 is defined to be 5 MPH, and this tolerance threshold 2540 is added to the aforementioned speed threshold such that velocity threshold 5340 is calculated to be 70 MPH. Consequently, if the velocity of a vehicle traveling within the predefined area exceeds this velocity threshold of 70 MPH, wherein this velocity threshold reflects the 5 MPH buffer above the 65 MPH vehicular speed threshold, then a motion event is identified, and a law enforcement officer may accordingly choose to issue a traffic citation to the driver of this vehicle. The foregoing notwithstanding, in an embodiment, velocity threshold selection module 3210 is configured to subtract tolerance threshold 2540 from speed threshold 2620 to thereby obtain velocity threshold 5340. It is noted, however, that various algorithms for calculating or selecting velocity threshold 5340 may be implemented, and that the present technology is not limited to any specific algorithm.

With reference still to FIG. 59, an embodiment provides that second exemplary velocity threshold selection system 5700 optionally includes factor identification module 5310, which is configured to identify one or more current factors 5320 associated with predefined area 420, wherein velocity threshold selection module 3210 may be communicatively associated or coupled with factor identification module 5310. Velocity threshold selection module 3210 is configured to select velocity threshold 5340 based on one or more current factors 5320. Furthermore, and with reference again to FIG. 56A, one embodiment provides that second exemplary velocity threshold selection system 5700 further includes factor selection module 5410, which may be communicatively associated or coupled with factor identification module 5310. Factor selection module 5410 is configured to select one or more current factors 5320 from group of current factors 5420, which may include, for example, one or more of current date 2330, current time 2340, current traffic factor 2350, current road factor 2360, current weather factor 2370 and current environmental factor 2380.

With reference still to FIG. 59, and with reference again to FIG. 57, an embodiment provides that second exemplary velocity threshold selection system 5700 includes electronic display unit 5010, which is configured to receive electronic information and generate a visual display based on the electronic information. Second exemplary velocity threshold selection system 5700 also includes router 3330, which may be communicatively associated or coupled with velocity threshold selection module 3210 and electronic display unit 5010. Router 3330 is configured to route velocity threshold 5340 to electronic display unit 5010 such that velocity threshold 5340 is displayed by electronic display unit 5010.

With reference still to FIG. 59, and with reference again to FIG. 58, an embodiment provides that second exemplary velocity threshold selection system 5700 includes router 3330, which may be communicatively associated or coupled with velocity threshold selection module 3210. Router 3330 is configured to route velocity threshold 5340 to a velocity database 1670 that stores a preselected velocity threshold such that velocity database 1670 stores velocity threshold 5340, and such that the preselected velocity threshold is thereby updated to reflect velocity threshold 5340.

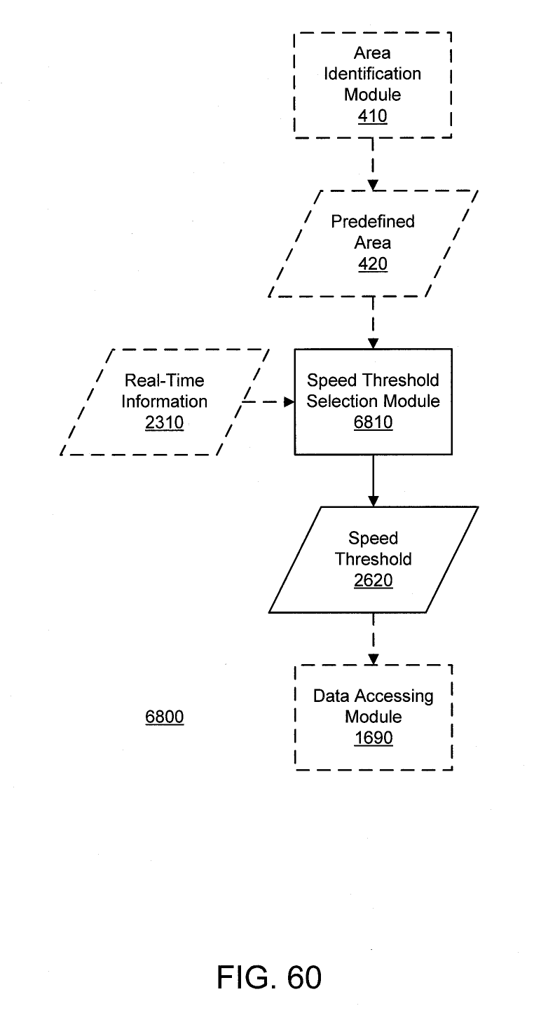

With reference now to FIG. 60, an exemplary speed threshold selection system 6800 in accordance with an embodiment is shown. Exemplary speed threshold selection system 6800 optionally includes area identification module 410, which is configured to identify predefined area 420. Exemplary speed threshold selection system 6800 also includes a speed threshold selection module 6810, which may be communicatively associated or coupled with area identification module 410 and data accessing module 1690. Speed threshold selection module 6810 is configured to select speed threshold 2620 based on predefined area 420.

To illustrate, consider the example where data defining speed threshold 2620 is stored within a database of different speed thresholds, but wherein this speed threshold 2620 (in contrast to the other stored speed thresholds) is associated with predefined area 420, such as Where information defining predefined area 420 includes an electronic link to (or information identifying) the stored data that defines speed threshold 2620. Once predefined area 420 is identified, such that the information defining predefined area 420 may be accessed, the stored data that defines speed threshold 2620 may be accessed from the aforementioned database such that speed threshold 2620 has been selected from among a number of possible speed thresholds stored in the database.

In one embodiment, speed threshold selection module 6810 is configured to access real-time information 2310. It is noted that real-time information 2310 may identify one or more parameters selected from a group of parameters 2320 that includes, for example, a current date 2330, current time 2340, current traffic factor 2350, current road factor 2360, current weather factor 2370 and current environmental factor 2380. It is further noted that one or more of these parameters may be associated with, or define a current state of, predefined area 420. Moreover, speed threshold selection module 6810 is further configured to select speed threshold 2620 based on one or more of these parameters, such as where one or more of these parameters are associated with, or describe a current state of, predefined area 420. In this manner, speed threshold 2620 may be selected or defined based on real-time information that indicates a safe velocity with which an object may currently travel within predefined area 420.

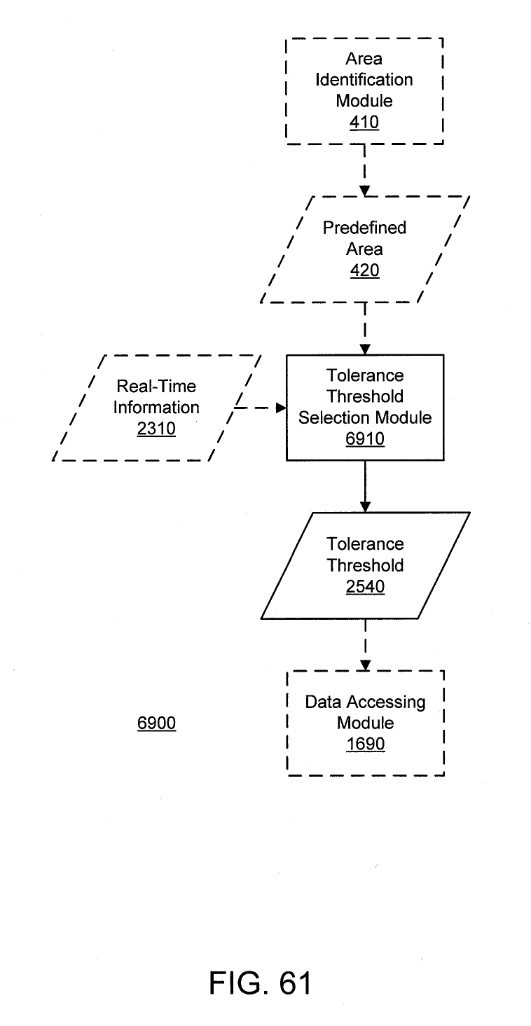

With reference now to FIG. 61, an exemplary tolerance threshold selection system 6900 in accordance with an embodiment is shown. Exemplary tolerance threshold selection system 6900 optionally includes area identification module 410, which is configured to identify predefined area 420. Exemplary tolerance threshold selection system 6900 also includes a tolerance threshold selection module 6910, which may be communicatively associated or coupled with area identification module 410 and data accessing module 1690. Tolerance threshold selection module 6910 is configured to select tolerance threshold 2540 based on predefined area 420.

To illustrate, consider the example where law enforcement officers in a first geographical jurisdiction have been instructed to not issue a traffic citation to a driver that is merely traveling at a rate of speed of 5 MPH over the applicable vehicular speed threshold on a particular highway within the first geographical jurisdiction, and where law enforcement officers in a second geographical jurisdiction have been instructed to not issue a traffic citation to a driver that is merely traveling at a rate of speed of 10 MPH over the applicable vehicular speed threshold on a particular highway (e.g., the same or a different highway) within the second geographical jurisdiction. Once predefined area 420 has been identified, such that it has been determined in which of the two geographical jurisdictions an object of interest is traveling, the corresponding tolerance threshold 2540 (e.g., 5 or 10 MPH) may be selected from among a number of possible tolerance thresholds (which may be stored in a database) based on predefined area 420.

In one embodiment, tolerance threshold selection module 6910 is configured to access real-time information 2310. It is noted that real-time information 2310 may identify one more parameters selected from a group of parameters 2320 that includes, for example, current date 2330, current time 2340, current traffic factor 2350, current road factor 2360, current weather factor 2370 and current environmental factor 2380. It is further noted that one or more of these parameters may be associated with, or define a current state of, predefined area 420. Moreover, tolerance threshold selection module 6910 is further configured to select tolerance threshold 2540 based on one or more of these parameters, such as where one or more of these parameters are associated with, or describe a current state of, predefined area 420. In this manner, tolerance threshold 2540 may be selected or defined based on real-time information that indicates a safe velocity with which an object may currently travel within predefined area 420.

In view of the foregoing, it is noted that first and second exemplary velocity threshold selection systems 5300, 5700 have been described herein. In an embodiment, one or more portions of these systems are combined with one another. Moreover, one embodiment provides that first and second exemplary velocity threshold selection systems 5300, 5700, or one or more portions thereof, may be combined with one or more other systems described herein, or one or more portions thereof.

XI. Exemplary Communication Arrangements

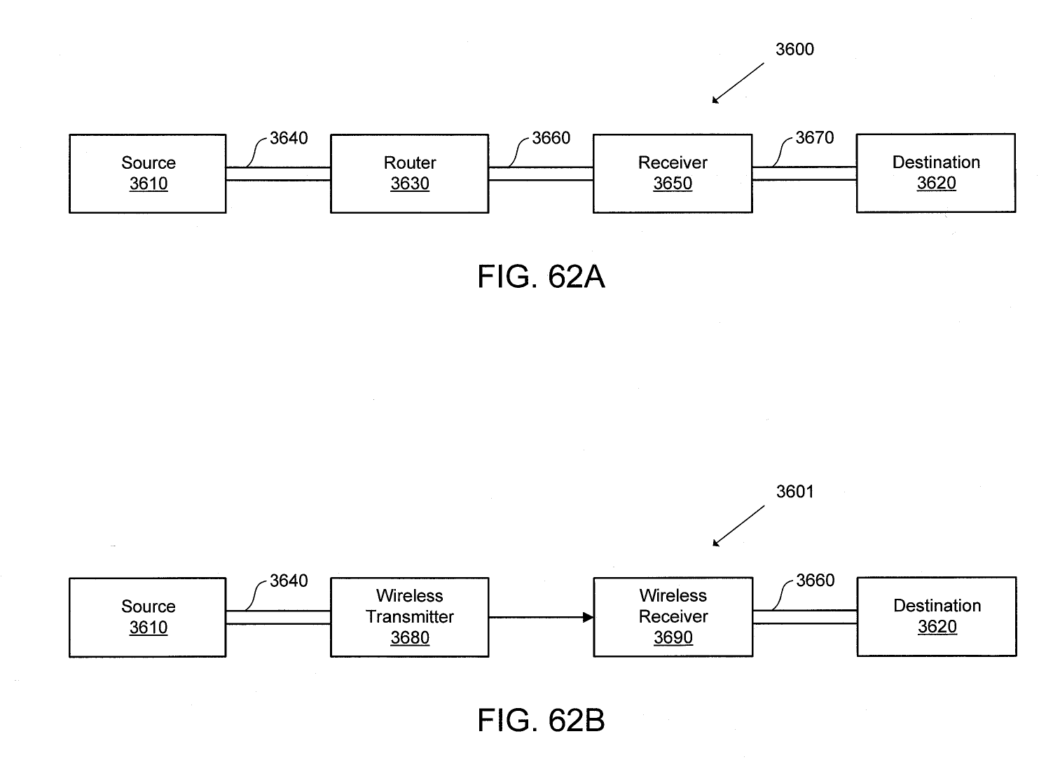

With reference now to FIG. 62A, a first exemplary communication arrangement 3600 in accordance with an embodiment is shown, wherein a signal is to be routed from a source 3610 to a destination 3620. First, the information is routed from source 3610 to a router 3630 through a first transmission line 3640. Subsequently, this information is routed from router 3630 to a receiver 3650 through a second transmission line 3660. Finally, the information is routed from receiver 3650 to destination 3620 through a third transmission line 3670. It is noted that these transmission lines may include, for example, metal (e.g., copper) wires or fiber-optic lines. It is further noted that information may also be routed over the Internet and/or through a distinguishable intranet.

With reference now to FIG. 62B, a second exemplary communication arrangement 3601 in accordance with an embodiment is shown, wherein a signal is to be routed from source 3610 to destination 3620. First, the information is routed from source 3610 to a Wireless transmitter 3680 through first transmission line 3640. Subsequently, this information is wirelessly routed from wireless transmitter 3680 to a wireless receiver 3690, such as through a wireless communication network. Finally, the information is routed from wireless receiver 3690 to destination 3620 through second transmission line 3660. It is noted that various wireless communication methods may be implemented, such as by using short wavelength radio transmissions (e.g., Bluetooth™ transmissions), or such as by routing signals across cellular or satellite communication networks, and that the present technology is not limited to any particular wireless communication methodology.

XII. Exemplary Computer System Environments

It is noted that various components of the present technology may be hard-wired or configured to carry out various actions and operations discussed herein. Pursuant to one embodiment, however, a computer system may be implemented to carry out various operations of the present technology. Consequently, an exemplary computer system and configuration will now be explored. However, the present technology is not limited to this exemplary system and configuration. Indeed, other systems and configurations may be implemented.

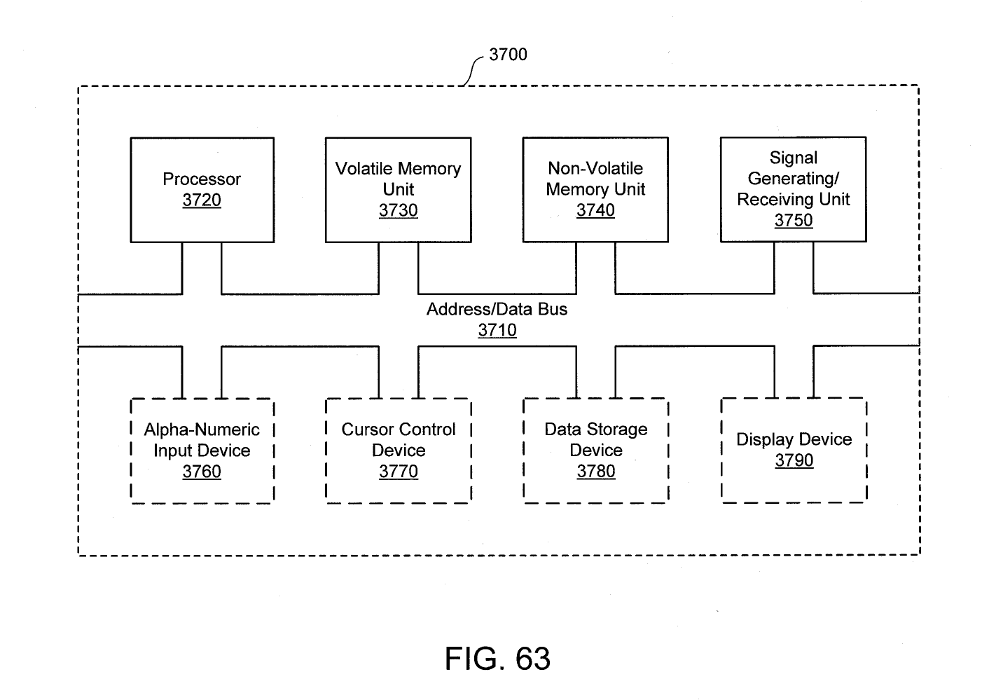

With reference now to FIG. 63, an exemplary computer system 3700 in accordance with an embodiment is shown. Computer system 3700 may be any type of computing device (e.g., a computing device utilized to perform calculations, processes, operations, and functions associated with a program or algorithm). Within the discussions herein, certain processes and steps are discussed that are realized, pursuant to one embodiment, as a series of instructions, such as a software program, that reside within computer-readable memory units and are executed by one or more processors of computer system 3700. When executed, the instructions cause computer system 3700 to perform specific actions and exhibit specific behavior described in various embodiments herein.

With reference still to FIG. 63, computer system 3700 includes an address/data bus 3710 configured to communicate information between a source and a destination. In addition, one or more data processors, such as processor 3720, are coupled with address/data bus 3710, wherein processor 3720 is configured to process information and instructions. In an embodiment, processor 3720 is a microprocessor or microcontroller, although other types of data processors may be implemented.

Computer system 3700 also includes a number of data storage components, such as, for example, a volatile memory unit 3730. Volatile memory unit 3730 is communicatively associated or coupled with address/data bus 3710. Additionally, volatile memory unit 3730 is configured to store information and instructions for processor 3720. Moreover, volatile memory unit 3730 may include, for example, random access memory (RAM), such as static RAM and/or dynamic RAM. Computer system 3700 further includes a non-volatile memory unit 3740, which is communicatively associated or coupled with address/data bus 3710 and configured to store static information and instructions for processor 3720. In an embodiment, non-volatile memory unit 3740 includes read-only memory (ROM), such as programmable ROM, flash memory, erasable programmable ROM (EPROM), and/or electrically erasable programmable ROM (EEPROM). The foregoing notwithstanding, it is noted that the present technology is not limited to the use of the exemplary storage units discussed herein, and that other types of memory may be implemented.

With reference still to FIG. 63, computer system 3700 also includes one or more signal generating and receiving devices, such as signal generating/receiving unit 3750, which is communicatively associated or coupled with address/data bus 3710 and configured to enable computer system 3700 to interface with other electronic devices and computer systems. The communication interface(s) implemented by the one or more signal generating and receiving devices may utilize wired (e.g., serial cables, modems, and network adaptors) and/or wireless (e.g., wireless modems and wireless network adaptors) communication technologies.

In an embodiment, computer system 3700 optionally includes an alphanumeric input device 3760 that is communicatively associated or coupled with address/data bus 3710, wherein alphanumeric input device 3760 includes alphanumeric and function keys for communicating information and command selections to processor 3720. Moreover, pursuant to one embodiment, a cursor control device 3770 is communicatively associated or coupled with address/data bus 3710, wherein optional cursor control device 3770 is configured to communicate user input information and command selections to processor 3720. For example, cursor control device 3770 may be implemented using a mouse, a track-ball, a track-pad, an optical tracking device, or a touch screen. In a second example, a cursor is directed and/or activated in response to input from alphanumeric input device 3760, such as when special keys or key sequence commands are executed. It is noted, however, that a cursor may be directed by other means, such as, for example, voice commands.

With reference still to FIG. 63, computer system 3700, pursuant to one embodiment, optionally includes a data storage device 3780 that is communicatively associated or coupled with address/data bus 3710, wherein data storage device 3780 is configured to store information and/or computer-executable instructions. To illustrate, one example provides that data storage device 3780 is a magnetic or optical disk drive, such as a hard disk drive (HDD), a floppy disk drive, a compact disk ROM (CD-ROM) drive, a digital versatile disk (DVD) drive, or a Blu-ray Disk™ (BD) drive.

Furthermore, in an embodiment, a display device 3790 is communicatively associated or coupled with address/data bus 3710 and configured to display video and/or graphics. Display device 3790 may be, for example, a cathode ray tube (CRT) display, a field emission display (FED), a plasma display, a liquid crystal display (LCD), a light emitting diode (LED) display, or any other display device suitable for displaying video and/or graphic images and alphanumeric characters capable of being recognized by a user.

It is noted that computer system 3700 is presented as an exemplary computing environment in accordance with an embodiment. However, computer system 3700 is not strictly limited to being a computer system. For example, one embodiment provides that computer system 3700 represents a type of data processing analysis that may be used in accordance with various embodiments described herein. Moreover, other computing systems may be implemented. Indeed, the present technology is not limited to any particular data processing environment.

In addition to the foregoing, it is noted that various methods of the present technology may be carried out by a computer system configured to execute a set of instructions. Such instructions may be stored, for example, on or within a computer-readable medium such that the instructions, when executed, cause a computer system to perform a method of the present technology. Consequently, an exemplary system and configuration for a computer-readable medium will now be explored. However, the present technology is not limited to this exemplary system and configuration. Indeed, other systems and configurations may be implemented.

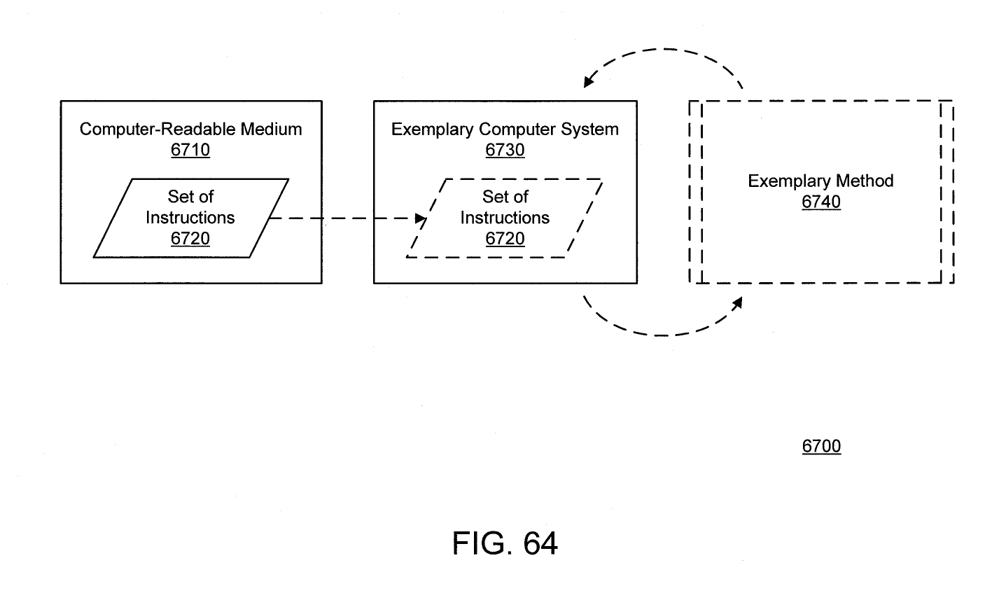

With reference now to FIG. 64 an exemplary instruction execution system 6700 in accordance with an embodiment is shown. Exemplary instruction execution system 6700 includes a computer-readable medium 6710 configured to store a set of instructions 6720 that when executed cause a computer system, such as exemplary computer system 6730, to perform a method of the present technology, such as exemplary method 6740. For example, in one embodiment, set of instructions 6720 is acquired by computer system 6730 from computer-readable medium 6710, and then computer system 6730 executes set of instructions 6720 and consequently performs exemplary method 6740.

The foregoing notwithstanding, it is noted that the electronic and software based systems discussed herein are merely examples of how suitable computing environments for the present technology might be implemented, and that these examples are not intended to suggest any limitation as to the scope of use or functionality of the present technology. Neither should such exemplary systems be interpreted as having any dependency or requirement relating to any one or combination of the components and modules illustrated in the disclosed examples.

### Exemplary Methodologies

A number of exemplary methodologies of the present technology will now be explored. It is noted, however, that the present technology is not limited to these exemplary methodologies. Indeed, other methodologies may also be implemented.

1. First Exemplary Method of Motion Event Detection

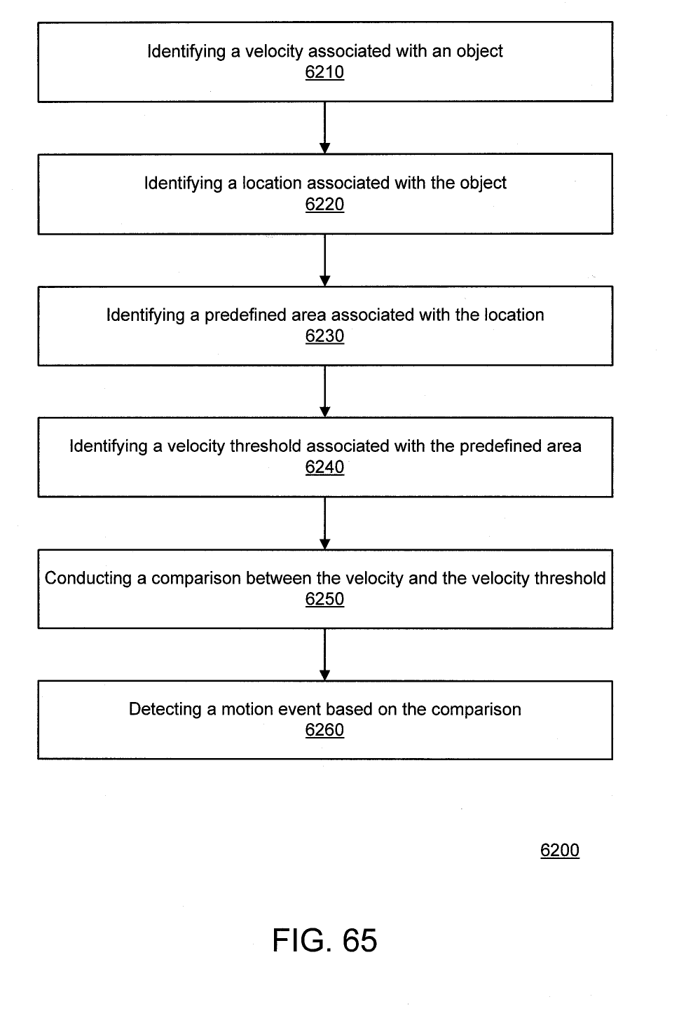

With reference now to FIG. 65, a first exemplary method of motion event detection 6200 in accordance with an embodiment is shown. First exemplary method of motion event detection 6200 includes identifying a velocity associated with an object 6210. For example, if the object is traveling in a geographic area of interest, a velocity determination system, device and/or module may be implemented to determine the velocity with which the object is currently traveling. After the velocity has been determined, data reflecting this velocity, such as digital or analog data that may be processed, for example, by a computer processing unit or microcontroller, may then be generated, saved in a data storage unit, and then subsequently accessed. Consequently, it is noted that identifying the velocity associated with the object 6210 may simply include accessing the data reflecting the determined velocity.

Pursuant to one embodiment, however, identifying the velocity associated with the object 6210 includes determining (or approximating) the velocity and/or generating data reflecting this velocity. For example, if the object is traveling in a geographic area of interest, a speed detection unit, such as a radio detection and ranging (RADAR) speed detection unit or a light detection and ranging (LIDAR) speed detection unit, may be implemented to determine or estimate the velocity of the object within this geographic area. It is noted, however, that various types of speed detection units may be implemented, and that the present technology is not limited to a specific type of speed detection unit. As such, a speed detection unit other than a RADAR or LIDAR speed detection unit may be implemented.

In one embodiment, first exemplary method of motion event detection 6200 includes selecting a signal transceiver system configured to transmit and receive signals, generating a transmission instruction, and routing the transmission instruction to the signal transceiver system so as to cause the signal transceiver system to transmit a signal toward the object at a first point in time, wherein the signal transceiver system receives the signal at a second point in time, and wherein the signal has first and second frequencies at the first and second points in time, respectively. First exemplary method of motion event detection 6200 also includes identifying the first and second frequencies, calculating a Doppler shift between the first and second frequencies, and calculating the velocity based on the Doppler shift.

Moreover, in an embodiment, first exemplary method of motion event detection 6200 includes selecting a signal transceiver system configured to transmit and receive signals, generating a transmission instruction, and routing the transmission instruction to the signal transceiver system so as to cause the signal transceiver system to transmit first and second signals toward the object at first and third points in time, respectively, wherein the signal transceiver system receives the first and second signals at second and fourth points in time, respectively. First exemplary method of motion event detection 6200 also includes identifying the first, second, third and fourth points in time, and calculating a first time difference between the first and second points in time and a second time difference between the third and fourth points in time. First exemplary method of motion event detection 6200 further includes identifying a signal velocity associated with the first signal and a signal velocity associated with the second signal, multiplying the first time difference by the signal velocity associated with the first signal to determine a first propagation distance, and multiplying the second time difference by the signal velocity associated with the second signal to determine a second propagation distance. First exemplary method of motion event detection 6200 also includes dividing each of the first and second propagation distances in half to determine first and second distances, respectively, and calculating a third time difference between one of the first and second points in time and one of the third or fourth points in time. First exemplary method of motion event detection 6200 further includes selecting a first sight line, vector or axis, wherein both of the signal transceiver and the object are located along the first sight line, vector or axis at the first or second points in time, and selecting a second sight line, vector or axis, wherein both of the signal transceiver and the object are located along the second sight line, vector or axis at the third or fourth points in time. First exemplary method of motion event detection 6200 also includes calculating an angle between the first and second sight lines, vectors or axes, and calculating the velocity based on the first distance, the second distance, the angle and the third time difference.

With reference still to FIG. 65, first exemplary method of motion event detection 6200 also includes identifying a location associated with the object 6220. For example, if the object is traveling in a geographic area of interest, a location determination system, device and/or module may be implemented to determine the current location of the object within this geographic area of interest. After the location has been determined, data reflecting this location, such as digital or analog data that may be processed, for example, by a computer processing unit or microcontroller, may then be generated, saved in a data storage unit, and then subsequently accessed. Consequently, it is noted that identifying the location associated with the object 6220 may simply include accessing the data reflecting the determined location.

Pursuant to one embodiment, however, identifying the location associated with the object 6220 includes determining (or approximating) the location and/or generating data reflecting this location. For example, if the object is traveling in a geographic area of interest, a location detection unit, such as a radio detection and ranging (RADAR) location detection unit or a light detection and ranging (LIDAR) location detection unit, may be implemented to determine or estimate the location of the object within this geographic area. It is noted, however, that various types of location detection units may be implemented, and that the present technology is not limited to a specific type of location detection unit. As such, a location detection unit other than a RADAR or LIDAR location detection unit may be implemented.

It is noted that the location of the object may be determined with respect to a particular geographic positioning device (e.g., a Global Positioning System (GPS) receiver), such as a geographic positioning device that is communicatively associated or coupled with a different object (e.g., a manned or unmanned aerial vehicle that patrols a geographic area of interest). To illustrate, an embodiment provides that first exemplary method of motion event detection 6200 includes determining (or approximating) a position associated with a geographic positioning device, determining (or approximating) a distance between the geographic positioning device and the object with a distance detection unit, selecting a sight line, vector or axis, wherein both of the geographic positioning device and the object are located along the sight line, vector or axis, and selecting at least one direction vector based on the sight line, vector or axis. First exemplary method of motion event detection 6200 also includes determining (or approximating) the location associated with the object based on the position, the distance and the at least one direction vector.

Moreover, in one embodiment, first exemplary method of motion event detection 6200 includes determining (or approximating) a position associated with a geographic positioning device and determining (or approximating) a distance between the geographic positioning device and the object with a distance detection unit. First exemplary method of motion event detection 6200 also includes selecting a sight line, vector or axis, wherein both of the geographic positioning device and the object are located along the sight line, vector or axis, and identifying a reference line, vector or axis, wherein the reference line, vector or axis may be, for example, a horizontal reference line, vector or axis. First exemplary method of motion event detection 6200 further includes determining (or approximating) an angle between the reference line, vector or axis and the sight line, vector or axis, wherein the angle may be, for example, an azimuth, and determining (or approximating) the location associated with the object based on the position, the distance, the angle and the reference line, vector or axis.

Furthermore, an embodiment provides that first exemplary method of motion event detection 6200 includes selecting a signal transceiver system configured to transmit and receive signals, generating a transmission instruction, and routing the transmission instruction to the signal transceiver system so as to cause the signal transceiver system to transmit a signal toward the object at a first point in time, wherein the signal transceiver system receives the signal at a second point in time. First exemplary method of motion event detection 6200 also includes calculating a time difference between the first and second points in time, accessing a signal velocity associated with the signal, multiplying the time difference by the signal velocity to determine a propagation distance, and dividing the propagation distance in half to determine the distance.

Moreover, pursuant to embodiment, first exemplary method of motion event detection 6200 includes determining (or approximating) a position associated with a geographic positioning device and determining (or approximating) a distance between the geographic positioning device and the object with a distance detection unit. First exemplary method of Motion event detection 6200 also includes selecting a sight line, vector or axis, wherein both of the geographic positioning device and the object are located along the sight line, vector or axis, and selecting a reference line, vector or axis based on the sight line, vector or axis, wherein the reference line, vector or axis may be, for example, a horizontal or vertical reference line, vector or axis. First exemplary method of motion event detection 6200 further includes determining (or approximating) an angle between the reference line, vector or axis and the sight line, vector or axis, wherein the angle may be, for example an elevation angle, and determining (or approximating) the location associated with the object based on the position, the distance, the angle and the reference line, vector or axis.

With reference still to FIG. 65, first exemplary method of motion event detection 6200 further includes identifying a predefined area associated with the location 6230. For example, once the location of the object is identified, a geographical region (e.g., the predefined area) within which this current position is located is next identified. In particular, information defining physical features (e.g., the outer boundaries, elevation range and/or landmarks) of the predefined area may be stored in an optional database, and this information may be accessed (e.g., either locally or remotely across a communication network utilizing wired and/or wireless data transmission paradigms) based on the identified location of the object, such as where the identified location is determined to be located within the outer boundaries (and/or the corresponding elevation range) of the predefined area.

Moreover, an embodiment provides that landmarks within a predefined proximity to the identified location are identified and compared to a number of preselected landmarks associated with the predefined area. For example, an unmanned aerial drone may be equipped with an imaging device (e.g., a digital camera) configured to capture digital images of the geographic area in which the object is currently traveling. Landmarks within these digital images are then identified (such as manually or by an automated process using object recognition software), and the identified landmarks are compared (such as manually or by an automated process using object recognition and comparison software) to a number of preselected landmarks associated with the predefined area. If a match is found between at least one of the identified landmarks and at least one of the preselected landmarks, then the location associated with the object is identified as being positioned in at least a close proximity to the predefined area.

The foregoing notwithstanding, in an embodiment, identifying the predefined area associated with the location 6230 may include simply accessing the data reflecting the geographic boundaries of the predefined area after it has already been determined that the location associated with the object is located within the predefined area. Pursuant to one embodiment, however, identifying the predefined area associated with the location 6230 includes accessing the data reflecting the geographic boundaries of the predefined area and determining that the location associated with the object is located within the predefined area. For example, after the location has been identified, data reflecting this location, such as digital or analog data that may be processed, for example, by a computer processing unit or microcontroller, wherein the data may include, for example, latitude, longitude and/or elevation coordinates corresponding to the location, may be compared to the data reflecting the geographic boundaries of the predefined area to thereby determine whether the location is located within the predefined area.

With reference still to FIG. 65, first exemplary method of motion event detection 6200 also includes identifying a velocity threshold associated with the predefined area 6240. To illustrate, consider the example where the information that defines the outer boundaries of the predefined area also defines the velocity threshold (e.g., a vehicular speed threshold) assigned to the predefined area, and where this information is stored in a database. Once the predefined area is identified, the information detailing the velocity threshold assigned to this predefined area may be accessed from the database, such as by submitting an information request for the specific velocity threshold that corresponds to the identified predefined area.

With reference still to FIG. 65, first exemplary method of motion event detection 6200 further includes conducting a comparison between the velocity and the velocity threshold 6250. For example, the velocity and velocity threshold may be compared to thereby determine or calculate whether the velocity is greater or less than the velocity threshold, and the comparison would yield, for example, (1) a binary output (e.g., a “1” state or a “0” state in Boolean algebra or logic) reflecting this determination or calculation or (2) a digital or analog output reflecting the degree (e.g., the number of miles per hour) by which the velocity is greater or less than the velocity threshold.

With reference still to FIG. 65, first exemplary method of motion event detection 6200 also includes detecting a motion event based on the comparison 6260. To illustrate, a first exemplary implementation provides that if the comparison yields a binary output of logic “1”, thereby indicating that the velocity is, for example, greater than the velocity threshold (or greater than the velocity threshold by a preselected margin), then a motion event will be detected. In accordance with a second exemplary implementation, however, the comparison yields a digital or analog output reflecting the degree (e.g., the number of miles per hour) by which the velocity is greater than the velocity threshold. If the velocity is greater than the velocity threshold by a preselected margin, then a motion event will be detected.

It is noted that the detected motion event may be, for example, a citable speeding violation, such as when a vehicle is traveling at a rate of speed within the predefined area that is above or below an applicable vehicular speed threshold by a preselected margin. It is further noted, however, that the present technology is not limited to the detection of a particular type of motion event.

In an embodiment, first exemplary method of motion event detection 6200 includes accessing velocity data identifying the velocity associated with the object and accessing location data identifying the location associated with the object. Moreover, in one embodiment, first exemplary method of motion event detection 6200 also includes determining (or approximating) the velocity and location, and generating the velocity data and the location data based on the velocity and location, respectively. For example, velocity and location determination systems, devices and/or modules may be implemented to determine the velocity and location, and then velocity data and location data that reflect the determined velocity and location, respectively, are generated. It is noted that the velocity data and location data may be, for example, digital or analog data that is capable of being processed, for example, by a computer processing unit or microcontroller. It is further noted, however, that various data generation methodologies may be implemented. Indeed, the present technology is not limited to any particular method of data generation.

The foregoing notwithstanding, in an embodiment, first exemplary method of motion event detection 6200 includes accessing location information from a location database based on the location data, wherein the location information identifies the predefined area, and accessing velocity information based on the location information, wherein the velocity information identifies the velocity threshold. In one embodiment, the location database includes an electronic or magnetic data storage unit or database. It is noted, however, that the present technology is not limited to the implementation of electronic and/or magnetic data storage units and databases. Indeed, other types of data storage units and databases may be implemented.

In an embodiment, first exemplary method of motion event detection 6200 includes forwarding the velocity data and the velocity information to an electronic difference, engine to determine a difference between the velocity and the velocity threshold and detecting the motion event based on the difference. To illustrate, consider the example where the velocity threshold is a speed threshold of 65 MPH associated with or assigned to a particular geographic area in which the object is currently traveling at the identified velocity. Once calculated, the difference reflects that the object is currently traveling at a rate of speed that is greater than 65 MPH. Accordingly, a motion event will be detected.

Pursuant to one embodiment, however, a motion event is detected based on the velocity being less (rather than greater) than the velocity threshold. To illustrate, consider the example where a speed threshold of 65 MPH is associated with or assigned to a particular geographic area, and where the velocity threshold is a lower velocity threshold of 40 MPH associated with or assigned to this geographic area. Once calculated, the difference reflects that the object is currently traveling at a rate of speed that is less than 40 MPH. Accordingly, a motion event will be detected (even though the object is traveling at a rate of speed that is lower than the applicable speed threshold of 65 MPH).

With reference still to FIG. 65, it is noted that first exemplary method of motion event detection 6200 includes detecting the motion event based on the comparison 6260. In one embodiment, first exemplary method of motion event detection 6200 includes detecting the motion event based on the aforementioned difference (or an absolute value of such difference) being greater than a preselected margin (or an absolute value of such preselected margin). To illustrate, consider the example where the difference is a digital or analog output reflecting the degree (e.g., the number of miles per hour) by which the velocity is greater than the velocity threshold, and where law enforcement officers have been instructed to not issue a traffic citation to a driver that is merely traveling at a rate of speed that is 5 MPH over the applicable vehicular speed threshold on a particular road or highway. First exemplary method of motion event detection 6200 includes determining whether the difference is greater than 5 MPH, and, if so, a motion event (e.g., a citable speeding violation taking into account the preselected 5 MPH margin) is detected. If however, the difference is not greater than 5 MPH, a motion event will not be detected.

Thus, an embodiment provides that a motion event is detected when the identified velocity is higher or lower than the velocity threshold by a preselected numerical margin (e.g., when the calculated difference is greater than the preselected margin). To further illustrate, consider the example where the velocity threshold is a speed threshold of 65 MPH associated with or assigned to a particular geographic area in which the object is currently traveling at the identified velocity. If the object is currently traveling at a rate of speed of 75 MPH, then the difference, once calculated, reflects that the object is currently traveling at a rate of speed that is 10 MPH greater than the applicable speed threshold. Furthermore, if the preselected margin is defined as a 5 MPH numerical margin, the difference will be determined to be greater than the preselected margin, and a motion event will consequently be detected.

In one embodiment, first exemplary motion event detection 6200 includes identifying the predefined area based on the location associated with the object. First exemplary method of motion event detection 6200 also includes generating the location information based on the predefined area. For example, first exemplary method of motion event detection 6200 may include identifying the location associated with the object and then accessing a database or data storage unit that stores information pertaining to a plurality of different predefined areas, such as the respective outer boundaries of the various predefined areas as well as their respective land elevation ranges. Additionally, first exemplary method of motion event detection 6200 may also include selecting one of these predefined areas based on the identified location, and then generating location information that identifies the selected predefined area.

Moreover, in an embodiment, first exemplary method of motion event detection 6200 includes identifying the velocity threshold based on the predefined area and generating the velocity information based on the velocity threshold. For example, first exemplary method of motion event detection 6200 may include selecting the predefined area from among a plurality of predefined areas and then accessing, such as from a database or data storage unit, a velocity threshold that corresponds to the selected predefined area. Additionally, first exemplary method of motion event detection 6200 may also include generating velocity information that identifies the accessed velocity threshold, wherein the generated velocity information includes digital or analog data that is capable of being processed, for example, by a computer processing unit or microcontroller.

In one embodiment, the velocity threshold is an upper velocity threshold associated with the predefined area, and the velocity information identifies this upper velocity threshold as Well as a lower velocity threshold associated with the predefined area, wherein the upper velocity threshold is higher than the lower velocity threshold. Moreover, first exemplary method of motion event detection 6200 includes identifying the upper and lower velocity thresholds based on the predefined area and generating the velocity information based on the upper and lower velocity thresholds. A motion event may then be detected based on the velocity being either greater than the upper velocity threshold or less than the lower velocity threshold.

To illustrate, consider the example where it is considered dangerous for a vehicle to travel along a road or highway in a particular geographic area at a rate of speed that is greater than 10 MPH over, or less than 15 MPH below, the applicable vehicular speed threshold. If the vehicular speed threshold along this road or highway is 65 MPH, the upper velocity threshold is defined as 75 MPH, such that the 10 MPH upper margin is accounted for, and the lower velocity threshold is defined as 50 MPH, such that the 15 MPH lower margin is accounted for. The appropriate predefined area is selected from among a plurality of predefined areas, and the upper and lower velocity thresholds, which correspond to the selected predefined area, are accessed. Additionally, first exemplary method of motion event detection 6200 may also include generating velocity information that identifies the accessed upper and lower velocity thresholds, and this velocity information is used as an input to a difference calculation so as to determine whether the identified velocity is greater than the upper velocity threshold or lower than the lower velocity threshold. Finally, if it is indeed determined that the identified velocity is greater than the upper velocity threshold or lower than the lower velocity threshold, a motion event will consequently be detected.

Similarly, in one embodiment, the velocity threshold is an upper velocity threshold associated with the predefined area, and the velocity information identifies the upper velocity threshold as well as a lower velocity threshold associated with the predefined area, wherein the upper velocity threshold is higher than the lower velocity threshold, and wherein the aforementioned difference is a first difference between the velocity and the upper velocity threshold. Moreover, first exemplary method of motion event detection 6200 includes forwarding the velocity data and the velocity information to an electronic difference engine to determine the first difference and a second difference between the velocity and the lower velocity threshold. First exemplary method of motion event detection 6200 may also include determining that the velocity is either greater than the upper velocity threshold or less than the lower velocity threshold, selecting a difference from among the first and second differences so as to output a selected difference, and detecting the motion event based on the selected difference, such as where a magnitude of the selected difference is greater than a magnitude of a preselected numerical margin.

Furthermore, in one embodiment, first exemplary method of motion event detection 6200 includes determining first and second absolute values of the first and second differences, respectively, and selecting an absolute value (e.g., a lowest absolute value) from among the first and second absolute values so as to output a selected absolute value. First exemplary method of motion event detection 6200 also includes comparing the selected absolute value to a selected difference threshold (or to an absolute value of the selected difference threshold) and detecting the motion event based on the selected absolute value being greater than the selected difference threshold (or than the absolute value of the selected difference threshold).

For example, in an embodiment, the velocity threshold is an upper velocity threshold associated with the predefined area, and first exemplary method of motion event detection 6200 includes determining a first difference between the velocity and the upper velocity threshold and a second difference between the velocity and a lower velocity threshold associated with the predefined area, wherein the upper velocity threshold is higher than the lower velocity threshold, determining that the velocity is either greater than the upper velocity threshold or less than the lower velocity threshold, and determining first and second absolute values of the first and second differences, respectively. First exemplary method of motion event detection 6200 also includes selecting a lowest absolute value from among the first and second absolute values so as to output a selected absolute value, comparing the selected absolute value to an absolute value of a selected difference threshold, and detecting the motion event based on the selected absolute value being greater than the absolute value of the selected difference threshold.

To further illustrate, consider the example where the first and second differences are determined to be numerical values of +5 (positive 5) and +30 (positive 30), respectively. The first and second absolute values are determined to be 5 and 30, respectively, and the lower numerical value of 5 is selected. Indeed, the fact that the first absolute value is less than the second absolute value indicates that the velocity is closer to the upper velocity threshold than to the lower velocity threshold. The selected absolute value is then compared to the selected difference threshold, which is set to a numerical value of 4, and the resulting comparison reflects that the selected absolute value is greater than the selected difference threshold. Consequently, a motion event is detected.

To further illustrate, consider the example where the first and second differences are determined to be numerical values of −30 (negative 30) and −5 (negative 5), respectively. The first and second absolute values are determined to be 30 and 5, respectively, and the lower numerical value of 5 is selected. Indeed, the fact that the second absolute value is less than the first absolute value indicates that the velocity is closer to the lower velocity threshold than to the upper velocity threshold. The selected absolute value is then compared to the selected difference threshold, which is set to a numerical value of 4, and the resulting comparison reflects that the selected absolute value is greater than the selected difference threshold. Consequently, a motion event is detected.

In one embodiment, first exemplary method of motion event detection 6200 includes selecting either (1) a first register value (e.g., a logic “0”) if the first absolute value is the lowest absolute value from among the first and second absolute values or (2) a second register value (e.g., a logic “1”) if the second absolute value is the lowest absolute value from among the first and second absolute values so as to generate a selected register value (e.g., logic “0” or “1”). First exemplary method of motion event detection 6200 also includes storing the selected register value in a register, calculating first and second difference thresholds based on the first and second velocity thresholds, respectively, and selecting one of the first and second difference thresholds based on the selected register value so as to output the selected difference threshold.

To illustrate, consider the example where the upper and lower velocity thresholds are 65 MPH and 40 MPH, respectively. First exemplary method of motion event detection 6200 includes calculating, for example, (1) 10% of the upper velocity threshold such that the first difference threshold is consequently defined as 6.5 MPH and (2) 10% of the lower velocity threshold such that the second difference threshold is consequently defined as 4 MPH. One of these difference thresholds may then be output based on the selected register value. It is noted, however, that a percentage other than 10% may be implemented, and that in fact different percentages of the upper and lower velocity thresholds, respectively, may be calculated.

The foregoing notwithstanding, is noted that an object may be traveling within a geographic region along or pursuant to a specific course, path or route. If this course, path or route significantly corresponds to a predefined course, path or route (e.g., a road or highway), then this information may be useful in identifying which velocity threshold, from among a plurality of velocity thresholds associated with the applicable geographic region, is to be selected and applied. Thus, in an embodiment, first exemplary method of motion event detection 6200 includes accessing course, path or route data identifying a course, path or route associated with the object. For example, the course, path or route data may be digital or analog data reflecting the numerical data corresponding to the course, path or route in a digital or analog format that may be processed, for example, by a computer processing unit or microcontroller. First exemplary method of motion event detection 6200 also includes accessing the location information from the location database based on the location data and the course, path or route data, wherein the predefined area is associated with the location and the course, path or route. Indeed pursuant to one embodiment, first exemplary method of motion event detection 6200 includes identifying a course, path or route associated with the object and identifying the predefined area based on the location and the course, path or route.

Additionally, in an embodiment, first exemplary method of motion event detection 6200 further includes determining the course, path or route and generating the course, path or route data based on the course, path or route. To illustrate, one embodiment provides that first exemplary method of motion event detection 6200 includes determining (or approximating) a position associated with a geographic positioning device, selecting a first sight line, vector or axis, wherein both of the geographic positioning device and the object are located along the first sight line, vector or axis at a first point in time, selecting a second sight line, vector or axis, wherein both of the geographic positioning device and the object are located along the second sight line, vector or axis at a second point in time, and determining (or approximating) first and second distances between the geographic positioning device and the object along the first and second sight lines, vectors or axes, respectively. First exemplary method of motion event detection 6200 also includes selecting a first direction vector based on the first sight line, vector or axis, selecting a second direction vector based on the second sight line, vector or axis, determining (or approximating) a first location associated with the object based on the position, first distance and first direction vector, determining (or approximating) a second location associated with the object based on the position, second distance and second direction vector, and calculating the course, path or route based on the first and second locations.

Moreover, in an embodiment, first exemplary method of motion event detection 6200 includes determining (or approximating) a position associated with a geographic positioning device, selecting a first sight line, vector or axis, wherein both of the geographic positioning device and the object are located along the first sight line, vector or axis at a first point in time, selecting a second sight line, vector or axis, wherein both of the geographic positioning device and the object are located along the second sight line, vector or axis at a second point in time, and determining (or approximating) first and second distances between the geographic positioning device and the object along the first and second sight lines, vectors or axes, respectively. First exemplary method of motion event detection 6200 also includes identifying a reference line, vector or axis, wherein the reference line, vector or axis may be, for example, a horizontal reference line, vector or axis, determining (or approximating) a first angle between the first reference line, vector or axis and the first sight line, vector or axis, wherein the first angle may be, for example, a first azimuth, determining (or approximating) a first location associated with the object based on the position, first distance and first angle, determining (or approximating) a second angle between the reference line, vector or axis and the second sight line, vector or axis, wherein the second angle may be, for example, a second azimuth, and determining (or approximating) a second location associated with the object based on the position, second distance and second angle. First exemplary method of motion event detection 6200 further includes calculating the course, path or route based on the first and second locations.

Furthermore, in one embodiment, first exemplary method of motion event detection 6200 includes determining (or approximating) first and second positions of a geographic positioning device, selecting a first sight line, vector or axis, wherein both of the geographic positioning device and the object are located along the first sight line, vector or axis when the geographic positioning device is in the first position, selecting a second sight line, vector or axis, wherein both of the geographic positioning device and the object are located along the second sight line, vector or axis when the geographic positioning device is in the second position, and determining (or approximating) first and second distances between the geographic positioning device and the object along the first and second sight lines, vectors or axes, respectively. First exemplary method of motion event detection 6200 also includes selecting a first direction vector based on the first sight line, vector or axis, determining (or approximating) a first location associated with the object based on the position, first distance and first direction vector, selecting a second direction vector based on the second sight line, vector or axis, and determining (or approximating) a second location associated with the object based on the position, second distance and second direction vector. First exemplary method of motion event detection 6200 further includes calculating the course, path or route based on the first and second locations.

Moreover, in an embodiment, first exemplary method of motion event detection 6200 includes determining (or approximating) first and second positions of a geographic positioning device, selecting a first sight line, vector or axis, wherein both of the geographic positioning device and the object are located along the first sight line, vector or axis when the geographic positioning device is in the first position, selecting a second sight line, vector or axis, wherein both of the geographic positioning device and the object are located alone the second sight line, vector or axis when the geographic positioning device is in the second position, and determining (or approximating) first and second distances between the geographic positioning device and the object along the first and second sight lines, vectors or axes, respectively. First exemplary method of motion event detection 6200 also includes identifying a reference line, vector or axis, wherein the reference line, vector or axis may be, for example, a horizontal reference line, vector or axis, determining (or approximating) a first angle between the first reference line, vector or axis and the first sight line, vector or axis, wherein the first angle may be, for example, a first azimuth, and determining (or approximating) a first location associated with the object based on the first position, first distance and first angle. First exemplary method Of motion event detection 6200 further includes determining (or approximating) a second angle between the second reference line, vector or axis and the second sight line, vector or axis, wherein the second angle may be, for example, a second azimuth, determining (or approximating) a second location associated with the object based on the second position, second distance and second angle, and calculating the course, path or route based on the first and second locations.

It is noted that new information that is captured or identified in real-time may be useful to carrying out one or more of the operations discussed herein. As such, an embodiment provides that first exemplary method of motion event detection 6200 includes accessing real-time information identifying one or more parameters, wherein the one or more parameters may be selected, for example, from a group of parameters that includes a number of the following exemplary parameters: a current date, current time, current traffic factor, current road factor, current weather factor and current environmental factor. It is noted that one or more of these parameters may be associated with, or define a current state of, the predefined area. First exemplary method of motion event detection 6200 also includes accessing the velocity information, or identifying the velocity threshold, based on the one or more parameters.

To illustrate, consider the example where two different upper vehicular speed thresholds are assigned or associated with a school zone, such as where a first upper vehicular speed threshold of 15 MPH is applicable in the school zone during school hours and a second upper vehicular speed threshold of 25 MPH is applicable in the school zone at all other times. During a specific week, the school hours for this school zone last from 7:00 a.m. to 3:00 p.m. during the days of Monday through Friday. Consequently, the current date could be accessed in real-time to determine if the day of the week is currently Saturday or Sunday; if so, the current vehicular speed threshold would be 25 MPH. Moreover, a combination of both the current date and the current time could be accessed in real-time to determine if the current day of the week is between Monday and Friday and if the current time of day is between 7:00 a.m. and 3:00 p.m.; if so, the current vehicular speed threshold would be 15 MPH. Furthermore, a combination of both the current date and the current time could be accessed in real-time to determine if the current time of day is before 7:00 a.m. or after 3:00 p.m. during one of the days between Monday and Friday; if so, the current vehicular speed threshold would be 25 MPH.

In an embodiment, first exemplary method of motion event detection 6200 includes identifying a speed threshold based on the predefined area. First exemplary method of motion event detection 6200 also includes accessing or identifying a tolerance threshold, such as by calculating the tolerance threshold based on the speed threshold. First exemplary method of Motion event detection 6200 further includes adding the tolerance threshold to, or subtracting the tolerance threshold from, the speed threshold to thereby obtain the velocity threshold. Moreover, in one embodiment, first exemplary method of motion event detection 6200 includes accessing speed information from a velocity database based on the location information, wherein the speed information identifies a speed threshold associated with the predefined area, accessing a tolerance threshold, adding the tolerance threshold to, or subtracting the tolerance threshold from, the speed threshold to thereby obtain the velocity threshold, and generating the velocity information based on the velocity threshold.

To illustrate, consider the example where law enforcement officers have been instructed to not issue a traffic citation to a driver that is merely traveling at a rate of speed of 5 MPH over the applicable vehicular speed threshold of 65 MPH on a particular highway. The speed information is generated such that the speed threshold associated with this highway is 65 MPH. Additionally, the tolerance threshold is defined to be 5 MPH. Moreover, the tolerance threshold is added to the aforementioned speed threshold such that the velocity threshold is calculated to be 70 MPH. Consequently, if the velocity of a driver exceeds the velocity threshold, wherein the velocity threshold reflects the 5 MPH buffer above the 65 MPH vehicular speed threshold, then a motion event is identified, and a law enforcement officer may accordingly choose to issue a traffic citation to the driver.

In an embodiment, first exemplary method of motion event detection 6200 includes calculating the tolerance threshold based on the speed threshold. To illustrate, consider the example where the vehicular speed threshold (or speed threshold) assigned to or associated with the predefined area is 50 MPH 10% of this speed threshold is determined to be 5 MPH, and the tolerance threshold is consequently defined as 5 MPH. Similarly, if the vehicular speed threshold (or speed threshold) assigned to or associated with the predefined area is 65 MPH, then 10% of this speed threshold is determined to be 6.5 MPH, and the tolerance threshold is consequently defined as 6.5 MPH.

The foregoing notwithstanding, it is noted that the present technology is not limited to any specific algorithm or paradigm for calculating or determining the tolerance threshold, and that other algorithms and paradigms not discussed herein may be implemented. For example, a percentage other than 10% may be implemented, and different percentages of different velocity thresholds may be calculated.

Thus, an embodiment provides that first exemplary method of motion event detection 6200 includes accessing speed information from a velocity database based on the location information, wherein the speed information identifies a speed threshold associated with the predefined area. In one embodiment, the velocity database includes an electronic or magnetic data storage unit or database. It is noted, however, that the present technology is not limited to the implementation of electronic and/or magnetic data storage units and databases. Indeed, other types of data storage units and databases may be implemented.

In addition to the foregoing, one embodiment provides that first exemplary method of motion event detection 6200 includes accessing real-time information identifying one or more parameters, wherein the one or more parameters may be selected, for example, from a group of parameters that includes a number of the following exemplary parameters: a current ate, current time, current traffic factor, current road factor, current weather factor and current environmental factor. It is noted that one or more of these parameters may be associated with, or define a current state of, the predefined area. First exemplary method of motion event detection 6200 also includes accessing the speed information from the velocity database based on the one of more parameters.

With reference still to FIG. 65, it is noted that first exemplary method of motion event detection 6200 includes conducting the comparison between the velocity and the velocity threshold 6250. In an embodiment, first exemplary method of motion event detection 6200 also includes detecting the motion event based on the velocity being greater than the velocity threshold. To illustrate, consider the example where the velocity threshold is defined as the Vehicular speed threshold along a particular road or highway in which a vehicle is currently traveling at a velocity. The aforementioned comparison yields a binary value that is a logic “1” (e.g., +5 volts) if the velocity is determined to be greater than the velocity threshold. In response to this binary value of logic “1”, which may be referred to, for example, as a positive indicator for a motion event, a motion event will be detected. In contrast, the comparison will yield a binary value that is logic “0” (e.g., 0 or −5 volts) if the velocity is determined to be equal to or less than the velocity threshold. In response to this binary value of logic “0”, which may be referred to, for example, as a negative indicator for a motion event, a motion event will not be detected.

To further illustrate, consider the example where it is considered dangerous for a vehicle to travel along a road or highway in a particular geographic area at a rate of speed that is greater than 10 MPH over the applicable vehicular speed threshold. If the vehicular speed threshold along this road or highway is 65 MPH, the velocity threshold is defined as 75 MPH, such that the 10 MPH upper margin is accounted for. Additionally, the aforementioned comparison yields a binary value that is a logic “1” if the velocity is determined to be greater (rather than less) than the velocity threshold. In response to this binary value of logic “1”, a Motion event will be detected, and a law enforcement officer may consequently decide to issue a citation to the operator of the vehicle due to the vehicle's dangerously high rate of speed. In contrast, the comparison will yield a binary value that is logic “0” if the velocity is determined to be equal to or less than the velocity threshold. In response to this binary value of logic “0”, a motion event will not be detected.

The foregoing notwithstanding, in one embodiment, first exemplary method of motion event detection 6200 includes detecting the motion event based on the velocity being less than the velocity threshold. To illustrate, consider the example where it is considered dangerous for a vehicle to travel along a road or highway at a rate of speed that is significantly (e.g., greater than 15 MPH) below the applicable vehicular speed threshold, as this vehicle is not moving with the flow of traffic. If the vehicular speed threshold along this road or highway is 65 MPH, the velocity threshold is defined as, for example, 50 MPH, such that the 15 MPH lower margin is accounted for. Additionally, the aforementioned comparison yields a binary value that is a logic “1” if the velocity is determined to be less (rather than greater) than the velocity threshold. In response to this binary value of logic “1”, a motion event will be detected, and a law enforcement officer may consequently decide to issue a citation to the operator of the vehicle due to the vehicle's dangerously low rate of speed. In contrast, the comparison will yield a binary value that is logic “0” if the velocity is determined to be equal to or greater than velocity threshold. In response to this binary value of logic “0”, a motion event will not be detected.

Moreover, in an embodiment, the velocity threshold is an upper velocity threshold associated with the predefined area, and the comparison is a first comparison between the velocity and the upper velocity threshold. Additionally, first exemplary method of motion event detection 6200 includes conducting the first comparison between the velocity and the upper velocity threshold so as to determine whether the velocity is greater than the upper velocity threshold, identifying a lower velocity threshold associated with the predefined area, wherein the upper velocity threshold is greater than the lower velocity threshold, and conducting a second comparison between the velocity and the lower velocity threshold so as to determine whether the velocity is less than the lower velocity threshold. First exemplary method of motion event detection 6200 also includes detecting the motion event based on the velocity being either greater than the upper velocity threshold or less than the lower velocity threshold.

In an embodiment, first exemplary method of motion event detection 6200 includes determining a difference between the velocity and the velocity threshold and determining an absolute value of the difference. First exemplary method of motion event detection 6200 also includes comparing the absolute value of the difference to a difference threshold (or to an absolute value of the difference threshold) and detecting the motion event based on the absolute value of the difference being greater than the difference threshold (or than the absolute value of the difference threshold). Moreover, in one embodiment, first exemplary method of motion event detection 6200 includes calculating the difference threshold based on the velocity threshold and a numerical input. For example, if the velocity threshold is 65 MPH and the numerical input is 10% (or 0.1), then 10% of this velocity threshold is calculated, and the difference threshold will consequently be defined as 6.5 MPH.

The foregoing notwithstanding, in an embodiment, a response may be automatically initiated when a motion event is detected. To illustrate, one embodiment provides that first exemplary method of motion event detection 6200 includes automatically generating an alarm signal in response to the detecting of the motion event. It is noted that the alarm signal may include, or be implemented or associated with, for example, one or more electronic signals and/or sensory signals (e.g., audio, visual and heat sensory signals). For example, once the motion event is detected, an audio sound may be emitted from an audio speaker system and/or a visual cue may be emitted from a light source. In this manner, a motion event detection system may be integrated with the anatomical or biological sensory system of a law enforcement officer such that the law enforcement officer may be alerted to the detection of the motion event through audio and/or visual cues.

In one embodiment, a new or updated velocity threshold is selected in real-time based on real-time information. To illustrate, an embodiment provides that first exemplary method of motion event detection 6200 includes accessing real-time information identifying one or more parameters, wherein the one or more parameters may be selected, for example, from a group of parameters that includes a number of the following exemplary parameters: a current date, current time, current traffic factor, current road factor, current weather factor and current environmental factor. It is noted that one or more of these parameters may be associated with, or define a current state of, the predefined area. First exemplary method of motion event detection 6200 also includes selecting an updated velocity threshold based on the one or more parameters and generating updated velocity information identifying the updated velocity threshold. First exemplary method of motion event detection 6200 may further optionally include routing the updated velocity information to a velocity database storing the velocity threshold so as to update the velocity threshold based on the updated velocity threshold. In this manner, the stored velocity threshold is updated to reflect the updated velocity threshold.

Moreover, in an embodiment, first exemplary method of motion event detection 6200 includes routing the updated velocity information to an electronic display unit such that the updated velocity threshold is displayed by the electronic display unit. To illustrate, consider the example where the electronic display unit is positioned along a road or highway. The electronic display unit displays the velocity threshold such that operators of vehicles traveling along this road or highway can see the velocity threshold when they pass by, or are in viewing distance of the electronic display unit. In this manner, the electronic display unit is configured, and positioned, to inform oncoming vehicle operators of the current velocity threshold. Once the velocity threshold is updated, such that the velocity threshold changes to an updated velocity threshold, the electronic display unit displays this new velocity threshold to the oncoming vehicle operators. In this manner, the new velocity threshold is posted in real-time to reflect the most recently selected velocity threshold that is associated with the road or highway.

It is noted that the electronic display unit may include, or be integrated with, for example, a cathode ray tube (CRT) display, a field emission display (FED), a plasma display, a liquid crystal display (LCD) or a light emitting diode (LED) display. It is further noted, however, that the present technology is not limited to the implementation of these exemplary displays, and that the electronic display unit may include, or be implemented with, a display other than one of the aforementioned exemplary displays.

In one embodiment, first exemplary method of motion event detection 6200 includes generating one or more signals including an authorization key and the updated velocity information. First exemplary method of motion event detection 6200 also includes routing the one or more signals over a communication network (e.g., a wireless communication network) to if gateway communicatively associated or coupled with an electronic display unit such that the updated velocity threshold is displayed by the electronic display unit based on the authorization key. In this manner, the electronic display unit may be updated in real-time from a remote location.

Moreover, in an embodiment, first exemplary method of motion event detection 6200 includes generating one or more signals including an authorization key and the updated velocity information and routing the one or more signals over a wireless communication network to a gateway so as to access a velocity database, which stores the velocity threshold, based on the authorization key and update the velocity threshold based on the updated velocity threshold. In this manner, an authorized individual may be able to remotely update the velocity threshold assigned to a particular geographic area of interest.

In view of the foregoing, it is noted that an authorization key may be implemented, such as for security purposes. In accordance with one embodiment, however, such an authorization key is not implemented. It is further noted that the aforementioned communication network may be, for example, a wireless communication network, such as a radio frequency (RF) network (e.g., a cellular network) or a satellite communications network, or a wired communication network, such as a public switched telephone network (PSTN), a cable network or a fiber-optic network. However, the present technology is not limited to these exemplary communication networks. Indeed, other types of communication networks may be implemented.

II. Second Exemplary Method of Motion Event Detection

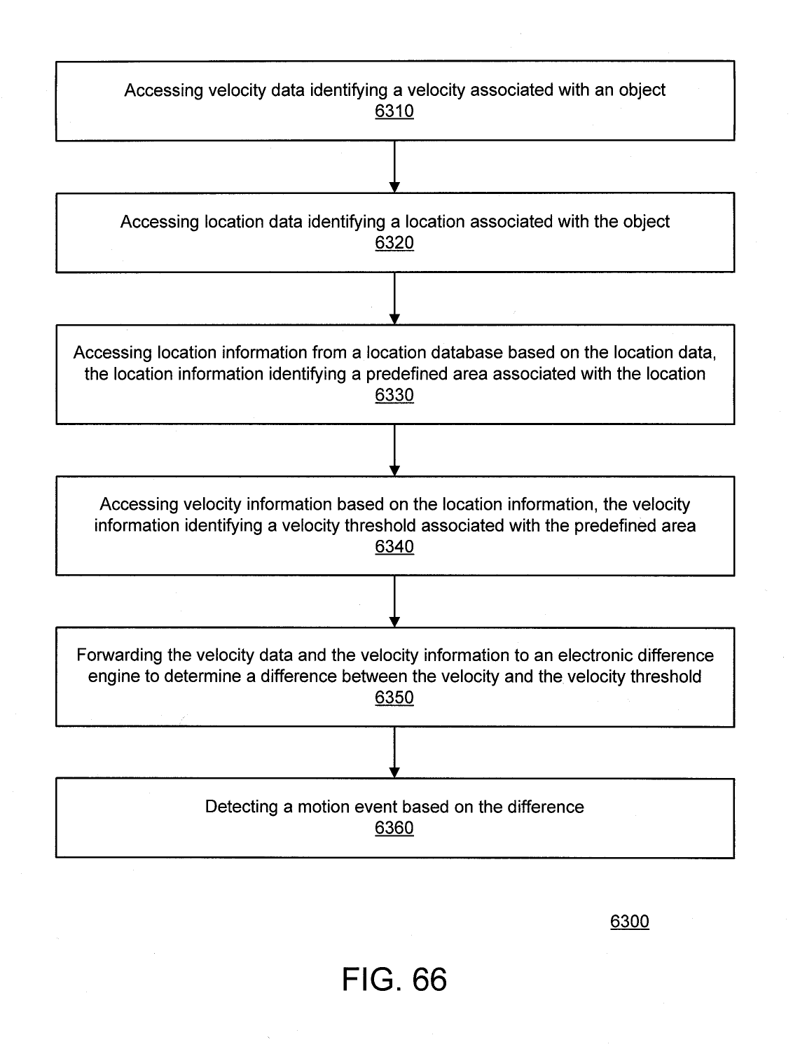

With reference now to FIG. 66, a second exemplary method of motion event detection 6300 in accordance with an embodiment is shown. Second exemplary method of motion event detection 6300 includes accessing velocity data identifying a velocity associated with an object 6310. For example, if the object is traveling in a geographic area of interest, a velocity determination system, device and/or module may be implemented to determine the velocity with which the object is currently traveling. After the velocity has been determined, data reflecting this velocity, such as digital or analog data that may be processed, for example, by a computer processing unit or microcontroller, may then be generated, saved in a data storage unit, and then subsequently accessed.

In one embodiment, second exemplary method of motion event detection 6300 includes determining the velocity and/or generating the velocity data such that the velocity data reflects this velocity. For example, if the object is traveling in a geographic area of interest, a speed detection unit, such as a radio detection and ranging (RADAR) speed detection unit or a light detection and ranging (LIDAR) speed detection unit, may be implemented to determine or estimate the velocity of the object within this geographic area. It is noted, however, that various types of speed detection units may be implemented, and that the present technology is not limited to a specific type of speed detection unit. As such, a speed detection unit other than a RADAR or LIDAR speed detection unit may be implemented.

Moreover, in an embodiment, second exemplary method of motion event detection 6300 includes selecting a signal transceiver system configured to transmit and receive signals, generating a transmission instruction, and routing the transmission instruction to the signal transceiver system so as to cause the signal transceiver system to transmit a signal toward the object at a first point in time, wherein the signal transceiver system receives the signal at a second point in time, and wherein the signal has first and second frequencies at the first and second points in time, respectively. Second exemplary method of motion event detection 6300 also includes identifying the first and second frequencies, calculating a Doppler shift between the first and second frequencies, and calculating the velocity based on the Doppler shift.

Furthermore, in one embodiment, second exemplary method of motion event detection 6300 includes selecting a signal transceiver system configured to transmit and receive signals, generating a transmission instruction, and routing the transmission instruction to the signal transceiver system so as to cause the signal transceiver system to transmit first and second signals toward the object at first and third points in time, respectively, wherein the signal transceiver system receives the first and second signals at second and fourth points in time, respectively. Second exemplary method of motion event detection 6300 also includes identifying the first, second, third and fourth points in time, calculating a first time difference between the first and second points in time and a second time difference between the third and fourth points in time, identifying a signal velocity associated with the first signal and a signal velocity, associated with the second signal, multiplying the first time difference by the signal velocity associated with the first signal to determine a first propagation distance, multiplying the second time difference by the signal velocity associated with the second signal to determine a second propagation distance, and dividing each of the first and second propagation distances in half to determine first and second distances, respectively. Second exemplary method of motion event detection 6300 further includes calculating a third time difference between one of the first and second points in time and one of the third or fourth points in time, selecting a first sight line, vector or axis, wherein both of the signal transceiver and the object are located along the first sight line, vector or axis at the first or second points in time, selecting a second sight line, vector or axis, wherein both of the signal transceiver and the object are located along the second sight line, vector or axis at the third or fourth points in time, calculating an angle between the first and second sight lines, vectors or axes, and calculating the velocity based on the first distance, the second distance, the angle and the third time difference.

With reference still to FIG. 66, second exemplary method of motion event detection 6300 includes accessing location data identifying a location associated with the object 6320. For example, if the object is traveling in a geographic area of interest, a location determination system, device and/or module may be implemented to determine the location of the object within this geographic area of interest. After the location associated with the object as been determined, data reflecting this location, such as digital or analog data that may be processed, for example, by a computer processing unit or microcontroller, may then be generated, saved in a data storage unit, and then subsequently accessed.

In one embodiment, second exemplary method of motion event detection 6300 includes determining the location associated with the object and/or generating the location data such that the location data reflects this location. For example, if the object is traveling in a geographic area of interest, a location detection unit, such as a radio detection and ranging (RADAR) location detection unit or a light detection and ranging (LIDAR) location detection unit, may be implemented to determine or estimate the location of the object within this geographic area. It is noted, however, that various types of location detection units may be implemented, and that the present technology is not limited to a specific type of location detection unit. As such, a location detection unit other than a RADAR or LIDAR location detection unit may be implemented.

Additionally, in an embodiment, second exemplary method of motion event detection 6300 includes determining (or approximating) a position associated with a geographic positioning device (e.g., a Global Positioning System (GPS) receiver) and determining (or approximating) a distance between the geographic positioning device and the object with a distance detection unit. Second exemplary method of motion event detection 6300 also includes selecting a sight line, vector or axis, wherein both of the geographic positioning device and the object are located along the sight line, vector or axis, selecting at least one direction vector based on the sight line, vector or axis, and determining (or approximating) the location associated with the object based on the position, the distance and the at least one direction vector.

Moreover, in one embodiment, second exemplary method of motion event detection 6300 includes determining (or approximating) a position associated with a geographic positioning device and determining (or approximating) a distance between the geographic positioning device and the object with a distance detection unit. Second exemplary method of motion event detection 6300 also includes selecting a sight line, vector or axis, wherein both of the geographic positioning device and the object are located along the sight line, vector or axis, and identifying a reference line, vector or axis, wherein the reference line, vector or axis may be a horizontal reference line, vector or axis. Second exemplary method of motion event detection 6300 further includes determining (or approximating) an angle between the reference line, vector or axis and the sight line, vector or axis, wherein the angle may be an azimuth, and determining (or approximating) the location associated with the object based on the position, the distance, the angle and the reference line, vector or axis.

Furthermore, in an embodiment, second exemplary method of motion event detection 6300 includes selecting a signal transceiver system configured to transmit and receive signals, generating a transmission instruction, and routing the transmission instruction to the signal transceiver system so as to cause the signal transceiver system to transmit a signal toward the object at a first point in time, wherein the signal transceiver system receives the signal at a second point in time. Second exemplary method of motion event detection 6300 also includes calculating a time difference between the first and second points in time, accessing a signal velocity associated with the signal, multiplying the time difference by the signal velocity to determine a propagation distance, and dividing the propagation distance in half to determine the distance between the geographic positioning device and the object.

Additionally, in one embodiment, second exemplary method of motion event detection 6300 includes determining (or approximating) a position associated with a geographic positioning device and determining (or approximating) a distance between the geographic positioning device and the object with a distance detection unit. Second exemplary method of motion event detection 6300 also includes selecting a sight line, vector or axis, wherein both of the geographic positioning device and the object are located along the sight line, vector or axis, and selecting a reference line, vector or axis based on the sight line, vector or axis, wherein the reference line, vector or axis may be a horizontal or vertical reference line, vector or axis. Second exemplary method of motion event detection 6300 further includes determining (or approximating) an angle between the reference line, vector or axis and the sight line, vector or axis, wherein the angle may be an elevation angle, and determining (or approximating) the location associated with the object based on the position, the distance, the angle and the reference line, vector or axis.

In view of the foregoing, an embodiment provides that second exemplary method of motion event detection 6300 includes determining (or approximating) the velocity and location associated with the object, such as in a manner described herein. Second exemplary Method of motion event detection 6300 also includes generating the velocity data and the location data based on the velocity and location, respectively. For example, digital or analog data reflecting the determined velocity and location may be generated, wherein this digital or analog data may be processed, for example, by a computer processing unit or microcontroller.

With reference still to FIG. 66, second exemplary method of motion event detection 6300 includes accessing location information from a location database based on the location data, wherein the location information identifies a predefined area associated with the location 6330. In one embodiment, the location database includes an electronic or magnetic data storage unit or database. It is noted, however, that the present technology is not limited to the implementation of electronic and/or magnetic data storage units and databases. Indeed, other types of data storage units and databases may be implemented.

For example, once the location of the object is identified, a geographical region (e.g., the predefined area) within which this current position is located is next identified. In particular, information defining physical features (e.g., the outer boundaries, elevation range and/or landmarks) of the predefined area may be stored in an optional database, and this information may be accessed (e.g., either locally or remotely across a communication network utilizing wired and/or wireless data transmission paradigms) based on the identified location of the object, such as where the identified location is determined to be located within the outer boundaries (and/or the corresponding elevation range) of the predefined area.

Moreover, an embodiment provides that landmarks within a predefined proximity to the identified location are identified and compared to a number of preselected landmarks associated with the predefined area. For example, an unmanned aerial drone may be equipped with an imaging device (e.g., a digital camera) configured to capture digital images of the geographic area in which the object is currently traveling. Landmarks within these digital images are then identified (such as manually or by an automated process using object recognition software), and the identified landmarks are compared (such as manually or by an automated process using object recognition and comparison software) to a number of preselected landmarks associated with the predefined area. If a match is found between at least one of the identified landmarks and at least one of the preselected landmarks, then the location associated with the object is identified as being positioned in at least a close proximity to the predefined area.

In an embodiment, accessing the location information from the location database based on the location data, wherein the location information identifies the predefined area associated with the location 6330 may include simply accessing the data reflecting the geographic boundaries of the predefined area after it has already been determined that the location associated with the object is located within the predefined area. Pursuant to one embodiment, however, accessing the location information from the location database based on the location data, wherein the location information identifies the predefined area associated with the location 6330 includes accessing the data reflecting the geographic boundaries of the predefined area and determining that the location associated with the object is positioned within the predefined area. For example, after the location associated with the object has been identified, data reflecting this location, such as digital or analog data that may be processed, for example, by a computer processing unit or microcontroller, wherein the data may include, for example, latitude, longitude and/or elevation coordinates corresponding to the location, may be compared to the data reflecting the geographic boundaries of the predefined area to thereby determine whether the location associated with the object is positioned within the predefined area.

Moreover, in one embodiment, second exemplary method of motion event detection 6300 includes identifying the predefined area based on the location associated with the object and generating the location information based on the predefined area. For example, second exemplary method of motion event detection 6300 may include identifying the location associated with the object and then accessing a database or data storage unit that stores information pertaining to a plurality of different predefined areas, such as the respective outer boundaries of the various predefined areas as well as their respective land elevation ranges. Additionally, second exemplary method of motion event detection 6300 may also include selecting one of these predefined areas based on the identified location and then generating location information that identifies the selected predefined area.

With reference still to FIG. 66, second exemplary method of motion event detection 6300 includes accessing velocity information based on the location information, wherein the velocity information identifies a velocity threshold associated with the predefined area 6340. To illustrate, consider the example where the information that defines the outer boundaries of the predefined area also defines the velocity threshold (e.g., a vehicular speed threshold) assigned to the predefined area, and where this information is stored in a database. Once the predefined area is identified, the information detailing the velocity threshold assigned to this predefined area may be accessed from the database, such as by submitting an information request for the specific velocity threshold that corresponds to the identified predefined area.

In an embodiment, second exemplary method of motion event detection 6300 includes identifying the velocity threshold based on the predefined area and generating the velocity information based on the velocity threshold. For example, second exemplary method of motion event detection 6300 may include selecting the predefined area from among a plurality of predefined areas and then accessing, from a database or data storage unit, a velocity threshold that corresponds to the selected predefined area. Additionally, second exemplary method of motion event detection 6300 may also include generating velocity information that identifies the accessed velocity threshold, wherein the generated velocity information includes digital or analog data that is capable of being processed, for example, by a computer processing unit or microcontroller.

With reference still to FIG. 66, second exemplary method of motion event detection 6300 includes forwarding the velocity data and the velocity information to an electronic difference engine to determine a difference between the velocity and the velocity threshold 6350. For example, the velocity and velocity threshold may be compared to thereby determine or calculate whether the velocity is greater or less than the velocity threshold, and the comparison would yield, for example, (1) a binary output (e.g., a “1” state or a “0” state in Boolean algebra or logic) reflecting this determination or calculation or (2) a digital or analog output reflecting the degree (e.g., the number of miles per hour) by which the velocity is greater or less than the velocity threshold.

With reference still to FIG. 66, second exemplary method of motion event detection 6300 includes detecting a motion event based on the difference 6360, such as by detecting the motion event based on the difference (or an absolute value of the difference) being greater than a preselected margin (or than an absolute value of the preselected margin). To illustrate, a first exemplary implementation provides that if the comparison yields a binary output of logic “1”, thereby indicating that the velocity is, for example, greater than the velocity threshold (or greater than the velocity threshold by a preselected margin), then a motion event will be detected. In accordance with a second exemplary implementation, however, the comparison yields a digital or analog output reflecting the degree (e.g., the number of miles per hour) by which the velocity is greater than the velocity threshold. If the velocity is greater than the velocity threshold by a preselected margin, then a motion event will be detected.

It is noted that the detected motion event may be, for example, a citable speeding violation, such as when a vehicle is traveling at a rate of speed within the predefined area that is above or below an applicable vehicular speed threshold by a preselected margin. It is further noted, however, that the present technology is not limited to the detection of a particular type of motion event.

In one embodiment, the velocity threshold is an upper velocity threshold associated with the predefined area, and the velocity information identifies this upper velocity threshold as well as a lower velocity threshold associated with the predefined area, wherein the upper velocity threshold is higher than the lower velocity threshold. Moreover, second exemplary method of motion event detection 6300 includes identifying the upper and lower velocity thresholds based on the predefined area and generating the velocity information based on the upper and lower velocity thresholds. A motion event may then be detected based on the velocity being either greater than the upper velocity threshold or less than the lower velocity threshold.

To illustrate, consider the example where it is considered dangerous for a vehicle to travel along a road or highway in a particular geographic area at a rate of speed that is greater than 10 MPH over, or less than 15 MPH below, the applicable vehicular speed threshold. If the vehicular speed threshold along this road or highway is 65 MPH, the upper velocity threshold is defined as 75 MPH, such that the 10 MPH upper margin is accounted for, and the lower velocity threshold is defined as 50 MPH, such that the 15 MPH lower margin is accounted for. The appropriate predefined area is selected from among a plurality of predefined areas, and the upper and lower velocity thresholds, which correspond to the selected predefined area, are accessed. Additionally, second exemplary method of motion event detection 6300 may also include generating velocity information that identifies the accessed upper and lower velocity thresholds, and this velocity information is used as an input to a difference calculation so as to determine whether the identified velocity is greater than the upper velocity threshold or lower than the lower velocity threshold. Finally, if it is indeed determined that the identified velocity is greater than the upper velocity threshold or lower than the lower velocity threshold, a motion event will consequently be detected.

Similarly, in one embodiment, the velocity threshold is an upper velocity threshold associated with the predefined area, and the velocity information identifies the upper velocity threshold as well as a lower velocity threshold associated with the predefined area, wherein the upper velocity threshold is higher than the lower velocity threshold, and wherein the aforementioned difference is a first difference between the velocity and the upper velocity threshold. Moreover, second exemplary method of motion event detection 6300 includes forwarding the velocity data and the velocity information to the electronic difference engine to determine the first difference and a second difference between the velocity and the lower velocity threshold. Furthermore, second exemplary method of motion event detection 6300 may also include determining that the velocity is either greater than the upper velocity threshold or less than the lower velocity threshold, selecting a difference from among the first and second differences so as to output a selected difference, and detecting the motion event based on the Selected difference, such as where a magnitude of the selected difference is greater than a magnitude of a preselected numerical margin.

Furthermore, in one embodiment, second exemplary method of motion event detection 6300 includes determining that the velocity is either greater than the upper velocity threshold or less than the lower velocity threshold, determining first and second absolute values of the first and second differences, respectively, and selecting an absolute value (e.g., a lowest absolute value) from among the first and second absolute values so as to output a selected absolute value. Second exemplary method of motion event detection 6300 also includes comparing the selected absolute value to a selected difference threshold (or to an absolute value of the selected difference threshold) and detecting the motion event based on the selected absolute value being greater than the selected difference threshold (or than the absolute value of the selected difference threshold).

To illustrate, consider the example where the first and second differences are determined to be numerical values of +5 (positive 5) and +30 (positive 30), respectively. The first and second absolute values are determined to be 5 and 30, respectively, and the lower numerical value of 5 is selected. Indeed, the fact that the first absolute value is less than the second absolute value indicates that the velocity is closer to the upper velocity threshold than to the lower velocity threshold. The selected absolute value is then compared to the selected difference threshold, which is set to a numerical value of 4, and the resulting comparison reflects that the selected absolute value is greater than the selected difference threshold. Consequently, a Motion event is detected.

To further illustrate, consider the example where the first and second differences are determined to be numerical values of −30 (negative 30) and −5 (negative 5), respectively. The first and second absolute values are determined to be 30 and 5, respectively, and the lower numerical value of 5 is selected. Indeed, the fact that the second absolute value is less than the first absolute value indicates that the velocity is closer to the lower velocity threshold than to the upper velocity threshold. The selected absolute value is then compared to the selected difference threshold, which is set to a numerical value of 4, and the resulting comparison reflects that the selected absolute value is greater than the selected difference threshold. Consequently, a motion event is detected.

In one embodiment, second exemplary method of motion event detection 6300 includes selecting either (1) a first register value (e.g., a logic “0”) if the first absolute value is the lowest absolute value from among the first and second absolute values or (2) a second register value (e.g., a logic “1”) if the second absolute value is the lowest absolute value from among the first and second absolute values so as to generate a selected register value (e.g., logic “0” or “1”). Second exemplary method of motion event detection 6300 also includes storing the selected register value in a register, calculating first and second difference thresholds based on the first and second velocity thresholds, respectively, and selecting one of the first and second difference thresholds based on the selected register value so as to output the selected difference threshold.

To illustrate, consider the example where the upper and lower velocity thresholds are 65 MPH and 40 MPH, respectively. Second exemplary method of motion event detection 6300 includes calculating, for example, (1) 10% of the upper velocity threshold such that the first difference threshold is consequently defined as 6.5 MPH and (2) 10% of the lower velocity threshold such that the second difference threshold is consequently defined as 4 MPH. One of these difference thresholds may then be output based on the selected register value. It is noted, however, that a percentage other than 10% may be implemented, and that in fact different percentages of the upper and lower velocity thresholds, respectively, may be calculated.

The foregoing notwithstanding, is noted that an object may be traveling within a geographic region along or pursuant to a specific course, path or route. If this course, path or route significantly corresponds to a predefined course, path or route (e.g., a road or highway), then this information may be useful in identifying which velocity threshold, from among a plurality of velocity thresholds associated with the applicable geographic region, is to be selected and applied. Thus, in an embodiment, second exemplary method of motion event detection 6300 includes accessing course, path or route data identifying a course, path or route associated with the object. For example, the course, path or route data may be digital or analog data reflecting the numerical data corresponding to the course, path or route in a digital or analog format that may be processed, for example, by a computer processing unit or microcontroller. Second exemplary method of motion event detection 6300 also includes accessing the location information from the location database based on the location data and the course, path or route data, wherein the predefined area is associated with the location and the course, path or route.

Additionally, in one embodiment, second exemplary method of motion event detection 6300 further includes determining the course, path or route and generating the course, path or route data based on the course, path or route. To illustrate, an embodiment provides that second exemplary method of motion event detection 6300 includes determining (or approximating) a position associated with a geographic positioning device, selecting a first sight line, vector or axis, wherein both of the geographic positioning device and the object are located along the first sight line, vector or axis at a first point in time, selecting a second sight line, vector or axis, wherein both of the geographic positioning device and the object are located along the second sight line, vector or axis at a second point in time, and determining (or approximating) first and second distances between the geographic positioning device and the object along the first and second sight lines, vectors or axes, respectively. Second exemplary method of motion event detection 6300 also includes selecting a first direction vector based on the first sight line, vector or axis, selecting a second direction vector based on the second sight line, vector or axis, determining (or approximating) a first location associated with the object based on the position, first distance and first direction vector, determining (or approximating) a second location associated with the object based on the position, second distance and second direction vector, and calculating the course, path or route based on the first and second locations.

Moreover, in an embodiment, second exemplary method of motion event detection 6300 includes determining (or approximating) a position associated with a geographic positioning device, selecting a first sight line, vector or axis, wherein both of the geographic positioning device and the object are located along the first sight line, vector or axis at a first point in time, selecting a second sight line, vector or axis, wherein both of the geographic positioning device and the object are located along the second sight line, vector or axis at a second point in time, and determining (or approximating) first and second distances between the geographic positioning device and the object along the first and second sight lines, vectors or axes, respectively. Second exemplary method of motion event detection 6300 also includes identifying a reference line, vector or axis, wherein the reference line, vector or axis may be, for example, a horizontal reference line, vector or axis, determining (or approximating) a first angle between the first reference line, vector or axis and the first sight line, vector or axis, wherein the first angle may be, for example, a first azimuth, determining (or approximating) a first location associated with the object based on the position, first distance and first angle, determining (or approximating) a second angle between the reference line, vector or axis and the second sight line, vector or axis, wherein the second angle may be, for example, a second azimuth, and determining (or approximating) a second location associated with the object based on the position, second distance and second angle. Second exemplary method of motion event detection 6300 further includes calculating the course, path or route based on the first and second locations.

Furthermore, in one embodiment, second exemplary method of motion event detection 6300 includes determining (or approximating) first and second positions of a geographic positioning device, selecting a first sight line, vector or axis, wherein both of the geographic positioning device and the object are located along the first sight line, vector or axis when the geographic positioning device is in the first position, selecting a second sight line, vector or axis, wherein both of the geographic positioning device and the object are located along the second sight line, vector or axis when the geographic positioning device is in the second position, and determining (or approximating) first and second distances between the geographic positioning device and the object along the first and second sight lines, vectors or axes, respectively. Second exemplary method of motion event detection 6300 also includes selecting a first direction vector based on the first sight line, vector or axis, determining (or approximating) a first location associated with the object based on the position, first distance and first direction vector, selecting a second direction vector based on the second sight line, vector or axis, and determining (or approximating) a second location associated with the object based on the position, second distance and second direction vector. Second exemplary method of motion event detection 6300 further includes calculating the course, path or route based on the first and second locations.

Moreover, in an embodiment, second exemplary method of motion event detection 6300 includes determining (or approximating) first and second positions of a geographic positioning device, selecting a first sight line, vector or axis, wherein both of the geographic positioning device and the object are located along the first sight line, vector or axis when the geographic positioning device is in the first position, selecting a second sight line, vector or axis, wherein both of the geographic positioning device and the object are located along the second sight line, vector or axis when the geographic positioning device is in the second position, and determining (or approximating) first and second distances between the geographic positioning device and the object along the first and second sight lines, vectors or axes, respectively. Second exemplary method of motion event detection 6300 also includes identifying a reference line, vector or axis, wherein the reference line, vector or axis may be, for example, a horizontal reference line, vector or axis, determining (or approximating) a first angle between the first reference line, vector or axis and the first sight line, vector or axis, wherein the first angle may be, for example, a first azimuth, and determining (or approximating) a first location associated with the object based on the first position, first distance and first angle. Second exemplary method of motion event detection 6300 further includes determining (or approximating) a second angle between the second reference line, vector or axis and the second sight line, vector or axis, wherein the second angle may be, for example, a second azimuth, determining (or approximating) a second location associated with the object based on the second position, second distance and second angle, and calculating the course, path or route based on the first and second locations.

In an embodiment, second exemplary method of motion event detection 6300 includes accessing real-time information identifying one or more parameters, wherein the one or more parameters may be selected, for example, from a group of parameters that includes a number of the following exemplary parameters: a current date, current time, current traffic factor, current road factor, current weather factor and current environmental factor. It is noted that one or more of these parameters may be associated with, or define a current state of, the predefined area. Second exemplary method of motion event detection 6300 also includes accessing the velocity information based on the one or more parameters.

To illustrate, consider the example where two different upper vehicular speed thresholds are assigned or associated with a school zone, such as where a first upper vehicular speed threshold of 15 MPH is applicable in the school zone during school hours and a second upper vehicular speed threshold of 25 MPH is applicable in the school zone at all other times. During a specific week, the school hours for this school zone last from 7:00 a.m. to 3:00 p.m. during the days of Monday through Friday. Consequently, the current date could be accessed in real-time to determine if the day of the week is currently Saturday or Sunday; if so, the current vehicular speed threshold would be 25 MPH. Moreover, a combination of both the current date and the current time could be accessed in real-time to determine if the current day of the week is between Monday and Friday and if the current time of day is between 7:00 a.m. and 3:00 p.m.; if so, the current vehicular speed threshold would be 15 MPH. Furthermore, a combination of both the current date and the current time could be accessed in real-time to determine if the current time of day is before 7:00 a.m. or after 3:00 p.m. during one of the days between Monday and Friday; if so, the current vehicular speed threshold would be 25 MPH.

In an embodiment, second exemplary method of motion event detection 6300 includes accessing speed information from a velocity database based on the location information, wherein the speed information identifies a speed threshold associated with the predefined area. Second exemplary method of motion event detection 6300 also includes accessing a tolerance threshold, adding the tolerance threshold to, or subtracting the tolerance threshold from, the Speed threshold to thereby obtain the velocity threshold, and generating the velocity information based on the velocity threshold.

To illustrate, consider the example where law enforcement officers have been instructed to not issue a traffic citation to a driver that is merely traveling at a rate of speed of 5 MPH over the applicable vehicular speed threshold of 65 MPH on a particular highway. The speed information is generated such that the speed threshold associated with this highway is 65 MPH. Additionally, the tolerance threshold is defined to be 5 MPH. Moreover, the tolerance threshold is added to the aforementioned speed threshold such that the velocity threshold is calculated to be 70 MPH. Consequently, if the velocity of a driver exceeds the velocity threshold, wherein the velocity threshold reflects the 5 MPH buffer above the 65 MPH vehicular speed threshold, then a motion event is identified, and a law enforcement officer may accordingly choose to issue a traffic citation to the driver.

In an embodiment, second exemplary method of motion event detection 6300 includes calculating the tolerance threshold based on the speed threshold. To illustrate, consider the example where the vehicular speed threshold (or speed threshold) assigned to or associated with the predefined area is 50 MPH. 10% of this speed threshold is determined to be 5 MPH, and the tolerance threshold is consequently defined as 5 MPH. Similarly, if the vehicular speed threshold (or speed threshold) assigned to or associated with the predefined area is 65 MPH, then 10% of this speed threshold is determined to be 6.5 MPH, and the tolerance threshold is Consequently defined as 6.5 MPH.

The foregoing notwithstanding, it is noted that the present technology is not limited to any specific algorithm or paradigm for calculating or determining the tolerance threshold, and that other algorithms and paradigms not discussed herein may be implemented. For example, a percentage other than 10% may be implemented, and different percentages of different velocity thresholds may be calculated.

Thus, an embodiment provides that second exemplary method of motion event detection 6300 includes accessing speed information from a velocity database based on the location information, wherein the speed information identifies a speed threshold associated with the predefined area. In one embodiment, the velocity database includes an electronic or magnetic data storage unit or database. It is noted, however, that the present technology is not limited to the implementation of electronic and/or magnetic data storage units and databases. Indeed, other types of data storage units and databases may be implemented.

In addition to the foregoing, one embodiment provides that second exemplary method of motion event detection 6300 includes accessing real-time information identifying one or more parameters, wherein the one or more parameters may be selected, for example, from a group of parameters that includes a number of the following exemplary parameters: a current date, current time, current traffic factor, current road factor, current weather factor and current environmental factor. It is noted that one or more of these parameters may be associated with, or define a current state of, the predefined area. Second exemplary method of motion event detection 6300 also includes accessing the speed information from the velocity database based on the one or more parameters.

With reference still to FIG. 66, it is noted that second exemplary method of motion event detection 6300 includes forwarding the velocity data and the velocity information to the electronic difference engine to determine the difference between the velocity and the velocity threshold 6350 and detecting the motion event based on the difference 6360. In an embodiment, second exemplary method of motion event detection 6300 also includes detecting the motion event based on the velocity being greater than the velocity threshold. To illustrate, consider the example where the velocity threshold is defined as the vehicular speed threshold along a particular road or highway in which a vehicle is currently traveling at a particular velocity. The aforementioned comparison yields a binary value that is a logic “1.” (e.g., +5 volts) if the velocity is determined to be greater than the velocity threshold. In response to this binary value of logic “1”, which may be referred to, for example, as a positive indicator for a motion event, a motion event will be detected. In contrast, the comparison will yield a binary value that is logic “0” (e.g., 0 or −5 volts) if the velocity is determined to be equal to or less than the velocity threshold. In response to this binary value of logic “0”, which may be referred to, for example, as a negative indicator for a motion event, a motion event will not be detected.

To further illustrate, consider the example where it is considered dangerous for a vehicle to travel along a road or highway in a particular geographic area at a rate of speed that is greater than 10 MPH over the applicable vehicular speed threshold. If the vehicular speed threshold along this road or highway is 65 MPH, the velocity threshold is defined as 75 MPH, such that the 10 MPH upper margin is accounted for. Additionally, the aforementioned Comparison yields a binary value that is a logic “1” if the velocity is determined to be greater (rather than less) than the velocity threshold. In response to this binary value of logic “1”, a motion event will be detected, and a law enforcement officer may consequently decide to issue a citation to the operator of the vehicle due to the vehicle's dangerously high rate of speed. In contrast, the comparison will yield a binary value that is a logic “0” if the velocity is determined to be equal to or less than the velocity threshold. In response to this binary value of logic “0”, a motion event will not be detected.

The foregoing notwithstanding, in one embodiment, second exemplary method of motion event detection 6300 includes detecting the motion event based on the velocity being less than the velocity threshold. To illustrate, consider the example where it is considered dangerous for a vehicle to travel along a road or highway at a rate of speed that is significantly (e.g., greater than 15 MPH) below the applicable vehicular speed threshold, as this vehicle is not moving with the flow of traffic. If the vehicular speed threshold along this road or highway is 65 MPH, the velocity threshold is defined as, for example, 50 MPH, such that the 15 MPH lower margin is accounted for. Additionally, the aforementioned comparison yields a binary value that is a logic “1” if the velocity is determined to be less (rather than greater) than the velocity threshold. In response to this binary value of logic “1”, a motion event will be detected, and a law enforcement officer may consequently decide to issue a citation to the operator of the vehicle due to the vehicle's dangerously low rate of speed. In contrast, the comparison will yield a binary value that is logic “0” if the velocity is determined to be equal to or greater than the velocity threshold. In response to this binary value of logic “0”, a motion event will not be detected.

Moreover, in an embodiment, the velocity threshold is an upper velocity threshold associated with the predefined area, wherein the velocity information identifies the upper velocity threshold and a lower velocity threshold associated with the predefined area, and wherein the upper velocity threshold is greater than the lower velocity threshold. Additionally, second exemplary method of motion event detection 6300 includes conducting a first comparison between the velocity and the upper velocity threshold so as to determine whether the velocity is greater than the upper velocity threshold and conducting a second comparison between the velocity and the lower velocity threshold so as to determine whether the velocity is less than the lower velocity threshold. Second exemplary method of motion event detection 6300 also includes detecting the motion event based on the velocity being either greater than the upper velocity threshold or less than the lower velocity threshold.

With reference still to FIG. 66, it is noted that second exemplary method of motion event detection 6300 includes forwarding the velocity data and the velocity information to the electronic difference engine to determine the difference between the velocity and the velocity threshold 6350 and detecting the motion event based on the difference 6360. In an embodiment, second exemplary method of motion event detection 6300 includes determining an absolute value of the difference. Second exemplary method of motion event detection 6300 also includes comparing the absolute value of the difference to a difference threshold (or to an absolute value of the difference threshold) and detecting the motion event based on the absolute value being greater than the difference threshold (or than the absolute value of the difference threshold). Moreover, in one embodiment, second exemplary method of motion event detection 6300 includes calculating the difference threshold based on the velocity threshold and a numerical input. For example, if the velocity threshold is 65 MPH and the numerical input is 10% (or 0.1), then 10% of this velocity threshold is calculated, and the difference threshold will consequently be defined as 6.5 MPH.

The foregoing notwithstanding, in an embodiment, a response may be automatically initiated when a motion event is detected. To illustrate, one embodiment provides that second exemplary method of motion event detection 6300 includes automatically generating an alarm signal in response to the detecting of the motion event. It is noted that the alarm signal may include, or be implemented or associated with, for example, one or more electronic signals and/or sensory signals (e.g., audio, visual and heat sensory signals). For example, once the motion event is detected, an audio sound may be emitted from an audio speaker system and/or a visual cue may be emitted from a light source. In this manner, a motion event detection system may be integrated with the anatomical or biological sensory system of a law enforcement officer such that the law enforcement officer may be alerted to the detection of the motion event through audio and/or visual cues.

In one embodiment, a new or updated velocity threshold is selected in real-time based on real-time information. To illustrate, an embodiment provides that second exemplary method of motion event detection 6300 includes accessing real-time information identifying one or more parameters, wherein the one or more parameters may be selected, for example, from a group of parameters that includes a number of the following exemplary parameters: a current date, current time, current traffic factor, current road factor, current weather factor and current environmental factor. It is noted that one or more of these parameters may be associated with, or define a current state of, the predefined area. Second exemplary method of motion event detection 6300 also includes selecting an updated velocity threshold based on the one or more parameters and generating updated velocity information identifying the updated velocity threshold. Second exemplary method of motion event detection 6300 may further optionally include routing the updated velocity information to a velocity database storing the velocity threshold so as to update the velocity threshold based on the updated velocity threshold. In this manner, the stored velocity threshold is updated to reflect the updated velocity threshold.

Moreover, in an embodiment, second exemplary method of motion event detection 6300 includes routing the updated velocity information to an electronic display unit such that the updated velocity threshold is displayed by the electronic display unit. To illustrate, consider the example where the electronic display unit is positioned along a road or highway. The electronic display unit displays the velocity threshold such that operators of vehicles traveling along this road or highway can see the velocity threshold when they pass by, or are in viewing distance of, the electronic display unit. In this manner, the electronic display unit is configured, and positioned, to inform oncoming vehicle operators of the current velocity threshold. Once the velocity threshold is updated, such that the velocity threshold changes to an updated velocity threshold, the electronic display unit displays this new velocity threshold to the oncoming vehicle operators. In this manner, the new velocity threshold is posted in real-time to reflect the most recently selected velocity threshold that is associated with the road or highway.

It is noted that the electronic display unit may include, or be integrated with, for example, a cathode ray tube (CRT) display, a field emission display (FED), a plasma display, a liquid crystal display (LCD) or a light emitting diode (LED) display. It is further noted, however, that the present technology is not limited to the implementation of these exemplary displays, and that the electronic display unit may include, or be implemented with, a display other than one of the aforementioned exemplary displays.

In one embodiment, second exemplary method of motion event detection 6300 includes generating one or more signals including an authorization key and the updated velocity information and routing the one or more signals over a communication network (e.g., a wireless communication network) to a gateway that is communicatively associated or coupled with an electronic display unit such that the updated velocity threshold is displayed by the electronic display unit based on the authorization key. In this manner, the electronic display unit may be updated in real-time from a remote location.

Moreover, in an embodiment, second exemplary method of motion event detection 6300 includes generating one or more signals including an authorization key and the updated velocity information and routing the one or more signals over a wireless communication network to a gateway so as to access a velocity database, which stores the velocity threshold, based on the authorization key and update the velocity threshold based on the updated velocity threshold. In this manner, an authorized individual may be able to remotely update the velocity threshold assigned to a particular geographic area of interest.

In view of the foregoing, it is noted that an authorization key may be implemented, such as for security purposes. In accordance with one embodiment, however, such an authorization key is not implemented. It is further noted that the aforementioned communication network may be, for example, a wireless communication network, such as a radio frequency (RF) network (e.g., a cellular network) or a satellite communications network, or a wired communication network, such as a public switched telephone network (PSTN), a cable network or a fiber-optic network. However, the present technology is not limited to these exemplary communication networks. Indeed, other types of communication networks may be implemented.

III. Third Exemplary Method of Motion Event Detection

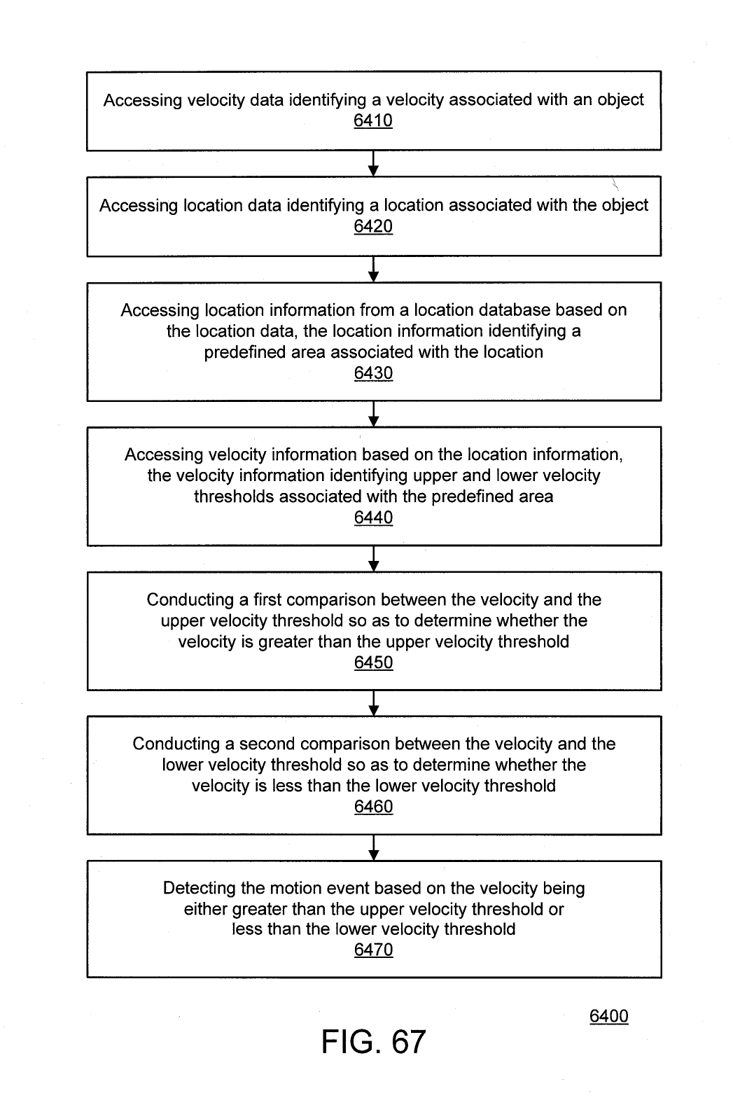

With reference now to FIG. 67, a third exemplary method of motion event detection 6400 in accordance with an embodiment is shown. Third exemplary method of motion event detection 6400 includes accessing velocity data identifying a velocity associated with an object 6410. To illustrate, if the velocity of the object has been determined to be 55 MPH, then the velocity data may include, for example, information reflecting the numerical value “55” as well as the applicable units (e.g., MPH versus KM/H) in a digital or analog format that may be processed, for example, by a computer processing unit or microcontroller. This data is accessed, such as from a velocity determination system, device or module, or such as from a data storage unit in which the velocity data has been stored.

With reference still to FIG. 67, in an embodiment, third exemplary method of motion event detection 6400 includes accessing location data identifying a location associated with the object 6420. To illustrate, if the location of the latitude, longitude and elevation coordinates of the object have been determined, then the location data may include, for example, information reflecting the respective numerical values of these coordinates, as well as the applicable units (e.g., feet above or below a reference plane for the elevation coordinate), in a digital or analog format that may be processed, for example, by a computer processing unit or microcontroller. This data is accessed, such as from a location determination system, device or module, or such as from a data storage unit in which the location data has been stored.

With reference still to FIG. 67, in an embodiment, third exemplary method of motion event detection 6400 includes accessing location information from a location database based on the location data, wherein the location information identifies a predefined area associated with the location 6430. For example, once the location of the object is identified, a geographical region (e.g., the predefined area) within which this current position is located is next identified. In particular, information defining physical features (e.g., the outer boundaries, elevation range and/or landmarks) of the predefined area may be stored in an optional database, and this information may be accessed (e.g., either locally or remotely across a communication network utilizing wired and/or wireless data transmission paradigms) based on the identified location of the object, such as where the identified location is determined to be located within the outer boundaries (and/or the corresponding elevation range) of the predefined area.

Moreover, an embodiment provides that landmarks within a predefined proximity to the identified location are identified and compared to a number of preselected landmarks associated with the predefined area. For example, an unmanned aerial drone may be equipped with an imaging device (e.g., a digital camera) configured to capture digital images of the geographic area in which the object is currently traveling. Landmarks within these digital images are then identified (such as manually or by an automated process using object recognition software), and the identified landmarks are compared (such as manually or by an automated process using object recognition and comparison software) to a number of preselected landmarks associated with the predefined area. If a match is found between at least one of the identified landmarks and at least one of the preselected landmarks, then the location associated with the object is identified as being positioned in at least a close proximity to the predefined area.

With reference still to FIG. 67, in an embodiment, third exemplary method of motion event detection 6400 includes accessing velocity information based on the location information, wherein the velocity information identifies upper and lower velocity thresholds associated with the predefined area 6440. To illustrate, consider the example where it is considered dangerous for a vehicle to travel along a road or highway in a particular geographic area at a rate of speed that is greater than 10 MPH over, or less than 15 MPH below, the applicable vehicular speed threshold. If the vehicular speed threshold along this road or highway is 65 MPH, the upper velocity threshold is defined as 75 MPH, such that the 10 MPH upper margin is accounted for, and the lower velocity threshold is defined as 50 MPH, such that the 15 MPH lower margin is accounted for. The appropriate predefined area is selected from among a plurality of predefined areas, and the upper and lower velocity thresholds, which correspond to the selected predefined area, are accessed.

With reference still to FIG. 67, in an embodiment, third exemplary method of motion event detection 6400 includes conducting a first comparison between the velocity and the upper velocity threshold so as to determine whether the velocity is greater than the upper velocity threshold 6450. Additionally, third exemplary method of motion event detection 6400 includes conducting a second comparison between the velocity and the lower velocity threshold so as to determine whether the velocity is less than the lower velocity threshold 6460. Moreover, third exemplary method of motion event detection 6400 further includes detecting the motion event based on the velocity being either greater than the upper velocity threshold or less than the lower velocity threshold 6470. To illustrate, consider the example where the upper and lower velocity thresholds are defined as 75 MPH and 50 MPH, respectively. The velocity is compared to the upper velocity threshold to determine if the velocity is greater than 75 MPH. Additionally, the velocity is compared to the lower velocity threshold to determine if the velocity is less than 50 MPH. If either of these qualifying factors is true, then a motion event is detected.

IV. First Exemplary Method of Velocity Threshold Selection

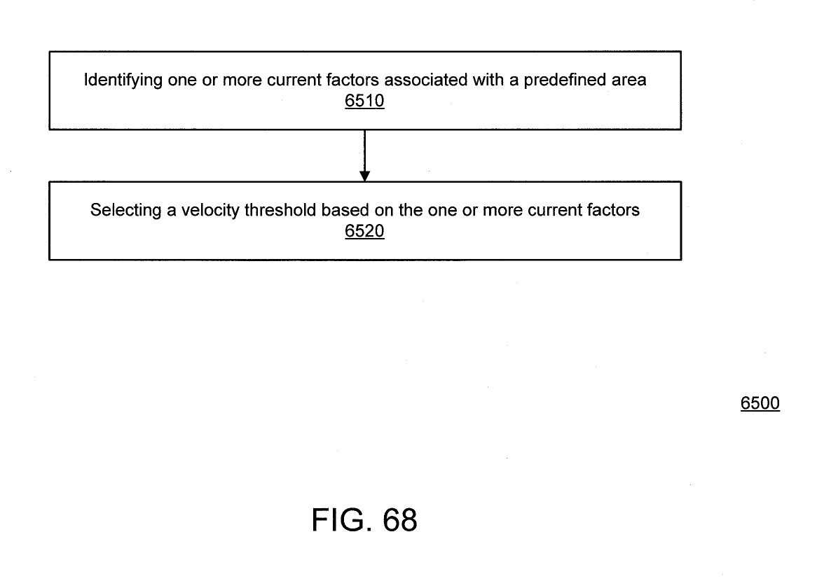

With reference now to FIG. 68, a first exemplary method of velocity threshold selection 6500 in accordance with an embodiment is shown. First exemplary method of velocity threshold selection 6500 includes identifying one or more current factors associated with a predefined area 6510 and selecting a velocity threshold based on the one or more current factors 6520. Additionally, in an embodiment, first exemplary method of velocity threshold selection 6500 optionally includes selecting the one or more current factors from a group of current factors that includes a number of the following exemplary factors: a current date, current time, current traffic factor, current road factor, current weather factor and current environmental factor. It is noted that one or more of these factors may be associated with, or define a current state of, the predefined area. Furthermore, one embodiment provides that first exemplary method of velocity threshold selection 6500 may optionally include routing the velocity threshold to an electronic display unit such that the velocity threshold is displayed by the electronic display unit.

To illustrate, consider the example where the one or more current factors includes real-time information, such as a current traffic factor that identifies a vehicular traffic jam or bottleneck along a heavily traveled highway within the predefined area. A velocity threshold may be automatically selected in real-time, based on this current traffic factor, to be a lower vehicular speed threshold than is usually assigned to this highway, and this lower vehicular speed threshold may be posted along the highway, such as with an electronic velocity threshold display unit that is capable of being updated in real-time to reflect an updated, or newly selected, velocity threshold. In this manner, the probability of a vehicular collision occurring within the predefined area as a result of the traffic jam or bottleneck will be lowered.

Similarly, a second example provides that the one or more current factors includes real-time information, such as a current road factor that identifies an obstacle, such as a stalled vehicle or a torn up section of asphalt, on a heavily traveled highway within the predefined area. A velocity threshold may be automatically selected in real-time, based on this current road factor to be a lower vehicular speed threshold than is usually assigned to this highway, and this lower vehicular speed threshold may be posted along the highway, such as with an electronic velocity threshold display unit that is capable of being updated in real-time to reflect the updated, or newly selected, velocity threshold. In this manner, the probability of a vehicular collision occurring within the predefined area as a result of the identified obstacle will be lowered.

In a third example, the one or more current factors includes real-time information, such as a current weather factor that identifies (1) a degree of rain, snow or hail that is falling upon, or has accumulated upon, a heavily traveled highway within the predefined area and/or (2) a degree of relatively high winds to which the geographic vicinity of interest is currently being subjected. A velocity threshold may be automatically selected in real-time, based on this current weather factor, to be a lower vehicular speed threshold than is usually assigned to this highway, and this lower vehicular speed threshold may be posted along the highway, such as with an electronic velocity threshold display unit that is capable of being updated in real-time to reflect the updated, or newly selected, velocity threshold. In this manner, the probability of a vehicular collision occurring within the predefined area as a result of the identified weather factor will be lowered.

Similarly, a fourth example provides that the one or more current factors includes real-time information, such as a current environmental factor, which identifies an earthquake occurring in the vicinity of a heavily traveled highway. A velocity threshold may be automatically selected in real-time, based on this current environmental factor, to be a lower vehicular speed threshold than is usually assigned to this highway, and this lower vehicular speed threshold may be posted along the highway, such as with an electronic velocity threshold display unit that is capable of being updated in real-time to reflect the updated, or newly selected, velocity threshold. In this manner, the probability of a vehicular collision occurring within the predefined area as a result of the identified earthquake will be lowered.

The foregoing notwithstanding, in an embodiment, first exemplary method of velocity threshold selection 6500 includes accessing a velocity database storing a preselected velocity threshold. First exemplary method of velocity threshold selection 6500 also includes storing the velocity threshold in the velocity database so as to update the preselected velocity threshold to reflect the velocity threshold. In this manner, the current velocity threshold assigned to the predefined area may be updated in real-time by storing the updated velocity threshold in a specific database. In one embodiment, this database may be accessed by a number of different individuals so that these individuals may be informed, in real-time, of any changes to the previous velocity threshold assigned to the predefined area.

To illustrate, consider the example where a construction zone is located along a heavily traveled highway within the predefined area. A velocity threshold of 65 MPH is generally assigned to this highway; however, due to the construction that is currently taking place, this velocity threshold is changed to 45 MPH. In particular, a velocity database that stores the preselected velocity threshold of 65 MPH is accessed, and the new velocity threshold of 45 MPH is stored in the velocity database such that the preselected velocity threshold of 65 MPH is updated to reflect the new velocity threshold of 45 MPH. Additionally, if it is determined that this new velocity threshold of 45 MPH is not sufficiently low in view of the current level of travel, then an even lower velocity threshold (e.g., 30 MPH) may be selected in real-time, and this lower velocity threshold may be stored in the velocity database such that the previously selected velocity threshold of 45 MPH is updated to reflect the newest velocity threshold.

It is noted that the new velocity thresholds may be selected, for example, by a velocity threshold selection algorithm configured to access a number of real-time parameters associated with the predefined area and calculate or select a new velocity threshold based on a nuttier of these parameters. In this manner, the implemented velocity threshold selection process may be fully-automated. Pursuant to one embodiment, however, the new velocity thresholds may be selected by a particular person (e.g., a civil engineer) authorized to access a number of these real-time parameters and calculate or select a new velocity threshold based on a number of these parameters. As such, an exemplary implementation provides that a degree of human authority or oversight is retained such that the velocity threshold selection process includes a manual component.

In an embodiment, first exemplary method of velocity threshold selection 6500 includes accessing a speed threshold and a tolerance threshold, wherein the speed threshold is associated with the predefined area. First exemplary method of velocity threshold selection 6500 also includes selecting the velocity threshold based on the speed threshold and the tolerance threshold. For example, second exemplary method of velocity threshold selection 6600 may include adding the tolerance threshold to (or subtracting the tolerance threshold from) the speed threshold to thereby obtain the velocity threshold.

To illustrate, consider the example where law enforcement officers have been instructed to not issue a traffic citation to a driver that is merely traveling at a rate of speed of 5 MPH over the applicable vehicular speed threshold of 65 MPH on a particular highway. As such, the tolerance threshold is defined to be 5 MPH, and this tolerance threshold is added to the aforementioned speed threshold such that the velocity threshold is calculated to be 70 MPH. Consequently, if the velocity of a vehicle traveling within the predefined area exceeds this velocity threshold of 70 MPH, wherein this velocity threshold reflects the 5 MPH buffer above the 65 MPH vehicular speed threshold, then a motion event is identified, and a law enforcement officer may accordingly choose to issue a traffic citation to the driver of this vehicle.

The foregoing notwithstanding, in one embodiment, first exemplary method of velocity threshold selection 6500 includes identifying the predefined area and selecting the speed threshold based on the predefined area. Consider the example where data defining the speed threshold is stored within a database of different speed thresholds, but wherein this speed threshold (in contrast to the other stored speed thresholds) is associated with the predefined area, such as where information defining the predefined area includes an electronic link to (or information identifying) the stored data that defines the speed threshold. Once the predefined area is identified, such that the information defining the predefined area may be accessed, the stored data that defines the speed threshold associated with this predefined area may be accessed from the aforementioned database such that the speed threshold has been selected from among a number of possible speed thresholds stored in the database.

Furthermore, in an embodiment, first exemplary method of velocity threshold selection 6500 includes accessing real-time information identifying one or more parameters, such as, for example, one or more parameters selected from a group of parameters that includes a number of the following exemplary parameters: a current date, current time, current traffic factor, current road factor, current weather factor and current environmental factor. It is noted that one or more of these parameters may be associated with, or define a current state of the predefined area. First exemplary method of velocity threshold selection 6500 also includes selecting the speed threshold based on the one or more parameters. In this manner, the speed threshold may be selected in real-time based on real-time information that pertains to the area of interest.

In view of the foregoing, it is noted that, in an embodiment, the speed threshold is associated with the predefined area. Moreover, pursuant to one embodiment, the tolerance threshold is associated with the predefined area. Furthermore, an embodiment provides that first exemplary method of velocity threshold selection 6500 includes identifying the predefined area and selecting the tolerance threshold based on the predefined area.

To illustrate, consider the example where law enforcement officers in a first geographical jurisdiction have been instructed to not issue a traffic citation to a driver that is merely traveling at a rate of speed of 5 MPH over the applicable vehicular speed threshold on a particular highway within the first geographical jurisdiction, and where law enforcement officers in a second geographical jurisdiction have been instructed to not issue a traffic citation to a driver that is merely traveling at a rate of speed of 10 MPH over the applicable vehicular speed threshold on a particular highway (e.g., the same or a different highway) within the second geographical jurisdiction. Once the predefined area has been identified, such that it has been determined in which of the two geographical jurisdictions an object of interest is traveling, the corresponding tolerance threshold (e.g., 5 or 10 MPH) may be selected from among a number of possible tolerance thresholds (which may be stored in a database) based on the predefined area.

The foregoing notwithstanding, in one embodiment, first exemplary method of velocity threshold selection 6500 includes calculating the tolerance threshold based on the speed threshold. To illustrate, consider the example where a numerical input of 0.1 (or 10%) is selected. If the speed threshold assigned to or associated with the predefined area is 50 MPH, then 10% of this speed threshold is calculated to be 5 MPH, and the tolerance threshold is consequently defined as 5 MPH. Similarly, if the speed threshold assigned to or associated with the predefined area is 65 MPH, then 10% of this speed threshold is calculated to be 6.5 MPH, and the tolerance threshold is consequently defined as 6.5 MPH. In this manner, the tolerance threshold is a function of the speed threshold. Indeed, in one embodiment, the tolerance threshold is automatically recalculated or changed in response to a change in the speed threshold. The foregoing notwithstanding, it is noted that the present technology is not limited to any specific algorithm or paradigm for calculating or determining the tolerance threshold, and that other algorithms and paradigms not discussed herein may be implemented.

Furthermore, in an embodiment, first exemplary method of velocity threshold selection 6500 includes accessing real-time information identifying one or more parameters selected from a group of parameters that includes a number of the following exemplary parameters: a current date, current time, current traffic factor, current road factor, current weather factor and current environmental factor. It is noted that one or more of these parameters may be associated with, or define a current state of, the predefined area. First exemplary method of velocity threshold selection 6500 also includes selecting the tolerance threshold based on the one or more parameters. In this manner, the tolerance threshold may be selected in real-time based on real-time information that pertains to the area of interest.

V. Second Exemplary Method of Velocity Threshold Selection

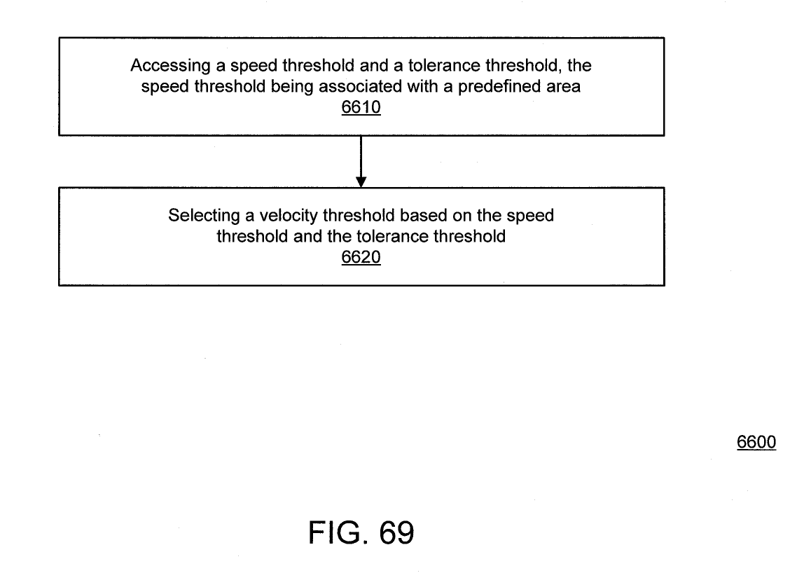

With reference now to FIG. 69, a second exemplary method of velocity threshold selection 6600 in accordance with an embodiment is shown. Second exemplary method of velocity threshold selection 6600 includes accessing a speed threshold and a tolerance threshold, wherein the speed threshold is associated with a predefined area 6610. Second exemplary method of velocity threshold selection 6600 also includes selecting a velocity threshold based on the speed threshold and the tolerance threshold 6620. For example, second exemplary method of velocity threshold selection 6600 may include adding the tolerance threshold to (or subtracting the tolerance threshold from) the speed threshold to thereby obtain the velocity threshold.

To illustrate, consider the example where law enforcement officers have been instructed to not issue a traffic citation to a driver that is merely traveling at a rate of speed of 5 MPH over the applicable vehicular speed threshold of 65 MPH on a particular highway. As such, the tolerance threshold is defined to be 5 MPH, and this tolerance threshold is added to the aforementioned speed threshold such that the velocity threshold is calculated to be 70 MPH. Consequently, if the velocity of a vehicle traveling within the predefined area exceeds this velocity threshold of 70 MPH, wherein this velocity threshold reflects the 5 MPH buffer above the 65 MPH vehicular speed threshold, then a motion event is identified, and a law enforcement officer may accordingly choose to issue a traffic citation to the driver of this vehicle.

With reference still to FIG. 69, it is noted that the speed threshold may be a predefined speed threshold, such as where the speed threshold is defined and then stored in a database or data storage unit such that the speed threshold may be subsequently accessed. In one embodiment, however, the speed threshold is selected or defined in real-time, such as based on, or in response to, one or more factors associated with the predefined area. For example, a number of factors that describe a current state of the predefined area may be identified and then utilized to select or define the speed threshold. In view of the foregoing, a number of methods for accessing, identifying, selecting or defining the speed threshold will now be explored. It is noted, however, that the present technology is not limited to any particular method of accessing, identifying, selecting or defining the speed threshold.

In one embodiment, second exemplary method of velocity threshold selection 6600 includes identifying the predefined area and selecting the speed threshold based on the predefined area. Consider the example where data defining the speed threshold is stored within a database of different speed thresholds, but wherein this speed threshold (in contrast to the other stored speed thresholds) is associated with the predefined area, such as where information defining the predefined area includes an electronic link to (or information identifying) the stored data that defines the speed threshold. Once the predefined area is identified, such that the information defining the predefined area may be accessed, the stored data that defines the speed threshold associated with this predefined area may be accessed from the aforementioned database such that the speed threshold has been selected from among a number of possible speed thresholds stored in the database.

The foregoing notwithstanding, in an embodiment, second exemplary method of velocity threshold selection 6600 includes accessing real-time information identifying one or more parameters selected from a group of parameters that includes a number of the following exemplary parameters: a current date, current time, current traffic factor, current road factor, current weather factor and current environmental factor. It is noted that one or more of these parameters may be associated with, or define a current state of, the predefined area. Second exemplary method of velocity threshold selection 6600 also includes selecting the speed threshold based on the one or more parameters, such as where one or more of these parameters are associated with, or describe a current state of, the predefined area. In this manner, the speed threshold may be selected or defined based on real-time information that indicates a safe velocity with which an object may currently travel within the predefined area.

In view of the foregoing, it is noted that, in an embodiment, the speed threshold is associated with the predefined area. Pursuant to one embodiment, the tolerance threshold is associated with the predefined area. Moreover, an embodiment provides that second exemplary Method of velocity threshold selection 6600 includes identifying the predefined area and selecting the tolerance threshold based on the predefined area. To illustrate, consider the example where law enforcement officers in a first geographical jurisdiction have been instructed to not issue a traffic citation to a driver that is merely traveling at a rate of speed of 5 MPH over the applicable vehicular speed threshold on a particular highway within the first geographical jurisdiction, and where law enforcement officers in a second geographical jurisdiction have been instructed to not issue a traffic citation to a driver that is merely traveling at a rate of speed of 10 MPH over the applicable vehicular speed threshold on a particular highway (e.g., the same or a different highway) within the second geographical jurisdiction. Once the predefined area has been identified, such that it has been determined in which of the two geographical jurisdictions an object of interest is traveling, the corresponding tolerance threshold (e.g., 5 or 10 MPH) may be selected from among a number of possible tolerance thresholds (which may be stored in a database) based on the predefined area.

The foregoing notwithstanding, in an embodiment, second exemplary method of velocity threshold selection 6600 includes calculating the tolerance threshold based on the speed threshold. To illustrate, consider the example where a numerical input of 0.1 (or 10%) is selected. If the speed threshold assigned to or associated with the predefined area is 50 MPH, then 10% of this speed threshold is calculated to be 5 MPH, and the tolerance threshold is consequently defined as 5 MPH. Similarly, if the speed threshold assigned to or associated with the predefined area is 65 MPH, then 10% of this speed threshold is calculated to be 6.5 MPH, and the tolerance threshold is consequently defined as 6.5 MPH. In this manner, the tolerance threshold is a function of the speed threshold. Indeed, in one embodiment, the tolerance threshold is automatically recalculated or changed in response to a change in the speed threshold. The foregoing notwithstanding, it is noted that the present technology is not limited to any specific algorithm or paradigm for calculating or determining the tolerance threshold, and that other algorithms and paradigms not discussed herein may be implemented.

In an embodiment, second exemplary method of velocity threshold selection 6600 includes accessing real-time information identifying one or more parameters selected from a group of parameters that includes a number of the following exemplary parameters: a current date, current time, current traffic factor, current road factor, current weather factor and current environmental factor. It is noted that one or more of these parameters may be associated with, or define a current state of, the predefined area. Second exemplary method of velocity threshold selection 6600 also includes selecting the tolerance threshold based on the one or more parameters.

The foregoing notwithstanding, in one embodiment, second exemplary method of velocity threshold selection 6600 includes identifying one or more current factors associated with the predefined area and selecting the velocity threshold based on the one or more current factors. Moreover, in one embodiment, second exemplary method of velocity threshold selection 6600 includes selecting the one or more current factors from a group of current factors that includes a number of the following exemplary factors: a current date, current time, current traffic factor, current road factor, current weather factor and current environmental factor. It is noted that one or more of these factors may be associated with, or define a current state of, the predefined area.

Once the velocity threshold is accessed, identified, selected or defined, the velocity threshold may be displayed and/or stored. Indeed, an embodiment provides that second exemplary method of velocity threshold selection 6600 includes routing the velocity threshold to an electronic display unit such that the velocity threshold is displayed by the electronic display unit. Moreover, in one embodiment, second exemplary method of velocity threshold selection 6600 includes accessing a velocity database storing a preselected velocity threshold and storing the velocity threshold in the velocity database so as to update the preselected velocity threshold to reflect the velocity threshold.

Although various embodiments discussed herein involve a series of specific steps, actions or operations for achieving a result, it is noted these steps, actions or operations are examples of various steps, actions or operations that may be performed in accordance with a number of exemplary implementations. Indeed, the embodiments disclosed herein may be configured such that various other steps, actions or operations are performed, such as variations of the steps, actions or operations recited. Moreover, the steps disclosed herein may be performed in an order different than presented, and not all of the steps are necessarily performed in a particular embodiment.

### Exemplary Summary Concepts

It is noted that the foregoing discussion has presented at least the following concepts:

I. First Exemplary Concept Group

1. A method of motion event detection including or comprising:

identifying a velocity associated with an object;

identifying a location associated with the object;

identifying a predefined area associated with the location;

identifying a velocity threshold associated with the predefined area; conducting a comparison between the velocity and the velocity threshold; and

detecting a motion event based on the comparison.

2. The method of Concept 1, further including or comprising:

accessing velocity data identifying the velocity;

accessing location data identifying the location;

accessing location information from a location database based on the location data, the location information identifying the predefined area;

accessing velocity information based on the location information, the velocity information identifying the velocity threshold;

forwarding the velocity data and the velocity information to an electronic difference engine to determine a difference between the velocity and the velocity threshold; and

detecting the motion event based on the difference.

3. The method of Concept 2, further including or comprising:

detecting the motion event based on an absolute value of the difference being greater than an absolute value of a preselected Margin.

4. The method of Concept 2, further including or comprising:

determining the velocity and location; and

generating the velocity data and the location data based on the velocity and location, respectively.

5. The method of Concept 2, further including or comprising:

identifying the predefined area based on the location; and

generating the location information based on the predefined area.

6. The method of Concept 2, further including or comprising:

identifying the velocity threshold based on the predefined area; and

generating the velocity information based on the velocity threshold.

7. The method of Concept 2, wherein the velocity threshold is an upper velocity threshold associated with the predefined area, the velocity information identifying the upper velocity threshold and a lower velocity threshold associated with the predefined area, and the method further including or comprising:

identifying the upper and lower velocity thresholds based on the predefined area; and

generating the velocity information based on the upper and lower velocity thresholds.

8. The method of Concept 2, wherein the velocity threshold is an upper velocity threshold associated with the predefined area, the velocity information identifying the upper velocity threshold and a lower velocity threshold associated with the predefined area, the difference being a first difference between the velocity and the upper velocity threshold, and the method further including or comprising:

forwarding the velocity data and the velocity information to the electronic difference engine to determine the first difference and a second difference between the velocity and the lower velocity threshold.

9. The method of Concept 8, further including or comprising:

determining that the velocity is either greater than the upper velocity threshold or less than the lower velocity threshold;

selecting a difference from among the first and second differences so as to output a selected difference; and

detecting the motion event based on the selected difference.

10. The method of Concept 8, further including or comprising:

determining that the velocity is either greater than the upper velocity threshold or less than the lower velocity threshold;

determining first and second absolute values of the first and second differences, respectively;

selecting a lowest absolute value from among the first and second absolute values so as to output a selected absolute value;

comparing the selected absolute value to an absolute value of a selected difference threshold; and

detecting the motion event based on the selected absolute value being greater than the absolute value of the selected difference threshold.

11. The method of Concept 10, further including or comprising:

selecting either a first register value if the first absolute value is the lowest absolute value or a second register value if the second absolute value is the lowest absolute value to generate a selected register value;

storing the selected register value in a register;

calculating first and second difference thresholds based on the upper and lower velocity thresholds, respectively; and

selecting one of the first and second difference thresholds based on the selected register value so as to output the selected difference threshold.

12: The method of Concept 1, further including or comprising:

selecting a signal transceiver system configured to transmit and receive signals;

generating a transmission instruction;

routing the transmission instruction to the signal transceiver system so as to cause the signal transceiver system to transmit a signal toward the object at a first point in time, the signal transceiver system receiving the signal at a second point in time, and the signal having first and second frequencies at the first and second points in time, respectively;

identifying the first and second frequencies;

calculating a Doppler shift between the first and second frequencies; and

calculating the velocity based on the Doppler shift.

13. The method of Concept 1, further including or comprising:

selecting a signal transceiver system configured to transmit and receive signals;

generating a transmission instruction;

routing the transmission instruction to the signal transceiver system so as to cause the signal transceiver system to transmit first and second signals toward the object at first and third points in time, respectively, the signal transceiver system receiving the first and second signals at second and fourth points in time, respectively;

identifying the first, second, third and fourth points in time;

calculating a first time difference between the first and second points in time and a second time difference between the third and fourth points in time;

identifying a signal velocity associated with the first signal and a signal velocity associated with the second signal;

multiplying the first time difference by the signal velocity associated with the first signal to determine a first propagation distance;

multiplying the second time difference by the signal velocity associated with the second signal to determine a second propagation distance;

dividing each of the first and second propagation distances in half to determine first and second distances, respectively;

calculating a third time difference between one of the first and second points in time and one of the third or fourth points in time;

selecting a first sight line, vector or axis, both of the signal transceiver and the object being located along the first sight line, vector or axis at the first or second points in time;

selecting a second sight line, vector or axis, both of the signal transceiver and the object being located along the second sight line, vector or axis at the third or fourth points in time;

calculating an angle between the first and second sight lines, vectors or axes; and

calculating the velocity based on the first distance, the second distance, the angle and the third time difference.

14. The method of Concept 1, further including or comprising:

determining a position associated with a geographic positioning device;

determining a distance between the geographic positioning device and the object with a distance detection unit;

selecting a sight line, vector or axis, both of the geographic positioning device and the object being located along the sight line, vector or axis;

selecting at least one direction vector based on the sight line, vector or axis; and

determining the location based on the position, the distance and the at least one direction vector.

15. The method of Concept 1, further including or comprising:

determining a position associated with a geographic positioning device;

determining a distance between the geographic positioning device and the object with a distance detection unit;

selecting a sight line, vector or axis, both of the geographic positioning device and the object being located along the sight line, vector or axis;

identifying a reference line, vector or axis, the reference line, vector or axis being a horizontal reference line, vector or axis;

determining an angle between the reference line, vector or axis and the sight line, vector or axis, the angle being an azimuth; and

determining the location based on the position, the distance, the angle and the reference line, vector or axis.

16. The method of Concept 15, further including or comprising:

selecting a signal transceiver system configured to transmit and receive signals;

generating a transmission instruction;

routing the transmission instruction to the signal transceiver system so as to cause the signal transceiver system to transmit a signal toward the object at a first point in time, the signal transceiver system receiving the signal at a second point in time;

calculating a time difference between the first and second points in time;

accessing a signal velocity associated with the signal;

multiplying the time difference by the signal velocity to determine a propagation distance; and

dividing the propagation distance in half to determine the distance.

17. The method of Concept 1, further including or comprising:

determining a position associated with a geographic positioning device;

determining a distance between the geographic positioning device and the object with a distance detection unit;

selecting a sight line, vector or axis, both of the geographic positioning device and the object being located along the sight line, vector or axis;

selecting a reference line, vector or axis based on the sight line, vector or axis, the reference line, vector or axis being a horizontal or vertical reference line, vector or axis;

determining an angle between the reference line, vector or axis and the sight line, vector or axis, the angle being an elevation angle; and

determining the location based on the position, the distance, the angle and the reference line, vector or axis.

18. The method of Concept 2, wherein the location database includes or comprises an electronic or magnetic data storage unit.

19. The method of Concept 2, further including or comprising:

accessing course, path or route data identifying a course, path or route associated with the object; and

accessing the location information from the location database based on the location data and the course, path or route data, the predefined area being associated with the location and the course, path or route.

20. The method of Concept 19, further including or comprising:

determining the course, path or route; and

generating the course, path or route data based on the course, path or route.

21. The method of Concept 20, further including or comprising:

determining a position associated with a geographic positioning device;

selecting a first sight line, vector or axis, both of the geographic positioning device and the object being located along the first sight line, vector or axis at a first point in time;

selecting a second sight line, vector or axis, both of the geographic positioning device and the object being located along the second sight line, vector or axis at a second point in time;

determining first and second distances between the geographic positioning device and the object along the first and second sight lines, vectors or axes, respectively;

selecting a first direction vector based on the first sight line, vector or axis;

selecting a second direction vector based on the second sight line, vector or axis;

determining a first location associated with the object based on the position, first distance and first direction vector;

determining a second location associated with the object based on the position, second distance and second direction vector; and

calculating the course, path or route based on the first and second locations.

22. The method of Concept 21, further including or comprising:

determining a position associated with a geographic positioning device;

selecting a first sight line, vector or axis, both of the geographic positioning device and the object being located along the first sight line, vector or axis at a first point in time;

selecting a second sight line, vector or axis, both of the geographic positioning device and the object being located along the second sight line, vector or axis at a second point in time;

determining first and second distances between the geographic positioning device and the object along the first and second sight lines, vectors or axes, respectively;

identifying a reference line, vector or axis, the reference line, vector or axis being a horizontal reference line, vector or axis;

determining a first angle between the first reference line, vector or axis and the first sight line, vector or axis, the first angle being a first azimuth;

determining a first location associated with the object based on the position, first distance and first angle;

determining a second angle between the reference line, vector or axis and the second sight line, vector or axis, the second angle being a second azimuth;

determining a second location associated with the object based on the position, second distance and second angle; and

calculating the course, path or route based on the first and second locations.

23. The method of Concept 22, further including or comprising:

determining first and second positions of a geographic positioning device;

selecting a first sight line, vector or axis, both of the geographic positioning device and the object being located along the first sight line, vector or axis when the geographic positioning device is in the first position;

selecting a second sight line, vector or axis, both of the geographic positioning device and the object being located along the second sight line, vector or axis when the geographic positioning device is in the second position;

determining first and second distances between the geographic positioning device and the object along the first and second sight lines, vectors or axes, respectively;

selecting a first direction vector based on the first sight line, vector or axis;

determining a first location associated with the object based on the position, first distance and first direction vector;

selecting a second direction vector based on the second sight line, vector or axis;

determining a second location associated with the object based on the position, second distance and second direction vector; and

calculating the course, path or route based on the first and second locations.

24. The method of Concept 23, further including or comprising:

determining first and second positions of a geographic positioning device;

selecting a first sight line, vector or axis, both of the geographic positioning device and the object being located along the first sight line, vector or axis when the geographic positioning device is in the first position;

selecting a second sight line, vector or axis, both of the geographic positioning device and the object being located along the second sight line, vector or axis when the geographic positioning device is in the second position;

determining first and second distances between the geographic positioning device and the object along the first and second sight lines, vectors or axes, respectively;

identifying a reference line, vector or axis, the reference line, vector or axis being a horizontal reference line, vector or axis;

determining a first angle between the first reference line, vector or axis and the first sight line, vector or axis, the first angle being a first azimuth;

determining a first location associated with the object based on the first position, first distance and first angle;

determining a second angle between the second reference line, vector or axis and the second sight line, vector or axis, the second angle being a second azimuth;

determining a second location associated with the object based on the second position, second distance and second angle; and

calculating the course, path or route based on the first and second locations.

25. The method of Concept 2, further including or comprising:

accessing real-time information identifying one or more parameters selected from a group of parameters including or comprising a current date, current time, current traffic factor, current road factor, current weather factor and current environmental factor; and

accessing the velocity information based on the one or more parameters.

26. The method of Concept 2, further including or comprising:

accessing speed information from a velocity database based on the location information, the speed information identifying a speed threshold associated with the predefined area;

accessing a tolerance threshold;

adding the tolerance threshold to, or subtracting the tolerance threshold from, the speed threshold to thereby obtain the velocity threshold; and

generating the velocity information based on the velocity threshold.

27. The method of Concept 26, further including or comprising:

calculating the tolerance threshold based on the speed threshold.

28. The method of Concept 26, wherein the velocity database includes or comprises an electronic or magnetic data storage unit.

29. The method of Concept 26, further including or comprising:

accessing real-time information identifying one or more parameters selected from a group of parameters including or comprising a current date, current time, current traffic factor, current road factor, current weather factor and current environmental factor; and

accessing the speed information from the velocity database based on the one or more parameters.

30. The method of Concept 1, further including or comprising:

detecting the motion event based on the velocity being greater than the velocity threshold.

31. The method of Concept 1, further including or comprising:

detecting the motion event based on the velocity being less than the velocity threshold.

32. The method of Concept 1, wherein the velocity threshold is an upper velocity threshold associated with the predefined area, and the comparison being a first comparison between the velocity and the upper velocity threshold, and the method further including or comprising:

conducting the first comparison between the velocity and the upper velocity threshold so as to determine whether the velocity is greater than the upper velocity threshold;

identifying a lower velocity threshold associated with the predefined area;

conducting a second comparison between the velocity and the lower velocity threshold so as to determine whether the velocity is less than the lower velocity threshold; and

detecting the motion event based on the velocity being either greater than the upper velocity threshold or less than the lower velocity threshold.

33. The method of Concept 1, further including or comprising:

determining a difference between the velocity and the velocity threshold;

determining an absolute value of the difference;

comparing the absolute value of the difference to an absolute value of a difference threshold; and

detecting the motion event based on the absolute value of the difference being greater than the absolute value of the difference threshold.

34. The method of Concept 33, further including or comprising:

calculating the difference threshold based on the velocity threshold and a numerical input.

35. The method of Concept 1, further including or comprising:

automatically generating an alarm signal in response to the detecting of the motion event.

36. The method of Concept 1, further including or comprising:

accessing real-time information identifying one or more parameters selected from a group of parameters including or comprising a current date, current time, current traffic factor, current road factor, current weather factor and current environmental factor;

selecting an updated velocity threshold based on the one or more parameters; and

generating updated velocity information identifying the updated velocity threshold.

37. The method of Concept 36, further including or comprising:

routing the updated velocity information to an electronic display unit such that the updated velocity threshold is displayed by the electronic display unit.

38. The method of Concept 36, further including or comprising:

routing the updated velocity information to a velocity database storing the velocity threshold so as to update the velocity threshold based on the updated velocity threshold.

39. The method of Concept 36, further including or comprising:

generating one or more signals including or comprising an authorization key and the updated velocity information; and

routing the one or more signals over a wireless communication network to a gateway communicatively associated with an electronic display unit such that the updated velocity threshold is displayed by the electronic display unit based on the authorization key.

40. The method of Concept 36, further including or comprising:

generating one or more signals including or comprising an authorization key and the updated velocity information; and

routing the one or more signals over a wireless communication network to a gateway so as to access a velocity database storing the velocity threshold based on the authorization key and update the velocity threshold based on the updated velocity threshold.

41. The method of Concept 1, further including or comprising:

identifying a course, path or route associated with the object; and

identifying the predefined area based on the location and the course, path or route.

42. The method of Concept 1, further including or comprising:

accessing real-time information identifying one or more parameters selected from a group of parameters including or comprising a current date, current time, current traffic factor, current road factor, current weather factor and current environmental factor; and

identifying the velocity threshold based on the one or more parameters.

43. The method of Concept 1, further including or comprising:

identifying a speed threshold based on the predefined area;

calculating a tolerance threshold based on the speed threshold; and

adding the tolerance threshold to, or subtracting the tolerance threshold from, the speed threshold to thereby obtain the velocity threshold.

44. The method of Concept 1, further including or comprising:

detecting the motion event based on an absolute value of a difference between the velocity and the velocity threshold being greater than an absolute value of a preselected margin.

45. The method of Concept 1, wherein the velocity threshold is an upper velocity threshold associated with the predefined area, the method further including or comprising:

determining a first difference between the velocity and the upper velocity threshold and a second difference between the velocity and a lower velocity threshold associated with the predefined area;

determining that the velocity is either greater than the upper velocity threshold or less than the lower velocity threshold;

determining first and second absolute values of the first and second differences, respectively;

selecting a lowest absolute value from among the first and second absolute values so as to output a selected absolute value;

comparing the selected absolute value to an absolute value of a selected difference threshold; and

detecting the motion event based on the selected absolute value being greater than the absolute value of the selected difference threshold.

46. A computer-readable medium storing a set of instructions that when executed cause a computer system to perform a method as recited in any one of the preceding Concepts.

II. Second Exemplary Concept Group

1. A method of motion event detection including or comprising:

accessing velocity data identifying a velocity associated with an object;

accessing location data identifying a location associated with the object;

accessing location information from a location database based on the location data, the location information identifying a predefined area associated with the location;

accessing velocity information based on the location information, the velocity information identifying a velocity threshold associated with the predefined area;

forwarding the velocity data and the velocity information to an electronic difference engine to determine a difference between the velocity and the velocity threshold; and

detecting a motion event based on the difference.

2. The method of Concept 1, further including or comprising:

detecting the motion event based on an absolute value of the difference being greater than an absolute value of a preselected margin.

3. The method of Concept 1, further including or comprising:

determining the velocity and location; and

generating the velocity data and the location data based on the velocity and location, respectively.

4. The method of Concept 1, further including or comprising:

identifying the predefined area based on the location; and

generating the location information based on the predefined area.

5. The method of Concept 1, further including or comprising:

identifying the velocity threshold based on the predefined area; and

generating the velocity information based on the velocity threshold.

6. The method of Concept 1, wherein the velocity threshold is an upper velocity threshold associated with the predefined area, the velocity information identifying the upper velocity threshold and a lower velocity threshold associated with the predefined area, and the method further including or comprising:

identifying the upper and lower velocity thresholds based on the predefined area; and

generating the velocity information based on the upper and lower velocity thresholds.

7. The method of Concept 1, further including or comprising:

selecting a signal transceiver system configured to transmit and receive signals;

generating a transmission instruction;

routing the transmission instruction to the signal transceiver system so as to cause the signal transceiver system to transmit a signal toward the object at a first point in time, the signal transceiver system receiving the signal at a second point in time, and the signal having first and second frequencies at the first and second points in time, respectively;

identifying the first and second frequencies;

calculating a Doppler shift between the first and second frequencies; and

calculating the velocity based on the Doppler shift.

8. The method of Concept 1, further including or comprising:

selecting a signal transceiver system configured to transmit and receive signals;

generating a transmission instruction;

routing the transmission instruction to the signal transceiver system so as to cause the signal transceiver system to transmit first and second signals toward the object at first and third points in time, respectively, the signal transceiver system receiving the first and second signals at second and fourth points in time, respectively;

identifying the first, second, third and fourth points in time;

calculating a first time difference between the first and second points in time and a second time difference between the third and fourth points in time;

identifying a signal velocity associated with the first signal and a signal velocity associated with the second signal;

multiplying the first time difference by the signal velocity associated with the first signal to determine a first propagation distance;

multiplying the second time difference by the signal velocity associated with the second signal to determine a second propagation distance;

dividing each of the first and second propagation distances in half to determine first and second distances, respectively;

calculating a third time difference between one of the first and second points in time and one of the third or fourth points in time;

selecting a first sight line, vector or axis, both of the signal transceiver and the object being located along the first sight line, vector or axis at the first or second points in time;

selecting a second sight line, vector or axis, both of the signal transceiver and the object being located along the second sight line, vector or axis at the third or fourth points in time;

calculating an angle between the first and second sight lines, vectors or axes; and

calculating the velocity based on the first distance, the second distance, the angle and the third time difference.

9. The method of Concept 1, further including or comprising:

determining a position associated with a geographic positioning device;

determining a distance between the geographic positioning device and the object with a distance detection unit;

selecting a sight line, vector or axis, both of the geographic positioning device and the object being located along the sight line, vector or axis;

selecting at least one direction vector based on the sight line, vector or axis; and

determining the location based on the position, the distance and the at least one direction vector.

10. The method of Concept 1, further including or comprising:

determining a position associated with a geographic positioning device;

determining a distance between the geographic positioning device and the object with a distance detection unit;

selecting a sight line, vector or axis, both of the geographic positioning device and the object being located along the sight line, vector or axis;

identifying a reference line, vector or axis, the reference line, vector or axis being a horizontal reference line, vector or axis;

determining an angle between the reference line, vector or axis and the sight line, vector or axis, the angle being an azimuth; and

determining the location based on the position, the distance, the angle and the reference line, vector or axis.

11. The method of Concept 10, further including or comprising:

selecting a signal transceiver system configured to transmit and receive signals;

generating a transmission instruction;

routing the transmission instruction to the signal transceiver system so as to cause the signal transceiver system to transmit a signal toward the object at a first point in time, the signal transceiver system receiving the signal at a second point in time;

calculating a time difference between the first and second points in time;

accessing a signal velocity associated with the signal;

multiplying the time difference by the signal velocity to determine a propagation distance; and

dividing the propagation distance in half to determine the distance.

12. The method of Concept 1, further including or comprising:

determining a position associated with a geographic positioning device;

determining a distance between the geographic positioning device and the object with a distance detection unit;

selecting a sight line, vector or axis, both of the geographic positioning device and the object being located along the sight line, vector or axis;

selecting a reference line, vector or axis based on the sight line, vector or axis, the reference line, vector or axis being a horizontal or vertical reference line, vector or axis;

determining an angle between the reference line, vector or axis and the sight line, vector maxis, the angle being an elevation angle; and

determining the location based on the position, the distance, the angle and the reference line, vector or axis.

13. The method of Concept 1, wherein the location database includes or comprises an electronic or magnetic data storage unit.

14. The method of Concept 1, further including or comprising:

accessing course, path or route data identifying a course, path or route associated with the object; and

accessing the location information from the location database based on the location data and the course, path or route data, the predefined area being associated with the location and the course, path or route.

15. The method of Concept 14, further including or comprising:

determining the course, path or route; and

generating the course, path or route data based on the course, path or route.

16. The method of Concept 15, further including or comprising:

determining a position associated with a geographic positioning device;

selecting a first sight line, vector or axis, both of the geographic positioning device and the object being located along the first sight line, vector or axis at a first point in time;

selecting a second sight line, vector or axis, both of the geographic positioning device and the object being located along the second sight line, vector or axis at a second point in time;

determining first and second distances between the geographic positioning device and the object along the first and second sight lines, vectors or axes, respectively;

selecting a first direction vector based on the first sight line, vector or axis;

selecting a second direction vector based on the second sight line, vector or axis;

determining a first location associated with the object based on the position, first distance and first direction vector;

determining a second location associated with the object based on the position, second distance and second direction vector; and

calculating the course, path or route based on the first and second locations.

17. The method of Concept 16, further including or comprising: determining a position associated with a geographic positioning device;

selecting a first sight line, vector or axis, both of the geographic positioning device and the object being located along the first sight line, vector or axis at a first point in time;

selecting a second sight line, vector or axis, both of the geographic positioning device and the object being located along the second sight line, vector or axis at a second point in time;

determining first and second distances between the geographic positioning device and the object along the first and second sight lines, vectors or axes, respectively;

identifying a reference line, vector or axis, the reference line, vector or axis being a horizontal reference line, vector or axis;

determining a first angle between the first reference line, vector or axis and the first sight line, vector or axis, the first angle being a first azimuth;

determining a first location associated with the object based on the position, first distance and first angle;

determining a second angle between the reference line, vector or axis and the second sight line, vector or axis, the second angle being a second azimuth;

determining a second location associated with the object based on the position, second distance and second angle; and

calculating the course, path or route based on the first and second locations.

18. The method of Concept 17, further including or comprising:

determining first and second positions of a geographic positioning device;

selecting a first sight line, vector or axis, both of the geographic positioning device and the object being located along the first sight line, vector or axis when the geographic positioning device is in the first position;

selecting a second sight line, vector or axis, both of the geographic positioning device and the object being located along the second sight line, vector or axis when the geographic positioning device is in the second position;

determining first and second distances between the geographic positioning device and the object along the first and second sight lines, vectors or axes, respectively;

selecting a first direction vector based on the first sight line, vector or axis;

determining a first location associated with the object based on the position, first distance and first direction vector;

selecting a second direction vector based on the second sight line, vector or axis;

determining a second location associated with the object based on the position, second distance and second direction vector; and

calculating the course, path or route based on the first and second locations.

19. The method of Concept 18, further including or comprising:

determining first and second positions of a geographic positioning device;

selecting a first sight line, vector or axis, both of the geographic positioning device and the object being located along the first sight line, vector or axis when the geographic positioning device is in the first position;

selecting a second sight line, vector or axis, both of the geographic positioning device and the object being located along the second sight line, vector or axis when the geographic positioning device is in the second position;

determining first and second distances between the geographic positioning device and the object along the first and second sight lines, vectors or axes, respectively;

identifying a reference line, vector or axis, the reference line, vector or axis being a horizontal reference line, vector or axis;

determining a first angle between the first reference line, vector or axis and the first sight line, vector or axis, the first angle being a first azimuth;

determining a first location associated with the object based on the first position, first distance and first angle;

determining a second angle between the second reference line, vector or axis and the second sight line, vector or axis, the second angle being a second azimuth;

determining a second location associated with the object based on the second position, second distance and second angle; and

calculating the course, path or route based on the first and second locations.

20. The method of Concept 1, further including or comprising:

accessing real-time information identifying one or more parameters selected from a group of parameters including or comprising a current date, current time, current traffic factor, current road factor, current weather factor and current environmental factor; and

accessing the velocity information based on the one or more parameters.

21. The method of Concept 1, further including or comprising:

accessing speed information from a velocity database based on the location information, the speed information identifying a speed threshold associated with the predefined area;

accessing a tolerance threshold;

adding the tolerance threshold to, or subtracting the tolerance threshold from, the speed threshold to thereby obtain the velocity threshold; and

generating the velocity information based on the velocity threshold.

22. The method of Concept 21, further including or comprising:

calculating the tolerance threshold based on the speed threshold.

23. The method of Concept 22, wherein the velocity database includes or comprises an electronic or magnetic data storage unit.

24. The method of Concept 23, further including or comprising:

accessing real-time information identifying one or more parameters selected from a group of parameters including or comprising a current date, current time, current traffic factor, current road factor, current weather factor and current environmental factor; and

accessing the speed information from the velocity database based on the one or more parameters.

25. The method of Concept 1, further including or comprising:

detecting the motion event based on the velocity being greater than the velocity threshold.

26. The method of Concept 1, further including or comprising:

detecting the motion event based on the velocity being less than the velocity threshold.

27. The method of Concept 1, wherein the velocity threshold is an upper velocity threshold associated with the predefined area, the velocity information identifying the upper velocity threshold and a lower velocity threshold associated with the predefined area, and the method further including or comprising:

conducting a first comparison between the velocity and the upper velocity threshold so as to determine whether the velocity is greater than the upper velocity threshold;

conducting a second comparison between the velocity and the lower velocity threshold so as to determine whether the velocity is less than the lower velocity threshold; and

detecting the motion event based on the velocity being either greater than the upper velocity threshold or less than the lower velocity threshold.

28. The method of Concept 1, further including or comprising: determining an absolute value of the difference;

comparing the absolute value of the difference to an absolute value of a difference threshold; and

detecting the motion event based on the absolute value of the difference being greater than the absolute value of the difference threshold.

29. The method of Concept 28, further including or comprising:

calculating the difference threshold based on the velocity threshold and a numerical input.

30. The method of Concept 1, wherein the velocity threshold is an upper velocity threshold associated with the predefined area, the velocity information identifying the upper velocity threshold and a lower velocity threshold associated with the predefined area, the difference being a first difference between the velocity and the upper velocity threshold, and the method further including or comprising:

forwarding the velocity data and the velocity information to the electronic difference engine to determine the first difference and a second difference between the velocity and the tower velocity threshold.

31. The method of Concept 30, further including or comprising:

determining that the velocity is either greater than the upper velocity threshold or less than the lower velocity threshold;

selecting a difference from among the first and second differences so as to output a selected difference; and

detecting the motion event based on the selected difference.

32. The method of Concept 30, further including or comprising:

determining that the velocity is either greater than the upper velocity threshold or less than the lower velocity threshold;

determining first and second absolute values of the first and second differences, respectively;

selecting a lowest absolute value from among the first and second absolute values so as to output a selected absolute value;

comparing the selected absolute value to an absolute value of a selected difference threshold; and

detecting the motion event based on the selected absolute value being greater than the absolute value of the selected difference threshold.

33. The method of Concept 32, further including or comprising: selecting either a first register value if the first absolute value is the lowest absolute value or a second register value if the second absolute value is the lowest absolute value to generate a selected register value;

storing the selected register value in a register;

calculating first and second difference thresholds based on the upper and lower velocity thresholds, respectively; and

selecting one of the first and second difference thresholds based on the selected register value so as to output the selected difference threshold.

34. The method of Concept 1, further including or comprising:

automatically generating an alarm signal in response to the detecting of the motion event.

35. The method of Concept 1, further including or comprising:

accessing real-time information identifying one or more parameters selected from a group of parameters including or comprising a current date, current time, current traffic factor, current road factor, current weather factor and current environmental factor;

selecting an updated velocity threshold based on the one or more parameters; and

generating updated velocity information identifying the updated velocity threshold.

36. The method of Concept 35, further including or comprising:

routing the updated velocity information to an electronic display unit such that the updated velocity threshold is displayed by the electronic display unit.

37. The method of Concept 35, further including or comprising:

routing the updated velocity information to a velocity database storing the velocity threshold so as to update the velocity threshold based on the updated velocity threshold.

38. The method of Concept 35, further including or comprising:

generating one or more signals including or comprising an authorization key and the updated velocity information; and

routing the one or more signals over a wireless communication network to a gateway associated with an electronic display unit such that the updated velocity threshold is displayed by the electronic display unit based on the authorization key.

39. The method of Concept 35, further including or comprising:

generating one or more signals including or comprising an authorization key and the updated velocity information; and

routing the one or more signals over a wireless communication network to a gateway so as to access a velocity database storing the velocity threshold based on the authorization key and update the velocity threshold based on the updated velocity threshold.

40. A computer-readable medium storing a set of instructions that when executed cause a computer system to perform a method as recited in any one of the preceding Concepts.

III. Third Exemplary Concept Group

1. A motion event detection system including or comprising:

a velocity identification module configured to identify a velocity associated with an object;

a location identification module configured to identify a location associated with the object;

an area identification module communicatively associated with the location identification module, the area identification module configured to identify a predefined area associated with the location;

a threshold identification module communicatively associated with the area identification module, the threshold identification module configured to identify a velocity threshold associated with the predefined area;

a comparator communicatively associated with the velocity and threshold identification modules, the comparator configured to conduct a comparison between the velocity and the velocity threshold; and

a detection module communicatively associated with the comparator, the detection module configured to detect a motion event based on the comparison.

2. The motion event detection system of Concept 1, further including or comprising:

a signal transceiver system configured to transmit and receive signals;

an instruction generator configured to generate a transmission instruction;

a router communicatively associated with the signal transceiver system and the instruction generator, the router configured to route the transmission instruction to the signal transceiver system so as to cause the signal transceiver system to transmit a signal toward the object at a first point in time, the signal transceiver system receiving the signal at a second point in time, and the signal having first and second frequencies at the first and second points in time, respectively;

a frequency identification module communicatively associated with the signal transceiver system, the frequency identification module configured to identify the first and second frequencies;

a shift calculator communicatively associated with the frequency identification module, the shift calculator configured to calculate a Doppler shift between the first and second frequencies; and

a velocity calculator communicatively associated with the shift calculator, the velocity calculator configured to calculate the velocity based on the Doppler shift.

3. The motion event detection system of Concept 1, further including or comprising:

a signal transceiver system configured to transmit and receive signals;

an instruction generator configured to generate a transmission instruction;

a router communicatively associated with the signal transceiver system and the instruction generator, the router configured to route the transmission instruction to the signal transceiver system so as to cause the signal transceiver system to transmit first and second signals toward the object at first and third points in time, respectively, the signal transceiver system receiving the first and second signals at second and fourth points in time, respectively;

a time identification module communicatively associated with the signal transceiver system, the time identification module configured to identify the first, second, third and fourth points in time;

a time difference calculator communicatively associated with the time identification module, the time difference calculator configured to calculate a first time difference between the first and second points in time, a second time difference between the third and fourth points in lime, and a third time difference between one of the first and second points in time and one of the third or fourth points in time;

a signal velocity identification module communicatively associated with the signal transceiver system, the signal velocity identification module configured to identify a signal velocity associated with the first signal and a signal velocity associated with the second signal;

a multiplier communicatively associated with the time difference calculator and the signal velocity identification module, the multiplier configured to multiply the first time difference by the signal velocity associated with the first signal to determine a first propagation distance, and multiply the second time difference by the signal velocity associated with the second signal to determine a second propagation distance;

a divider communicatively associated with the multiplier, the divider configured to divide each of the first and second propagation distances in half to determine first and second distances, respectively;

a sight selection module communicatively associated with the signal transceiver system, the sight selection module configured to select first and second sight lines, vectors or axes, both of the signal transceiver and the object being located along the first sight line, vector or axis at the first or second points in time, and both of the signal transceiver system and the object being located along the second sight line, vector or axis at the third or fourth points in time;

an angle calculator communicatively associated with the sight selection module, the angle calculator configured to calculate an angle between the first and second sight lines, vectors or axes; and

a velocity calculator communicatively associated with the divider, the angle calculator and the time difference calculator, the velocity calculator configured to calculate the velocity based on the first distance, the second distance, the angle and the third time difference.

4. The motion event detection system of Concept 1, further including or comprising:

a geographic positioning device configured to determine a position associated with the geographic positioning device;

a distance determination module communicatively associated with the geographic positioning device, the distance determination module configured to determine a distance between the geographic positioning device and the object;

a sight selection module communicatively associated with the geographic positioning device, the sight selection module configured to select a sight line, vector or axis, both of the geographic positioning device and the object being located along the sight line, vector or axis;

a vector selection module communicatively associated with the sight selection module, the vector selection module configured to select at least one direction vector based on the sight line, vector or axis; and

a location determination module communicatively associated with the geographic positioning device, the distance determination module and the vector selection module, the location determination module configured to determine the location based on the position, the distance and the at least one direction vector.

3. The motion event detection system of Concept 1, further including or comprising:

a geographic positioning device configured to determine a position associated with the geographic positioning device;

a distance determination module communicatively associated with the geographic positioning device, the distance determination module configured to determine a distance between the geographic positioning device and the object;

a sight selection module communicatively associated with the geographic positioning device, the sight selection module configured to select a sight line, vector or axis, both of the geographic positioning device and the object being located along the sight line, vector or axis;

a reference selection module configured to identify a reference line, vector or axis, the reference line, vector or axis being a horizontal reference line, vector or axis;

an angle determination module communicatively associated with the reference selection module and the sight selection module, the angle determination module configured to determine an angle between the reference line, vector or axis and the sight line, vector or axis, the angle being an azimuth; and

a location determination module communicatively associated with the geographic positioning device, the distance determination module, the angle determination module and the reference selection module, the location determination module Configured to determine the location based on the position, the distance, the angle and the reference line, vector or axis.

6. The motion event detection system of Concept 5, further including or comprising:

a signal transceiver system configured to transmit and receive signals;

an instruction generator configured to generate a transmission instruction;

a router communicatively associated with the signal transceiver system and the instruction generator, the router configured to route the transmission instruction to the signal transceiver system so as to cause the signal transceiver system to transmit a signal toward the object at a first point in time, the signal transceiver system receiving the signal at a second point in time;

a time identification module communicatively associated with the signal transceiver system, the time identification module configured to identify the first and second points in time;

a time difference calculator communicatively associated with the time identification module, the time difference calculator configured to calculate a time difference between the first and second points in time;

a signal velocity identification module communicatively associated with the signal transceiver system, the signal velocity identification module configured to identify a signal velocity associated with the signal;

a multiplier communicatively associated with the time difference calculator and the signal velocity identification module, the multiplier configured to multiply the time difference by the signal velocity to determine a propagation distance; and

a divider communicatively associated with the multiplier, the divider configured to divide the propagation distance in half to determine the distance.

7. The motion event detection system of Concept 1, further including or comprising:

a geographic positioning device configured to determine a position associated with the geographic positioning device;

a distance determination module communicatively associated with the geographic positioning device, the distance determination module configured to determine a distance between the geographic positioning device and the object;

a sight selection module communicatively associated with the geographic positioning device, the sight selection module configured to select a sight line, vector or axis, both of the geographic positioning device and the object being located along the sight line, vector or axis;

a reference selection module communicatively associated with the sight selection module, the reference selection module configured to select a reference line, vector or axis based on the sight line, vector or axis, the reference line, vector or axis being a horizontal or vertical reference line, vector or axis;

an angle determination module communicatively associated with the reference selection module and the sight selection module, the angle determination module configured to determine an angle between the reference line, vector or axis and the sight line, vector or axis, the angle being an elevation angle; and

a location determination module communicatively associated with the geographic positioning device, the distance determination module, the angle determination module and the reference selection module, the location determination module configured to determine the location based on the position, the distance, the angle and the reference line, vector or axis.

8. The motion event detection system of Concept 1, further including or comprising:

a velocity data storage unit storing velocity data identifying the velocity;

a location data storage unit storing location data identifying the location;

a location database storing location information identifying the predefined area;

a velocity database storing velocity information identifying the velocity threshold; and

a data accessing module communicatively associated with the velocity and location data storage units and the velocity and location databases; the data accessing module configured to access the velocity data, the location data, the location information and the velocity information.

9. The motion event detection system of Concept 8, wherein the location database includes or comprises an electronic or magnetic data storage unit.

10. The motion event detection system of Concept 8, further including or comprising:

a velocity determination module communicatively associated with the velocity identification module, the velocity determination module configured to determine the velocity; and

a velocity data generation module communicatively associated with the velocity determination module, the velocity data generation module configured to generate the velocity data based on the velocity.

11. The motion event detection system of Concept 8, further including or comprising:

a location determination module communicatively associated with the location identification module, the location determination module configured to determine the location; and

a location data generation module communicatively associated with the location determination module, the location data generation module configured to generate the location data based on the location.

12. The motion event detection system of Concept 8, wherein the area identification module is configured to identify the predefined area based on the location, the system further including or comprising:

a location information generation module communicatively associated with the area identification module, the location information generation module configured to generate the location information based on the predefined area.

13. The motion event detection system of Concept 8, wherein the threshold identification module is configured to identify the velocity threshold based on the predefined area, the system further including or comprising:

a velocity information generation module communicatively associated with the threshold identification module, the velocity information generation module configured to generate the velocity information based on the velocity threshold.

14. The motion event detection system of Concept 8, wherein the velocity threshold is an upper velocity threshold associated with the predefined area, the velocity information identifying the upper velocity threshold and a lower velocity threshold associated with the predefined area, the threshold identification module being configured to identify the upper and lower velocity thresholds based on the predefined area, and the system further including or comprising:

a velocity information generation module communicatively associated with the threshold identification module, the velocity information generation module configured to generate the velocity information based on the upper and lower velocity thresholds.

15. The motion event detection system of Concept 8, further including or comprising:

an access key storage unit storing an access key;

a server communicatively associated with the location database, the server configured to receive an information request including or comprising the access key and location data, access the location information in response to the information request and based on the access key and location data, and forward the location information to a destination associated with the information request,

the data accessing module being communicatively associated with the server and the access key storage unit, the data accessing module configured to access the access key, generate the information request, forward the information request to the server, receive the location information from the server in response to the information request and based on the access key and location data, and access the velocity information based on the location information, the predefined area being associated with the location; and

an electronic difference engine communicatively associated with the data accessing module, the electronic difference engine configured to receive the velocity data and the velocity information and determine a difference between the velocity and the velocity threshold, the detection module being communicatively associated with the electronic difference engine and configured to detect the motion event based on the difference.

16. The motion event detection system of Concept 15, wherein the detection module is configured to detect the motion event based on an absolute value of the difference being greater than an absolute value of a preselected margin.

17. The motion event detection system of Concept 15, further including or comprising:

a course, path or route data storage unit storing course, path or route data identifying a course, path or route associated with the object, the data accessing module being communicatively associated with the course, path or route data storage unit, and the data accessing module being configured to access the course, path or route data, generate the information request such that the information request includes or comprises the course, path or route data, forward the information request to the server, receive the location information from the server in response to the information request and based on the access key, location information and course, path or route data, the predefined area being associated with the location and the course, path or route.

18. The motion event detection system of Concept 17, further including or comprising:

a course, path or route determination module configured to determine the course, path or route; and

a course, path or route data generation module communicatively associated with the data accessing module and the course, path or route determination module, the course, path or route data generation module configured to generate the course, path or route data based on the course, path or route.

19. The motion event detection system of Concept 17, further including or comprising:

a geographic positioning device configured to determine a position associated with the geographic positioning device;

a sight selection module communicatively associated with the geographic positioning device, the sight selection module configured to select first and second sight lines, vectors or axes, both of the geographic positioning device and the object being located along the first and second sight lines, vectors or axes at first and second points in time, respectively;

a distance determination module communicatively associated with the geographic positioning device and the sight selection module, the distance determination module configured to determine first and second distances between the geographic positioning device and the object along the first and second sight lines, vectors or axes, respectively;

a vector selection module communicatively associated with the sight selection module, the vector selection module configured to select first and second direction vectors based on the first and second sight lines, vectors or axes, respectively;

a location determination module communicatively associated with the geographic positioning device, the distance determination module and the vector selection module, the location determination module configured to determine a first location associated with the object based on the position, first distance and first direction vector and determine a second location associated with the object based on the position, second distance and second direction vector; and

a course, path or route calculator communicatively associated with the location determination module, the course, path or route calculator configured to calculate the course, path or route based on the first and second locations.

20. The motion event detection system of Concept 17, further including or comprising:

a geographic positioning device configured to determine a position associated with the geographic positioning device;

a sight selection module communicatively associated with the geographic positioning device, the sight selection module configured to select first and second sight lines, vectors or axes, both of the geographic positioning device and the object being located along the first and second sight lines, vectors or axes at first and second points in time, respectively;

a distance determination module communicatively associated with the geographic positioning device and the sight selection module, the distance determination module configured to determine first and second distances between the geographic positioning device and the object along the first and second sight lines, vectors or axes, respectively;

a reference selection module configured to identify a reference line, vector or axis, the reference line, vector or axis being a horizontal reference line, vector or axis;

an angle determination module communicatively associated with the reference selection module and the sight selection module, the angle determination module configured to determine a first angle between the reference line, vector or axis and the first sight line, vector or axis and determine a second angle between the reference line, vector or axis and the second sight line, vector or axis, the first and second angles being first and second azimuths, respectively;

a location determination module communicatively associated with the geographic positioning device, the distance determination module and the angle determination module, the location determination module configured to determine a first location associated with the object based on the position, first distance and first angle and determine a second location associated with the object based on the position, second distance and second angle; and

a course, path or route calculator communicatively associated with the location determination module, the course, path or route calculator configured to calculate the course, path or route based on the first and second locations.

21. The motion event detection system of Concept 17, further including or comprising:

a geographic positioning device configured to determine first and second positions of the geographic positioning device;

a sight selection module communicatively associated with the geographic positioning device, the sight selection module configured to select first and second sight lines, vectors or axes, both of the geographic positioning device and the object being located along the first and second sight lines, vectors or axes when the geographic positioning device is in the first and second positions, respectively;

a distance determination module communicatively associated with the geographic positioning device and the sight selection module, the distance determination module configured first and second distances between the geographic positioning device and the object along the first and second sight lines, vectors or axes, respectively;

a vector selection module communicatively associated with the sight selection module, the vector selection module configured to select first and second direction vectors based on the first and second sight lines, vectors or axes, respectively;

a location determination module communicatively associated with the geographic positioning device, the distance determination module and the vector selection module, the location determination module configured to determine a first location associated with the object based on the first position, first distance and first direction vector and determine a second location associated with the object based on the second position, second distance and second direction vector; and

a course, path or route calculator communicatively associated with the location determination module, the course, path or route calculator configured to calculate the course, path or route based on the first and second locations.

22. The motion event detection system of Concept 17, further including or comprising:

a geographic positioning device configured to determine first and second positions of the geographic positioning device;

a sight selection module communicatively associated with the geographic positioning device, the sight selection module configured to select first and second sight lines, vectors or axes, both of the geographic positioning device and the object being located along the first and second sight lines, vectors or axes when the geographic positioning device is in the first and second positions, respectively;

a distance determination module communicatively associated with the geographic positioning device and the sight selection module, the distance determination module configured to determine first and second distances between the geographic positioning device and the object along the first and second sight lines, vectors or axes, respectively;

a reference selection module configured to identify a reference line, vector or axis, the reference line, vector or axis being a horizontal reference line, vector or axis;

an angle determination module communicatively associated with the reference selection module and the sight selection module, the angle determination module configured to determine a first angle between the reference line, vector or axis and the first sight line, vector or axis and determine a second angle between the reference line, vector or axis and the second sight line, vector or axis, the first and second angles being first and second azimuths, respectively;

a location determination module communicatively associated with the geographic positioning device, the distance determination module and the angle determination module, the location determination module configured to determine a first location associated with the object based on the first position, first distance and first angle and determine a second location associated with the object based on the second position, second distance and second angle; and

a course, path or route calculator communicatively associated with the location determination module, the course, path or route calculator configured to calculate the course, path or route based on the first and second locations.

23. The motion event detection system of Concept 15, further including or comprising:

an information collection module configured to collect real-time information identifying one or more parameters selected from a group of parameters including or comprising a current date, current time, current traffic factor, current road factor, current weather factor and current environmental factor, the data accessing module being communicatively associated with the information collection module, and the data accessing module being configured to access the real-time information and access the velocity information based on the one or more parameters.

24. The motion event detection system of Concept 23, further including or comprising:

a velocity threshold selection module communicatively associated with the data accessing module, the velocity threshold selection module configured to receive the real-time information and select an updated velocity threshold based on the one or more parameters; and

an information generator communicatively associated with the velocity threshold selection module, the information generator configured to generate updated velocity information identifying the updated velocity threshold.

25. The motion event detection system of Concept 24, further including or comprising:

an electronic display unit configured to receive electronic information and generate a visual display based on the electronic information; and

a router communicatively associated with the information generator and the electronic display unit, the router configured to receive the updated velocity information and route the updated velocity information to the electronic display unit such that the updated velocity threshold is displayed by the electronic display unit.

26. The motion event detection system of Concept 24, further including or comprising:

a router communicatively associated with the information generator and the velocity database, the router configured to receive the updated velocity information and route the updated velocity information to the velocity database such that the velocity database stores the updated velocity information to thereby update the velocity threshold to reflect the updated velocity threshold.

27. The motion event detection system of Concept 24, further including or comprising:

an electronic display unit configured to receive electronic information and generate a visual display based on the electronic information;

a gateway communicatively associated with the electronic display unit, the gateway configured to receive a communication including or comprising the electronic information and an authorization key and forward the electronic information to the electronic display unit based on the authorization key;

a signal generator communicatively associated with the information generator, the signal generator configured to generate one or more signals including or comprising the authorization key and the updated velocity information;

a router communicatively associated with the signal generator and the gateway, the router configured to route the one or more signals over a wireless communication network to the gateway such that the gateway receives the one or more signals and, based on the authorization key, forwards the updated velocity information to the electronic display unit such that the updated velocity threshold is displayed by the electronic display unit.

28. The motion event detection system of Concept 24, further including or comprising:

a gateway communicatively associated with the velocity database, the gateway configured to receive a communication including or comprising an authorization key and update the velocity threshold in response to the communication and based on the authorization key;

a signal generator communicatively associated with the information generator, the signal generator configured to generate one or more signals including or comprising an authorization key and the updated velocity information; and

a router communicatively associated with the signal generator and the gateway, the router configured to route the one or more signals over a wireless communication network to the gateway such that the gateway receives the one or more signals and, based on the authorization key, stores the updated velocity information in the velocity database to thereby update the velocity threshold to reflect the updated velocity threshold.

29. The motion event detection system of Concept 15, further including or comprising:

a speed threshold database storing speed information identifying a speed threshold associated with the predefined area;

a tolerance threshold database storing a tolerance threshold, the data accessing module being communicatively associated with the speed and tolerance threshold databases, and the data accessing module being configured to access the speed information based on the location information and access the tolerance threshold; and

a velocity information generation module communicatively associated with the data accessing module, the velocity information generation module configured to receive the speed information and the tolerance threshold, add the tolerance threshold to, or subtract the tolerance threshold from, the speed threshold to thereby obtain the velocity threshold, and generate the velocity information based on the velocity threshold.

30. The motion event detection system of Concept 29, further including or comprising:

a tolerance threshold calculator communicatively associated with the data accessing module, the tolerance threshold calculator configured to calculate the tolerance threshold based on the speed threshold.

31. The motion event detection system of Concept 29, wherein the speed threshold database includes or comprises an electronic or magnetic data storage unit.

32. The motion event detection system of Concept 29, further including or comprising:

an information collection module configured to collect real-time information identifying one or more parameters selected from a group of parameters including or comprising a current date, current time, current traffic factor, current road factor, current weather factor and current environmental factor, the data accessing module being communicatively associated with the information collection module, and the data accessing module being configured to access the real-time information and access the speed information from the speed threshold database based on the one or more parameters.

33. The motion event detection system of Concept 1, wherein the detection module is configured to detect the motion event based on the velocity being greater than the velocity threshold.

34. The motion event detection system of Concept 1, wherein the detection module is configured to detect the motion event based on the velocity being less than the velocity threshold.

35. The motion event detection system of Concept 1, wherein the velocity threshold is an upper velocity threshold associated with the predefined area, the threshold identification module being further configured to identify a lower velocity threshold associated with the predefined area, the comparison being a first comparison between the velocity and the upper velocity threshold, the comparator being a first comparator unit configured to conduct the first comparison so as to determine whether the velocity is greater than the upper velocity threshold, and the system further including or comprising:

a second comparator unit communicatively associated with the threshold identification module, the second comparator unit configured to conduct a second comparison, the second comparison being a comparison between the velocity and the lower velocity threshold, so as to determine whether the velocity is less than the lower velocity threshold, and the detection module being communicatively associated with second comparator unit and further configured to detect the motion event based on the velocity being either greater than the upper velocity threshold or less than the lower velocity threshold.

36. The motion event detection system of Concept 1, further including or comprising:

a velocity data storage unit storing velocity data identifying the velocity;

a velocity database storing velocity information identifying the velocity threshold; and

an electronic difference engine communicatively associated with the velocity data storage unit and the velocity database, the electronic difference engine configured to receive the velocity data and the velocity information and determine a difference between the velocity and the velocity threshold, the detection module being communicatively associated with the electronic difference engine and configured to detect the motion event based on the difference.

37. The motion event detection system of Concept 36, wherein the detection module is configured to detect the motion event based on an absolute value of the difference being greater than an absolute value of a preselected margin.

38. The motion event detection system of Concept 36, further including or comprising:

an absolute value determination module communicatively associated with the electronic difference engine, the absolute value determination module configured to determine an absolute value of the difference, the comparator being communicatively associated with the absolute value determination module and configured to compare the absolute value of the difference to an absolute value of a difference threshold so as to generate a comparison, and the detection module being communicatively associated with the comparator and configured to detect the motion event in response to the comparison reflecting that the absolute value of the difference is greater than the absolute value of the difference threshold.

39. The motion event detection system of Concept 38, further including or comprising:

a calculator communicatively associated with the comparator and the threshold identification module, the calculator configured to calculate the difference threshold based on the velocity threshold and a numerical input.

40. The motion event detection system of Concept 1, wherein the velocity threshold is an upper velocity threshold associated with the predefined area, the threshold identification module being further configured to identify a lower velocity threshold associated with the predefined area, and the system further including or comprising:

a velocity data storage unit storing velocity data identifying the velocity;

a velocity database storing velocity information identifying the upper and lower velocity thresholds;

an electronic difference engine communicatively associated with the velocity data storage unit and the velocity database, the electronic difference engine configured to receive the velocity data and the velocity information, determine a first difference between the velocity and the upper velocity threshold, and determine a second difference between the velocity and the lower velocity threshold; and

a range analysis module communicatively associated with the electronic difference engine, the range analysis module configured to determine that the velocity is either greater than the upper velocity threshold or less than the lower velocity threshold.

41. The motion event detection system of Concept 40, further including or comprising:

a difference selection module communicatively associated with the electronic difference engine, the difference selection module configured to select a difference from among the first and second differences so as to output a selected difference, the detection module being communicatively associated with the difference selection module, and the detection module configured to detect the motion event based on the selected difference.

42. The motion event detection system of Concept 40, further including or comprising:

an absolute value determination module communicatively associated with the electronic difference engine, the absolute value determination module configured to determine first and second absolute values of the first and second differences, respectively; and

an absolute value selection module communicatively associated with the absolute value determination module, the absolute value selection module configured to select a lowest absolute value from among the first and second absolute values so as to output a selected absolute value, the comparator being communicatively associated with the absolute value selection module and configured to compare the selected absolute value to an absolute value of a selected difference threshold so as to generate a comparison, and the detection module being communicatively associated with the comparator and configured to detect the motion event in response to the comparison reflecting that the selected absolute value is greater than the absolute value of the selected difference threshold.

43. The motion event detection system of Concept 42, further including or comprising:

a register value selection module communicatively associated with the absolute value selection module, the register value selection module configured to select either a first register value if the first absolute value is the lowest absolute value or a second register value if the second absolute value is the lowest absolute value to generate a selected register value;

a calculator communicatively associated with the threshold identification module, the calculator configured to calculate first and second difference thresholds based on the upper and lower velocity thresholds, respectively; and

a threshold selection module communicatively associated with the register value selection module, the calculator and the comparator, the threshold selection module configured to select one of the first and second difference thresholds based on the selected register value so as to output the selected difference threshold.

The motion event detection system of Concept 43, further including or comprising:

a register communicatively associated with the register value selection module and the threshold selection module, the register configured to store the selected register value.

45. The motion event detection system of Concept 1, further including or comprising:

a signal generator communicatively associated with the detection module, the signal generator configured to automatically generate an alarm signal in response to the motion event being detected.

IV. Fourth Exemplary Concept Group

1. A method of motion event detection including or comprising:

accessing velocity data identifying a velocity associated with an object;

accessing location data identifying a location associated with the object;

accessing location information from a location database based on the location data, the location information identifying a predefined area associated with the location;

accessing velocity information based on the location information, the velocity information identifying upper and lower velocity thresholds associated with the predefined area;

conducting a first comparison between the velocity and the upper velocity threshold so as to determine whether the velocity is greater than the upper velocity threshold;

conducting a second comparison between the velocity and the lower velocity threshold so as to determine whether the velocity is less than the lower velocity threshold; and

detecting the motion event based on the velocity being either greater than the upper velocity threshold or less than the lower velocity threshold.

2. A computer-readable medium storing a set of instructions that when executed cause a computer system to perform the method of Concept 1.

V. Fifth Exemplary Concept Group

1. A method of velocity threshold selection including or comprising:

identifying one or more current factors associated with a predefined area; and

selecting a velocity threshold based on the one or more current factors.

2. The method of Concept 1, further including or comprising:

selecting the one or more current factors from a group of current factors including or comprising a current date, current time, current traffic factor, current road factor, current weather factor and current environmental factor.

3. The method of Concept 1, further including or comprising:

accessing a speed threshold and a tolerance threshold, the speed threshold being associated with the predefined area; and

selecting the velocity threshold based on the speed threshold and the tolerance threshold.

4. The method of Concept 3, further including or comprising:

identifying the predefined area; and

selecting the speed threshold based on the predefined area.

5. The method of Concept 3, further including or comprising:

accessing real-time information identifying one or more parameters selected from a group of parameters including or comprising a current date, current time, current traffic factor, current road factor, current weather factor and current environmental factor; and

selecting the speed threshold based on the one or more parameters.

6. The method of Concept 3, wherein the tolerance threshold is associated with the predefined area.

7. The method of Concept 3, further including or comprising:

identifying the predefined area; and

selecting the tolerance threshold based on the predefined area.

8. The method of Concept 3, further including or comprising:

calculating the tolerance threshold based on the speed threshold.

9. The method of Concept 3, further including or comprising:

accessing real-time information identifying one or more parameters selected from a group of parameters including or comprising a current date, current time, current traffic factor, current road factor, current weather factor and current environmental factor; and

selecting the tolerance threshold based on the one or more parameters.

10. The method of Concept 3, further including or comprising:

adding the tolerance threshold to the speed threshold to thereby obtain the velocity threshold.

11. The method of Concept 3, further including or comprising:

subtracting the tolerance threshold from the speed threshold to thereby obtain the velocity threshold.

12. The method of Concept 1, further including or comprising:

routing the velocity threshold to an electronic display unit such that the velocity threshold is displayed by the electronic display unit.

13. The method of Concept 1, further including or comprising:

accessing a velocity database storing a preselected velocity threshold; and

storing the velocity threshold in the velocity database so as to update the preselected velocity threshold to reflect the velocity threshold.

14. A computer-readable medium storing a set of instructions that when executed cause a computer system to perform a method as recited in any one of the preceding Concepts.

VI. Sixth Exemplary Concept Group

1. A velocity threshold selection system including or comprising:

a factor identification module configured to identify one or more current factors associated with a predefined area; and

a velocity threshold selection module communicatively associated with the factor identification module, the velocity threshold selection module configured to select a velocity threshold based on the one or more current factors.

2. The velocity threshold selection system of Concept 1, further including or comprising:

a factor selection module communicatively associated with the factor identification module, the factor selection module configured to select the one or more current factors from a group of current factors including or comprising a current date, current time, current traffic factor, current road factor, current weather factor and current environmental factor.

3. The velocity threshold selection system of Concept 1, further including or comprising:

a data accessing module configured to access a speed threshold and a tolerance threshold, the speed threshold being associated with the predefined area, the velocity threshold selection module being communicatively associated with the data accessing module, and the velocity threshold selection module configured to select the velocity threshold based on the speed threshold and the tolerance threshold.

4. The velocity threshold selection system of Concept 3, further including or comprising:

an area identification module configured to identify the predefined area; and

a speed threshold selection module communicatively associated with the area identification and data accessing modules, the speed threshold selection module configured to select the speed threshold based on the predefined area.

5. The velocity threshold selection system of Concept 3, further including or comprising:

a speed threshold selection module communicatively associated with the data accessing module, the speed threshold selection module configured to access real-time information identifying one or more parameters selected from a group of parameters including or comprising a current date, current time, current traffic factor, current road factor, current weather factor and current environmental factor and select the speed threshold based on the one or more parameters.

6. The velocity threshold selection system of Concept 3, wherein the tolerance threshold is associated with the predefined area.

7. The velocity threshold selection system of Concept 3, further including or comprising:

an area identification module configured to identify the predefined area; and

a tolerance threshold selection module communicatively associated with the area identification and data accessing modules, the tolerance threshold selection module configured to select the tolerance threshold based on the predefined area.

8. The velocity threshold selection system of Concept 3, further including or comprising:

a tolerance threshold selection module communicatively associated with the data accessing module, the tolerance threshold selection module configured to access real-time information identifying one or more parameters selected from a group of parameters including or comprising a current date, current time, current traffic factor, current road factor, current weather factor and current environmental factor and select the tolerance threshold based on the one or more parameters.

9. The velocity threshold selection system of Concept 3, further including or comprising:

a tolerance threshold calculator communicatively associated with the data accessing module, the tolerance threshold calculator configured to calculate the tolerance threshold based on the speed threshold.

10. The velocity threshold selection system of Concept 3, wherein the velocity threshold selection module is configured to add the tolerance threshold to the speed threshold to thereby obtain the velocity threshold.

11. The velocity threshold selection system of Concept 3, wherein the velocity threshold selection module is configured to subtract the tolerance threshold from the speed threshold to thereby obtain the velocity threshold.

12. The velocity threshold selection system of Concept 1, further including or comprising:

an electronic display unit configured to receive electronic information and generate a visual display based on the electronic information; and

a router communicatively associated with the velocity threshold selection module and the electronic display unit, the router configured to route the velocity threshold to the electronic display unit such that the velocity threshold is displayed by the electronic display unit.

13. The velocity threshold selection system of Concept 1, further including or comprising:

a router communicatively associated with the velocity threshold selection module, the router configured to route the velocity threshold to a velocity database storing a preselected velocity threshold such that the velocity database stores the velocity threshold, and such that the preselected velocity threshold is thereby updated to reflect the velocity threshold.

VII. Seventh Exemplary Concept Group

1. A method of velocity threshold selection including or comprising:

accessing a speed threshold and a tolerance threshold, the speed threshold being associated with a predefined area; and

selecting a velocity threshold based on the speed threshold and the tolerance threshold.

2. The method of Concept 1 further including or comprising:

identifying the predefined area; and

selecting the speed threshold based on the predefined area.

3. The method of Concept 1, further including or comprising:

accessing real-time information identifying one or more parameters selected from a group of parameters including or comprising a current date, current time, current traffic factor, current road factor, current weather factor and current environmental factor; and

selecting the speed threshold based on the one or more parameters.

4. The method of Concept 1, wherein the tolerance threshold is associated with the predefined area.

5. The method of Concept 1, further including or comprising:

identifying the predefined area; and

selecting the tolerance threshold based on the predefined area.

6. The method of Concept 1, further including or comprising:

calculating the tolerance threshold based on the speed threshold.

7. The method of Concept 1, further including or comprising:

accessing real-time information identifying one or more parameters selected from a group of parameters including or comprising a current date, current time, current traffic factor, current road factor, current weather factor and current environmental factor; and

selecting the tolerance threshold based on the one or more parameters.

8. The method of Concept 1, further including or comprising:

adding the tolerance threshold to the speed threshold to thereby obtain the velocity threshold.

9. The method of Concept 1, further including or comprising:

subtracting the tolerance threshold from the speed threshold to thereby obtain the velocity threshold.

10. The method of Concept 1, further including or comprising:

identifying one or more current factors associated with the predefined area; and

selecting the velocity threshold based on the one or more current factors.

11. The method of Concept 10, further including or comprising:

selecting the one or more current factors from a group of current factors including or comprising a current date, current time, current traffic factor, current road factor, current weather factor and current environmental factor.

12. The method of Concept 1, further including or comprising:

routing the velocity threshold to an electronic display unit such that the velocity threshold is displayed by the electronic display unit.

13. The method of Concept 1, further including or comprising:

accessing a velocity database storing a preselected velocity threshold; and

storing the velocity threshold in the velocity database so as to update the preselected velocity threshold to reflect the velocity threshold.

14. A computer-readable medium storing a set of instructions that when executed cause a computer system to perform a method as recited in any one of the preceding Concepts.

VIII. Eighth Exemplary Concept Group

1. A velocity threshold selection system including or comprising:

a data accessing module configured to access a speed threshold and a tolerance threshold, the speed threshold being associated with a predefined area; and

a velocity threshold selection module communicatively associated with the data accessing module, the velocity threshold selection module configured to select a velocity threshold based on the speed threshold and the tolerance threshold.

2. The velocity threshold selection system of Concept 1, further including or comprising:

an area identification module configured to identify the predefined area; and

a speed threshold selection module communicatively associated with the area identification and data accessing modules, the speed threshold selection module configured to select the speed threshold based on the predefined area.

3. The velocity threshold selection system of Concept 1, further including or comprising:

a speed threshold selection module communicatively associated with the data accessing module, the speed threshold selection module configured to access real-time information identifying one or more parameters selected from a group of parameters including or comprising a current date, current time, current traffic factor, current road factor, current weather factor and current environmental factor and select the speed threshold based on the one or more parameters.

4. The velocity threshold selection system of Concept 1, wherein the tolerance threshold is associated with the predefined area.

5. The velocity threshold selection system of Concept 1, further including or comprising:

an area identification module configured to identify the predefined area; and

a tolerance threshold selection module communicatively associated with the area identification and data accessing modules, the tolerance threshold selection module configured to select the tolerance threshold based on the predefined area.

6. The velocity threshold selection system of Concept 1, further including or comprising:

a tolerance threshold selection module communicatively associated with the data accessing module, the tolerance threshold selection module configured to access real-time information identifying one or more parameters selected from a group of parameters including or comprising a current date, current time, current traffic factor, current road factor, current weather factor and current environmental factor and select the tolerance threshold based on the one or more parameters.

7. The velocity threshold selection system of Concept 1, further including or comprising:

a tolerance threshold calculator communicatively associated with the data accessing module, the tolerance threshold calculator configured to calculate the tolerance threshold based on the speed threshold.

8. The velocity threshold selection system of Concept 1, wherein the velocity threshold selection module is configured to add the tolerance threshold to the speed threshold to thereby obtain the velocity threshold.

9. The velocity threshold selection system of Concept 1, wherein the velocity threshold selection module is configured to subtract the tolerance threshold from the speed threshold to thereby obtain the velocity threshold.

10. The velocity threshold selection system of Concept 1, further including or comprising:

a factor identification module configured to identify one or more current factors associated with the predefined area, the velocity threshold selection module being communicatively associated with the factor identification module, and the velocity threshold selection module configured to select a velocity threshold based on the one or more current factors.

11. The velocity threshold selection system of Concept 10, further including or comprising:

a factor selection module communicatively associated with the factor identification module, the factor selection module configured to select the one or more current factors from a group of current factors including or comprising a current date, current time, current traffic factor, current road factor, current weather factor and current environmental factor.

12. The velocity threshold selection system of Concept 1, further including or comprising:

an electronic display unit configured to receive electronic information and generate a visual display based on the electronic information; and

a router communicatively associated with the velocity threshold selection module and the electronic display unit, the router configured to route the velocity threshold to the electronic display unit such that the velocity threshold is displayed by the electronic display unit.

13. The velocity threshold selection system of Concept 1, further including or comprising:

a router communicatively associated with the velocity threshold selection module, the router configured to route the velocity threshold to a velocity database storing a preselected velocity threshold such that the velocity database stores the velocity threshold, and such that the preselected velocity threshold is thereby updated to reflect the velocity threshold.

It is noted that reference throughout this specification to features, advantages, or similar language does not imply that all of the features and advantages should be or are in any single embodiment. Rather, language referring to the features and advantages may be understood to mean that a specific feature, advantage, or feature described in connection with an embodiment is included in at least one embodiment of the present technology. Thus, discussions of the features and advantages, and similar language, throughout this specification may, but do not necessarily, refer to the same embodiment.

Various embodiments of the present disclosure, as discussed above, may be practiced with steps and/or operations in a different order, and/or with hardware elements in configurations which are different than those which are disclosed. Therefore, although the technology has been described based upon the foregoing exemplary embodiments, it is noted that certain modifications, variations, and alternative constructions may be implemented without departing from the scope of the present technology.

Although various exemplary embodiments of the present technology are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-readable medium storing a set of instructions that when executed cause a computer system to perform a method of motion event detection, said method comprising:
identifying a velocity associated with an object;
identifying a location associated with said object;
identifying a predefined area associated with said location;
identifying a velocity threshold associated with said predefined area;
conducting a comparison between said velocity and said velocity threshold; and
detecting a motion event based on said comparison.

2. The computer-readable medium of claim 1, wherein said method further comprises:
identifying a course, path or route associated with said object; and
identifying said predefined area based on said location and said course, path or route.

3. The computer-readable medium of claim 1, wherein said method further comprises:
accessing real-time information identifying one or more parameters selected from a group of parameters comprising a current date, current time, current traffic factor, current road factor, current weather factor and current environmental factor; and
identifying said velocity threshold based on said one or more parameters.

4. The computer-readable medium of claim 1, wherein said method further comprises:
identifying a speed threshold based on said predefined area;
calculating a tolerance threshold based on said speed threshold; and
adding said tolerance threshold to, or subtracting said tolerance threshold from, said speed threshold to thereby obtain said velocity threshold.

5. The computer-readable medium of claim 1, wherein said velocity threshold is an upper velocity threshold associated with said predefined area, said comparison being a first comparison between said velocity and said upper velocity threshold, and said method further comprising:
conducting said first comparison between said velocity and said upper velocity threshold so as to determine whether said velocity is greater than said upper velocity threshold;
identifying a lower velocity threshold associated with said predefined area;
conducting a second comparison between said velocity and said lower velocity threshold so as to determine whether said velocity is less than said lower velocity threshold; and
detecting said motion event based on said velocity being either greater than said upper velocity threshold or less than said lower velocity threshold.

6. The computer-readable medium of claim 1, wherein said method further comprises:
detecting said motion event based on an absolute value of a difference between said velocity and said velocity threshold being greater than an absolute value of a preselected margin.

7. The computer-readable medium of claim 1, wherein said method further comprises:
determining a difference between said velocity and said velocity threshold;
determining an absolute value of said difference;
calculating a difference threshold based on said velocity threshold and a numerical input;
comparing said absolute value of said difference to an absolute value of said difference threshold; and
detecting said motion event based on said absolute value of said difference being greater than said absolute value of said difference threshold.

8. The computer-readable medium of claim 1, wherein said velocity threshold is an upper velocity threshold associated with said predefined area, said method further comprising:
determining a first difference between said velocity and said upper velocity threshold and a second difference between said velocity and a lower velocity threshold associated with said predefined area;
determining that said velocity is either greater than said upper velocity threshold or less than said lower velocity threshold;
determining first and second absolute values of said first and second differences, respectively;
selecting a lowest absolute value from among said first and second absolute values so as to output a selected absolute value;
comparing said selected absolute value to an absolute value of a selected difference threshold; and
detecting said motion event based on said selected absolute value being greater than said absolute value of said selected difference threshold.

9. The computer-readable medium of claim 1, wherein said method further comprises:
accessing real-time information identifying one or more parameters selected from a group of parameters comprising a current date, current time, current traffic factor, current road factor, current weather factor and current environmental factor;
selecting an updated velocity threshold based on said one or more parameters; and
routing said updated velocity threshold to a velocity database storing said velocity threshold so as to update said velocity threshold based on said updated velocity threshold.

10. A method of motion event detection comprising:
accessing velocity data identifying a velocity associated with an object;
accessing location data identifying a location associated with said object;
accessing location information from a location database based on said location data, said location information identifying a predefined area associated with said location;
accessing velocity information based on said location information, said velocity information identifying a velocity threshold associated with said predefined area;
forwarding said velocity data and said velocity information to an electronic difference engine to determine a difference between said velocity and said velocity threshold; and
detecting a motion event based on said difference.

11. The method of claim 10, further comprising:
accessing course, path or route data identifying a course, path or route associated with said object; and
accessing said location information from said location database based on said location data and said course, path or route data, said predefined area being associated with said location and said course, path or route.

12. The method of claim 10, further comprising:
accessing real-time information identifying one or more parameters selected from a group of parameters comprising a current date, current time, current traffic factor, current road factor, current weather factor and current environmental factor; and
accessing said velocity information based on said one or more parameters.

13. The method of claim 10, further comprising:
accessing speed information from a velocity database based on said location information, said speed information identifying a speed threshold associated with said predefined area;
calculating a tolerance threshold based on said speed threshold;
adding said tolerance threshold to, or subtracting said tolerance threshold from, said speed threshold to thereby obtain said velocity threshold; and
generating said velocity information based on said velocity threshold.

14. The method of claim 10, wherein said velocity threshold is an upper velocity threshold associated with said predefined area, said velocity information identifying said upper velocity threshold and a lower velocity threshold associated with said predefined area, and said method further comprising:
conducting a first comparison between said velocity and said upper velocity threshold so as to determine whether said velocity is greater than said upper velocity threshold;
conducting a second comparison between said velocity and said lower velocity threshold so as to determine whether said velocity is less than said lower velocity threshold; and
detecting said motion event based on said velocity being either greater than said upper velocity threshold or less than said lower velocity threshold.

15. The method of claim 10, further comprising:
detecting said motion event based on an absolute value of said difference being greater than an absolute value of a preselected margin.

16. The method of claim 10, further comprising:
determining an absolute value of said difference;
calculating a difference threshold based on said velocity threshold and a numerical input;
comparing said absolute value of said difference to an absolute value of said difference threshold; and
detecting said motion event based on said absolute value of said difference being greater than said absolute value of said difference threshold.

17. The method of claim 10, wherein said velocity threshold is an upper velocity threshold associated with said predefined area, said velocity information identifying said upper velocity threshold and a lower velocity threshold associated with said predefined area, said difference being a first difference between said velocity and said upper velocity threshold, and said method further comprising:
forwarding said velocity data and said velocity information to said electronic difference engine to determine said first difference and a second difference between said velocity and said lower velocity threshold;
determining that said velocity is either greater than said upper velocity threshold or less than said lower velocity threshold;
determining first and second absolute values of said first and second differences, respectively;
selecting a lowest absolute value from among said first and second absolute values so as to output a selected absolute value;
comparing said selected absolute value to an absolute value of a selected difference threshold; and
detecting said motion event based on said selected absolute value being greater than said absolute value of said selected difference threshold.

18. The method of claim 10, further comprising:
accessing real-time information identifying one or more parameters selected from a group of parameters comprising a current date, current time, current traffic factor, current road factor, current weather factor and current environmental factor;
selecting an updated velocity threshold based on said one or more parameters;
generating updated velocity information identifying said updated velocity threshold; and
routing said updated velocity information to a velocity database storing said velocity threshold so as to update said velocity threshold based on said updated velocity threshold.

19. A computer-readable medium storing a set of instructions that when executed cause a computer system to perform the method of claim 10.

20. A motion event detection system comprising:
a velocity identification module configured to identify a velocity associated with an object;
a location identification module configured to identify a location associated with said object;
an area identification module communicatively associated with said location identification module, said area identification module configured to identify a predefined area associated with said location;
a threshold identification module communicatively associated with said area identification module, said threshold identification module configured to identify a velocity threshold associated with said predefined area;
a comparator communicatively associated with said velocity and threshold identification modules, said comparator configured to conduct a comparison between said velocity and said velocity threshold; and
a detection module communicatively associated with said comparator, said detection module configured to detect a motion event based on said comparison.
